(19) United States
(12) Patent Application Publication
(10) Pub. No.: US 2012/0074110 A1
(43) Pub. Date: Mar. 29, 2012

(54) FLUID LASER JETS, CUTTING HEADS, TOOLS AND METHODS OF USE

(76) Inventors: Mark S. Zediker, Castle Rock, CO (US); Daryl L. Grubb, Littleton, CO (US); Sharath K. Kolachalam, Highlands Ranch, CO (US); Sam N. Schroit, Littleton, CO (US); Ronald A. DeWitt, Katy, TX (US); Charles C. Rinzler, Denver, CO (US); William C. Gray, Parker, CO (US); Paul D. Deutch, Houston, TX (US); Brian O. Faircloth, Evergreen, CO (US); Yeshaya Koblick, Sharon, MA (US); Joel F. Moxley, Denver, CO (US)

(21) Appl. No.: 13/222,931

(22) Filed: Aug. 31, 2011

Related U.S. Application Data
(63) Continuation-in-part of application No. 13/210,581, filed on Aug. 16, 2011.
Application No. 13/210,581 is a continuation-in-part of application No. 12/544,136, filed on Aug. 19, 2009.
Application No. 12/544,136 is a continuation-in-part of application No. 12/544,094, filed on Aug. 19, 2009.
Application No. 13/210,581 is a continuation-in-part of application No. 12/706,576, filed on Feb. 16, 2010.
Application No. 12/706,576 is a continuation-in-part of application No. 12/544,136, filed on Aug. 19, 2009.
Application No. 13/210,581 is a continuation-in-part of application No. 12/840,978, filed on Jul. 21, 2010.
Application No. 12/840,978 is a continuation-in-part of application No. 12/543,986, filed on Aug. 19, 2009.
(60) Provisional application No. 61/378,910, filed on Aug. 31, 2010.
(60) Provisional application No. 61/374,594, filed on Aug. 17, 2010.
(60) Provisional application No. 61/446,312, filed on Feb. 24, 2011.
(60) Provisional application No. 61/090,384, filed on Aug. 20, 2008.
(60) Provisional application No. 61/102,730, filed on Oct. 3, 2008.
(60) Provisional application No. 61/106,472, filed on Oct. 17, 2008.
(60) Provisional application No. 61/153,271, filed on Feb. 17, 2009.
(60) Provisional application No. 61/106,472, filed on Oct. 17, 2008.
(60) Provisional application No. 61/153,271, filed on Feb. 17, 2009.
(60) Provisional application No. 61/295,562, filed on Jan. 15, 2010.
(60) Provisional application No. 61/439,970, filed on Feb. 7, 2011.
(60) Provisional application No. 61/493,174, filed on Jun. 3, 2011.
(60) Provisional application No. 61/446,042, filed on Feb. 24, 2011.
(60) Provisional application No. 61/514,391, filed on Aug. 2, 2011.

(51) Int. Cl. B23K 26/38; B23K 26/12

(52) U.S. Cl. 219/121.72; 219/121.67

(57) ABSTRACT

There are provided high power laser systems, apparatus and methods for performing laser operations in particular in environments where an optically obstructive medium may be present in the laser beam path, such as within the borehole of an oil, gas or geothermal well, or below the surface of a body of water. Further, there are provided such systems, apparatus and methods that manage potentially damaging back reflections that may be generated during such laser operations. The high power laser operations would including tasks, such as, window cutting, pipe cutting and other workover completion activities, as well as decommissioning, plugging and abandonment tasks.

This application: (i) claims, under 35 U.S.C. §119(e)(1), the benefit of the filing date of Aug. 31, 2010 of provisional application Ser. No. 61/378,910; (ii) is a continuation-in-part of U.S. patent application Ser. No. 13/210,581, filed Aug. 16, 2011, which claims, under 35 U.S.C. §119(e)(1), the benefit of the filing date of Aug. 17, 2010 of provisional application Ser. No. 61/374,594; (iii) claims, under 35 U.S.C. §119(e)(1), the benefit of the filing date of Feb. 24, 2011 of provisional application Ser. No. 61/446,312; (iv) is a continuation-in-part of U.S. patent application Ser. No. 12/544,136, filed Aug. 19, 2009, which claims, under 35 U.S.C. §119(e)(1), the benefit of the filing date of Aug. 20, 2008 of provisional application Ser. No. 61/090,384, the benefit of the filing date of Oct. 3, 2008 of provisional application Ser. No. 61/102,730, the benefit of the filing date of Oct. 17, 2008 of provisional application Ser. No. 61/106,472, and the benefit of the filing date of Feb. 17, 2009 of provisional application Ser. No. 61/153,271; (v) is a continuation-in-part of U.S. patent application Ser. No. 12/544,094, filed Aug. 19, 2009; (vi) is a continuation-in-part of U.S. patent application Ser. No. 12/706,576 filed Feb. 16, 2010, which is a continuation-in-part of U.S. patent application Ser. No. 12/544,136 filed Aug. 19, 2009, and which claims, under 35 U.S.C. §119(e)(1), the benefit of the filing date of Oct. 17, 2008 of provisional application Ser. No. 61/106,472, the benefit of the filing date of Feb. 17, 2009 of provisional application Ser. No. 61/153,271, and the benefit of the filing date of Jan. 15, 2010 of provisional application Ser. No. 61/295,562; (vii) is a continuation-in-part of U.S. patent application Ser. No. 12/840,978 filed Jul. 21, 2010; and, (viii) claims, under 35 U.S.C. §119(e)(1), the benefit of the filing date of Feb. 7, 2011 of provisional application Ser. No. 61/439,970, (ix) claims, under 35 U.S.C. §119(e)(1), the benefit of the filing date of Jun. 3, 2011 of provisional application Ser. No. 61/493,174, filed Jun. 3, 2011; (x) claims, under 35 U.S.C. §119(e)(1), the benefit of the filing date of Feb. 24, 2011 of provisional patent application Ser. No. 61/446,042; (xi) claims, under 35 U.S.C. §119(e)(1), the benefit of the filing date of Aug. 2, 2011 of provisional patent application Ser. No. 61/514,391; and, is a continuation-in-part of U.S. patent application Ser. No. 12/543,986, filed Aug. 19, 2009, the entire disclosures, of each, of which are incorporated herein by reference.

This invention was made with Government support under Award DE-AR0000044 awarded by the Office of ARPA-E U.S. Department of Energy. The Government has certain rights in this invention.

### BACKGROUND OF THE INVENTION

### Field of the Invention

The present inventions relate to methods, apparatus and systems for the delivery of high power laser beams to a work surface and in particular work surfaces that are in remote, hazardous, optically occluded and difficult to access locations, such as: oil wells, boreholes in the earth, pipelines, underground mines, natural gas wells, geothermal wells, mining, subsea structures, or nuclear reactors. The high power laser beams may be used at the delivered location for activities, such as, monitoring, welding, cladding, annealing, heating, cleaning, controlling, assembling, drilling, machining, powering equipment and cutting. Thus, the present invention relates to methods and apparatus for the delivery of a laser beam through the use of an isolated laser beam that may be in a fluid jet that may for example be a gas jet, a dual jet having a gas and a liquid, or two different liquids, each having different indices of refraction. The present inventions further relate to such methods and apparatus for laser assisted milling, cutting, flow assurance, decommissioning, plugging, abandonment and perforating activities in the exploration, production and development of natural resources, such as oil, gas and geothermal.

As used herein, unless specified otherwise “high power laser energy” means a laser beam having at least about 1 kW (kilowatt) of power. As used herein, unless specified otherwise “great distances” means at least about 500 m (meter). As used herein, unless specified otherwise, the term “substantial loss of power,” “substantial power loss” and similar such phrases, mean a loss of power of more than about 3.0 dB/km (decibel/kilometer) for a selected wavelength. As used herein the term “substantial power transmission” means at least about 50% transmittance.

As used herein, unless specified otherwise, “optical connector”, “fiber optics connector”, “connector” and similar terms should be given their broadest possible meaning and include any component from which a laser beam is or can be propagated, any component into which a laser beam can be propagated, and any component that propagates, receives or both a laser beam in relation to, e.g., free space, (which would include a vacuum, a gas, a liquid, a foam and other non-optical component materials), an optical component, a wave guide, a fiber, and combinations of the forgoing.

As used herein the term “pipeline” should be given its broadest possible meaning, and includes any structure that contains a channel having a length that is many orders of magnitude greater than its cross-sectional area and which is for, or capable of, transporting a material along at least a portion of the length of the channel. Pipelines may be many miles long and may be many hundreds of miles long. Pipelines may be located below the earth, above the earth, under water, within a structure, or combinations of these and other locations. Pipelines may be made from metal, steel, plastics, ceramics, composite materials, or other materials and compositions know to the pipeline arts and may have external and internal coatings, known to the pipeline arts. In general, pipelines may have internal diameters that range from about 2 to about 60 inches although larger and smaller diameters may be utilized. In general natural gas pipelines may have internal diameters ranging from about 2 to 60 inches and oil pipelines have internal diameters ranging from about 4 to 48 inches. Pipelines may be used to transmit numerous types of materials, in the form of a liquid, gas, fluidized solid, slurry or combinations thereof. Thus, for example pipelines may carry hydrocarbons; chemicals; oil; petroleum products; gasoline; ethanol; biofuels; water; drinking water; irrigation water; cooling water; water for hydroelectric power generation; water, or other fluids for geothermal power generation; natural gas; paints; slurries, such as mineral slurries, coal slurries, pulp slurries; and ore slurries; gases, such as nitrogen and hydrogen; cosmetics; pharmaceuticals; and food products, such as beer.

As used herein the term “earth” should be given its broadest possible meaning, and includes, the ground, all natural materials, such as rocks, and artificial materials, such as concrete, that are or may be found in the ground, including without limitation rock layer formations, such as, granite, basalt, sandstone, dolomite, sand, salt, limestone, rhyolite, quartzite and shale rock.

As used herein the term “borehole” should be given it broadest possible meaning and includes any opening that is created in a material, a work piece, a surface, the earth, a structure (e.g., building, protected military installation, nuclear plant, offshore platform, or ship), or in a structure in the ground, (e.g., foundation, roadway, airstrip, cave or subterranean structure) that is substantially longer than it is wide, such as a well, a well bore, a well hole, a micro hole, slimhole and other terms commonly used or known in the arts to define these types of narrow long passages. Wells would further include exploratory, production, abandoned, reentered, reworked, and injection wells, and cased and uncased or open holes. Although boreholes are generally oriented substantially vertically, they may also be oriented on an angle from vertical, to and including horizontal. Thus, using a vertical line, based upon a level as a reference point, a borehole can have orientations ranging from 0° i.e., vertical, to 90°,i.e., horizontal and greater than 90° e.g., such as a heel and toe, and combinations of these such as for example “U” and “Y” shapes. Boreholes may further have segments or sections that have different orientations, they may have straight sections and arcuate sections and combinations thereof; and for example may be of the shapes commonly found when directional drilling is employed. Thus, as used herein unless expressly provided otherwise, the “bottom” of a borehole, the “bottom surface” of the borehole and similar terms refer to the end of the borehole, i.e., that portion of the borehole furthest along the path of the borehole from the borehole's opening, the surface of the earth, or the borehole's beginning. The terms “side” and “wall” of a borehole should to be given their broadest possible meaning and include the longitudinal surfaces of the borehole, whether or not casing or a liner is present, as such, these terms would include the sides of an open borehole or the sides of the casing that has been positioned within a borehole. Boreholes may be made up of a single passage, multiple passages, connected passages and combinations thereof, in a situation where multiple boreholes are connected or interconnected each borehole would have a borehole bottom. Boreholes may be formed in the sea floor, under bodies of water, on land, in ice formations, or in other locations and settings.

Boreholes are generally formed and advanced by using mechanical drilling equipment having a rotating drilling tool, e.g., a bit. For example and in general, when creating a borehole in the earth, a drilling bit is extending to and into the earth and rotated to create a hole in the earth. In general, to perform the drilling operation the bit must be forced against the material to be removed with a sufficient force to exceed the shear strength, compressive strength or combinations thereof, of that material. Thus, in conventional drilling activity mechanical forces exceeding these strengths of the rock or earth must be applied. The material that is cut from the earth is generally known as cuttings, e.g., waste, which may be chips of rock, dust, rock fibers and other types of materials and structures that may be created by the bit's interactions with the earth. These cuttings are typically removed from the borehole by the use of fluids, which fluids can be liquids, foams or gases, or other materials know to the art.

As used herein the term “advancing” a borehole should be given its broadest possible meaning and includes increasing the length of the borehole. Thus, by advancing a borehole, provided the orientation is less than 90° the depth of the borehole may also increase. The true vertical depth (“TVD”) of a borehole is the distance from the top or surface of the borehole to the depth at which the bottom of the borehole is located, measured along a straight vertical line. The measured depth (“MD”) of a borehole is the distance as measured along the actual path of the borehole from the top or surface to the bottom. As used herein unless specified otherwise the term depth of a borehole will refer to MD. In general, a point of reference may be used for the top of the borehole, such as the rotary table, drill floor, well head or initial opening or surface of the structure in which the borehole is placed.

As used herein the terms “ream”, “reaming”, a borehole, or similar such terms, should be given their broadest possible meaning and includes any activity performed on the sides of a borehole, such as, e.g., smoothing, increasing the diameter of the borehole, removing materials from the sides of the borehole, such as e.g., waxes or filter cakes, and under-reaming.

As used herein the terms “drill bit”, “bit”, “drilling bit” or similar such terms, should be given their broadest possible meaning and include all tools designed or intended to create a borehole in an object, a material, a work piece, a surface, the earth or a structure including structures within the earth, and would include bits used in the oil, gas and geothermal arts, such as fixed cutter and roller cone bits, as well as, other types of bits, such as, rotary shoe, drag-type, fishtail, adamantine, single and multi-toothed, cone, reaming cone, reaming, self-cleaning, disc, three cone, rolling cutter, crossroller, jet, core, impreg and hammer bits, and combinations and variations of the these.

In both roller cone, fixed bits, and other types of mechanical drilling the state of the art, and the teachings and direction of the art, provide that to advance a borehole great force should be used to push the bit against the bottom of the borehole as the bit is rotated. This force is referred to as weight-on-bit (“WOB”). Typically, tens of thousands of pounds WOB are used to advance a borehole using a mechanical drilling process.

Mechanical bits cut rock by applying crushing (compressive) and/or shear stresses created by rotating a cutting surface against the rock and placing a large amount of WOB. In the case of a PDC bit this action is primarily by shear stresses and in the case of roller cone bits this action is primarily by crushing (compression) and shearing stresses. For example, the WOB applied to an 8¾″ PDC bit may be up to 15,000 lbs, and the WOB applied to an 8¾″ roller cone bit may be up to 60,000 lbs. When mechanical bits are used for drilling hard and ultra-hard rock excessive WOB, rapid bit wear, and long tripping times result in an effective drilling rate that is essentially economically unviable. The effective drilling rate is based upon the total time necessary to complete the borehole and, for example, would include time spent tripping in and out of the borehole, as well as, the time for repairing or replacing damaged and worn bits.

As used herein the term “drill pipe” is to be given its broadest possible meaning and includes all forms of pipe used for drilling activities; and refers to a single section or piece of pipe. As used herein the terms “stand of drill pipe,” “drill pipe stand,” “stand of pipe,” “stand” and similar type terms should be given their broadest possible meaning and include two, three or four sections of drill pipe that have been connected, e.g., joined together, typically by joints having threaded connections. As used herein the terms “drill string,” “string,” “string of drill pipe,” string of pipe” and similar type terms should be given their broadest definition and would include a stand or stands joined together for the purpose of being employed in a borehole. Thus, a drill string could include many stands and many hundreds of sections of drill pipe.

As used herein the term “tubular” is to be given its broadest possible meaning and includes drill pipe, casing, riser, coiled tube, composite tube, vacuum insulated tubing (“VIT), production tubing and any similar structures having at least one channel therein that are, or could be used, in the drilling industry. As used herein the term “joint” is to be given its broadest possible meaning and includes all types of devices, systems, methods, structures and components used to connect tubulars together, such as for example, threaded pipe joints and bolted flanges. For drill pipe joints, the joint section typically has a thicker wall than the rest of the drill pipe. As used herein the thickness of the wall of tubular is the thickness of the material between the internal diameter of the tubular and the external diameter of the tubular.

As used herein, unless specified otherwise the terms “blowout preventer,” “BOP,” and “BOP stack” should be given their broadest possible meaning, and include: (i) devices positioned at or near the borehole surface, e.g., the surface of the earth including dry land or the seafloor, which are used to contain or manage pressures or flows associated with a borehole; (ii) devices for containing or managing pressures or flows in a borehole that are associated with a subsea riser or a connector; (iii) devices having any number and combination of gates, valves or elastomeric packers for controlling or managing borehole pressures or flows; (iv) a subsea BOP stack, which stack could contain, for example, ram shears, pipe rams, blind rams and annular preventers; and, (v) other such similar combinations and assemblies of flow and pressure management devices to control borehole pressures, flows or both and, in particular, to control or manage emergency flow or pressure situations.

As used herein, unless specified otherwise “offshore” and “offshore drilling activities” and similar such terms are used in their broadest sense and would include drilling activities on, or in, any body of water, whether fresh or salt water, whether manmade or naturally occurring, such as for example rivers, lakes, canals, inland seas, oceans, seas, bays and gulfs, such as the Gulf of Mexico. As used herein, unless specified otherwise the term “offshore drilling rig” is to be given its broadest possible meaning and would include fixed towers, tenders, platforms, barges, jack-ups, floating platforms, drill ships, dynamically positioned drill ships, semi-submersibles and dynamically positioned semi-submersibles. As used herein, unless specified otherwise the term “seafloor” is to be given its broadest possible meaning and would include any surface of the earth that lies under, or is at the bottom of, any body of water, whether fresh or salt water, whether manmade or naturally occurring.

As used herein, unless specified otherwise the term “fixed platform,” would include any structure that has at least a portion of its weight supported by the seafloor. Fixed platforms would include structures such as: free-standing caissons, well-protector jackets, pylons, braced caissons, piled-jackets, skirted piled-jackets, compliant towers, gravity structures, gravity based structures, skirted gravity structures, concrete gravity structures, concrete deep water structures and other combinations and variations of these. Fixed platforms extend from at or below the seafloor to and above the surface of the body of water, e.g., sea level. Deck structures are positioned above the surface of the body of water atop of vertical support members that extend down in to the water to the seafloor. Fixed platforms may have a single vertical support, or multiple vertical supports, e.g., pylons, legs, etc., such as a three, four, or more support members, which may be made from steel, such as large hollow tubular structures, concrete, such as concrete reinforced with metal such as rebar, and combinations of these. These vertical support members are joined together by horizontal and other support members. In a piled-jacket platform the jacket is a derrick-like structure having hollow essentially vertical members near its bottom. Piles extend out from these hollow bottom members into the seabed to anchor the platform to the seabed.

As used herein the terms “decommissioning,” “plugging” and “abandoning” and similar such terms should be given their broadest possible meanings and would include activities relating to the cutting and removal of casing and other tubulars from a well (above the surface of the earth, below the surface of the earth and both), modification or removal of structures, apparatus, and equipment from a site to return the site to a prescribed condition, the modification or removal of structures, apparatus, and equipment that would render such items in a prescribe inoperable condition, the modification or removal of structures, apparatus, and equipment to meet environmental, regulatory, or safety considerations present at the end of such items useful, economical or intended life cycle. Such activities would include for example the removal of onshore, e.g., land based, structures above the earth, below the earth and combinations of these, such as e.g., the removal of tubulars from within a well in preparation for plugging. The removal of offshore structures above the surface of a body of water, below the surface, and below the seafloor and combinations of these, such as fixed drilling platforms, the removal of conductors, the removal of tubulars from within a well in preparation for plugging, the removal of structures within the earth, such as a section of a conductor that is located below the seafloor and combinations and variations of these.

As used herein the terms “removal of material,” “removing material,” “remove” and similar such terms should be given their broadest possible meaning, unless expressly stated otherwise. Thus, such terms would include melting, flowing, vaporization, softening, laser induced break down, ablation; as well as, combinations and variations of these, and other processes and phenomena that can occur when directed energy from a laser beam is delivered to a material, object or work surface. Such terms would further include combinations of the forgoing laser induced processes and phenomena with the energy that the fluid jet imparts to the material to be cut. Moreover, irrespective of the processes or phenomena taking place, such terms would include the lessening, opening, cutting, severing or sectioning of the material, object or targeted structure.

As used herein the terms “work piece,” “work surface,” “work area” “target” and similar such terms should be given their broadest possible meaning, unless expressly stated otherwise. Thus, such terms would include any and all types of objects, organisms, coatings, buildups, materials, formations, tubulars, substances or things, and combinations and variations of these, that are intended to be, or planned to be, struck, e.g., illuminated or contacted, by a high power laser beam.

As used herein the terms “workover,” “completion” and “workover and completion” and similar such terms should be given their broadest possible meanings and would include activities that place at or near the completion of drilling a well, activities that take place at or the near the commencement of production from the well, activities that take place on the well when the well is producing or operating well, activities that take place to reopen or reenter an abandoned or plugged well or branch of a well, and would also include for example, perforating, cementing, acidizing, fracturing, pressure testing, the removal of well debris, removal of plugs, insertion or replacement of production tubing, forming windows in casing to drill or complete lateral or branch wellbores, cutting and milling operations in general, insertion of screens, stimulating, cleaning, testing, analyzing and other such activities. These terms would further include applying heat, directed energy, preferably in the form of a high power laser beam to heat, melt, soften, activate, vaporize, disengage, desiccate and combinations and variations of these, materials in a well, or other structure, to remove, assist in their removal, cleanout, condition and combinations and variation of these, such materials.

### SUMMARY

It is desirable to have the ability to transmit laser energy, and in particular high power laser energy, though fluids, mixtures and other such medium that are non-transmissive, partially-transmissive, absorptive, partially-absorptive, or that otherwise interfere with or reduce the power of the laser beam when the laser beam is passed through such medium. It is further desirable to perform laser processing of materials in such environments; and as such, it is desirable to have the ability to use high power laser beams in such environments for activities, such as, monitoring, welding, cladding, annealing, heating, cleaning, controlling, assembling, drilling, machining, powering equipment and cutting. It is further desirable to perform laser assisted milling, cutting, flow assurance, decommissioning, plugging, abandonment and perforating activities in the exploration, production and development of natural resources, such as oil, gas and geothermal, in such environments. The present invention, among other things, solves these needs by providing the articles of manufacture, devices and processes taught herein.

Thus, there is provided herein a method for removing material from an object using a high power laser beam, the method having: directing a laser beam into an orifice of a first nozzle; directing a first fluid into the orifice of the first nozzle; the first nozzle forming a first fluid jet, the first fluid jet having the laser beam and the first fluid; directing the first fluid jet and the laser beam into an orifice of a second nozzle; directing a second fluid into an annulus of the second nozzle, the annulus surrounding the orifice of the second nozzle; the second nozzle forming a second fluid jet, the second fluid jet having an annular fluid jet of the second fluid surrounding the first fluid jet, whereby a laser compound annular fluid jet is formed; and, directing the laser compound annular fluid jet toward an object, whereby the laser beam assists in the removal of at least a portion of the object.

Further there are provide such methods that may further include steps wherein: the first fluid is a liquid and has an index of refraction, the second fluid is a liquid and has an index of refraction, and the index of refraction for the first fluid is greater than the index of refraction for the second fluid, wherein the second fluid jet functions as a cladding medium; wherein the index of refraction of the first fluid is greater than or equal to about 1.53; wherein the jet having the annular fluid jet of the second fluid surrounding the first fluid jet has a numerical aperture of from about 0.12 to about 1.16; wherein the numerical aperture is about 0.5 to about 0.9; wherein the object is a tubular in a borehole; wherein the object is a tubular associated with an offshore drilling rig; having a step for managing back reflections; wherein the second nozzle defines area and the laser beam has a focal point in an area of the second nozzle; wherein the first nozzle defines an area and laser beam has a focal point in an area of the first nozzle; wherein the first nozzle defines an area and the laser beam has a focal point in an area of the first nozzle; wherein the laser beam has a power of at least about 10 kW when it enters the orifice of the first nozzle; wherein the laser beam has a power of at least about 10 kW at the object; wherein the laser beam has a power of at least about 10 kW at the object; wherein the laser beam loses less than 20% of its power as it moves from a location near the orifice of the first nozzle to the object; wherein the second fluid has a mixture of the first fluid and a third fluid; wherein the second fluid has a mixture of the first fluid and a third fluid; wherein the first fluid is an oil having a refractive index of greater than about 1.53; wherein a speed of the first fluid in the second fluid jet is substantially the same as a speed of the second fluid in the second fluid jet; wherein a speed of the second fluid in the second fluid jet is greater than a speed of the first fluid in the second fluid jet; wherein a speed of the first fluid jet in the second fluid jet is greater than a speed of the second fluid in the second fluid jet.

Yet further there is provided a method for removing material from an object using a high power laser beam, the method having: directing a laser beam having at least about 5 kW of power into an orifice of a first nozzle; directing a first fluid having a pressure of at least about 3,000 psi into the orifice of the first nozzle; the first nozzle forming a first fluid jet, the first fluid jet having the laser beam and the first fluid; directing the first fluid jet and the laser beam into an orifice associated with a second nozzle; directing a second fluid having a pressure of at least about 3,000 psi into an annulus defined by the second nozzle, the annulus surrounding the second nozzle orifice; the second nozzle forming a second fluid jet, the second fluid jet having an annular fluid jet of the second fluid surrounding the first fluid jet, whereby a laser compound annular fluid jet is formed; and, directing the laser compound annular fluid jet toward the object, whereby the laser beam removals material from the object.

Further there are provide such methods that may further include steps wherein: wherein at least a portion of the tubular is within a borehole; wherein the first fluid is a liquid and has an index of refraction, the second fluid is a liquid and has an index of refraction, and the index of refraction for the first fluid is greater than the index of refraction for the second fluid; wherein the pressure of the first fluid jet is at least about 20,000 psi; wherein the jet having the annular fluid jet of the second fluid surrounding the first fluid jet has a numerical aperture of from about 0.12 to about 1.16; wherein the numerical aperture is about 0.5 to about 0.9; having a step for managing back reflections; wherein the step of directing the laser compound annular fluid jet has directing the laser beam in a predetermined delivery pattern; wherein the predetermined delivery pattern has a first pass and a second pass; wherein the passes have an area of overlap; wherein the passes have a plurality of areas of overlap; having a periphery pass; wherein the total volume of material removed from the object by delivery of the pattern is substantially greater than the volume of material removed by the laser beam; wherein the total volume of material removed from the object by delivery of the pattern is at least 80% greater than the volume of material removed by the laser beam; wherein the total volume of material removed from the object by delivery of the pattern is at least 50% greater than the volume of material removed by the laser beam; having a step for managing back reflections, and wherein the laser beam has a power of at least about 10 kW at the object, and wherein the total volume of material removed from the object by delivery of the pattern is at least 80% greater than the volume of material removed by the laser beam; having a step for managing back reflections, and the laser beam having a power of at least about 10 kW at the object, and wherein the total volume of material removed from the object by delivery of the pattern is at least 50% greater than the volume of material removed by the laser beam; having a step for managing back reflections, and wherein the laser beam has a power of at least about 10 kW at the object, and wherein the total volume of material removed from the object by delivery of the pattern is at least 80% greater than the volume of material removed by the laser beam; having a step for managing back reflections, and the laser beam having a power of at least about 10 kW at the object, and wherein the total volume of material removed from the object by delivery of the pattern is at least 50% greater than the volume of material removed by the laser beam.

Yet further there is provided a method of cutting tubulars associated with a borehole, the method having: providing a laser tool near the tubular to be cut; forming a compound fluid laser jet and shooting the compound fluid laser jet through a medium in a direction toward the tubular, the compound fluid jet having a first axis corresponding to the direction, the compound fluid jet formed such that the jet has an inner core having a second axis corresponding to the first axis, and an outer liquid sheath having a third axis corresponding to the first axis; directing a laser beam within the inner core of the compound fluid laser jet along the first axis of the compound fluid laser jet, whereby the outer liquid in the jet substantially prevents a medium in a borehole from interfering with the laser beam; wherein the laser beam contacts a tubular without substantial power loss from the medium; and wherein the laser beam cuts at least a portion of the tubular.

Further there are provide such methods that may further include steps wherein: wherein the tubular has a sub-sea riser and the medium is seawater; wherein the tubular has a sub-sea riser; wherein the tubular has a casing; wherein the tubular has a drill pipe; wherein the medium is selected from the group consisting of water, brine, drilling mud, cuttings, and combinations thereof; wherein the medium is selected from the group consisting of water, seawater, salt water, brine, drilling mud, air, nitrogen, inert gas, diesel, drilling fluid, non-transmissive liquid, non-transmissive mixture, two-phase fluid, three-phase fluid, mist, foam, cuttings, and combinations thereof; wherein the tubular has a casing and the medium is selected from the group consisting of water, seawater, salt water, brine, drilling mud, air, nitrogen, inert gas, diesel, drilling fluid, non-transmissive liquid, two-phase fluid, three-phase fluid, mist, foam, cuttings, and combinations thereof; wherein the tubular has a drill pipe and the medium is selected from the group consisting of water, seawater, salt water, brine, drilling mud, air, nitrogen, inert gas, diesel, drilling fluid, non-transmissive liquid, two-phase fluid, three-phase fluid, mist, foam, cuttings, and combinations thereof; wherein the laser tool is positioned inside of the tubular; wherein the laser tool is positioned outside of the tubular; wherein the tubular is selected from the group consisting of sub-sea riser, drill pipe, and casing and the medium is selected from the group consisting of water, seawater, salt water, drilling mud, air, nitrogen, an inert gas, diesel, drilling fluid, and a non-transmissive liquid, two-phase fluid, three-phase fluid, mist, foam, cuttings, and combinations thereof; wherein the laser beam has a power of at least about 5 kW when it enters the inner core; wherein the laser beam has a power of at least about 10 kW at the tubular; wherein a speed of the inner fluid in the jet is substantially the same as a speed of the outer liquid in the jet; wherein a speed of the outer liquid in the jet is greater than a speed of the inner liquid in the jet.

Additionally there is provided a method of cutting an object associated with a borehole, the method having: providing a laser tool within the borehole near the object to be cut; forming a compound laser jet and shooting the compound laser jet through a medium in a direction toward the object to be cut, the compound jet having an axis corresponding to the direction, the compound jet formed such that the jet has an inner fluid core having an axis corresponding to the axis, and an outer fluid sheath having an axis corresponding to the axis; directing a laser beam within the inner core of the compound laser jet along the axis of the compound laser jet; the medium being substantially non-transmissive to the laser beam; the outer fluid in the jet preventing the medium from blocking the transmission of the laser beam; wherein the laser beam contacts the object and cuts at least a portion of the object.

Still further there is provided a method of delivering a high power laser beam through an at least partially obstructing medium, the method having: optically associating a high power laser tool with a source of a high power laser beam, the high power laser tool having a beam launch face; positioning the high power laser tool in an environment containing the partially obstructing medium; providing the high power laser beam to the laser tool, wherein the high power laser beam travels along a beam path defined by the high power laser tool, wherein the beam path extends from within the laser tool, through the beam launch face, away from the laser tool and into the medium; focusing the high power laser beam along the beam path, thereby providing a focal length of at least about a first distance and providing a focal point along the beam path; the focal point being in the medium and at least about a second distance away from the launch face; and, providing a high pressure gas jet along the portion of beam path extending away from the beam launch face; wherein, the high power laser beam is capable of traveling at least the second distance through the medium along the beam path without substantial power loss and substantial formation of back reflections along the beam path. Yet still further such method may also have the step of providing a plurality of laser beams to the laser tool; wherein the first distance is greater than about 1 foot and the second distance is greater than about 2 inches; wherein the first distance is greater from about 1 to about 3 feet and the second distance is from about 1 inch to about 8 inches; wherein the laser beam is capable of traveling at least 1.5 times as long as the second distance through the medium along the beam path without substantial power loss; wherein the laser beam is capable of traveling at least twice as long as the second distance through the medium along the beam path without substantial power loss; wherein the laser beam is capable of traveling at least 1.5 times as long as the second distance through the medium along the beam path without substantial power loss; wherein the laser beam is capable of traveling at least twice as long as the second distance through the medium along the beam path without substantial power loss; wherein the laser beam is capable of traveling at least 1.5 times as long as the second distance through the medium along the beam path without substantial power loss.

Moreover there is provided a method of delivering a high power laser beam through a medium to an object, the method having: optically associating a high power laser tool with a source for a high power laser beam, the high power laser tool having a beam launch face; positioning the high power laser tool in an environment containing the medium, the high power laser tool defining a beam path, wherein the beam path extends from within the laser tool, through the beam launch face, away from the laser tool and into the medium; providing the high power laser beam to the laser tool, whereby the high power laser beam travels along the beam path; focusing the high power laser beam along the beam path, thereby providing a focal length of at least about a first distance and providing a focal point along the beam path at least about a second distance away from the launch face; and, providing a high pressure gas jet along the portion of beam path extending away from the beam launch face; wherein, the high power laser beam is delivered along the beam path to the object in a predetermined beam delivery pattern without substantial power loss and substantial formation of back reflections along the beam path.

Additionally there are provided methods: wherein the beam launch face is a locking ring; wherein the beam launch face has the face of a high pressure gas jet nozzle; wherein the beam launch face has an outer surface of the laser tool; herein the jet has nitrogen having a pressure of at least 5,000 psi; wherein the jet has nitrogen having a pressure of at least 20,000 psi; wherein the jet has a pressure greater than a pressure of the medium in the environment; and wherein the focal point distance is about is greater than about 2 feet, is greater than about 3 feet.

Moreover there is provided a method of delivering a high power laser beam through a medium to an object, the method having: optically associating a high power laser tool with a source for a high power laser beam having at least 10 kW of power, the high power laser tool having a nozzle and a beam launch opening; positioning the high power laser tool a first distance from the object in an environment containing the medium, the high power laser tool defining a beam path, wherein the beam path extends from within the laser tool, through the nozzle, through the beam launch opening, away from the laser tool and into the medium and to the object; providing the high power laser beam to the laser tool, whereby the high power laser beam travels along the beam path to the object; focusing the high power laser beam along the beam path, thereby providing a focal length of at least about a second distance and providing a focal point along the beam path at least about a third distance away from the launch opening; and, providing a jet from the nozzle at least along the portion of beam path extending away from the beam launch opening; wherein, the high power laser beam is delivered along the beam path to the object in a predetermined pattern; wherein the second distance is greater than the first distance and the third distance, and the third distance is greater than the first distance. Such methods may further have steps wherein the jet has a supercritical fluid; wherein the jet has air; wherein the jet has an oil; wherein the jet has a pressure greater than a pressure of the medium in the environment; wherein the jet has a pressure greater than about 5,000 psi. And, such methods may further have the first distance less than about 1 inch, less than about 2 inches, less than about 6 inches, and from about 1 to about 6 inches. These methods may also have the second distance greater than about 18 inches, greater than about 24 inches, greater than about 30 inches, and greater than about 36 inches. These methods may also have the third distance greater than about 3 inches, greater than about 6 inches. These methods may also have the first distance about 1 inch, the second distance about 3 feet and the third distance about 6 inches.

Furthermore there is provided a method of delivering a high power laser beam through a medium to an object, the method having: optically associating a high power laser tool with a source for a high power laser beam having at least 5 kW of power, the high power laser tool having a face from which the laser beam is launched; positioning the high power laser tool face a first distance from the object in an environment containing the medium, the high power laser tool defining a beam path, wherein the beam path extends from within the laser tool, through the face, into the medium and to the object; providing the high power laser beam to the laser tool, whereby the high power laser beam travels along the beam path to the object; focusing the high power laser beam along the beam path, thereby providing a focal length of at least about a second distance and providing a focal point along the beam path at least about a third distance away from the face; and, providing a jet from a nozzle, the jet directed at the object; wherein the high power laser beam is delivered along the beam path to the object in a predetermined pattern; wherein the jet is delivered to the object in a predetermined pattern; wherein the second distance is greater than about 2 feet.

Yet further there are provided methods: wherein the laser beam forms a spot at a surface of the object having an area of at least about 0.065 inches; wherein the laser beam forms a spot at a surface of the object having an area of at least about 0.01 inches; wherein the medium is selected from the group consisting of water, seawater, salt water, brine, nitrogen, diesel, air, drilling mud, air, nitrogen, inert gas, diesel, drilling fluid, non-transmissive liquid, two-phase fluid, three-phase fluid, mist, foam, cuttings, and combinations thereof.

Further there is provided a method for launching a high power laser beam into a flowing liquid, the method having: directing a high power laser beam having at least 5 kW of power into a prism having a first index of refraction, wherein the prism as a first face and a second face, the laser beam entering the first face and the laser beam exiting the second face; flowing a liquid across the second face of the prism, the liquid having a second index of refraction, wherein the second index of refraction is essentially the same as the first index of refraction; wherein the laser beam travels into the fluid. In such methods the first index of refraction may be from about 10% greater to about 10% smaller than the second index of refraction, from about 5% greater to about 5% smaller than the second index of refraction and from about 1% greater to about 1% smaller than the second index of refraction.

Still additionally there is provided a method of removing material from a casing within a borehole to form a window, by cutting the casing, the method having: cutting a kerf into a casing in a borehole in a predetermined pattern; the kerf having a plurality of kerf overlap areas, wherein the kerf and overlap areas define a plurality of sections of uncut casing; and, removing the sections of uncut casing, thereby forming a window in the casing; wherein the total volume of material removed to form the window is substantially greater than the volume of material removed by cutting the kerf. This method may further have the steps wherein the total volume of material removed to form the window is at least 80% greater than the volume of material removed by cutting the kerf; wherein the total volume of material removed to form the window is at least 50% greater than the volume of material removed by cutting the kerf; wherein the kerf is cut using a high power laser beam.

There is still further provided an apparatus for cutting tubulars in a borehole, the apparatus having: a housing configured for insertion into a borehole, the housing having an inlet for receiving a laser beam and an outlet for delivering a laser compound fluid jet; a means for conveying the housing to a predetermined position with respect to a tubular in a borehole, said conveying means having a means for transmitting a laser beam to the housing, the transmitting means associated with the housing by way of the inlet for receiving the laser beam; the housing having a means for controlling the laser beam, a first nozzle assembly, a second nozzle assembly, a first fluid path for providing a first fluid to the first nozzle assembly, a second fluid path for providing a second fluid to the second nozzle assembly; the first fluid path containing the first fluid, the first fluid having a first index of refraction; the second fluid path containing the second fluid, the second fluid having a second index of refraction; the first nozzle assembly, the second nozzle assembly, and the means for controlling the laser beam configured within the housing to provide a laser fluid jet that exits the housing by way of the housing jet outlet, wherein the laser fluid jet has an inner core of the first fluid, the laser beam contained within the inner core, and an outer annular jet of the second fluid; and, the index of refraction of the first fluid is greater than the index of refraction of the second fluid, whereby the first fluid jet functions as a waveguide.

Furthermore, such apparatus may have the laser beam has at least about 3 kW of power at the housing laser inlet; the laser beam has at least about 5 kW of power at the housing laser inlet; wherein the laser beam has at least about 10 kW of power at the housing laser inlet; wherein the means for transmitting is a single optical fiber; wherein the means for transmitting is a single optical fiber; wherein the means for controlling has a means for focusing the laser; wherein the means for controlling has a means for collimating the laser; wherein the means for controlling has a means for directing the laser; wherein the first fluid is an oil having an index of refraction greater than about 1.53; wherein the second fluid has an index of refraction less than about 1.53.

Moreover there is provided an apparatus for cutting an object associated with a borehole, the apparatus having: a housing, the housing having an inlet for receiving a laser beam and an outlet for delivering a laser compound fluid jet; a means for conveying the housing to a predetermined position in relation to an object associated with a borehole, said conveying means having a means for transmitting a laser beam to the housing, the transmitting means associated with the housing by way of the inlet for receiving the laser beam; the housing having a means for controlling the laser beam, a first nozzle assembly, a second nozzle assembly, a first fluid path for providing a first fluid to the first nozzle assembly, a second fluid path for providing a second fluid to the second nozzle assembly; a means for providing the fluids to the housing; the first fluid path containing the first fluid, the first fluid having a first index of refraction; the second fluid path containing the second fluid, the second fluid having a second index of refraction; the first nozzle assembly, the second nozzle assembly, and the means for controlling the laser beam configured within the housing to provide a laser fluid jet that exits the housing by way of the housing jet outlet, wherein the laser fluid jet has an inner core of the first fluid, the laser beam contained within the inner core, and an outer annular jet of the second fluid; and, the index of refraction of the first fluid is greater than the index of refraction of the second fluid.

Still further there are provided apparatus: wherein the laser beam has at least about 1 kW of power at the housing laser inlet; wherein the laser beam has at least about 3 kW of power at the housing laser inlet; wherein the laser beam has at least about 5 kW of power at the housing laser inlet; wherein the laser beam has at least about 10 kW of power at the housing laser inlet; wherein the means for transmitting is a single optical fiber.

Additionally there is provided an apparatus for providing a laser waveguide compound fluid jet, the apparatus having: an inlet for receiving a laser beam and an outlet for delivering a laser compound fluid jet; a laser source in optical communication with the inlet for receiving the laser beam; an optic in optical communication with the inlet; a nozzle in optical communication with the optic; a first passage in fluid communication with the nozzle; a second fluid passage in fluid communication with the nozzle; the first passage having a first fluid and the second passage having a second fluid, the first fluid having an index of refraction that is greater than the second fluid; and, the nozzle in fluid and optical communication with the outlet.

Moreover there is provided an apparatus of delivering a high power laser beam through an optically obstructive medium the apparatus having: a housing, the housing having an outer surface; the housing having a fluid channel for directing a fluid to a nozzle for forming a fluid jet; a mirror capable of reflecting a high power laser beam; the mirror located within the housing; an optics assembly having a focusing element and a directing element; the focusing element having a focal length of greater than 1 foot; the directing element configured to direct the laser beam along a laser beam path, wherein the laser beam path extends between the mirror and an orifice in the nozzle; and, wherein the focal point is located outside of the housing and at least about 3 inches away from the housing surface. Such apparatus may further have a means for managing back reflections.

Additionally there is provided an apparatus of delivering a high power laser beam, the apparatus having: a laser tool having a housing and a laser cutting, the housing having an outer surface and the laser cutting head having an outer surface; a nozzle having an opening, the nozzle opening associated with the outer surface of the laser cutting head, the nozzle having a passage in fluid communication with the nozzle opening for forming and directing a fluid jet; a means for providing a laser beam path having a focal point along the laser beam path; and wherein the laser beam path is through the nozzle passage and nozzle opening and the focal point is on the laser beam path and the focal point is outside of the outer surface of the laser cutting head.

Moreover there is provided a laser beam delivery system, having: a means for providing a high power laser beam; a high power laser tool; a means for conveying the high power laser beam and a first fluid to the high power laser tool; a means for forming a laser jet; and, a means for managing back reflections.

Yet still further there is provided a high power laser tool, having: a body; an optics assembly having a focusing element and a prism; the optics assembly defining a first and a second laser beam path, the body having a nozzle for forming a fluid jet; the first laser beam path extending from a face of the prism into the body; and, the second laser beam path extending the face of the prism into the nozzle; wherein a laser beam will travel along the second beam path when a fluid having a preselected index of refraction is adjacent the face of the prism and contained within the nozzle.

### BRIEF DESCRIPTION OF THE DRAWINGS

FIG. 1 is a schematic view of an embodiment of a laser tool in accordance with the present invention.

FIG. 2 is a longitudinal cross-sectional view of an embodiment of a laser tool in accordance with the present invention.

FIG. 3 is a longitudinal cross-sectional view of an embodiment of a laser tool in accordance with the present invention.

FIG. 4 is a longitudinal schematic cross-sectional view of an embodiment of a laser tool in accordance with the present invention.

FIG. 5 is a longitudinal schematic cross-sectional view of an embodiment of a laser tool in accordance with the present invention.

FIGS. 6A and 6B are prospective and plan views respectively of an embodiment of a laser kerf in accordance with the present invention.

FIG. 7 is a cross-sectional view of an embodiment of a tubular cut in accordance with the present invention.

FIG. 8 is a cross-sectional view of an embodiment of a tubular cut in accordance with the present invention.

FIG. 9 is a cross-sectional view of an embodiment of a tubular cut in accordance with the present invention.

FIG. 10 is a cross-sectional view of a embodiments of a tubular cuts in accordance with the present invention.

FIGS. 11A and 11B are plan and cross-sectional views respectively of an embodiment of a tubular cut in accordance with the present invention.

FIGS. 12A and 12B are plan and cross-sectional views respectively of a embodiments of tubular openings in accordance with the present invention.

FIGS. 13A and 13B are diagrams illustrating flow velocity models of embodiments of nozzles in accordance with the present invention.

FIGS. 14A and 14B are diagrams illustrating flow velocity models of embodiments of nozzles in accordance with the present invention.

FIG. 15 is a diagram illustrating a flow velocity model of embodiments of nozzles in accordance with the present invention.

FIGS. 16A and 16B are diagrams illustrating flow velocity models of embodiments of nozzles in accordance with the present invention.

FIG. 17 is a cross-sectional view of an embodiment of a liquid jet head in accordance with the present invention.

FIGS. 17A and 17B are transverse cross-sectional views of the embodiment of FIG. 17 taken along lines A-A and B-B respectively.

FIG. 18 is an enlarged cross-sectional view of the embodiment of FIG. 17.

FIG. 19 is a cross-sectional perspective view of a portion of the embodiment of FIG. 17.

FIG. 20 is a schematic cross-sectional view of an embodiment of a compound fluid jet in accordance with the present invention.

FIG. 20A is a transverse cross-sectional view of the compound fluid jet of the embodiment of FIG. 20.

FIG. 20B is a table relating to the compound fluid jet of the embodiment of FIGS. 20 and 20A.

FIG. 21 is a schematic cross-sectional view of an embodiment of a compound fluid jet in accordance with the present invention.

FIG. 22A is a schematic cross-sectional view of an embodiment of a fluid jet in accordance with the present invention.

FIG. 22B is a schematic cross-sectional view of an embodiment of a compound fluid jet in accordance with the present invention.

FIG. 23 is a schematic cross-sectional view of an embodiment of a compound fluid jet in accordance with the present invention.

FIG. 24 is a schematic cross-sectional view of an embodiment of a fluid jet tool having multiple directional jets in accordance with the present invention.

FIG. 25A is a transverse cross sectional view, not necessarily to scale, showing the structure of an embodiment of an optical fiber in accordance with the present invention.

FIG. 25B is a longitudinal cross sectional view of the optical fiber of FIG. 25A.

FIG. 26 is a spectrum of laser energy transmitted in accordance with an embodiment of the present invention, showing the absence of SRS phenomena.

FIG. 27 is a schematic view of an embodiment of a mobile laser system in accordance with the present invention.

FIG. 28 is a schematic diagram for an embodiment of a configuration of lasers in accordance with the present invention.

FIG. 29 is a schematic diagram for an embodiment of a configuration of a laser in accordance with the present invention.

FIG. 30 is a perspective cutaway of an embodiment of a spool and optical rotatable coupler in accordance with the present invention.

FIG. 31 is a schematic diagram of an embodiment of a laser fiber amplifier in accordance with the present invention.

FIG. 32 is a cross sectional view of an embodiment of a spool in accordance with the present invention.

FIG. 33A is a prospective view of an embodiment of a creel in accordance with the present invention.

FIG. 33B is a plan view of the creel of FIG. 33.

FIGS. 34, 35, 36, 37, 38A, 38B, 39, 40, 41, 42 and 43 are transverse cross-sectional views of conveyance structures in accordance with the present invention.

FIG. 44A is a perspective view of an embodiment of a mobile high power laser system in accordance with the present invention.

FIG. 44B is a schematic view of the system of FIG. 44A deployed at a well site.

FIG. 45 is a schematic view of an embodiment of a laser tool in accordance with the present invention.

FIG. 45A is the laser tool of FIG. 45 with an embodiment of a junk basket in accordance with the present invention.

FIG. 45B is the laser tool of FIG. 45 with an embodiment of a junk basket in accordance with the present invention.

FIG. 45C is the laser tool of FIG. 45 with an embodiment of a junk basket in accordance with the present invention.

FIG. 46 is a schematic view of an embodiment of a laser tool in accordance with the present invention.

FIG. 47 is a schematic view of an embodiment of a laser tool in accordance with the present invention.

FIG. 48A is a schematic view of an embodiment of a laser tool system in accordance with the present invention.

FIG. 48B is a schematic view of an embodiment of a laser tool system in accordance with the present invention.

FIGS. 49 A and 49B are schematic views of embodiments of laser tool systems in accordance with the present invention.

FIG. 50 is a schematic view of an embodiment of a laser tool in accordance with the present invention.

FIG. 51 is a schematic view of an embodiment of a laser tool in accordance with the present invention.

FIG. 52 is a schematic view of an embodiment of a laser tool in accordance with the present invention.

FIG. 53 is a schematic view of an embodiment of a laser tool in accordance with the present invention.

FIGS. 54A, 54B, 54C, 54D, 54E, 54F and 54G are schematic diagrams of embodiments of laser delivery patterns in accordance with the present invention.

FIG. 55 is a schematic cross-sectional view of an embodiment of a gas jet laser head in accordance with the present invention.

FIG. 56 is a schematic cross-sectional view of an embodiment of a gas jet laser tool in accordance with the present invention.

FIG. 57 is a schematic cross-sectional view of an embodiment of a gas jet laser head in accordance with the present invention.

FIG. 57A is a transverse cross-sectional view of the laser head of FIG. 57 taken along line A-A.

FIG. 58A is a cross-sectional view of a gas jet laser head in accordance with the present invention.

FIG. 58B is a prospective cross-sectional view of an enlarged section of the laser head of FIG. 58A.

FIG. 58C is a prospective view of a section of the laser head of FIG. 58A.

FIG. 59 is a prospective 3-D view of an embodiment of a nozzle in accordance with the present invention.

FIG. 60 is a prospective 3-D view of an embodiment of a nozzle in accordance with the present invention.

FIG. 61A is a schematic cross-sectional view of an embodiment of a nozzle have multiple flow paths and chambers in accordance with the present invention.

FIG. 61B is a cross-sectional prospective view of a section of the nozzle of FIG. 61A.

FIG. 62A is a prospective view of a nozzle in accordance with the present invention.

FIG. 62B is a cross-sectional view of the nozzle of FIG. 62A.

FIG. 62C is a cross-sectional view of the nozzle of FIG. 62A associated with a laser head in accordance with the present invention.

FIG. 63 is a schematic cross-sectional view of an embodiment of an isolation system in accordance with the present invention.

FIG. 64A is a plan view of an embodiment of a laser tool having a second nozzle in accordance with the present invention.

FIG. 64B is a cross-sectional view of the embodiment of FIG. 64A along line B-B.

FIG. 65 is a schematic cross-sectional view of an embodiment of an isolation system in accordance with the present invention.

FIG. 66 is a cross-sectional view of an embodiment of a laser head in accordance with the present invention.

FIGS. 67A to 67E are cross-sectional views of embodiments of laser nozzles in accordance with the present invention.

FIG. 68 is a cross-sectional view of an embodiment of a compound laser nozzle in accordance with the present invention.

FIG. 69A is a cross-sectional view along the y-axis of an embodiment of a two prism fluid jet system in accordance with the present invention.

FIG. 69B is a cross-sectional view of the embodiment of FIG. 69A viewed along the x-axis.

FIG. 70A is a cross-sectional view along the y-axis of an embodiment of a two prism fluid jet system in accordance with the present invention.

FIG. 70B is a cross-sectional view of the embodiment of FIG. 70A viewed along the x-axis.

FIGS. 71A and 71B are schematic views of an angled polarizing back reflection management embodiment in accordance with the present invention, showing s-polarized and p-polarized back reflected paths respectively.

FIGS. 72A and 72B are schematic views of a vertical polarizing back reflection management embodiment in accordance with the present invention, showing p-polarized and s-polarized back reflected paths respectively.

FIG. 73 is schematic view representing an embodiment of an application in accordance with the present invention.

FIG. 74 is schematic view representing an embodiment of an application in accordance with the present invention.

FIGS. 75A-75C are schematic views representing an embodiment of an application in accordance with the present invention.

FIGS. 76A-76D are schematic views representing an embodiment of an application in accordance with the present invention.

FIG. 77 is schematic view representing an embodiment of an application in accordance with the present invention.

FIG. 78 is schematic view representing an embodiment of an application in accordance with the present invention.

FIG. 79 is schematic view representing an embodiment of an application in accordance with the present invention.

FIGS. 80A and 80B are schematic views representing an embodiment of an application in accordance with the present invention.

FIGS. 81A and 81B are schematic views representing an embodiment of an application in accordance with the present invention.

### DESCRIPTION OF THE PREFERRED EMBODIMENTS

In general, the present inventions relate to systems, methods and tools for applying directed energy for cutting, heat treating, thermal processing, annealing, cladding, hard facing, welding and removing material; by way of an isolated laser beam that may be transmitted within a fluid laser jet. Further, and in particular, these inventions relate to laser processing of objects located downhole in a borehole, associated with a borehole, or located under a body of water and would include, for example, the cutting, milling, perforating, and sectioning of such objects, including the perforating of boreholes into and through casing, cement and formations. These inventions still further relate to the advancing of boreholes in the earth, for example sandstone, limestone, basalt, salt, granite, shale, or the advancing of boreholes in other materials, that may or may not be found in the earth, such as for example concrete. The present inventions further relate to such methods and apparatus for laser assisted milling, cutting, flow assurance, decommissioning, plugging, abandonment and perforating activities in the exploration, production and development of natural resources, such as minerals, oil, gas and geothermal.

In general high power laser tools having a laser head are provided. The laser tool and laser head may be optically and mechanically connected to a high power laser over a substantial distance by a conveyance structure, such as for example, when the laser is on the surface of the earth or above the surface of a body of water and the tool is deep within a borehole or under a surface of a body of water. The high power laser may also be located near the laser tool, such as for example, when the tool and laser are associated with a remote operated vehicle (“ROV”) or a laser PIG.

In performing high power laser operations, and in particular in performing high power laser operations in environments where the laser beam may be occluded, blocked or otherwise interfered with or obstructed, methodologies should be employed to provide for a clear and substantially unimpeded laser beam path for the laser beam to travel along to reach its intended target or work surface. Interference with the laser beam path may occur from different phenomena, such as absorption, scatter, reflection, physical blocking of the beam path, thermal lensing and combinations and variations of these and other phenomena. Also, the length of the laser beam path, e.g., the distance that the laser beam travels upon leaving the laser tool or cutting head until it reaches the surface of the work area and cuts through or to a predetermined depth within the work piece, is a factor to be considered in conjunction with the nature or severity of the interference with the beam path. Thus, for example, a greater amount of absorption may be tolerable when the beam path is shorter; but may prove problematic as the beam path becomes longer.

An example of environmental interference with the beam path may occur, for example, in performing laser cutting of material in a borehole where the target, work surface, or area to be cut, may be in an environment filled with water, brine, drilling mud or other fluids typically found in a borehole. In such an environment it is preferable for the beam path to be kept free, or substantially free of, the borehole fluids. To accomplish this a fluid jet may be utilized to isolate the beam path from the borehole fluids and provide a clear, substantially clear, transmissive, or substantially transmissive beam path for the laser beam.

In dealing with high power, and in particular 10 kW, 20 kW and greater power laser tools, laser beams, beam paths and activates, other considerations in addition to keeping the beam path clear may come into play. These considerations may, for example, be related to, and effect, the fluid jet, the laser beam path within the tool and cutting head, the fluid jet path within the tool and cutting head, and the combined laser beam path and fluid jet path (i.e., laser fluid jet or laser fluid jet path) as well as flow rates and volumes for the jet fluid. These considerations would include, among others: thermal lensing; heat management; flow paths, volumes and velocities as they relate to heat management; flow paths, volumes and velocities as they relate to jet integrity; and back reflections. In designing and configuring laser cutting heads and beam paths, for use in laser fluid jets, the prior art is believed to be lacking in, if not essentially void of any, teachings to address these considerations, or even the recognition of these issues, as they relate to a fluid laser jet for use under water, within a liquid environment, and in particular deep within a borehole.

In general high power back reflections occur when the high power laser beam is reflected from a surface in a direction that is opposite, or essentially opposite, the intend direction of the laser beam along the intended laser beam path. Potential surfaces for the creation of back reflections may occur at the interface between a fluid jet and the medium through which it is being directed. Thus, for example the surface formed between the end of a gas jet that is being shot into a liquid, e.g., water may provide a source of back reflections. Bubbles in the media in which the work surface is located, if in the beam path, may provide a potential surface for the creation of back reflections. The surface of the work surface may provide a potential back reflection surface. The bottom of the kerf, or trough of the cut, where molten material may be present may provide a potential back reflection surface.

High power back reflections may become problematic, in particular, when they travel back along the laser beam path, or essentially along the laser beam path, and strike elements and components of the system that are incapable of handling, or handling for a period of time, the high power laser energy. These components could be in, or constitute, the laser cutting head, laser tool, connector, fiber, optical slip ring (which may for example be protected by the optical fibers), or any other component along, or associated with, the laser beam path from the laser to the work surface.

The mitigation and management of back reflections when propagating a laser fluid jet through a fluid, from a cutting head of a laser tool to a work surface, may be accomplished by several methodologies, which are set forth in various embodiments herein. The methodologies to address back reflections and mitigate potential damage from them would include the use of an optical isolator, which could be placed in either collimated space or at other points along the beam path after it is launched from a fiber or connector. The focal point may be positioned such that it is a substantial distance from the laser tool; e.g., greater than 4 inches, greater than 6 inches and greater than 8 inches. Preferably, the focus point may be beyond the fluid jet coherence distance, thus, greatly reducing the likelihood that a focused beam would strike a reflective surface formed between the end of the fluid jet and the medium in which it was being propagated, e.g., a gas jet in water. The laser beam may be configured such that it has a very large depth of focus in the area where the work surface is intended to be, which depth of focus may extend into and preferably beyond the cutting tool. Additionally, the use of an active optical element (e.g., a Faraday isolator) may be employed.

Other high power back reflection management and mitigation steps could include for example the use of apertures, several apertures, including an optical baffle assembly or assemblies. The apertures could be separate structures having an opening for the forward propagation of the laser beam, which opening is slightly larger than the beam path diameter or the beam diameter at the baffle location along the beam path. In this case, the aperture surfaces could be reflective of the back reflections or absorptive of the back reflections. The more apertures that are used and the smaller the aperture opening, the greater the likelihood that essentially all back reflections that are not directly in the beam path will be mitigated. As for the back reflections directly in the beam path they could be recoupled back into the optical fiber's core and carried by the core away from the tool. In this latter case, as in others, a back reflection monitor should be utilized. The back reflection monitor would detect the level, or power, of the back reflections and at a predetermined threshold, or power, shut down the laser or stop (e.g., shutter) the forward propagation of the laser beam at a predetermined point along the beam path. In addition to being separate components or structures within the tool or cutting head, the apertures may be formed on an optical element, such as a collimating lens. Thus, an annular highly reflective (HR) coating could be applied to the collimating lens on the side facing the back reflections. Such apertures that are part of an optic may be used in conjunction with other apertures and may be a part of an optical baffle system. The aperture may also be a cap made from a material having the capability to withstand high temperatures, such as Alumina and other high temperature ceramic materials. The cap would have a small opening in it, slightly larger than the core diameter of the fiber and could be placed over the distal beam launch surface, e.g., a fiber face, quartz block or connector end, that is optically associated with the tool.

Additional teachings and examples for addressing back reflections, and in particular back reflections in connectors and optics assemblies, which connectors and optics assemblies may be used with or in the present laser tools, are provided in U.S. provisional patent application Ser. No. 61/493,174, and U.S. provisional patent application Ser. No. 61/446,040, the entire disclosures, of each, of which are incorporated herein by reference. Such teachings also may be applicable to other components in the present high power laser tools.

A second fluid jet may also be used to shape or disrupt the surfaces that are likely to create back reflections, or a highly absorbent materials, for example a foam may be added to the work site area, in this manner the jet would pierce through the foam, preventing it from interfering with the forward propagation of the laser, but dampen or absorb, all back reflected light except that which came back along the jet beam path.

Polarizing elements may also be used to manage and mitigate back reflections. The forward propagating laser beam may be polarized and then filters, mirrors used would stop or redirect any polarized back reflections before they would damage components of the system.

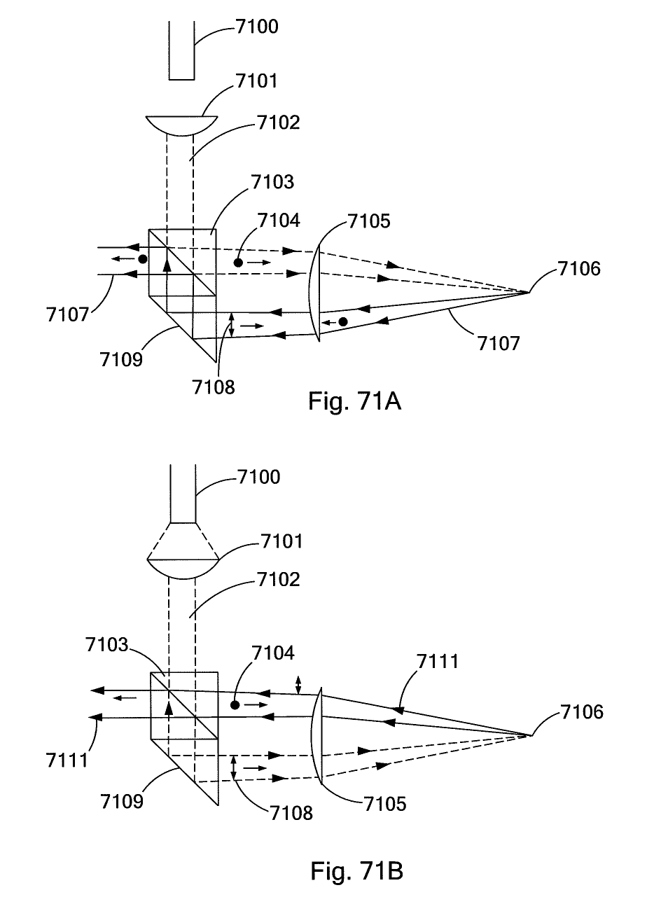

In FIGS. 71A and 71B there are shown schematic diagrams of an embodiment of a polarizing assembly to manage back reflections. There is a fiber 7100 that launches a laser beam into a collimating lens 7101. The laser beam exits the collimating lens 7101 as unpolarized light 7102 and travels into a polarizing beam splitter (cube) 7103, having a mirror or prism 7109. In the cube the laser beam is split into forward propagating s-polarized 7104 and p-polarized 7108 beams that travel through lens 7105 to focus point 7106. Back reflected light, as p-polarized 7111, and s-polarized 7107 beams are rejected and do not travel into the collimating lens 7101.

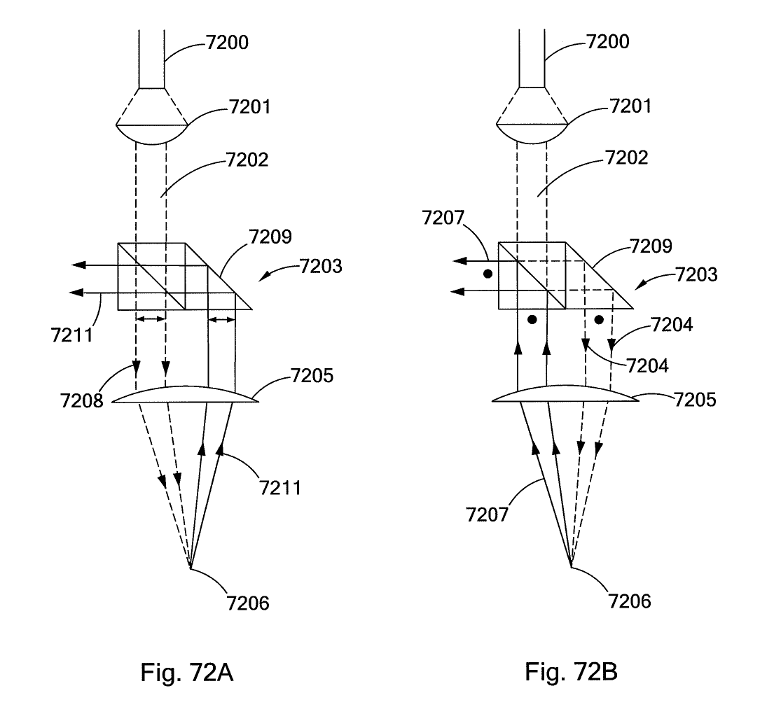

In FIGS. 72A and 72B there are shown schematic diagrams of an embodiment of a polarizing assembly (stacked vertically) to manage back reflections. There is a fiber 7200 that launches a laser beam into a collimating lens 7201. The laser beam exits the collimating lens 7201 as unpolarized light 7202 and travels into a polarizing beam splitter (cube) 7203, having a mirror or prism 7209. In the cube the laser beam is split into forward propagating s-polarized 7204 and p-polarized 7208 beams that travel through lens 7205 to focus point 7206. Back reflected light, as p-polarized 7211, and s-polarized 7207 beams are rejected and do not travel into the collimating lens 7201.

The size of the core of the fiber, for example the size, or the use of a single mode, as well as the size, number and composition of the cladding(s) of the fiber may also be selected to mitigate or manage back reflections. This consideration, the above discussed methodologies, and other means, such as the use of antireflective coatings, and other means found in a commercially available water cooled connectors, may be utilized in isolation or in combination with each other to mitigate and manage back reflections.

Although the forgoing addresses the mitigation and management of back reflections, it should be recognized that the management of back reflections may also include their utilization in the intended laser process or activity. The amount, intensity and duration of the back reflections may be utilized to determined different operating parameters of the system and the laser process. Thus, the presence or absence of back reflections could be used to monitor the progression of a cutting process, e.g., with the back reflections reducing, or dropping to essentially zero, when the cut is complete. Back reflections may also be redirected in a forward propagating direction, and as such, may be utilized directly in the laser process, e.g., they may be redirected toward the work site to cut the target material.

Thus, and in general, the tools, systems and methods may be used with or as a part of a high power laser systems, which may include, conveyance structures for use in delivering high power laser energy over great distances and to work areas where the high power laser energy may be utilized. Preferably, the system may include one or more high power lasers, which are capable of providing: one high power laser beam, a single combined high power laser beam, multiple high power laser beams, which may or may not be combined at various point or locations in the system, or combinations and variations of these. Examples of such systems and conveyance structures are provided in U.S. patent application Ser. No. 13/210,581 filed Aug. 16, 2011, the entire disclosure of which is incorporated herein by reference.

A single high power laser may be utilized in the system, or the system may have two or three high power lasers, or more. High power solid-state lasers, specifically semiconductor lasers and fiber lasers are preferred, because of their short start up time and essentially instant-on capabilities. The high power lasers for example may be fiber lasers or semiconductor lasers having 10 kW, 20 kW, 50 kW or more power and, which emit laser beams with wavelengths in the range from about 455 nm (nanometers) to about 2100 nm, preferably in the range about 800 nm to about 1600 nm, about 1060 nm to 1080 nm, 1530 nm to 1600 nm, 1800 nm to 2100 nm, and more preferably about 1064 nm, about 1070-1080 nm, about 1360 nm, about 1455 nm, 1490 nm, or about 1550 nm, or about 1900 nm (wavelengths in the range of 1900 nm may be provided by Thulium lasers).

For example a preferred type of fiber laser would be one that includes 20 modules or more. The gain bandwidth of a fiber laser is on the order of 20 nm, the linewidth of the free oscillator is 3 nm, Full Width Half Maximum (FWHM) and may range from 3 nm to 5 nm (although higher linewidths including 10 nm are envisioned and contemplated). Each module's wavelength is slightly different. The modules further each create a multi-mode beam. Thus, the cumulative effect of combining the beams from the modules is to maintain the Raman gain and the Brillouin gain at a lower value corresponding to the wavelengths and linewidths of the individual modules, and thus, consequently reducing the SBS (Stimulated Brillouin Scattering) and SRS (Stimulated Raman Scattering) phenomenon in a fiber when the combined beams are transmitted through the fiber. An example of this general type of fiber laser is the IPG YLR-20000. The detailed properties of which are disclosed in US patent application Publication Number 2010/0044106.

In some embodiments, a fiber laser emitted light at wavelengths comprised of 1060 nm to 1080 nm, 1530 nm to 1600 nm, 1800 nm to 2100 nm, diode lasers from 400 nm to 1600 nm, CO₂ Laser at 10,600 nm (however, CO₂ laser do not couple into conventional fused silica optical fibers and thus a solid fiber capable of transmitting these wavelengths, or hollow light pipe or later developed optical means may be utilized to transmit this laser beam), or Nd:YAG Laser emitting at 1064 nm can couple to the optical fibers. In some embodiments, the fiber can have a low water content. Preferably, the water content of the fiber should be as low as is possible.

Examples of lasers, and in particular solid-state lasers, such as fibers lasers, are set forth in US Patent Application Publication Numbers 2010/0044106, 2010/0044103, 2010/0044105 and 2010/0215326 and in pending U.S. patent application Ser. No. 12/840,978, the entire disclosures of each of which are incorporated herein by reference. Further diode lasers, and for example, such lasers having a wavelength of from about 0.9 microns to 2 microns may be utilized.

In general, the system may also include one or more mobile laser structures, which could be, for example: an integrated laser wireline truck; a laser coiled tubing rig; a laser power spool and transmission cable; an integrated laser workover and completion unit; or other mobile or movable structures, such as integrated wheeled structures, trailers, semi-trailer, skids, shipping containers, rail cars or carriages, or similar equipment. Although a fixed laser structure may be employed, for example at a site where the laser may be used for a longer term period, such as the decommissioning of a large facility. The mobile laser structures houses, or has a laser cabin that houses, the high power laser(s), and may further be specifically constructed to protect the laser from specifically anticipated environment conditions, such as desert conditions, off-shore conditions, arctic conditions, and other environmental conditions that may be present throughout the world, or it may be constructed to protect the laser against the general and varied types of weather and environmental conditions that are encountered at oilfield sites throughout the world. The mobile laser structure may also have the support systems for the operation of the laser, such as a chiller, electric generators, beam switches, beam combiners, controllers, computers and other types of laser support, control or monitoring systems.

The mobile laser structure may also have, integral with, as a part of, as a separate mobile structure, or as a combination or variations of these, a high power laser conveyance structure and a handling apparatus for that structure. The handling apparatus may include, or be, a spool, a creel, reverse loop structures that do not twist the fiber, an optical slip ring, a figure-eight wrapping structure, and other structures and equipment for the handling of long tubing, cables, wires or fibers. The handling apparatus should be selected, constructed or configured to avoid, minimize or manage, transmission losses that may occur from macro-bending, micro-bending, strain or other physical, optical or opto-physical phenomena that may occur when a high power optical fiber is wound and unwound or otherwise paid out and retrieved. Thus, for example, it is preferable to avoid placing the fiber in a tighter, i.e., smaller, bend radius, than the fiber manufacturer's specified minimum bend radius. More preferably, the fiber should be configured and deployed to avoid having any radius of curvature that is within 1% of the minimum bend radius to provide a margin of error during operations. In general the minimum bend radius is the minimum radius of curvature to avoid a predetermined stress level for a particular fiber. Thus, it is preferred that the radii of curvature in the system be equal to or greater than the minimum bend radius, however, they may be 1% tighter, 2% tighter and about 5% tighter, provided that losses and stress induced detrimental effects do not substantially adversely affect the desired performance of the system in an intended application. Moreover, techniques, methods and configurations to avoid, minimize, or manage such losses are provided in U.S. patent application Ser. No. 12/840,978 filed Jul. 21, 2010, and in U.S. patent application Ser. No. 13/210,581, filed Aug. 16, 2011, the entire disclosure, of each, of which is incorporated herein by reference.

The handling apparatus may also include a drive, power or rotating mechanism for paying out or retrieving the conveyance structure. This mechanism may be integral with the mobile laser structure and configured to receive and handle different conveyance structures; for example, a laser wire line truck, having a bay to receive different sizes of spools, spools having different conveyance structures, or both. The drive, power or rotating mechanism may be integral with the mobile laser structure. And, this mechanism may be operably associated with the mobile laser structure in other manners. Examples of handling apparatus are provided in U.S. patent application Ser. No. 13/210,581 the entire disclosure of which is incorporated herein by reference.

Thus, the conveyance structure may be: a single high power optical fiber; it may be a single high power optical fiber that has shielding; it may be a single high power optical fiber that has multiple layers of shielding; it may have two, three or more high power optical fibers that are surrounded by a single protective layer, and each fiber may additionally have its own protective layer; it may contain or have associated with the fiber a support structure which may be integral with or releasable or fixedly attached to optical fiber (e.g., a shielded optical fiber is clipped to the exterior of a metal cable and lowered by the cable into a borehole); it may contain other conduits such as a conduit to carry materials to assist a laser cutter, for example gas, air, nitrogen, oxygen, inert gases; it may have other optical or metal fiber for the transmission of data and control information and signals; it may be any of the combinations and variations thereof.

The conveyance structure transmits high power laser energy from the laser to a location where high power laser energy is to be utilized or a high power laser activity is to be performed by, for example, a high power laser tool. The conveyance structure may, and preferably in some applications does, also serve as a conveyance device for the high power laser tool. The conveyance structure's design or configuration may range from a single optical fiber, to a simple to complex arrangement of fibers, support cables, shielding on other structures, depending upon such factors as the environmental conditions of use, performance requirements for the laser process, safety requirements, tool requirements both laser and non-laser support materials, tool function(s), power requirements, information and data gathering and transmitting requirements, control requirements, and combinations and variations of these.

The conveyance structure may be, for example, coiled tubing, a tube within the coiled tubing, wire in a pipe, fiber in a metal tube, jointed drill pipe, jointed drill pipe having a pipe within a pipe, or may be any other type of line structure, which has a high power optical fiber associated with it. As used herein the term “line structure” should be given its broadest meaning, unless specifically stated otherwise, and would include without limitation: wireline; coiled tubing; slick line; logging cable; cable structures used for completion, workover, drilling, seismic, sensing, and logging; cable structures used for subsea completion and other subsea activities; umbilicals; cables structures used for scale removal, wax removal, pipe cleaning, casing cleaning, cleaning of other tubulars; cables used for ROV control power and data transmission; lines structures made from steel, wire and composite materials, such as carbon fiber, wire and mesh; line structures used for monitoring and evaluating pipeline and boreholes; and would include without limitation such structures as Power & Data Composite Coiled Tubing (PDT-COIL) and structures such as those sold under the trademarks Smart Pipe® and FLATpak®.

High powered conveyance structures and handling apparatus are disclosed in US Patent Application Publications 2010/0044106, 2010/0044103, 2010/0044105 and 2010/0215326 and in pending U.S. patent application Ser. No. 12/840,978, and U.S. patent application Ser. No. 13/210,581, the entire disclosures, of each, of which are incorporated herein by reference.

High power long distance laser fibers, which are disclosed in detail in US Patent Application Publications 2010/0044106, 2010/0044103, 2010/0044105 and 2010/0215326 and in pending U.S. patent application Ser. No. 12/840,978, the entire disclosures of each of which are incorporated herein by reference, break the length-power-paradigm, and advance the art of high power laser delivery beyond this paradigm, by providing optical fibers and optical fiber cables (which terms are used interchangeably herein and should be given their broadest possible meanings, unless specified otherwise), which may be used as, in association with, or as a part of conveyance structures, that overcome these and other losses, brought about by nonlinear effects, macro-bending losses, micro-bending losses, stress, strain, and environmental factors and provides for the transmission of high power laser energy over great distances without substantial power loss.

An example of an optical fiber cable for transmitting high power laser energy over great distances is a cable having a length that is greater than about 0.5 km, greater than 2 km greater than about 3 km or greater than about 5 km; the cable is a layered structure comprising: a core; a cladding; a coating; a first protective layer; and, a second protective layer, the cable is capable of transmitting laser energy having a power greater than or equal to about 1 kW, about 5 kW or about 10 kW, over the length of the cable with a power loss of less than about 2 dB/km and preferably less than about 1 dB/km and more preferably less than about 0.3 dB/km for a selected wavelength. This cable may also be capable of providing laser energy to a tool or surface; the laser energy having a spectrum, such that the laser energy at the delivery location is substantially free from SRS and SBS phenomena. Fiber cables may have lengths that are greater than 0.5 km, greater than about 1 km, greater than about 2 km, greater than about 3 km, or greater.

For example an optical fiber cable may be an optical fiber in a stainless steel metal tube, the tube having an outside diameter of about ⅛″ (“inch”). The optical fiber having a core diameter of about 600 μm, (microns), about 1000 μm, and from about 600-1000 μm, a cladding thickness of about 50 μm, (the thickness of a layer or coating is measured from the internal diameter or inner surface of the layer or coating to the outer diameter or outer surface of the layer or coating) and an acrylate coating thickness of about 100 μm. The optical fiber may be within a TEFLON sleeve that is within the stainless steel tube.

Single and multiple optical fiber cables and optical fibers may be utilized, or a single optical cable with multiple optical fibers may be utilized; thus for example an optical-fiber squid may be used, a beam combiner may be used, or other assemblies to combine multiple fibers into a single fiber may be used, as part of, or in conjunction with the laser systems and conveyance structures of the present invention. Although the use of single length of fiber, i.e., the length of fiber is made up of one fiber rather than a series of fibers coupled, spliced or otherwise optically affixed end to end, for the longer distance power transmission is preferred, the use of multiple lengths of fiber joined end to end may be utilized. Moreover, several lengths of the optical fiber cables, or several lengths of fiber core structures, or combinations of both, may be joined into a plurality of such structures, such as in a bundle of optical fiber cables, fiber core structures or combinations of both.

Large core optical fibers are utilized with the present systems and conveyance structures to provide for the transmission of high power laser energy over great distances. Thus, configurations having a core diameter equal to or greater than 50 microns, equal to or greater than 75 microns and most preferably equal to or greater than 100 microns, or a plurality of optical fibers utilized. These optical fibers are protected by a protective structure(s), which may be independent of, integral with, provided by, or associated with, the conveyance structure.

For example, each optical fiber may have a carbon coating, a polymer, and may include TEFLON coating to cushion the optical fibers when rubbing against each other during deployment. Thus the optical fiber, or bundle of optical fibers, can have a diameter of from about greater than or equal to 150 microns to about 700 microns, 700 microns to about 1.5 mm, or greater than 1.5 mm.

The fibers may have a buffer or jacket coatings that may include preferably tefzel, or teflon, or another fluoropolymer or similar materials which have significant transmission at the desired wavelength, and substantial temperature capability for the selected application.

The carbon coating, is less preferred and finds applications in avoiding hydrogen effects and can range in thicknesses from 10 microns to >600 microns. The polymer or TEFLON coating can range in thickness from 10 microns to >600 microns and preferred types of such coating are acrylate, silicone, polyimide, PFA and others. The carbon coating can be adjacent the optical fiber, with the polymer or TEFLON coating being applied to it. Polymer, TEFLON, or other coatings are generally applied last to reduce binding of the optical fibers during deployment.

In some non-limiting embodiments, fiber optics may handle or transmit up to 10 kW per an optical fiber, up to 20 kW per an optical fiber, up to and greater than 50 kW per optical fiber. The optical fibers may transmit any desired wavelength or combination of wavelengths. In some embodiments, the range of wavelengths the optical fiber can transmit may preferably be between about 800 nm and 2100 nm. The optical fiber can be connected by a connector to another optical fiber to maintain the proper fixed distance between one optical fiber and neighboring optical fibers. The optical fibers may also be spliced end-to-end to increase the overall length of the uninterrupted optical fiber.

For example, optical fibers can be connected such that the beam spot from neighboring optical fibers when irradiating the material, such as a rock surface or casing to be cut are under 2″ and non-overlapping to the particular optical fiber. The optical fiber may have any desired core size. In some embodiments, the core size may range from about 50 microns to 1 mm or greater and preferably is about 500 microns to about 1000 microns. The optical fiber can be single mode or multimode. If multimode, the numerical aperture of some embodiments may range from 0.1 to 0.6. A lower numerical aperture may be preferred for beam quality, and a higher numerical aperture may be easier to transmit higher powers with lower interface losses. In some embodiments, a fiber laser emitted light at wavelengths comprised of 1060 nm to 1080 nm, 1530 nm to 1600 nm, 1800 nm to 2100 nm, diode lasers from 800 nm to 2100 nm, or Nd:YAG Laser emitting at 1064 nm can couple to the optical fibers. In some embodiments, the optical fiber can have a low water content. The optical fiber can be jacketed, as a part of the conveyance structure or independently, such as with polyimide, acrylate, carbon polyamide, and carbon/dual acrylate or other material. If requiring high temperatures, a polyimide or a derivative material may be used to operate at temperatures over 300° C. The optical fibers can be a hollow core photonic crystal or solid core photonic crystal. In some embodiments, using hollow core photonic crystal fibers at wavelengths of 1500 nm or higher may minimize absorption losses (however, at present these fibers have drawbacks in that higher power connectors are not readily available and thus would require the system to be optically associated without the use of connectors). Additionally, Zirconium Fluoride (ZrF₄), Halide fibers, Fluoride glass fibers (e.g., Calcium Fluoride etc.) and active fibers may be utilized.

The use of the plurality of optical fibers can be bundled into a number of configurations to improve power density. The optical fibers forming a bundle may range from two at hundreds of watts to kilowatt powers in each optical fiber to millions at milliwatts or microwatts of power. In some embodiments, the plurality of optical fibers may be bundled and spliced at powers below 2.5 kW to step down the power. Power can be spliced to increase the power densities through a bundle, such as preferably up to 10 kW, more preferably up to 20 kW, and even more preferably up to or greater than 50 kW. The step down and increase of power allows the beam spot to increase or decrease power density and beam spot sizes through the fiber optics. In most examples, splicing the power to increase total power output may be beneficial so that power delivered through optical fibers does not reach past the critical power thresholds for fiber optics.

Thus, by way of example there is provided the following configurations set forth in Table 1 herein.

TABLE 1

| Diameter of bundle | Number of fibers in bundle |
|---|---|
| 100 microns | 1 |
| 200 microns-1 mm | 2 to 100 |
| 100 microns-1 mm | 1 |

A thin wire may also be packaged, for example in the ¼″ stainless tubing, along with the optical fibers to test the optical fiber for continuity. Alternatively a metal coating of sufficient thickness is applied to allow the optical fiber continuity to be monitored. These approaches, however, become problematic as the optical fiber exceeds 1 km in length, and do not provide a practical method for testing and monitoring. Other examples of continuity monitoring, break detection and fiber monitoring systems and apparatus are provided in U.S. provisional patent application Ser. No. 61/446,407, the entire disclosure of which is incorporated herein by reference.

The configurations in Table 1, as well as other configurations, can be of lengths equal to or greater than 1 m, equal to or greater than 1 km, equal to or greater than 2 km, equal to or greater than 3 km, equal to or greater than 4 km and equal to or greater than 5 km. These configurations can be used to transmit power levels from about 0.5 kW to about 10 kW, from greater than or equal to 1 kW, greater than or equal to 2 kW, greater than or equal to 5 kW, greater than or equal to 8 kW, greater than or equal to 10 kW and preferable at least about 20 kW.

In transmitting power over long distances, such as down a borehole or through a cable that is at least 1 km, there are in general three sources of power losses from non-linear effects in an optical fiber, Raleigh Scattering, Raman Scattering and Brillouin Scattering. The first, Raleigh Scattering is the intrinsic losses of the optical fiber due to the impurities in the optical fiber. The second, Raman Scattering can result in Stimulated Raman Scattering in a Stokes or Anti-Stokes wave off of the vibrating molecules of the optical fiber. Raman Scattering occurs preferentially in the forward direction and results in a wavelength shift of up to +25 nm from the original wavelength of the source. The third mechanism, Brillouin Scattering, is the scattering of the forward propagating pump off of the acoustic waves in the optical fiber created by the high electric fields of the original source light (pump). This third mechanism is highly problematic and may create great difficulties in transmitting high powers over long distances. The Brillouin Scattering can give rise to Stimulated Brillouin Scattering (SBS) where the pump light is preferentially scattered backwards in the optical fiber with a frequency shift of approximately 1 to about 20 GHz from the original source frequency. This Stimulated Brillouin effect can be sufficiently strong to backscatter substantially all of the incident pump light if given the right conditions. Therefore it is desirable to suppress this non-linear phenomenon. There are essentially four primary variables that determine the threshold for SBS: the length of the gain medium (the optical fiber); the linewidth of the source laser; the natural Brillouin linewidth of the optical fiber the pump light is propagating in; and, the mode field diameter of the optical fiber. Under typical conditions and for typical optical fibers, the length of the optical fiber is inversely proportional to the power threshold, so the longer the optical fiber, the lower the threshold. The power threshold is defined as the power at which a high percentage of incident pump radiation will be scattered such that a positive feedback takes place whereby acoustic waves are generated by the scattering process. These acoustic waves then act as a grating to incite further SBS. Once the power threshold is passed, exponential growth of scattered light occurs and the ability to transmit higher power is greatly reduced. This exponential growth continues with an exponential reduction in power until such point whereby any additional power input will not be transmitted forward which point is defined herein as the maximum transmission power. Thus, the maximum transmission power is dependent upon the SBS threshold, but once reached, the maximum transmission power will not increase with increasing power input.

Thus, as provided herein, novel and unique means for suppressing nonlinear scattering phenomena, such as the SBS and Stimulated Raman Scattering phenomena, means for increasing power threshold, and means for increasing the maximum transmission power are set forth for use in transmitting high power laser energy over great distances for, among other things, the advancement of boreholes.

The mode field diameter needs to be as large as practical without causing undue attenuation of the propagating source laser. Large core single mode optical fibers are currently available with mode diameters up to 30 microns, however bending losses are typically high and propagation losses are higher than desired. Small core step index optical fibers, with mode field diameters of 50 microns are of interest because of the low intrinsic losses, the significantly reduced fluence, the decreased SBS gain, a non-polarization preserving design, and, a multi-mode propagation constant. All of these factors effectively increase the SBS power threshold. Consequently, a larger core optical fiber with low Raleigh Scattering losses is a solution for transmitting high powers over great distances, preferably where the mode field diameter is 50 microns or greater in diameter.

The next consideration is the natural Brillouin linewidth of the optical fiber. As the Brillouin linewidth increases, the scattering gain factor decreases. The Brillouin linewidth can be broadened by varying the temperature along the length of the optical fiber, modulating the strain on the optical fiber and inducing acoustic vibrations in the optical fiber. Varying the temperature along the optical fiber results in a change in the index of refraction of the optical fiber and the background (kT) vibration of the atoms in the optical fiber effectively broadening the Brillouin spectrum. In down borehole application the temperature along the optical fiber will vary naturally as a result of the geothermal energy that the optical fiber will be exposed to at the depths, and ranges of depths, expressed herein. The net result will be a suppression of the SBS gain. Applying a thermal gradient along the length of the optical fiber could be a means to suppress SBS by increasing the Brillouin linewidth of the optical fiber. For example, such means could include using a thin film heating element or variable insulation along the length of the optical fiber to control the actual temperature at each point along the optical fiber. Applied thermal gradients and temperature distributions can be, but are not limited to, linear, step-graded, and non-periodic functions along the length of the optical fiber.

Modulating the strain for the suppression of nonlinear scattering phenomena, on the optical fiber can be achieved, but those means are not limited to anchoring the optical fiber in its jacket in such a way that the optical fiber is strained. By stretching each segment between support elements selectively, then the Brillouin spectrum will either red shift or blue shift from the natural center frequency effectively broadening the spectrum and decreasing the gain. If the optical fiber is allowed to hang freely from a tensioner, then the strain will vary from the top of the hole to the bottom of the hole, effectively broadening the Brillouin gain spectrum and suppressing SBS. Means for applying strain to the optical fiber include, but are not limited to, twisting the optical fiber, stretching the optical fiber, applying external pressure to the optical fiber, and bending the optical fiber. Thus, for example, as discussed above, twisting the optical fiber can occur through the use of a creel. Moreover, twisting of the optical fiber may occur through use of downhole stabilizers designed to provide rotational movement. Stretching the optical fiber can be achieved, for example as described above, by using support elements along the length of the optical fiber. Downhole pressures may provide a pressure gradient along the length of the optical fiber thus inducing strain.

Acoustic modulation of the optical fiber can alter the Brillouin linewidth. By placing acoustic generators, such as piezo crystals along the length of the optical fiber and modulating them at a predetermined frequency, the Brillouin spectrum can be broadened, effectively decreasing the SBS gain. For example, crystals, speakers, mechanical vibrators, or any other mechanism for inducing acoustic vibrations into the optical fiber may be used to effectively suppress the SBS gain. Additionally, acoustic radiation can be created by the escape of compressed air through predefined holes, creating a whistle effect.

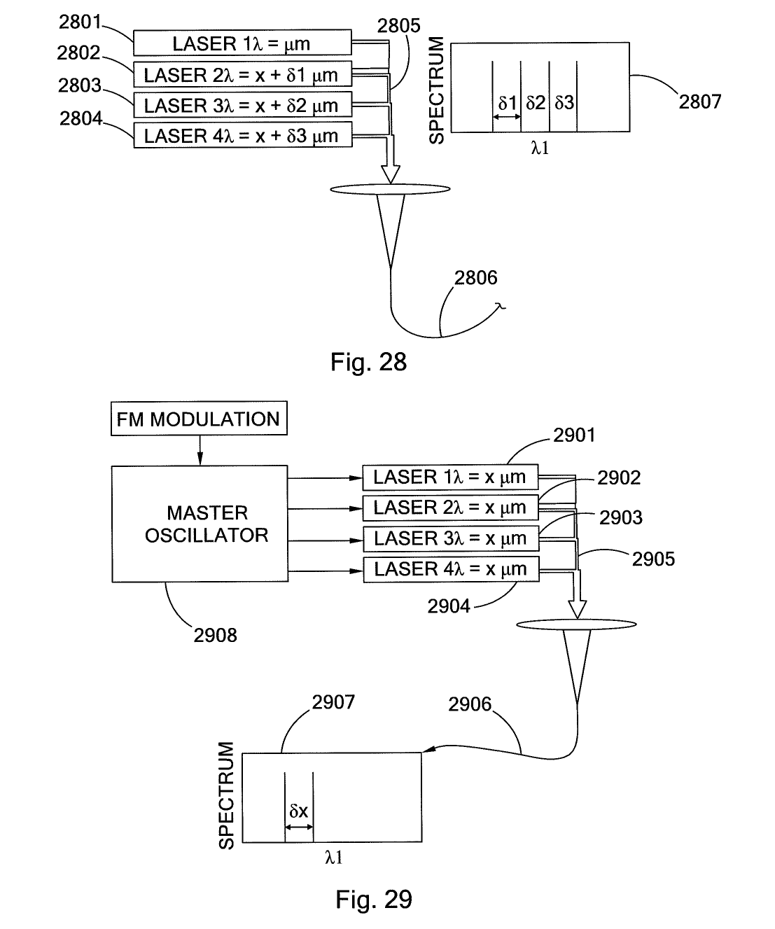

A spectral beam combination of laser sources may be used to suppress Stimulated Brillouin Scattering. Thus the spaced wavelength beams, the spacing as described herein, can suppress the Stimulated Brillouin Scattering through the interference in the resulting acoustic waves, which will tend to broaden the Stimulated Brillouin Spectrum and thus resulting in lower Stimulated Brillouin Gain. Additionally, by utilizing multiple colors the total maximum transmission power can be increased by limiting SBS phenomena within each color. An example of such a laser system is illustrated in FIG. 28.

For example, FIG. 28 Illustrates a spectral beam combination of lasers sources to enable high power transmission down a fiber by allocating a predetermined amount of power per color as limited by the Stimulated Brillouin Scattering (SBS) phenomena. Thus, there is provided in FIG. 28 a first laser source 2801 having a first wavelength of “x”, where x may preferably be less than 1 micron, but may also be 1 micron and larger. There is provided a second laser 2802 having a second wavelength of x+δ1 microns, where δ1 is a predetermined shift in wavelength, which shift could be positive or negative. There is provided a third laser 2803 having a third wavelength of x+δ1+δ2 microns and a fourth laser 2804 having a wavelength of x+δ1+δ2+δ3 microns. The laser beams are combined by a beam combiner 2805 and transmitted by an optical fiber 2806. The combined beam having a spectrum shown in 2807.

The interaction of the source linewidth and the Brillouin linewidth in part defines the gain function. Varying the linewidth of the source can suppress the gain function and thus suppress nonlinear phenomena such as SBS. The source linewidth can be varied, for example, by FM modulation or closely spaced wavelength combined sources, an example of which is illustrated in FIG. 29. Thus, a fiber laser can be directly FM modulated by a number of means, one method is simply stretching the fiber with a piezo-electric element which induces an index change in the fiber medium, resulting in a change in the length of the cavity of the laser which produces a shift in the natural frequency of the fiber laser. This FM modulation scheme can achieve very broadband modulation of the fiber laser with relatively slow mechanical and electrical components. A more direct method for FM modulating these laser sources can be to pass the beam through a non-linear crystal such as Lithium Niobate, operating in a phase modulation mode, and modulate the phase at the desired frequency for suppressing the gain.

FIG. 29. Illustrates a frequency modulated array of lasers. Thus, there is provided a master oscillator than can be frequency modulated, directly or indirectly, that is then used to injection-lock lasers or amplifiers to create a higher power composite beam than can be achieved by any individual laser. Thus, there are provided lasers 2901, 2902, 2903, and 2904, which have the same wavelength. The laser beams are combined by a beam combiner 2905 and transmitted by an optical fiber 2906. The lasers 2901, 2902, 2903 and 2904 are associated with a master oscillator 2908 that is FM modulated. The combined beam having a spectrum show in 2907, where δ is the frequency excursion of the FM modulation. Such lasers are disclosed in U.S. Pat. No. 5,694,408, the disclosure of which is incorporated here in reference in its entirety.

Raman scattering can be suppressed by the inclusion of a wavelength-selective filter in the optical path. This filter can be a reflective, transmissive, or absorptive filter. Moreover, an optical fiber connector can include a Raman rejection filter. Additionally a Raman rejection filter could be integral to the optical fiber. These filters may be, but are not limited to, a bulk filter, such as a dichroic filter or a transmissive grating filter, such as a Bragg grating filter, or a reflective grating filter, such as a ruled grating. For any backward propagating Raman energy, as well as, a means to introduce pump energy to an active fiber amplifier integrated into the overall optical fiber path, is contemplated, which, by way of example, could include a method for integrating a rejection filter with a coupler to suppress Raman Radiation, which suppresses the Raman Gain. Further, Brillouin scattering can be suppressed by filtering as well. Faraday isolators, for example, could be integrated into the system. A Bragg Grating reflector tuned to the Brillouin Scattering frequency, with a single frequency laser source and with the laser locked to a predetermined wavelength could also be integrated into the coupler to suppress the Brillouin radiation.

To overcome power loss in the optical fiber as a function of distance, active amplification of the laser signal can be used. An active fiber amplifier can provide gain along the optical fiber to offset the losses in the optical fiber. For example, by combining active fiber sections with passive fiber sections, where sufficient pump light is provided to the active, i.e., amplified section, the losses in the passive section will be offset. Thus, there is provided a means to integrate signal amplification into the system. In FIG. 31 there is illustrated an example of such a means having a first passive fiber section 3100 with, for example, −1 dB loss, a pump source 3101 optically associated with the fiber amplifier 3102, which may be introduced into the outer clad, to provide for example, a +1 dB gain of the propagating signal power. The fiber amplifier 3102 is optically connected to a coupler 3103, which can be free spaced or fused, which is optically connected to a passive section 3104. This configuration may be repeated numerous times, for varying lengths, power losses, and downhole conditions. Additionally, the fiber amplifier could act as the delivery optical fiber for the entirety of the transmission length. The pump source may be uphole, downhole, or combinations of uphole and downhole for various borehole configurations.

A further method is to use dense wavelength beam combination of multiple laser sources to create an effective linewidth that is many times the natural linewidth of the individual laser effectively suppressing the SBS gain. Here multiple lasers each operating at a predetermined wavelength and at a predetermined wavelength spacing are superimposed on each other, for example by a grating. The grating can be transmissive or reflective.

Mode field variation as a function of length, index of refraction as a function of length, core size variation as a function of length, the fusing of different types or specifications for fibers together, altering the gain spectrum of the fiber, altering the spectrum of the laser, the pulsing of the laser at shorter time durations than the time constant of the phonon propagation in the fiber, are methodologies, that may be utilized in combination with each other, and in combination with, a lone, or in addition to, other methodologies provided in this specification to suppresses or reduce non-liner effects.

The optical fiber or fiber bundle can be: encased in a separate shield or protective layer; or incorporated in or associated with a conveyance structure; or both, to shield the optical fiber and to enable it to survive at high pressures and temperatures. The cable could be similar in construction to the submarine cables that are laid across the ocean floor and may be buoyant, or have neutral buoyancy, if the borehole is filled with water. The cable may include one or many optical fibers in the cable, depending on the power handling capability of the optical fiber and the power required to achieve economic drilling rates. It being understood that in the field several km of optical fiber may have to be delivered down the borehole. The fiber cables may be made in varying lengths such that shorter lengths are used for shallower depths so higher power levels can be delivered and consequently higher drilling rates can be achieved. This method requires the optical fibers to be changed out when transitioning to depths beyond the length of the fiber cable. Alternatively a series of connectors could be employed if the connectors could be made with low enough loss to allow connecting and reconnecting the optical fiber(s) with minimal losses.

Thus, there is provided in Tables 2 and 3 herein power transmissions for exemplary optical cable configurations.

TABLE 2

| | Length | | # of fibers in | | |
|---|---|---|---|---|---|
| Power in | of fiber(s) | Diameter of bundle | bundle | Power out | |
| 20 kW | 5 km | 500 microns | 1 | 15 | kW |
| 20 kW | 7 km | 500 microns | 1 | 13 | kW |
| 20 kW | 5 km | 650 micron | 1 | 15 | kW |
| 20 kW | 5 km | 1 mm | 1 | 15 | kW |
| 20 kW | 7 km | 1.05 mm | 1 | 13 | kW |
| 20 kW | 5 km | 200 microns-1 mm | 2 to 100 | 12-15 | kW |
| 20 kW | 7 km | 200 microns-1 mm | 2 to 100 | 8-13 | kW |
| 20 kW | 5 km | 100-200 microns | 1 | 10 | kW |
| 20 kW | 7 km | 100-200 microns | 1 | 8 | kW |

TABLE 3
(with active amplification)

| | Length of | | # of | |
|---|---|---|---|---|
| Power in | fiber(s) | Diameter of bundle | fibers in bundle | Power out |
| 20 kW | 5 km | 500 microns | 1 | 20 kW |
| 20 kW | 7 km | 500 microns | 1 | 20 kW |
| 20 kW | 5 km | 200 microns-1 mm | 2 to 100 | 20 kW |
| 20 kW | 7 km | 200 microns-1 mm | 2 to 100 | 20 kW |
| 20 kW | 5 km | 100-200 microns | 1 | 20 kW |
| 20 kW | 7 km | 100-200 microns | 1 | 20 kW |

The optical fibers may be placed inside of or associated with a conveyance structure such as a coiled tubing, line structure, or composite tubular structure for advancement into and removal from the borehole. In this manner the line structure or tubing would be the primary load bearing and support structure as the assembly is lowered into the well. It can readily be appreciated that in wells of great depth the tubing will be bearing a significant amount of weight because of its length. In configurations where the optical fiber is located inside of an open passage or channel in the tube, as opposed to being integral with, fixed to, or otherwise associated with the side wall of the tube, to protect and secure the optical fibers, including the optical fiber bundle contained in the, for example, ¼″ or ⅛″ or similar size stainless steel tubing, inside the coiled tubing stabilization devices may be desirable. Thus, at various intervals along the length of the tubing supports can be located inside the tubing that fix or hold the optical fiber in place relative to the tubing. These supports, however, should not interfere with, or otherwise obstruct, the flow of fluid, if fluid is being transmitted through the tubing. An example of a commercially available stabilization system is the ELECTROCOIL System. These support structures, as described above, may be used to provide strain to the optical fiber for the suppression of nonlinear phenomena.

The optical fibers may also be associated with the tubing by, for example, being run parallel to the tubing, and being affixed thereto, by being run parallel to the tubing and be slidably affixed thereto, or by being placed in a second tubing that is associated or not associated with the first tubing. In this way, it should be appreciated that various combinations of tubulars may be employed to optimize the delivery of laser energy, fluids, and other cabling and devices into the borehole. Moreover, the optical fiber may be segmented and employed with conventional strands of drilling pipe and thus be readily adapted for use with a conventional mechanical drilling rig outfitted with connectable tubular drill pipe, or it may be associated with the exterior of the drill pipe as the pipe is tripped into the well (and correspondingly disassociated from the pipe as it is tripped out of the well).

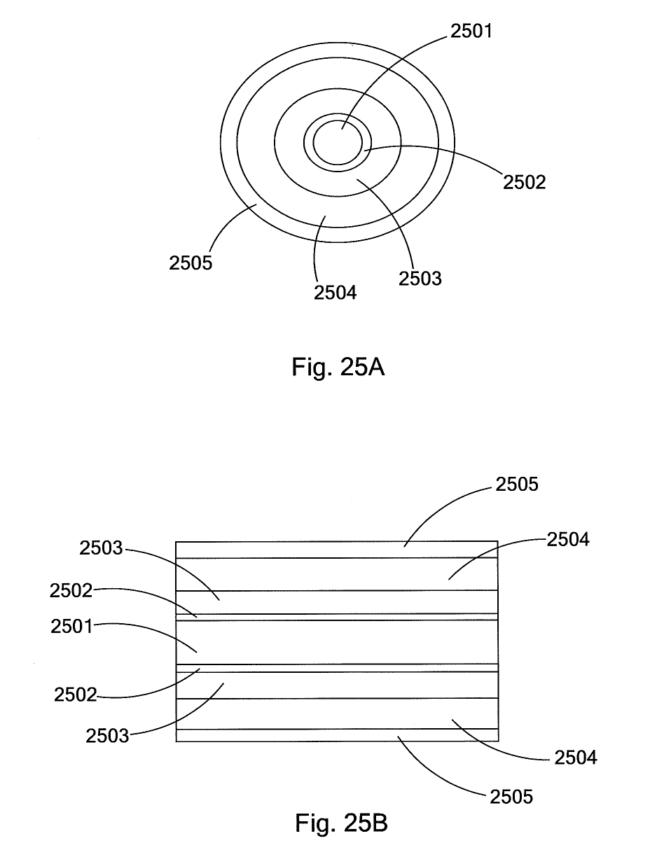

For example, and in general, there is provided in FIGS. 25A and 25B an optical fiber cable having a core 2501, a cladding 2502, a coating 2503, a first protective layer 2504, and a second protective layer 2505. Although shown in the figures as being concentric, it is understood that the components may be located off-center, off-center and on-center at different locations, and that the core, the core and cladding and the core, cladding and coating may be longer or shorter than the one or more of the protective layers.

The core 2501 is preferably composed of fused silica having a water content of at most about 0.25 ppm or less. The core may be composed of other materials, such as those disclosed in US Patent Application Publication Numbers 2010/0044106, 2010/0044103, 2010/0044105 and 2010/0215326 and in pending U.S. patent application Ser. No. 12/840,978, the entire disclosures of each of which are incorporated herein by reference. Higher purity materials, and the highest purity material available, for use in the core are preferred. Thus, this higher purity material minimizes the scattering losses caused by defects and inclusions. The core is about 200 to about 700 microns in diameter, preferably from about 500 to about 600 microns in diameter and more preferably about 600 microns in diameter.

The cladding 2502 is preferably composed of fluorine doped fused silica. The cladding may be composed of other materials such as fused silica doped with index-altering ions (germanium), as well as, those disclosed in US Patent Application Publication Numbers 2010/0044106, 2010/0044103, 2010/0044105 and 2010/0215326 and in pending U.S. patent application Ser. No. 12/840,978 the entire disclosures of each of which are incorporated herein by reference. The cladding thickness, depending upon the wavelength being used and the core diameter, is from about 50 microns to about 250 microns, preferably about 40 microns to about 70 microns and more preferably about 60 microns. As used herein with respect to a multi-layer structure, the term “thickness” means the distance between the layer's inner diameter and its outer diameter. The thickness of the cladding is dependent upon and relative to the core size and the intended wavelength. To determine the thickness of the cladding the following may be considered the wavelength, dopant levels, NA, bend sensitivity, the composition and thickness of the outer coating or additional claddings, and factors pertinent to end use considerations. Thus, by way of illustration in general fibers may fall within the following for 1.1 micron wavelength the outer diameter of the cladding could be 1.1× the outer diameter of core or greater; and, for a 1.5 micron wavelength the outer diameter of the cladding could be 1.5× the outer diameter of the core or greater. Although a single cladding is illustrated, it is understood that multiple cladding may be utilized.

The coating 2503 is preferably composed of a high temperature acrylate polymer, for higher temperatures a polyimide coating is desirable. The coating may be composed of other materials, such a metal, as well as those disclosed in US Patent Application Publication Numbers 2010/0044106, 2010/0044103, 2010/0044105 and 2010/0215326 and in pending U.S. patent application Ser. No. 12/840,978 the entire disclosures of each of which are incorporated herein by reference. The coating thickness is preferably from about 50 microns to about 250 microns, preferably about 40 microns to about 150 microns and more preferably about 90 microns. The coating thickness may even be thicker for extreme environments, conditions and special uses or it may be thinner for environments and uses that are less demanding. It can be tailored to protect against specific environmental and/or physical risks to the core and cladding that may be encountered and/or anticipated in a specific use for the cable.

The first protective layer 2504 and the second protective layer 2505 may be the same or they may be different, or they may be a single composite layer include different materials. Preferably the first and second protective layers are different materials.

The first protective layer may be thixotropic gel. This layer may be used to primarily protect the fiber from absorption loss from hydroxyl ions and vibration. Some gels set forth for example below, may be specifically designed or used to absorb hydroxyl ions, or prevent the migration of substances to cause their formation. The thixotropic gel protects the fiber from mechanical damage due to vibrations, as well as, provides support for the fiber when hanging vertically because its viscosity increases when it is static. A palladium additive is be added to the thixotropic gel to provide hydrogen scavenging. The hydrogen which diffuses into the fiber may be problematic for Germanium or similar ion doped cores. When using a pure fused silica core, it is less of an effect and may be dramatically reduced. The first protective layer may be composed of other materials, such as, TEFLON, and those disclosed in US Patent Application Publication Numbers 2010/0044106, 2010/0044103, 2010/0044105 and 2010/0215326 and in pending U.S. patent application Ser. No. 12/840,978 the entire disclosures of each of which are incorporated herein by reference. The thickness of the first protective layer should be selected based upon the environment and conditions of use as well as the desired flexibility and/or stiffness of the cable and the design, dimensions and performance requirements for the conveyance structure that they may be incorporated into or associated with. Thus, the composition and thickness of the first protective layer can be tailored to protect against specific environmental and/or physical risks to the core, cladding and coating that may be encountered and/or anticipated in a specific use for the cable. The use of the thixotropic gel provides the dual benefit of adding in the manufacture of the cable as well as providing mechanical protection to the core once the cable manufacturing is completed.

The second protective layer may be a stainless steel tube composed of 316 stainless. The second protective layer may provide physical strength to the fiber over great distances, as well as, protection from physical damage and the environment in which the cable may be used. The second protective layer may be composed of other materials, such as those disclosed US Patent Application Publication Numbers 2010/0044106, 2010/0044103, 2010/0044105 and 2010/0215326 and in pending U.S. patent application Ser. No. 12/840,978 the disclosures of each of which are incorporated herein by reference. The second protective layer thickness may be selected based upon the requirements for use and the environment in which the cable will be used. The thickness my further be dependent upon the weight and strength of the material from which it is made. Thus, the thickness and composition of the second protective layer can be tailored to protect against specific environmental and/or physical risks to the core, cladding and coating that may be encountered and/or anticipated in a specific use for the cable. The presence of, size, configuration and composition of the second protective layer may be based upon or tailored to the design, dimensions, and performance requirements for the conveyance structure that the optical fiber cable may be incorporated into or associated with.

The need for, use of and configuration of the first, second, or additional protective layers may be dependent upon the configuration dimensions and performance requirements for a conveyance structure that the optical fiber is associated with. One or more of these protective layers, if utilized, may be part of the conveyance structure, integral with the conveyance structure, a separate or separable component of the conveyance structure, and combinations and variations of these.

The optical fiber cables, and the conveyance structures that they may be incorporated into or associated with, can be greater than about 0.5 km (kilometer), greater than about 1 km, greater than about 2 km, greater than about 3 km, greater than about 4 km and greater than about 5 km. These cables and structures can withstand temperatures of up to about 300° C., pressures of up to about 3000 psi and as great as 36,000 psi, and corrosive environments over the length of the fiber without substantial loss of power and for extended periods of time. The optical fiber cables and conveyance structures can have a power loss, for a given wavelength, of less than about 2.0 dB/km, less than about 1.5 dB/km, less than about 1.0 dB/km, less than about 0.5 dB/km and less than about 0.3 dB/km. The optical fiber cables and conveyance structures can have power transmissions of at least about 50%, at least about 60%, at least about 80%, and at least about 90%.

The flexibility and/or stiffness of the optical fiber cable, conveyance structure or both, can be varied based upon the size and types of materials that are used in the various layers of the cable and structure. Thus, depending upon the application a stiffer or more flexible optical fiber cable, conveyance structure or both, may be desirable. For some applications it is preferred that the optical fiber cable, conveyance structure or both, have sufficient flexibility and strength to be capable of being repeatedly wound and unwound from a spool or reel having an outside diameter of no more than about 6 m. This outside diameter spool size can be transported by truck on public highways. Thus, a spool or reel having an outside diameter of less than about 6 meters and comprising between 0.5 meters and 5 km of the optical fiber cable or structure may be utilized. The spool or reel may have an outside diameter of less than about 6 meters, less than about 3 meters, and less than about 2 meters, and comprising greater than about 0.5 km (kilometer), greater than about 1 km, greater than about 2 km, greater than about 3 km, greater than about 4 km and greater than about 5 km in length of the optical fiber cable, conveyance structure or both.

An example of an embodiment of the optical fiber cable, that may be or be part of a conveyance structure, would be a fused silica core of about 600 microns diameter, a fluorine doped fused silica cladding, having a thickness of 60 microns, a high temperature Acrylate coating having a thickness of about 90 microns, a thixotropic gel or a TEFLON sleeve first protective layer having a thickness of about 2500 microns, and a 316 stainless steel second protective layer having an outer diameter of about 6250 microns and a length of about 2 km. The length of the fiber structure includes the core, cladding and coating is longer than the length of the stainless steel protective layer. This difference in length addresses any differential stretch of the stainless steel relative to the stretch of the fiber structure when the cable is in a hanging position, or under tensions, such as when it is extended down a well bore. The fiber has a numerical aperture of at least about 0.14. (Numerical aperture (NA) is generally, defined by the formula NA=n sin □; where n is the index of refraction of the medium, and □ (theta) is the half angle of the maximum cone of light that can exit or enter the fiber, or optical element. Further discussions of NA with respect to multi-clad fibers is contained in U.S. provisional patent application Ser. No. 61/493,174, the entire disclosure of which is incorporated herein by reference.) The fiber of this example can transmit a laser beam (wavelength 1080 nm) of about 20 kW (kilowatt) power, from the preferred laser, over a distance of about 2 km in temperatures of up to about 200° C. and pressures of about 3000 psi with less than 1 dB/km power loss.

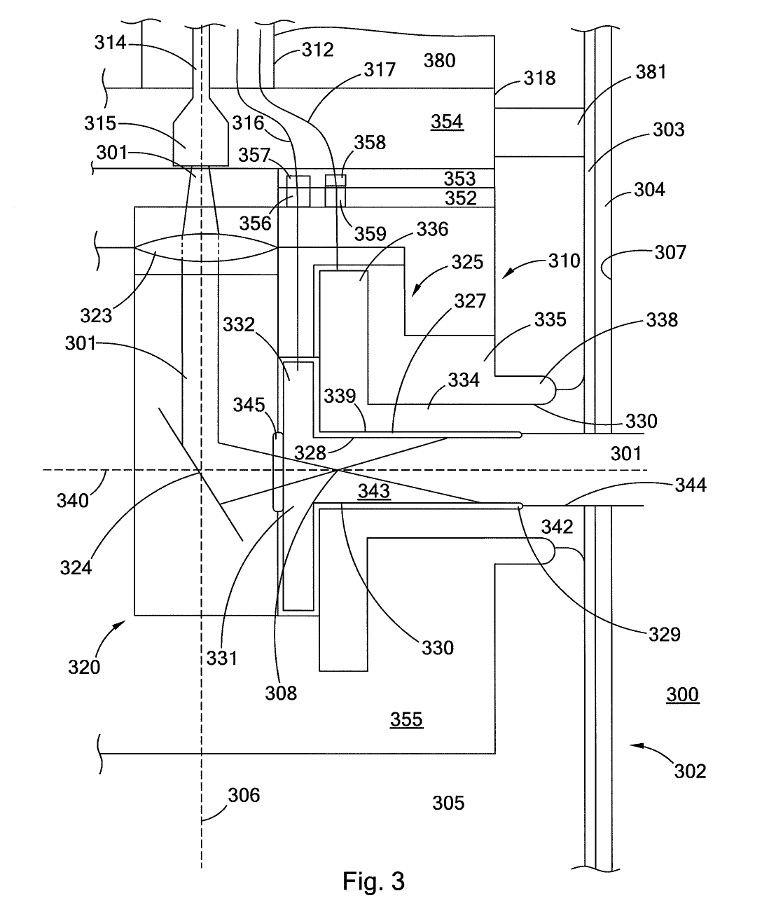

Another example of an embodiment of an optical fiber cable, that may be or be part of a conveyance structure, would have a fused silica core of about 500 microns diameter, a fluorine doped fused silica cladding, having a thickness of 50 microns, an Acrylate coating having a thickness of about 60 microns, and an ⅛ inch outer diameter stainless steel protective layer and a length of about 2 km. The fiber has a numerical aperture (NA) of 0.22. The fiber of this example transmitted a laser beam (wavelength 1080 nm) of about 10 kW (kilowatt) power, from the preferred laser, over a distance of about 2 km in temperatures of up to about 15° C.° and at ambient pressure and with less than 0.8 dB/km power loss. This fiber was tested using an IPG YLR 20000 laser was operated a duty cycle of 10% for a 1 kHz pulse rate. The operating conditions were established to keep the pulse duration longer than the time constant for SBS. Thus, the absence of SBS was the result of the fiber and laser, not the pulse duration. The laser beam was transmitted through a 2 km fiber, evaluated in a test system along the lines of the test system shown in FIG. 3 of US Patent Publication Number 2010/0215326 and provided the results set forth in Table 4, where peak power launched and power output are in watts.

TABLE 4

| Peak Power | | Percentage |
|---|---|---|
| Launched | Peak Power Output | transmitted |
| 924 | 452 | 48.9 |
| 1535 | 864 | 56.3 |
| 1563 | 844 | 54.0 |
| 1660 | 864 | 52.0 |
| 1818 | 970 | 53.3 |
| 1932 | 1045 | 54.1 |
| 2000 | 1100 | 55.0 |
| 2224 | 1153 | 51.8 |
| 2297 | 1216 | 52.9 |
| 2495 | 1250 | 50.1 |
| 2632 | 1329 | 50.5 |
| 2756 | 1421 | 51.6 |
| 3028 | 1592 | 52.6 |
| 3421 | 1816 | 53.1 |
| 3684 | 1987 | 53.9 |
| 3947 | 2105 | 53.3 |
| 4342 | 2263 | 52.1 |
| 4605 | 2382 | 51.7 |
| 4868 | 2487 | 51.1 |

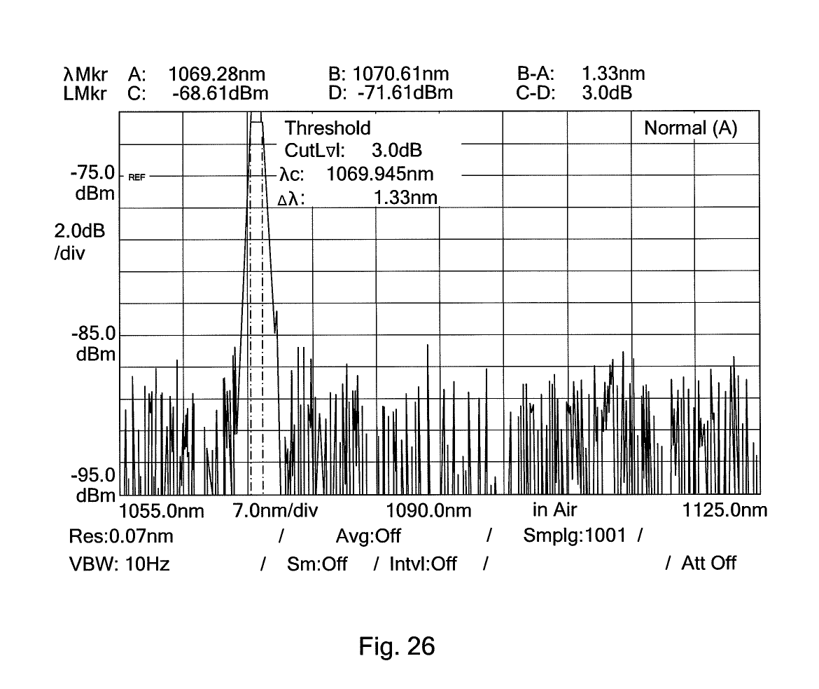

The spectrum for 4868 Watt power is shown at FIG. 26. The absence of SRS phenomenon is clearly shown in the spectrum. (As used herein terms such as, “absence of”, “without any” or “free from” a particular phenomenon or effect means that for all practical purpose the phenomena or effect is not present, and/or not observable by ordinary means used by one of skill in the art). Further the linear relationship of the launch (input) and output power confirms the absence of SBS phenomena. Further, the pulsed operation of the laser may have caused the wavelength of the fiber laser to chirp, which may have further contributed to the suppression of SBS and SRS phenomenon since this would result in an effectively wider laser linewidth.

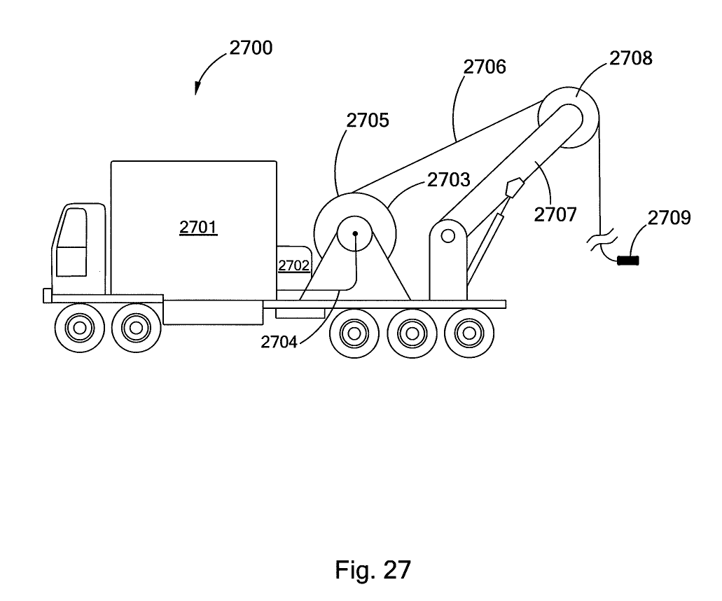

Turning to FIG. 27 there is provided a general configuration of an embodiment of a laser system. The arrangement of the components and structures in this embodiment is by way of example, it being recognized that these components may be arrange differently on the truck chassis, or that different types of chassis and sizes may be used as well as different components.

In particular, in the embodiment of FIG. 27, there is provided a mobile high power laser beam delivery system 2700. In the embodiment there is shown a laser cabin or room 2701. There is provided a source of electrical power 2702, which may be a generator or electrical connection device for connecting to a source of electricity. The laser room 2701 houses a laser source, which in this embodiment is a 20 kW laser having a wavelength of about 1070-1080 nm, (other laser sources, types, wavelengths, and powers may be utilized, and thus the laser source may be a number of lasers, a single laser, or laser modules, collectively having at least about 5 kW, 10 kW, 20 kW, 30 kW 40 kW, 70 kW or more power), which is preferably capable of being integrated with a control system for an assembly to pay out and retrieve the conveyance structure, and any high power laser tool that may be used in conjunction with the system. Examples of high power laser tools are provided in U.S. provisional patent application Ser. No. 61/378,910, Ser. No. 61/374,594, and Ser. No. 61/446,312, the entire disclosure of each of which is incorporated herein by reference.

A high power fiber 2704 leaves the laser room 2701 and enters an optical slip ring 2703, thus optically associating the high power laser with the optical slip ring. The fiber 2704 may be by a commercially available industrial hardened fiber optic cabling with QBH connectors at each end. Within the optical slip ring the laser beam is transmitted from a non-rotating optical fiber to the rotating optical fiber that is contained within the conveyance structure 2706 that is wrapped around spool 2705. The conveyance structure 2706 is associated with cable handling device 2707, which may be a hydraulic boom crane or similar type device, which has an optical block 2708. The optical cable block 2708 provides a radius of curvature when the optical cable is run over it such that bending and other losses are minimized. The distal end of the conveyance structure 2706 has a connecting apparatus 2709, which could be a fiber that is fused to a fiber in a tool or other laser equipment, a fiber termination coupled to mechanical connecting means, a commercially available high power water cooled connector, or more preferably a connector of the type provided in U.S. provisional patent application Ser. No. 61/493,174, the entire disclosure of which is incorporated herein by reference.

The optical block may be an injector, a sheave, or any other free moving, powered or similar device for permitting or assisting the conveyance structure to be paid out and retrieved. When determining the size, e.g., radius of curvature, of the spool, the optical block or other conveyance structure handling devices care should be taken to avoid unnecessary bending losses, such as macro- and micro-bending losses, as well as, losses from stress and strain to the fiber, as for example taught in U.S. patent application Ser. No. 12/840,978 the entire disclosure of which is incorporated herein by reference. The conveyance structure has a connector/coupler device 2709, that is optically associated with the optical fiber and that may be attached to, e.g., optically or optically and mechanically associated with, a high power laser tool, another connector, an optical fiber or another conveyance structure. The device 2709 may also mechanically connect to the tool, a separate mechanical connection device may be used, or a combination mechanical-optical connection device may be used. Examples of such connectors are contained in U.S. provisional patent application Ser. No. 61/493,174, the entire disclosure of which is incorporated herein by reference.

The conveyance structure 2706 on spool 2705 has at least one high power optical fiber, and may have additional fibers, as well as, other conduits, cables, channels, etc., for providing and receiving material, data, instructions to and from the high power laser tool, monitoring conditions of the system and the tool and other uses. Although this system is shown as truck mounted, it is recognized the system could be mounded on, or in other mobile or moveable platforms, such as a skid, a shipping container, a boat, a barge, a rail car, a drilling rig, a work over rig, a work over truck, a drill ship, a fixed platform, or it could be permanently installed at a location.

The spool may have a conveyance structure wound around the spool, the conveyance structure being capable of being unwound from and wound onto the spool, and thus being rewindable. The conveyance structure having a length greater than about 0.5 km, about 1 km, about 2 km, about 3 km and greater and may have: a core; a cladding; a coating; a first protective layer; and, a second protective layer. The conveyance structure may be capable of transmitting high power laser energy for its length with a power loss of less than about 2 dB/km and more preferably less than about 1 dB/km and still more preferably less than about 0.5 dB/km and yet more preferably about 0.3 dB/km. The outer diameter of the spool when wound is preferably less than about 6 m (meters) to facilitate transporting of the spool by truck.

The conveyance structure handling apparatus may be a part of, associated with, independent from, or function as an optical block. The handling apparatus may be, for example, a spool. There are many varied ways and configurations to use a spool as a handling apparatus; although, these configurations may be generally categorized into two basic spool approaches.

The first approach is to use a spool, which is simply a wheel with conveyance structure coiled around the outside of the wheel. For example, this coiled conveyance structure may be a hollow tube, a composite tube, a complex walled tube, it may be an optical fiber, it may be a bundle of optical fibers, it may be an armored optical fiber, it may be other types of optically transmitting cables or it may be a hollow tube that contains the aforementioned optically transmitting cables.

In this first general type of spool approach, the spool in this configuration has a hollow central axis, or such an axis is associated with the spool, where the optical power is transmitted to the input end of the optical fiber. The beam will be launched down the center of the spool, the spool rides on precision bearings in either a horizontal or vertical orientation to prevent any tilt of the spool as the fiber is spooled out. It is optimal for the axis of the spool to maintain an angular tolerance of about +/−10 micro-radians, which is preferably obtained by having the optical axis isolated and/or independent from the spool axis of rotation. The beam when launched into the fiber is launched by a lens which is rotating with the fiber at the Fourier Transform plane of the launch lens, which is insensitive to movement in the position of the lens with respect the laser beam, but sensitive to the tilt of the incoming laser beam. The beam, which is launched in the fiber, is launched by a lens that is stationary with respect to the fiber at the Fourier Transform plane of the launch lens, which is insensitive to movement of the fiber with respect to the launch lens.

The second general type of spool approach is to use a stationary spool similar to a creel and rotate the distal end of the structure or the laser tool attached to the distal end of the fiber in the structure, as the conveyance structure spools out to keep the conveyance structure and thus the fiber from twisting as it is extracted from the spool. If the fiber can be designed to accept a reasonable amount of twist along its length, then this may be the preferred method. Using this type of the second approach if the conveyance structure, and thus, the fiber could be pre-twisted around the spool then as the conveyance structure and the fiber are extracted from the spool, the conveyance structure straightens out and there is no need for the fiber and in particular its distal end to be rotated as the conveyance structure is paid out. There may be a series of tensioners that can suspend the fiber down the hole, or if the hole is filled with water to extract the debris from the bottom of the hole, then the fiber can be encased in a buoyant casing that will support the weight of the fiber and its casing the entire length of the hole. In the situation where the distal end does not rotate and the fiber is twisted and placed under twisting strain, there will be the further benefit of reducing SBS as taught herein.

The handling apparatus may have QBH fibers and a collimator. Vibration isolation means are also desirable in the construction of the handling apparatus, and in particular for a fiber slip ring. Thus, using the example of a spool, the spool's outer plate may be mounted to the spool support using a Delrin plate, while the inner plate floats on the spool and pins rotate the assembly. The fiber slip ring is the stationary fiber, which communicates power across the rotating spool hub to the rotating fiber.

When using a spool the mechanical axis of the spool is used to transmit optical power from the input end of the optical fiber to the distal end. This calls for a precision optical bearing system (the fiber slip ring) to maintain a stable alignment between the external fiber providing the optical power and the optical fiber mounted on the spool. The laser can be mounted inside of the spool, or other handling apparatus, or on a device that rotates the laser as the spool or other handling apparatus is rotated. The laser can be mounted external to the spool or if multiple lasers are employed both internal and external laser locations may be used. The internally, e.g., rotationally, mounted laser may, for example, be a high power laser for providing the high power laser beam for the remote laser activities, it may be a probe or monitoring laser, used for analysis and monitoring of the system and methods performed by the system or it may be both. Further, sensing and monitoring equipment may be located inside of, or otherwise affixed to, the rotating elements of the spool, or other handling apparatus.

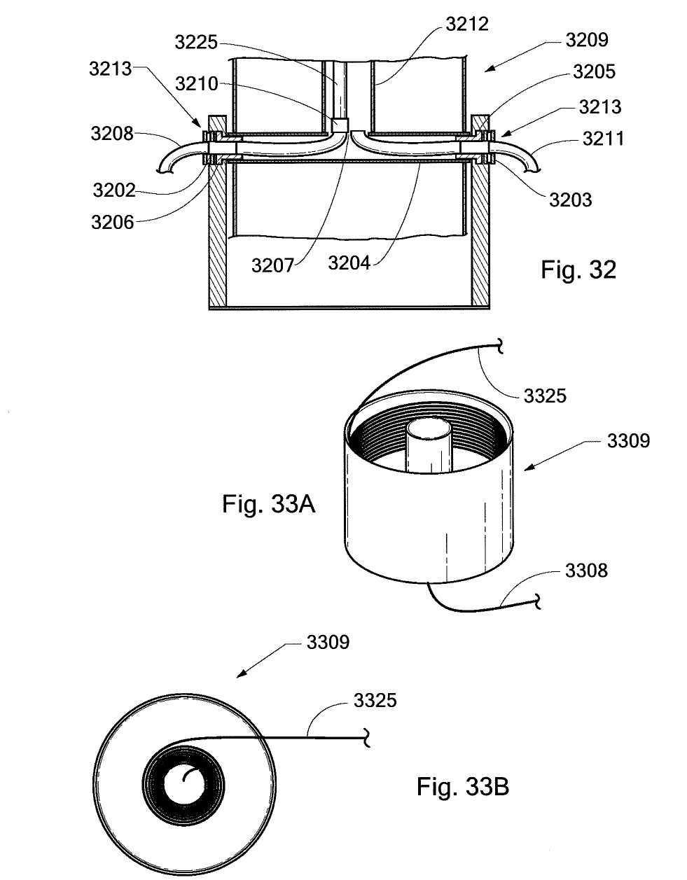

There is further provided a rotating coupler, which may be used with some handling apparatus, to connect the conveyance structure, which is rotating, to the laser beam transmission fiber and any fluid or electrical conveyance conduits, which are not rotating. As illustrated by way of example in FIG. 32, a spool of coiled tubing 3209 has two rotating coupling means 3213. One of said coupling means has an optical rotating coupling means 3202 and the other has a fluid rotating coupling means 3203. The optical rotating coupling means 3202 can be in the same structure as the fluid rotating coupling means 3203 or they can be separate. Thus, preferably, two separate coupling means are employed. Additional rotating coupling means may also be added to handle other cables, such as for example cables for downhole probes.

The optical rotating coupling means 3202 is connected to a hollow precision ground axle 3204 with bearing surfaces 3205, 3206. The laser transmission means 3208 is optically coupled to the hollow axle 3204 by optical rotating coupling means 3202, which permits the laser beam to be transmitted from the laser transmission means 3208 into the hollow axle 3204. The optical rotating coupling means for example may be made up of a QBH connector, a precision collimator, and a rotation stage, for example a Precitec collimator through a Newport rotation stage to another Precitec collimator and to a QBH collimator. To the extent that excessive heat builds up in the optical rotating coupling cooling should be applied to maintain the temperature at a desired level.

The hollow axle 3204 then transmits the laser beam to an opening 3207 in the hollow axle 3204, which opening contains an optical coupler 3210 that optically connects the hollow axle 3204 to the long distance high power laser beam transmission means 3225 that may be located inside of a tubing 3212. Thus, in this way the laser transmission means 3208, the hollow axle 3204 and the long distance high power laser beam transmission means 3225 are rotatably optically connected, so that the laser beam can be transmitted from the laser to the long distance high power laser beam transmission means 825.

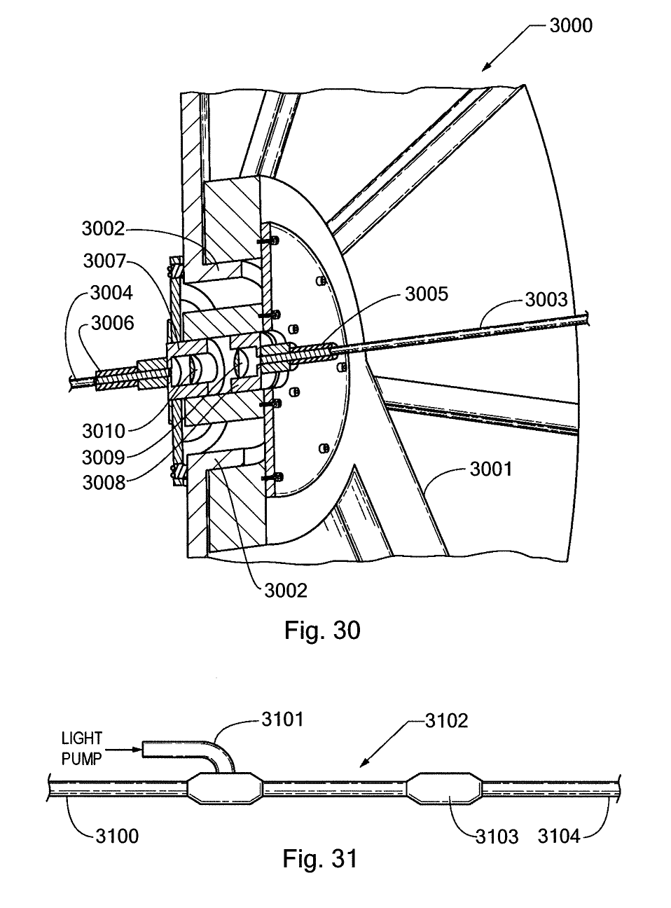

A further illustration of an optical connection for a rotation spool is provided in FIG. 30, wherein there is illustrated a spool 3000 and a support 3001 for the spool 3000. The spool 3000 is rotatably mounted to the support 3001 by load bearing bearings 3002. An input optical cable 3003, which transmits a laser beam from a laser source (not shown in this figure) to an optical coupler 3005. The laser beam exits the connector 3005 and passes through optics 3009 and 3010 into optical coupler 3006, which is optically connected to an output optical cable 3004. The optical coupler 3005 is mounted to the spool by a preferably non-load bearing 3008 (e.g., the bearing 3008 is not carrying, or is isolated or at least partially isolated from, the weight of the spool assembly), while coupler 3006 is mounted to the spool by device 3007 in a manner that provides for its rotation with the spool. In this way as the spool is rotated, the weight of the spool and coiled tubing is supported by the load bearing bearings 3002, while the rotatable optical coupling assembly allows the laser beam to be transmitted from cable 3003 which does not rotate to cable 3004 which rotates with the spool.

In addition to using a rotating spool of tubing, another device to pay out and retrieve, or for extending and retrieving, the conveyance structure is a stationary spool or creel. As illustrated, by way of example, in FIGS. 33A and 33B there is provided a creel 3309 that is stationary and which contains coiled within the long distance high power laser beam transmission means 3325. That means is connected to the laser beam transmission conveyance structure 3308, which is connected to the laser (not shown in this figure). In this way the laser beam may be transmitted into the long distance high power laser beam transmission fiber associated with, or being, the conveyance structure and that structure may be deployed down a borehole, or to a remote location where the high power laser energy may be utilized, by for example a high power laser tool. The long distance high power laser beam transmission conveyance structure may be for example, a coiled tubing, line structure, or composite tube, on the creel. The optical fiber associated therewith may preferably be an armored optical fiber of the type provided herein. In using the creel consideration should be given to the fact that the conveyance structure and thus the optical fiber will be twisted when it is deployed. To address this consideration the distal end of the fiber, the conveyance structure, the bottom hole assembly, or the laser tool, may be slowly rotated to keep the optical cable untwisted, the conveyance structure may be pre-twisted, the conveyance structure and optical fiber may be designed to tolerate the twisting and combinations and variations of these.

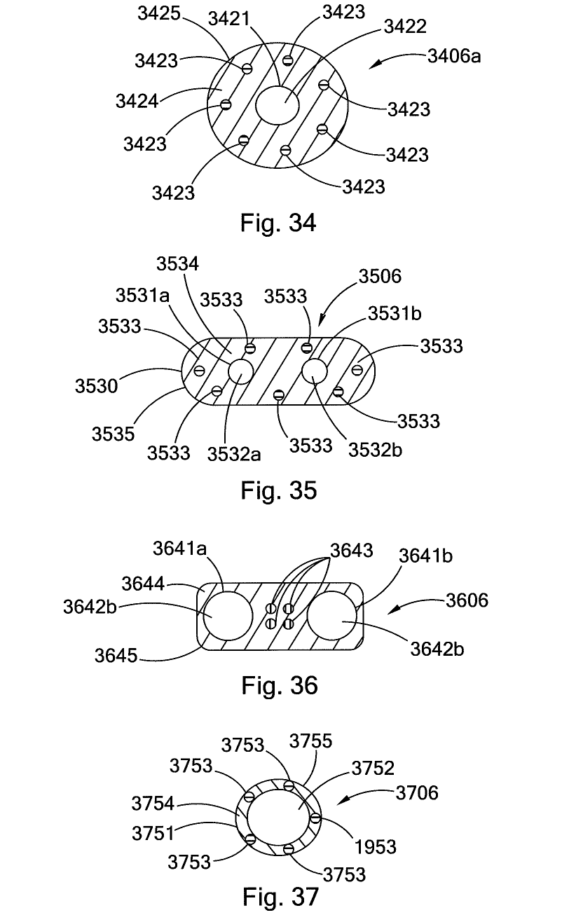

An embodiment of a conveyance structure is provided in FIG. 34. This embodiment has a conveyance structure 3406, having an inner member 3421, e.g., a tube, the inner member 3421 having an open area or open space 3422 forming a channel, passage or flow path. The conveyance structure 3406 has a plurality of lines 3423, e.g., electric conductors, hydraulic lines, tubes, data lines, fiber optics, fiber optics data lines, high power optical fibers capable of suppressing or managing non-linear effects, and/or high power optical fibers in a metal tube, TEFLON sleeve, or other protective layer. The conveyance structure 3406 has an outer member 3425. The inner member 3421 and the outer member 3425 may be made from the same material and composition, or they may be different materials and compositions. The area between the outer member 3425 and the inner member 3421 is filled with and/or contains a supporting or filling medium 3424, e.g., an elastomer or the same or similar material that the inner member and/or outer member is made from. In the configuration of this embodiment the lines are positioned such that they are outward of and surround the inner member.

An embodiment of a conveyance structure is provided in FIG. 35. The conveyance structure 3506 has two inner members, 3531a and 3531b, e.g., tubes. The inner members 3531a and 3531b forms an open area, or channel, or flow path 3532a, 3532b. The conveyance structure 3506 has a plurality of lines 3533, e.g., electric conductors, hydraulic lines, tubes, data lines, fiber optics, fiber optics data lines, high power optical fibers capable of suppressing or managing non-linear effects, high power optical fibers, and/or high power optical fibers in a metal tube, TEFLON sleeve, or other protective layer. The structure 3506 has an outer member 3535. The area between the outer member 3535 and the inner members 3531a and 3531b is filled with and/or contains a supporting medium 3534, e.g., an elastomer or the same or similar material that the inner member and/or outer member is made from. In the configuration of this embodiment the lines are positioned such that they are outward of and surround the inner members.

An embodiment of a conveyance structure is provided in FIG. 36. The conveyance structure 3606, has inner members, 3641a and 3641b, e.g., a tubes, the inner members 3641a and 3641b having an open area or open space 3642a, 3642b associated therewith, which space forms a channel, passage or flow path. The conveyance structure 3606 has a plurality of lines 3643, e.g., electric conductors, hydraulic lines, tubes, data lines, fiber optics, fiber optics data lines, high power optical fibers capable of suppressing or managing non-linear effects, high power optical fibers, and/or high power optical fibers in a metal tube, TEFLON sleeve, or other protective layer. The conveyance structure 3606 has an outer member 3645. The area between the outer member 3645 and the inner members 3641a and 3641b is filled with and/or contains a supporting medium 3644, e.g., an elastomer or the same or similar material that the inner member and/or outer member is made from. The inner members and the outer member may be made of the same or different materials, including the materials listed above. In the configuration of this embodiment the lines are positioned such that they are between the inner members.

An embodiment of a conveyance structure is provided in FIG. 37. The conveyance structure 3706 has an inner member 3751, e.g., a tube. The inner member 3751 has an open area or open space 3752, which space forms a channel, cavity, flow path, or passage. The conveyance structure 3706 has a plurality of lines 3753, e.g., electric conductors, hydraulic lines, tubes, data lines, fiber optics, fiber optics data lines, high power optical fibers capable of suppressing or managing non-linear effects, high power optical fibers, and/or high power optical fibers in a metal tube, TEFLON sleeve, or other protective layer. The conveyance structure 3706 has an outer member 3755. The area between the outer member 3755 and the inner member 3751 is filled with and/or contains a supporting medium 3754, e.g., an elastomer or the same or similar material that the inner member and/or outer member is made from. In the configuration of this embodiment the lines are positioned such that they are directly adjacent the inner and outer members.

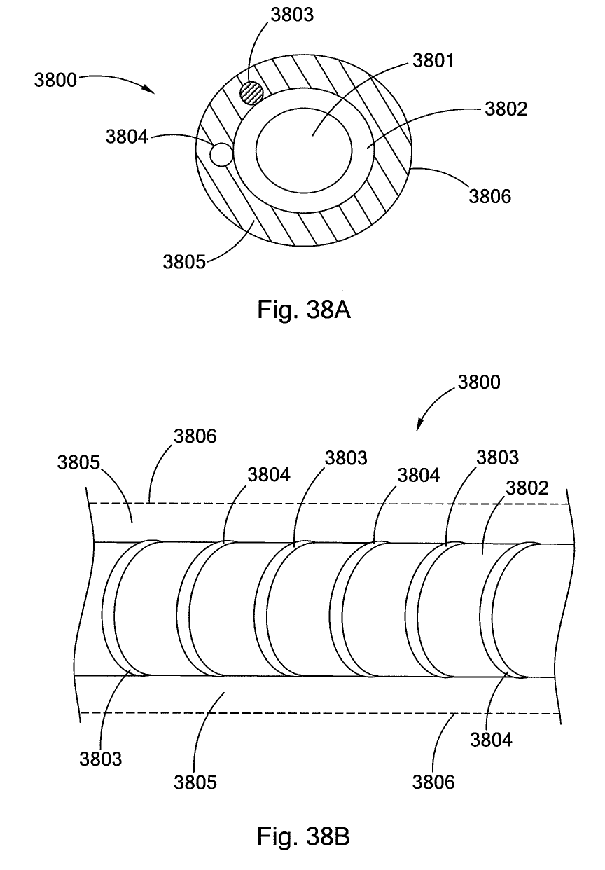

An embodiment of a high power conveyance structure is provided in FIGS. 38A and 38B. There is shown a cross section (FIG. 38A) and side view (FIG. 38B) of a composite conveyance structure. In FIG. 38A there is provided a cross-section of a composite conveyance structure 3800. There is an extruded inner member 3802, having an open space 3801, which forms a channel, passage, or flow path. Around the extruded core, preferably in a spiral fashion, lines 3803 and 3804 are positioned around and along the extruded inner member 3802. Line 3803 is a high power laser fiber having a core diameter of 1,000 microns, a dual clad and a TEFLON protective sleeve and Line 3804 is an electrical power cable. A high density polymer 3805 then coats and encapsulates the lines 3803, 3804 and the extruded inner member 3802. The high density polymer 3805 forms an outer surface 3806 of the composite tube 3800. FIG. 38B shows a section of the conveyance structure 3800, with the lines 3803, 3804 wrapped around the extruded tube 3802. The high density polymer 3805 and outer surface 3806 are shown as phantom lines, so that the spiral arrangement of lines 3803, 3804 can be seen.

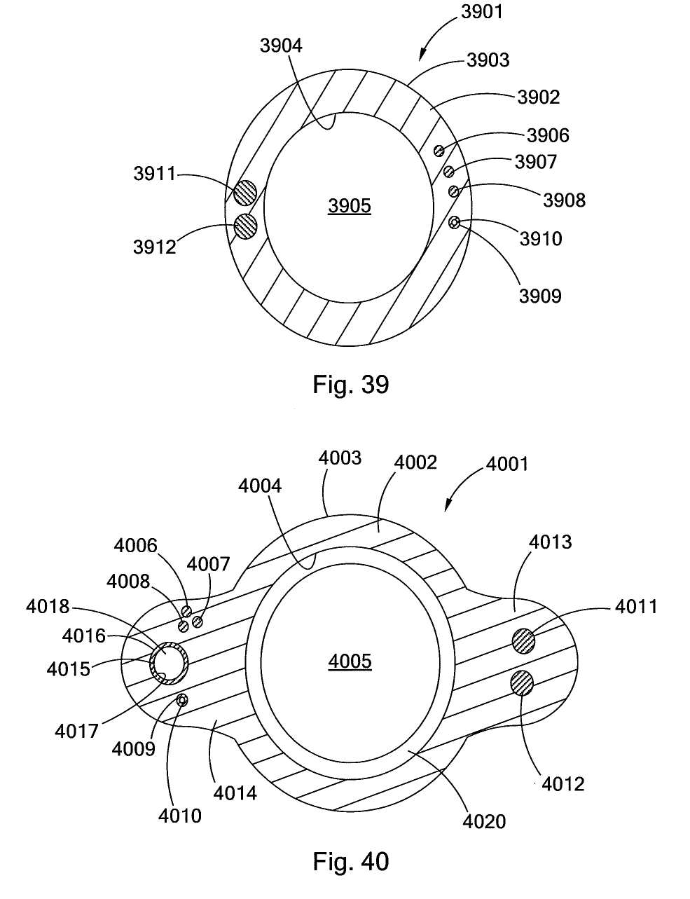

An embodiment of a carbon composite conveyance structure is provided in FIG. 39. The carbon composite conveyance structure 3901 has a body 3902 that has an inner side 3904, and an outer side 3903. The body forms an inner opening 3905, which provides a flow path for drilling or cutting media, such as mud, nitrogen, or air. Contained within the body 3902 are data and/or control lines 3906, 3907, and 3918. These lines may be wires, optical fibers or both for transmitting and receiving control signals and operating data. A high power optical fiber 3910, contained within a 0.125″ stainless steel tubing 2019 is contained within the body 3902. Clean gas, air, nitrogen or a liquid (provided the liquid does not damage the fiber, e.g., through for example hydrogen migration or solvent effects; if the fluid is present in the laser beam path the fluid should also be selected to be highly transmissive to the wavelength of the laser beam being utilized) may be flowed down the annulus between the inner surface of the stainless tube 3910 and the outer surface of the optical fiber 3910. This flow may be used to cool, pressurize, or clean downhole high power optics. If the flow is across the laser beam path the flow material should be selected to minimize the materials absorbance of the laser beam. Large gauge electrical power wires 3911, 3912 are contained within the body 3902 and may be used to provide electrical power to a tool, cutting tool, drilling tool, tractor, or other downhole or remote piece of equipment.

An embodiment of a conveyance structure is provided in FIG. 40. The conveyance structure 4001 has a body 4002 that has an inner side 4004, and an outer side 4003. The body forms an inner opening 4005 and a first ear or tab section 4013 and a second ear or tab section 4014. The body is solid and may be made from any of the materials discussed above that meet the intended use or environmental requirements for the structure. The opening 4005, is formed by an inner member 4020, which may be a composite tube, and provides a flow path for drilling or cutting media, such as mud, nitrogen, or air. Contained within tab 4013 of body 4002 are data and/or control lines 4006, 4007, and 4018. These lines may be wires, optical fibers or both for transmitting and receiving control signals and operating data. A high power optical fiber 4010, contained within a 0.125″ stainless steel tubing 4019 is contained within tab 4014 of body 4002. Clean gas, air, nitrogen or a liquid (provided the liquid does not damage the fiber, e.g., through for example hydrogen migration or solvent effects; if the fluid is present in the laser beam path the fluid should also be selected to be highly transmissive to the wavelength of the laser beam being utilized) may be flowed down opening 4018 that is formed by the inside 4017 of 0.50 stainless steel tubing 4015. The tubing 4015 has an outer side 4016, which is in contact with the body 4014. This flow may be used to cool, pressurize, or clean downhole high power optics and/or it may be used to form a jet to assist in laser cutting or drilling. If the flow is across the laser beam path the flow material should be selected to minimize the materials absorbance of the laser beam. Large gauge electrical power wires 4011, 4012 are contained within tab 4013 of the body 4002 and may be used to provide electrical power to a tool, cutting tool, drilling tool, tractor, or other downhole or remote piece of equipment.

The use of a plastic or polymer to form the inner surface of the passage conveying the clean gas flow, provide the ability to have very clean gas, which has advantages when the clean gas is in contact with optics, the laser beam path or both.

An embodiment of a conveyance structure may have a steel coiled tubing which forms a passage, flow path or channel. Contained within the channel is a composite pipe, which forms a passage, flow path or channel. This channel may be used to transmit drilling or cutting material such as mud, air or nitrogen. The channel may contain a ⅛″ stainless steel tube holding a high power laser optical fiber. Also contained within the channel may be data lines and electrical power lines. Channels may be used to convey clean fluids, gasses or liquids that may be used with or in conjunction with the downhole optics and laser beam paths. Depending upon the intended flow path and the intended association with or interaction with the laser beam path, the fluid should preferably be transmissive, and more preferably highly transmissive to the wavelength of the laser beam intended to be transmitted by fiber. In this embodiment as the coiled steel tubing is worn out, damaged or fatigued, the composite pipe can be removed, placed in a new coiled steel tubing, and reused.

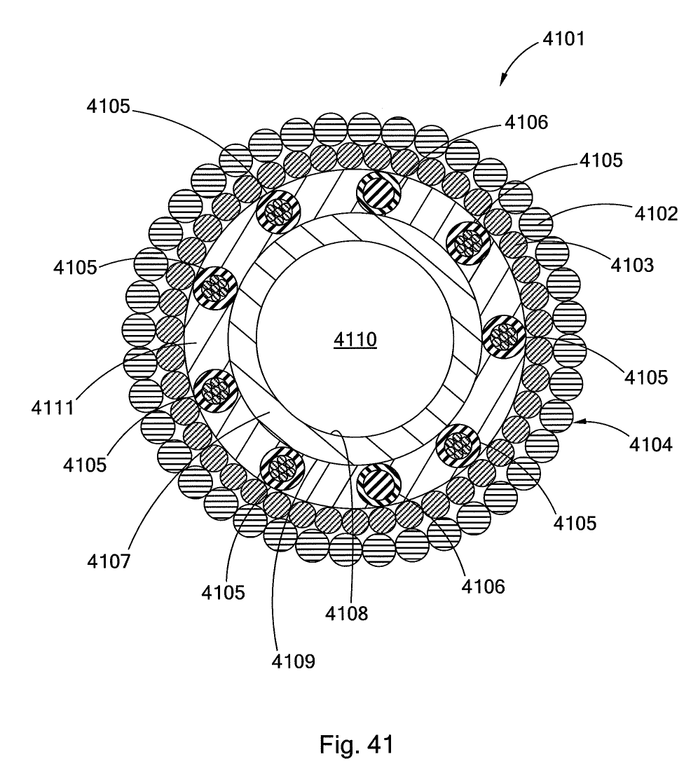

An embodiment of a conveyance structure is provided in FIG. 41. The conveyance structure 4101 has an outside diameter 4104 that is about 0.6836″. The conveyance structure 4101 has an outer armor layer having 38 wires 4102 that are spiral wound and have a diameter of about 0.0495″ and has an inner armor layer having 42 wires 4103 that are spiral wound and have a diameter of about 0.0390″. Inside of the inner armor layer are seven 20 AWG conductor wires 4105 and two 0.0625″ stainless steel tubes with high power optical fibers 2406. The conveyance structure 4101 has an inner stainless steel tube 4107 having an inner side 4108 and an outer side 4109. The outer side 4109 is adjacent the conductor wires 4105 and the tubes-with-fibers 4106. The area 4111 between the outer side 4109 and the inner armor layer may be filled with an elastomer or a polymer or other similar type of material such as a high density polymeric material. The stainless steel tube 4107 has an outer diameter of about 0.375″ and its inner side 4108 forms a space 4101 that creates a channel, passage or flow path.

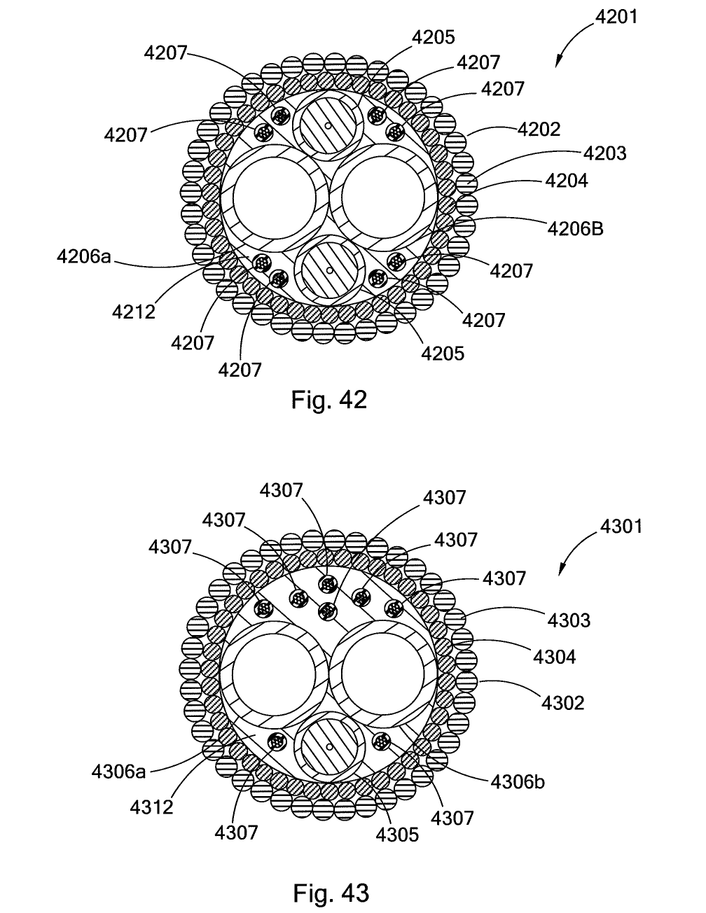

An embodiment of a conveyance structure is provided in FIG. 42. The conveyance structure 4201 has an outside diameter 4202 that is about 1.0254″. The conveyance structure 4201 has an outer armor layer having 38 wires 4203 that are spiral wound and have a diameter of about 0.0743″ and has an inner armor layer having 42 wires 4204 that are spiral wound and have a diameter of about 0.0585″. Inside of the inner armor layer are eight 20 AWG conductor wires 4207 and two 0.25″ stainless steel tubes with high power optical fibers 4205. The conveyance structure 4201 has two inner stainless steel tubes 4206a and 4206b each having an outer diameter of about 0.375″. The tubes may be used to carry the same or different fluids or materials. In one application the tubes may be used to carry liquids and/or gasses having different indices of refraction, for example tube 4206a may carry water and tube 4206b may carry an oil. The area 4212 inside of the inner armor layer may be filled with an elastomer or a polymer or other similar type of material such as a high density polymeric material.

An embodiment of a conveyance structure is provided in FIG. 43. The conveyance structure 4301 has an outside diameter 4302 that is about 1.0254″. The conveyance structure 4301 has an outer armor layer having 38 wires 4303 that are spiral wound and have a diameter of about 0.0743″ and has an inner armor layer having 42 wires 4304 that are spiral wound and have a diameter of about 0.0585″. Inside of the inner armor layer are eight 20 AWG conductor wires 4307 and one 0.25″ stainless steel tubes with high power optical fibers 4305. The conveyance structure 4301 has two inner stainless steel tubes 4306a and 4306b each having an outer diameter of about 0.375″. The tubes may be used to carry the same or different fluids or materials. In one application the tubes may be used to carry liquids and/or gasses having different indices of refraction, for example tube 4306a may carry water and tube 4306b may carry an oil. The area 4312 inside of the inner armor layer may be filled with an elastomer or a polymer or other similar type of material such as a high density polymeric material.

Although steel coiled tubing and composite tubing, and combinations of these are contemplated by this specification, composite tubing for use in a conveyance structure may have some advantages in that its use can reduce the size of the rig needed, can reduce the size of the injector or handling apparatus and optical block needed and may also reduce the overall power consumption, e.g., diesel fuel, that is used by the equipment. The inner channels of composite tubing also provide greater control over the cleanliness, and thus, in situations where the channel is in fluid communication with high power laser optics or high power laser beam paths this feature may prove desirable. The composite materials as seen in the above examples have the ability to imbed many different types of structures and components within them, and may be designed to have a memory that either returns the structure to straight for easy of insertion into a borehole, or to a particular curvature, for easy of winding. Composite conveyance structures may be idea for use with laser cutting tools for workover applications such as cutting and milling and for use with electric motor laser bottom hole assembly boring apparatus. These composite structures provide the ability to have many varied arrangement of components, such as by way of example: a single line (fiber or electric) packaged in a protective member; a single power transmission optical fiber packaged in a protective member; multiple fibers or lines individually packages and wound inside of a composite tube; multiple fiber ribbons (e.g., multiple fibers packaged into a ribbon which is then wound inside of a composite tube); fiber bundles in individual metal tubes which are bundled helically and then would within the composite tube; clean gas purge lines, which are lines to transport nitrogen, or other purge gas material to the laser tools or laser equipment and which would be wound inside of the composite tube; preselected index matching fluid lines to transport optically propertied fluid to the laser tools or laser equipment and which would be would inside of the composite tube.

In some embodiments the conveyance structures may be very light. For example an optical fiber with a Teflon shield may weigh about ⅔ lb per 1000 ft, an optical fiber in a metal tube may weight about 2 lbs per 1000 ft, and other similar, yet more robust configurations may way as little as about 5 lbs per 1000 ft or less, about 10 lbs per 1000 ft, or less, and about 100 lbs per thousand feet or less. Should weight not be a factor and for very harsh and/or demanding uses, the conveyance structures could weight substantially more.

An embodiment of a conveyance structure may have a support structure that forms a flow passage. Along the exterior surface of the support structure there may be located openings, which form channels along the length of the outer surface of the conveyance structure. The openings have a curved inner surface, or are otherwise configured to receive and preferably releasably hold a cable, fiber or other such member. The arc of the curved inner surface may preferably be greater than 180 degrees, and more preferably be around 270 degrees, thereby forming lips or fingers. In this way optical fibers, lines and other small pipe and cables may be placed or fitted into these channels as the conveyance structure is being advanced into a borehole and held in place by the fingers. As the conveyance structure is removed from the borehole the optical fibers, lines, etc. may be stripped or pulled from the channels.

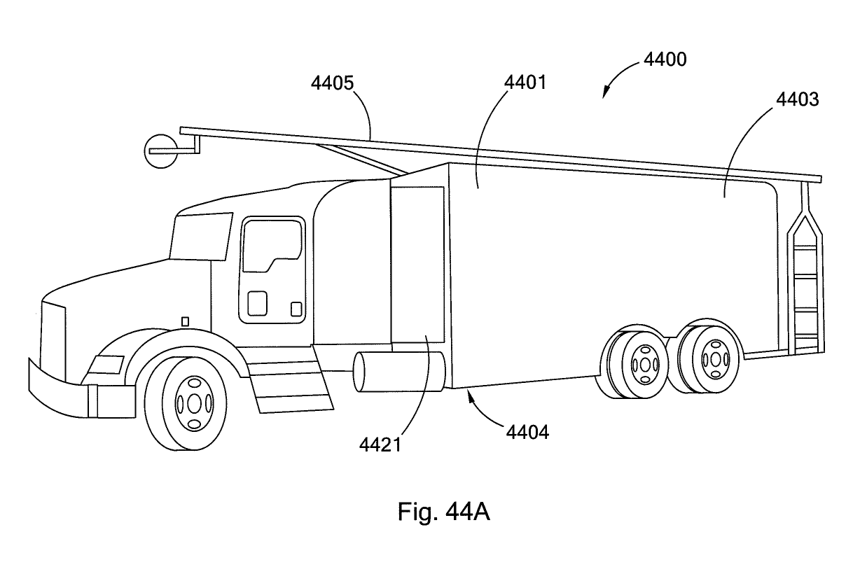

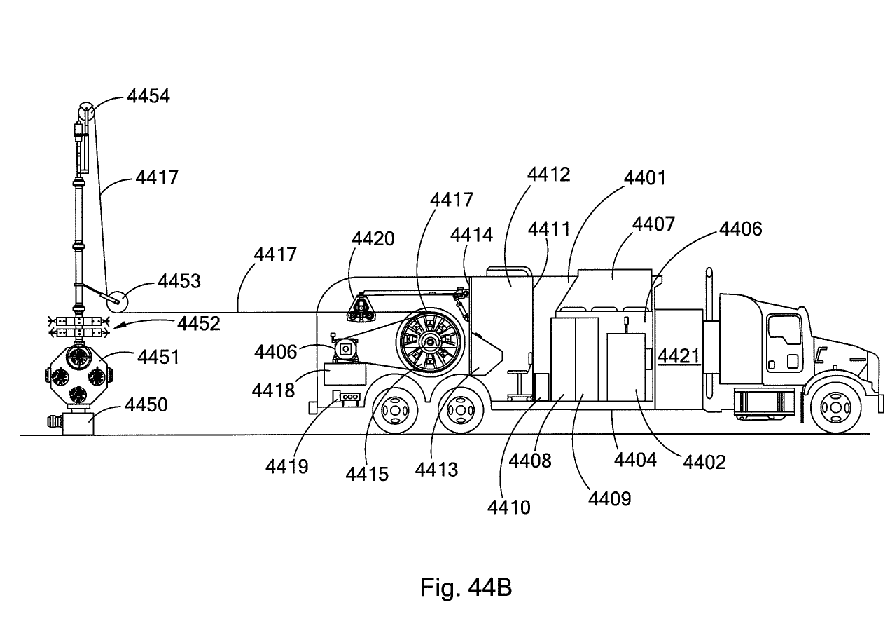

An embodiment of a high power laser system and its deployment in the field are provided in FIGS. 44A and 44B. Thus, there is provided a mobile laser conveyance truck (MLCT) 4400. The MLCT 4400 has a laser cabin 4401 and a handling apparatus cabin 4403, which is adjacent the laser cabin. The laser cabin 401 and the handling cabin 4403 are located on a truck chassis 4404. The MLCT 4400 has associated with it a lubricator 4405, for pressure management upon entry into a well.

The laser cabin 4401 houses a high power fiber laser 4402, (20 kW; wavelength of 1070-1080 nm); a chiller assembly 4406, which has an air management system 4407 to vent air to the outside of the laser cabin and to bring fresh air in (not shown in the drawing) to the chiller 4406. The laser cabin also has two holding tanks 4408, 4409. These tanks are used to hold fluids needed for the operation of the laser and the chiller during down time and transit. The tanks have heating units to control the temperature of the tank and in particular to prevent the contents from freezing, if power or the heating and cooling system for the laser cabin was not operating. A control system 4410 for the laser and related components is provided in the laser cabin 4403. A partition 4411 separates the interior of the laser cabin from the operator booth 4412.

The operator booth contains a control panel and control system 4413 for operating the laser, the handling apparatus, and other components of the system. The operator booth 4412 is separated from the handling apparatus cabin 4403 by partition 4414.

The handling apparatus cabin 4403 contains a spool 4415 (about 6 ft OD, barrel or axle OD of about 3 feet, and a width of about 6 feet) holding about 10,000 feet of the conveyance structure 4417. The spool 4415 has a motor drive assembly 4416 that rotates the spool. The spool has a holding tank 4418 for fluids that may be used with a laser tool or otherwise pumped through the conveyance structure and has a valve assembly for receiving high pressure gas or liquids for flowing through the conveyance structure.

The laser 4402 is optically associated with the conveyance structure 4417 on the spool 4415 by way of an optical fiber and optical slip ring (not shown in the figures). The fluid tank 4418 and the valve assembly 4419 are in fluid communication with the conveyance structure 4417 on the spool 4415 by way of a rotary slip ring (not shown).

The laser cabin 4410 and handling apparatus cabin 4403 have access doors or panels (not shown in the figures) for access to the components and equipment, to for example permit repair, replacement and servicing. At the back of the handling apparatus cabin 4403 there are door(s) (not shown in the figure) that open during deployment for the conveyance structure to be taken off the spool. The MLCT 4400 has a generator 4421 electrically to provide electrical power to the system.

Turning to FIG. 44B there is shown an embodiment of a deployment of the MLCT 4400. The MLCT 4400 is positioned near a wellhead 4450 having a Christmas tree 4451, a BOP 4452 and a lubricator 4405. The conveyance structure 4417 travels through winder 4429 (e.g., line guide, levelwind) to a first sheave 4453, to a second sheave 4454, which has a weight sensor 4455 associated with it. Sheaves 4453, 4454 make up an optical block. The weight sensor 4455 may be associated with sheave 4453 or the composite structure 4417. The conveyance structure 4417 enters into the top of the lubricator and is advanced through the BOP 4452, tree 4451 and wellhead 4450 into the borehole (not shown) below the surface of the earth 4456. The sheaves 4453, 4454 have a diameter of about 3 feet. In this deployment path for the conveyance structure the conveyance structure passes through several radii of curvature, e.g., the spool and the first and second sheaves. These radii are all equal to or large than the minimum bend radius of the high power optical fiber in the conveyance structure. Thus, the conveyance structure deployment path would not exceed (i.e., have a bend that is tighter than the minimum radius of curvature) the minimum bend radius of the fiber.

It is noted that the laser systems, methods, tools and devices of the present inventions may be used in whole or in part in conjunction with, in whole or in part in addition to, or in whole or in part as an alternative to existing methodologies for, e.g., monitoring, welding, cladding, annealing, heating, cleaning, drilling, advancing boreholes, controlling, assembling, assuring flow, drilling, machining, powering equipment, and cutting without departing from the spirit and scope of the present inventions. Additionally, it is noted that the sequence or timing of the various laser steps, laser activities and laser methods (whether solely based on the laser system, methods, tools and devices or in conjunction with existing methodologies) may be varied, repeated, sequential, consecutive and combinations and variations of these, without departing from the spirit and scope of the present inventions.

It is preferable that the assemblies, conduits, support cables, laser cutters and other components associated with the operation of the laser system, should be constructed to meet the pressure and environmental requirements for the intended use. The laser cutter head and optical related components, if they do not meet the pressure requirements for a particular use, or if redundant protection is desired, may be contained in or enclosed by a structure that does meet these requirements. For deep and ultra-deep water uses, deep depths within a borehole, for formation pressures, and combinations and variations of these, the laser cutter and optics related components should preferably be capable of operating under pressures of 1,000 psi, 2,000 psi, 4,500 psi, 5,000 psi, 10,000 psi, 15,000 psi or greater. The materials, fittings, assemblies, useful to meet these pressure requirements are known to those of ordinary skill in the offshore drilling arts, drilling tool arts, related sub-sea ROV arts, and in the high power laser arts.

The number of laser heads, e.g., cutters, utilized in a configuration of a laser tool can be a single head, two heads, three heads, and up to and including 12 or more heads. (Additionally, a single head may have a single laser beam path and thus provide a single laser beam or it may have multiple beam paths and provide multiple laser beams.) The number of heads depends upon several factors and the optimal number of heads for any particular configuration and end use may be determined based upon the end use requirements and the disclosures and teachings provided in this specification. The heads may further be positioned such that their respective laser beam paths are parallel, or at least non-intersecting within the center axis of the member to be laser processed, e.g., cut.

Examples of laser power, fluence and cutting rates, based upon published data, are set forth in Table 5.

TABLE 5

| | | laser | spot | Laser | | cutting |
|---|---|---|---|---|---|---|
| | thickness | power | size | fluence | | rate |
| type | (mm) | (watts) | (microns) | (MW/cm²) | gas | (m/min) |
| mild steel | 15 | 5,000 | 300 | 7.1 | O₂ | 1.8 |
| stainless | 15 | 5,000 | 300 | 7.1 | N₂ | 1.6 |
| steel | | | | | | |

The laser tools may also have monitoring and sensing equipment and apparatus associated with them. Such monitoring and sensing equipment and apparatus may be a component of the tool, a section of the tool, integral with the tool, or a separate component from the tool but which still may be operationally associated with the tool, and combinations and variations of these. Such monitoring and sensing equipment and apparatus may be used to monitor and detect, the conditions and operating parameters of the tool, the high power laser fiber, the optics, any fluid conveyance systems, the laser head, the process, e.g., a cut, and combinations of these and other parameters and conditions. Such monitoring and sensing equipment and apparatus may also be integrated into or associated with a control system or control loop to provide real time control of the operation of the tool. Such monitoring and sensing equipment may include by way of example: the use of an optical pulse, train of pulses, or continuous signal, that are continuously monitored that reflect from the distal end of the fiber and are used to determine the continuity of the fiber; the use of the fluorescence and black body radiation from the illuminated surface as a means to determine the continuity of the optical fiber; monitoring the emitted light as a means to determine the characteristics, e.g., completeness, of a cut; the use of ultrasound to determine the characteristics, e.g., completeness, of the cut; the use of a separate fiber to send a probe signal for the analysis of the characteristics, e.g., of the cut; and a small fiber optic video camera may be used to monitor, determine and confirm that a cut is complete. These monitoring signals may transmit at wavelengths substantially different from the high power signal such that a wavelength selective filter may be placed in the beam path uphole or downhole to direct the monitoring signals into equipment for analysis.

To facilitate some of these monitoring activities an Optical Spectrum Analyzer or Optical Time Domain Reflectometer or combinations thereof may be used. An AnaritsuMS9710C Optical Spectrum Analyzer having: a wavelength range of 600 nm-1.7 microns; a noise floor of 90 dBm @ 10 Hz, −40 dBm @ 1 MHz; a 70 dB dynamic range at 1 nm resolution; and a maximum sweep width: 1200 nm and an Anaritsu CMA 4500 OTDR may be used.

In the area of laser cutting or sectioning, the efficiency of the laser's cutting action, as well as, the completion of the cut, can also be determined by monitoring the ratio of emitted light to the reflected light. Materials undergoing melting, spallation, thermal dissociation, or vaporization will reflect and absorb different ratios of light. The ratio of emitted to reflected light may vary by material further allowing analysis of material type by this method. Thus, by monitoring the ratio of emitted to reflected light material type, cutting efficiency, completeness of cut, and combinations and variation of these may be determined. This monitoring may be performed uphole, downhole, or a combination thereof.

Further a complete cut may be evidenced by the complete lack of detectable light, or essentially a complete lack of such light. In certain cutting operations when the cut is complete, i.e., the two sections are completely severed by the laser, there will be an absence of any light. When using wavelengths that are absorbed by water in an aqueous cutting environment, the substantial absence of any emitted and reflected light may indicate that the cut is complete. Thus, for example, if a laser gas jet having a laser beam of about 1070 nm is being used, while the cut is being made in a tubular, considerable fire, sparks, back reflections and emitted light may be observed under water during the cutting process. When the cut is complete, these phenomena stop, placing the work surface and cut essentially in darkness. Upon completion of the cut the laser beam itself is quickly absorbed by the water and does not travel far beyond the gas jet. Thus, if a detection device was located beyond the point of substantial laser beam travel, the absence of any reflected, transmitted, or emitted light can be used to monitor the laser process and sign its successful completion. The use of the term “completed” cut, and similar such terms, includes severing the object into at least two sections, e.g., a cut in a tubular that is all the way through the wall of the tubular and around the entire circumference of the tubular.

A preferable system for monitoring and confirming that the laser cut is complete and thus that the laser beam has severed the member is a system that utilizes the color of the light returned from the cut. This light can be monitored using a collinear camera system or fiber collection system to determine what material is being cut. In the offshore and borehole environments it is likely that this may not be a clean signal. Thus, and preferably, a set of filters or a spectrometer may be used to separate out the spectrum collected by the sensor. This spectra can be used to determine if the laser is cutting metal, concrete or rock; and thus provide information that the laser beam has penetrated the member, that the cut is in progress, that the cut is complete and thus that the member has been severed.

The laser cutting tools and devices that may be utilized for the present removal methods and with, or as a part of, the present removal systems, in general, may have a section for receiving the high power laser energy, such as for example, from a high power connector on a high power fiber, or from an umbilical having a fluid path and a high power fiber. Although single fiber tools and devices are described herein, it should be understood that a cutting tool or device may receive high power laser energy from multiple fibers. In general, the laser cutting tools and devices may have one, or more, optics package or optics assemblies, which shape, focus, direct, re-direct and provide for other properties of the laser beam, which are desirable or intended for a cutting process. In general, the laser cutting tools and devices may also have one or more laser cutting heads, having for example a fluid jet, or jets, associated with the laser beam path that the laser beam takes upon leaving the tool and traveling toward the material to be laser processed, e.g., cutting a drill pipe in a borehole, or milling a window in a casing in a borehole, or cutting an offshore conductor.

To obtain, receive and direct the high power laser energy at and in the laser tool, commercially available high power water cooled connectors and optics may be utilized (provided that there is sufficient space or room in the tool for the water cooling components), the passively cooled high power connectors provided in U.S. provisional patent application Ser. No. 61/493,174 may be utilized, the high power optical components and assemblies provided in U.S. provisional patent application Ser. No. 61/446,040 may be utilized, and the high power conveyance structures provided in U.S. patent application Ser. No. 13/210,581 may be utilized.

Additionally, it may be desirable for the laser tools, and in particular laser cutting and milling tools, and preferably in particular tools that may be used in the interior of tubulars, boreholes, jacket members, or a conductors, or in other similarly confined and difficult to observe spaces, to have other mechanical, measuring and monitoring components, such as a centralizer, packers, valves for directing cement, valves for pressure testing, a locking device, and sensing devices to determine for example, the conditions of a cut, position of the tool, and pressure and other environmental conditions.

The laser tools may also incorporate an accumulator, two accumulators or more. The accumulators provide the ability to have a reservoir(s) of fluid(s) maintained under a predetermined pressure for use in a laser processing application. Thus, they enable the tool to be operated without the need for such fluids to be transported by a conveyance structure from the surface (or other location) to the tool at a remote location, e.g., within a borehole.

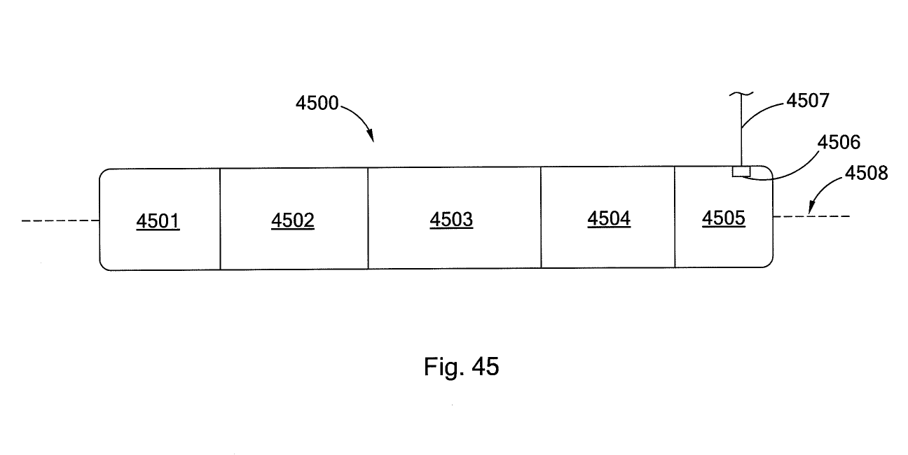

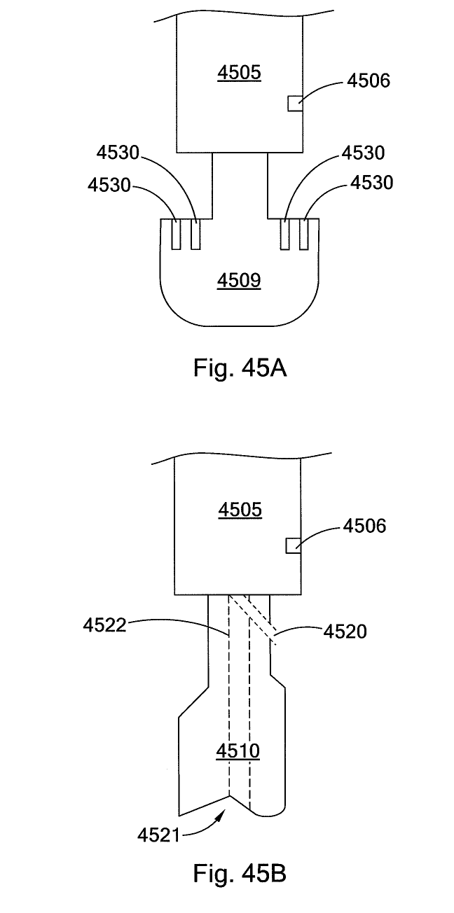

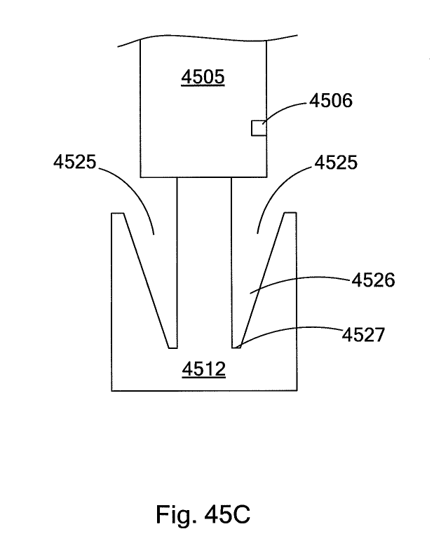

Turning to FIG. 45 there is provided a schematic of an embodiment of a laser cutting tool 4500 having a longitudinal axis shown by dashed line 4508. This tool could be used for, among other things, pipe cutting, decommissioning, plugging and abandonment, window cutting, milling, and perforating. The laser cutting tool 4500 has a conveyance termination section 4501. The conveyance termination section 4501 would receive and hold, for example, a composite high power laser umbilical, a coil tube having for example a high power laser fiber and a channel for transmitting a fluid for the laser cutting head, a wireline having a high power fiber, or a slick line and high power fiber, or other type of conveyance structure. The laser tool 4500 has an anchor and positioning section 4502. The anchor and positioning section (which may be a single device or section, or may be separate devices within the same of different sections) may have a centralizer, a packer, or shoe and piston or other mechanical, electrical, magnetic or hydraulic device that can hold the tool in a fixed and predetermined position longitudinally (e.g., along the length of the borehole), axially (e.g., with respect to the axis of the borehole, or within the cross-section of the borehole) or both. The section may also be used to adjust and set the standoff distance that the laser head is from the surface to be cut.

The laser tool 4500 has a motor section, which may be an electric motor, a step motor, a motor driven by a fluid, or other device to rotate the laser cutter head, or cause the laser beam path to rotate. The rotation of the laser tool, or laser head, may also be driven by the forces generated by the jet, either the laser fluid jet or a separate jet. For example, if the jet exits the tool at an angle or tangent to the tool it may cause rotation. In this configuration the laser fiber, and fluid path, if a fluid used in the laser head, passes by or through the motor section 4503. Motor, optic assemblies, and beam and fluid paths disclosed and taught in U.S. provisional patent application Ser. No. 61/446,042 (the entire disclosure of which is incorporated herein by reference) may be utilized. There is provided an optics section 4504, which for example, may shape and direct the beam and have optical components such as a collimating element or lens and a focusing element or lens. Optics assemblies, packages and optical elements disclosed and taught in U.S. provisional patent application Ser. No. 61/446,040 (the entire disclosure of which is incorporated herein by reference) may be utilized.

There is provided a laser cutting head section 4505, which directs and moves the laser beam along a laser beam path 4507. In this embodiment the laser cutting head 4505 has a laser beam exit 4506. In operation the laser beam path may be rotated through 360 degrees to perform a complete circumferential cut of a tubular. (The laser beam may also be simultaneously moved linearly and rotationally to form a spiral, s-curve, figure eight, or other more complex shaped cut.) The laser beam path 4507 may also be moved along the axis 4508 of the tool 4500. The laser beam path also may not be moved during propagation or delivery of the laser beam. In these manners, circular cuts, windows, perforations and other predetermined shapes may be made to a borehole (cased or open hole), a tubular, a support member, or a conductor. In the embodiment of FIG. 45, as well as some other embodiments, the laser beam path 4507 forms a 90-degree angle with the axis of the tool 4508. This angle could be greater than 90 degrees or less than 90 degrees.

The laser cutting head section 4505 preferably may have any of the laser fluid jet heads provided in this specification, it may have a laser beam delivery head that does not use a fluid jet, and it may have combinations of these and other laser delivery heads that are known to the art.

In performing downhole laser milling operations, such as window cutting and milling, it may be desirable or necessary to catch the cutting, or sections of material removed from a tubular, or the formation. Thus, for example, baskets and magnets may be associated with the laser tool and used to catch and control the cuttings. For example, and using the embodiment of FIG. 45 as an illustration: a junk magnet 4509 as shown in FIG. 45A may be used; a circulating basket 4510 as shown in FIG. 45B may be used; a junk basket 4512 as shown in FIG. 45C may be used, combinations of these may be used, and other types of apparatus to catch, hold, or remove cuttings may be used. In FIG. 45A the junk magnet 4509 is attached to the laser tool below the cutting head 4505. The junk magnet 4509 has a series of magnets 4530 that are preferably position so as to be removed from the side wall of the borehole to not cause undo drag when being moved through a cased borehole, yet close enough to catch or attach falling magnetic cuttings. In FIG. 45B the circulating basket 4510 is attached to the bottom end of the laser head 4505. The circulating basket has an exit path or jet 4520 for circulating fluid to leave the basket 4510, and a gap 4521 for taking in circulation fluid having cuttings and a cuttings return fluid path 4522 for returning the cuttings and fluids to the surface or out of the borehole. In FIG. 45C the basket 4512 is attached to the bottom of the laser head 4505. The basket 4512 has an annular opening 4525 into which cuttings fall. The annular opening 4525 has an annular holding space 4526, which has a bottom 4527.

Although the junk, e.g., cuttings or debris, catching devices are shown as being attached to the bottom of the laser head in the tool, it should be understood that they may be associated with other sections of the tool, or they may be associated with the tool without being attached to the tool. For example, the junk catching device may be associated with a laser tool when it is placed in the borehole below the location for the intended laser operation, and held in place by an anchoring device during the laser operation, to be retrieved, after the laser operation has been completed. Depending upon the objectives of the borehole the junk catching device may be left in the borehole for an extend period of time or indefinitely, or it may be retrieved upon the completion of the laser operation. These junk catching devices may be associated with any of the laser tools that are provided in this specification, where there is a need or requirement to catch or otherwise manage debris created by the laser process.

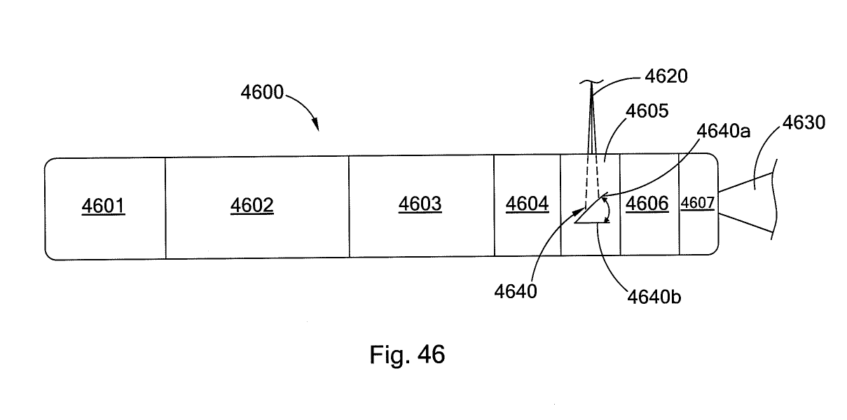

Turning to FIG. 46, there is shown an embodiment of a laser cutting tool 4600. The laser cutting tool 4600 has a conveyance termination section 4601, an anchoring and positioning section 4602, a motor section 4603, an optics package 4604, an optics and laser cutting head section 4605, a second optics package 4606, and a second laser cutting head section 4607. The conveyance termination section would receive and hold, for example, a composite high power laser umbilical, a coil tube having for example a high power laser fiber and a channel for transmitting a fluid for the laser cutting head, a wireline having a high power fiber, or a slick line and high power fiber.

The anchor and positioning section may have a centralizer, a packer, or shoe and piston or other mechanical, electrical, magnetic or hydraulic device that can hold the tool in a fixed and predetermined position both longitudinally and axially. The section may also be used to adjust and set the standoff distance that the laser head is from the surface to be cut. The motor section may be an electric motor, a step motor, a motor driven by a fluid or other device to rotate one or both of the laser cutting heads or cause one or both of the laser beam paths to rotate.

Motor, optic assemblies, and beam and fluid paths disclosed and taught in U.S. provisional patent application Ser. No. 61/446,042 (the entire disclosure of which is incorporated herein by reference) may be utilized. The optics section, for example, may shape and direct the beam and have optical components such as a collimating element or lens and a focusing element or lens. Optics assemblies, packages and optical elements disclosed and taught in U.S. provisional patent application Ser. No. 61/446,040 (the entire disclosure of which is incorporated by reference) may be utilized. The optics and laser cutting head section 4605 has a mirror 4640.

The mirror 4640 is movable between a first position 4640a, in the laser beam path, and a second position 4640b, outside of the laser beam path. The mirror 4640 may be a focusing element. Thus, when the mirror is in the first position 4640a, it directs and focuses the laser beam along beam path 4620. When the mirror is in the second position 4640b, the laser beam passes by the mirror and enters into the second optics section 4606, where it may be preferably shaped into a larger circular spot (having a diameter greater than the tools diameter), or a substantially linear or elongated elliptical pattern, for delivery along beam path 4630. Two fibers and optics assemblies may be used, a beam splitter within the tool, or other means to provide the two laser beam paths 4620, 4630 may be used.

The tool of the FIG. 46 embodiment may be used, for example, in the boring, sidetracking, window milling, rat hole formation, radially cutting, and sectioning operations, wherein beam path 4630 would be used for boring and beam path 4620 would be used for the axial cutting and segmenting of the structure. Thus, the beam path 4620 could be used to cut a window in a cased borehole and the formation behind the casing. A whipstock, or other off setting device, could be used to direct the tool into the window where the beam path 4630 would be used to form a rat hole; or depending upon the configuration of the laser head 4607, e.g., if it were a laser mechanical bit, continue to advance the borehole. Like the embodiment of FIG. 45, the laser beam path 4620 may be rotated and moved axially. The laser beam path 4630 may also be rotated and preferably should be rotated if the beam pattern is other than circular and the tool is being used for boring. The embodiment of FIG. 46 may also be used to clear, pierce, cut, or remove junk or other obstructions from the bore hole to, for example, facilitate the pumping and placement of cement plugs during the plugging of a bore hole.

The laser head section 4607 preferably may have any of the laser fluid jet heads provided in this specification, it may have a laser beam delivery head that does not use a fluid jet, and it may have combinations of these and other laser delivery heads that are known to the art.

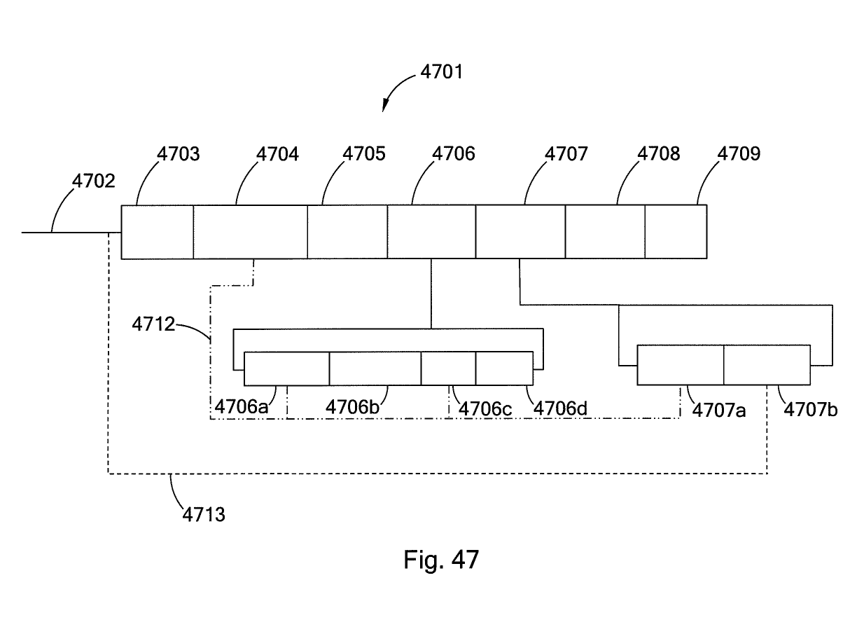

Turning to FIG. 47 there is provided a schematic of an embodiment of a laser tool. The laser tool 4701 has a conveyance structure 4702, which may have an E-line, a high power laser fiber, and an air pathway. The conveyance structure 4702 connects to the cable/tube termination section 4703. The tool 4701 also has an electronics cartridge 4704, an anchor section 4705, an hydraulic section 4706, an optics/cutting section (e.g., optics and laser head) 4707, a second or lower anchor section 4708, and a lower head 4709. The electronics cartridge 4704 may have a communications point with the tool for providing data transmission from sensors in the tool to the surface, for data processing from sensors, from control signals or both, and for receiving control signals or control information from the surface for operating the tool or the tools components. The anchor sections 4705, 4708 may be, for example, a hydraulically activated mechanism that contacts and applies force to the borehole. The lower head section 4709 may include a junk collection device, or a sensor package or other down hole equipment. The hydraulic section 4706 has an electric motor 4706a, a hydraulic pump 4606b, a hydraulic block 4706c, and an anchoring reservoir 4706d. The optics/cutting section 4707 has a swivel motor 4707a and a laser head section 4707b. Further, the motors 4704a and 4706a may be a single motor that has power transmitted to each section by shafts, which are controlled by a switch or clutch mechanism. The flow path for the gas to form the fluid jet is schematically shown by line 4713. The path for electrical power is schematically shown by line 4712. The laser head section 4707b preferably may have any of the laser fluid jet heads provided in this specification, it may have a laser beam delivery head that does not use a fluid jet, and it may have combinations of these and other laser delivery heads that are known to the art.

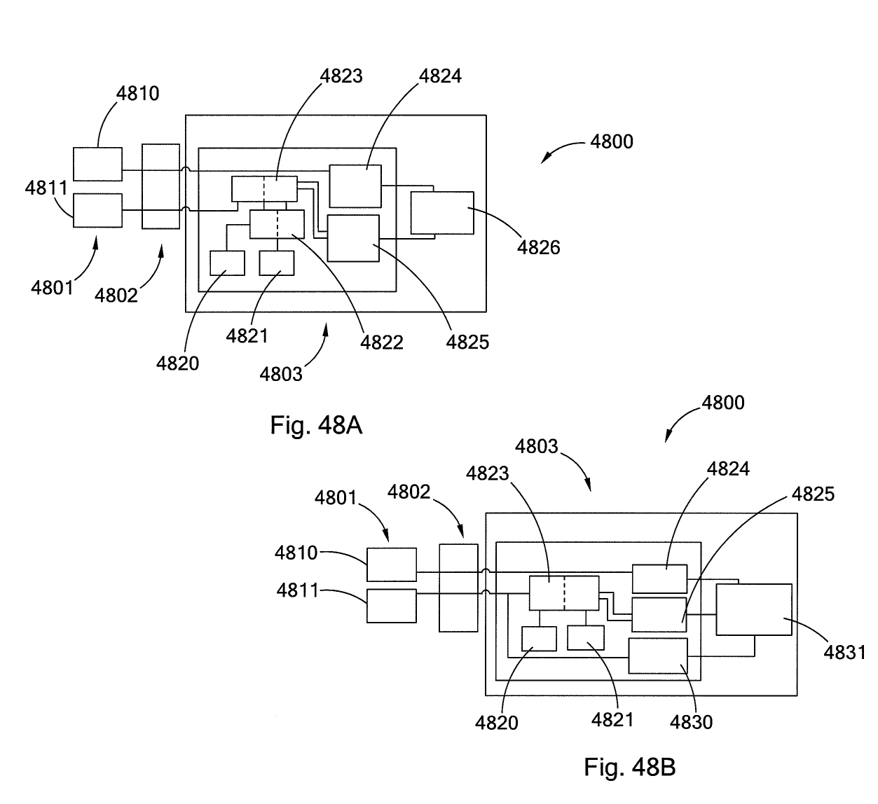

FIGS. 48A and 48B show schematic layouts for cutting systems using a two fluid dual annular laser jet. Thus, there is an uphole section 4801 of the system 4800 that is located above the surface of the earth, or outside of the borehole. There is a conveyance section 4802, which operably associates the uphole section 4801 with the downhole section 4803. The uphole section has a high power laser unit 4810 and a power supply 4811. In this embodiment the conveyance section 4802 is a tube, a bunched cable, or umbilical having two fluid lines and a high power optical fiber. In the embodiment of FIG. 48A the downhole section has a first fluid source 4820, e.g., water or a mixture of oils having a predetermined index of refraction, and a second fluid source 4821, e.g., an oil having a predetermined and different index of refraction from the first fluid. The fluids are feed into a dual reservoir 4822 (the fluids are not mixed and are kept separate as indicated by the dashed line), which may be pressurized and which feeds dual pumps 4823 (the fluids are not mixed and are kept separate as indicated by the dashed line). In operation the two fluids 4820, 4821 are pumped to the dual fluid jet nozzle 4826. The high power laser beam, along a beam path enters the optics 4824, is shaped to a predetermined profile, and delivered into the nozzle 4826. In the embodiment of FIG. 48B a control head motor 4830 has been added and controlled motion laser jet 4831 has been employed in place of the laser jet 4826. Additionally, the reservoir 4822 may not be used, as shown in the embodiment of FIG. 48B.

Turning to FIGS. 49A and 49B there is shown schematic layouts for cutting systems using a two fluid dual annular laser jet. Thus, there is an uphole section 4901 of the system 4900 that is located above the surface of the earth, or outside of the borehole. There is a conveyance section 4902, which operably associates the uphole section 4901 with the downhole section 4903. The uphole section has a high power laser unit 4910 and a power supply 4911 and has a first fluid source 4920, e.g., a gas or liquid, and a second fluid source 4921, e.g., a liquid having a predetermined index of refraction. The fluids are fed into a dual reservoir 4922 (the fluids are not mixed and are kept separate as indicated by the dashed line), which may be pressurized and which feeds dual pumps 4923 (the fluids are not mixed and are kept separate as indicated by the dashed line). In operation the two fluids 4920, 4921 are pumped through the conveyance section 4902 to the downhole section 4903 and into the dual fluid jet nozzle 4926. In this embodiment the conveyance section 4902 is a tube, a bunched cable, or umbilical. For FIG. 49A the conveyance section 4902 would have two fluid lines and a high power optical fiber In the embodiment of FIG. 49B the conveyance section 4902 would have two fluid lines, an electric line and a high power optical fiber. In the embodiment of FIG. 49A the downhole section has an optics assembly 4924 and a nozzle 4925. The high power laser beam, along a beam path enters the optics 4924, where it may be shaped to a predetermined profile, and delivered into the nozzle 4926. In the embodiment of FIG. 49B a control head motor 4930 has been added and controlled motion laser jet 4931 has been employed in place of the laser jet 4926. Additionally, the reservoir 4922 may not be used as shown in the embodiment of FIG. 49B.

Downhole tractors and other types of driving or motive devices may be used with the laser tools. These devices can be used to advance the laser tool to a specific location where a laser process, e.g., a laser cut is needed, or they can be used to move the tool, and thus the laser head and beam path to deliver a particular pattern to make a particular cut.

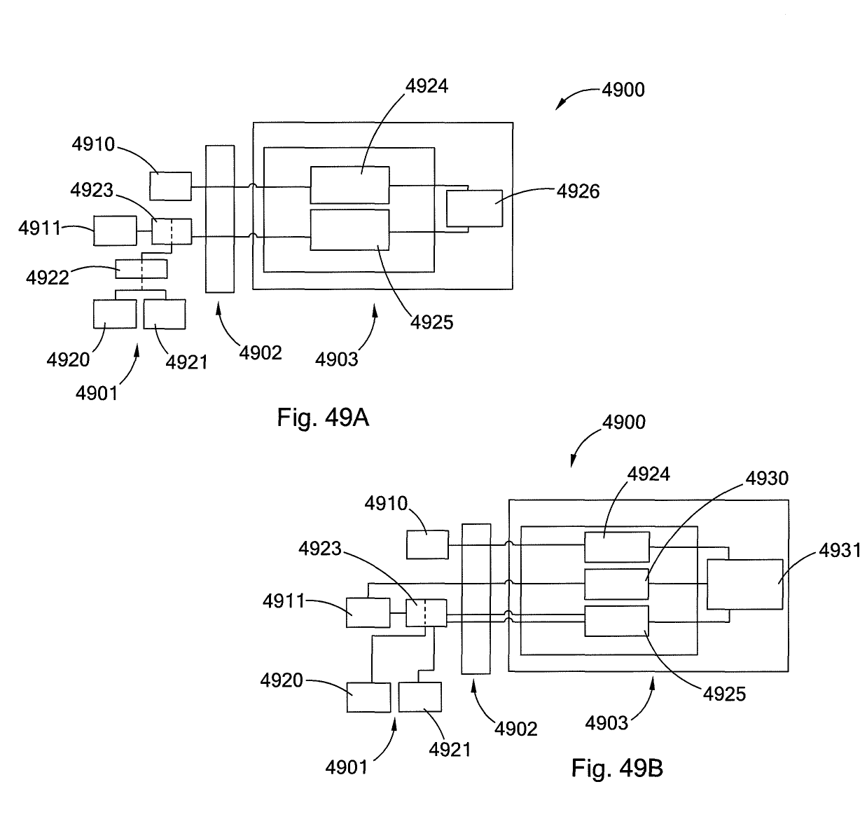

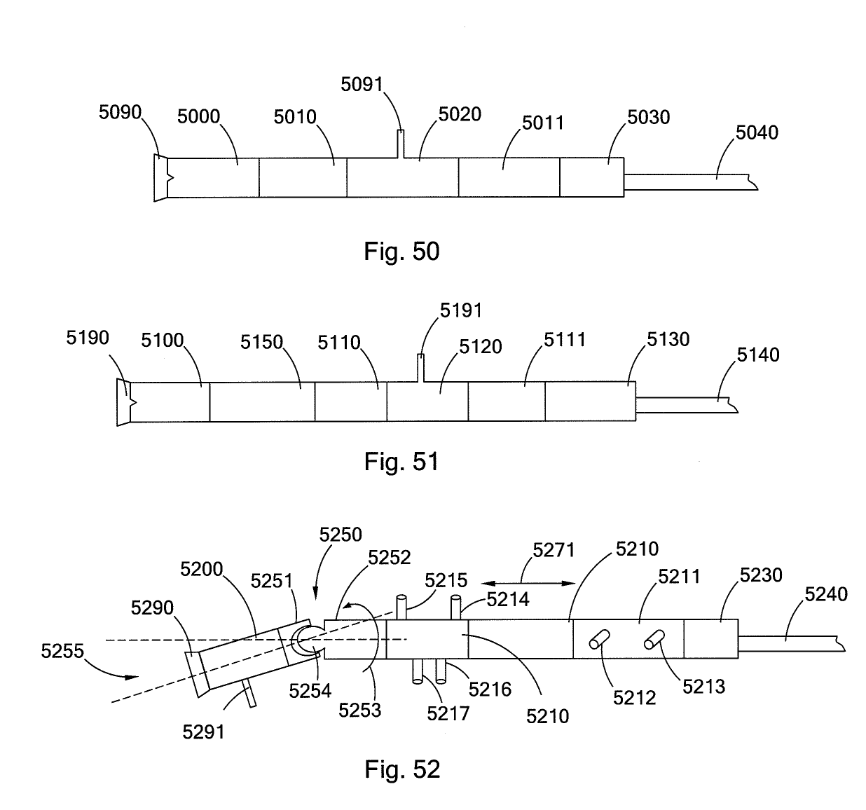

Turning to FIGS. 50 to 53 there are provided several embodiments of laser milling and drilling tools that may be used for window cutting and the advancing of a borehole (e.g., rat hole) from the window into the formation. These laser tool configuration may greatly reduce the number of trips, when compared to conventional mechanical window milling, cutting and drilling methodologies, that are needed to complete these operations, and preferably may complete these operations in a single trip in the borehole.

Referring to FIG. 50 there is shown an embodiment of a laser tool having a laser drill head section 5000, having a laser beam path 5090. The tool has two anchor sections, a lower anchor section 5010 and an upper anchor section 5011. The anchor sections, for this embodiment and other embodiments may be any type of anchoring and positioning devices know to those of skill in the downhole tool arts, such as for example, hydraulic, pneumatic, electric, or mechanical actuated pistons. The tool has a laser head 5020 that has a laser beam path 5091. The laser head 5020 and the drill head 5000 may have included as part of their respective section, or otherwise have associated with them devices that cause their rotation. The tool has a termination end 5030 that receives a high power laser conveyance structure 5040. It being understood that the arrangement and spacing of these components in the tool may be changed, and that additional and different components may be used or substituted in, for example, such as a MWD/LWD section.

Referring to FIG. 51 there is shown an embodiment of a laser tool having a laser drill head section 5100, having a laser beam path 5190. The tool has two anchor sections, a lower anchor section 5110 and an upper anchor section 5111. The tool has a laser head 5120 that has a laser beam path 5191. The laser head 5120 and the drill head 5100 may have included as part of their respective section, or otherwise have associated with them devices that cause their rotation. The tool has a termination end 5030 that receives a high power laser conveyance structure 5140. The tool has a knuckle section 5150 that provides the ability for the tool to bend at a predetermined angle at this section. The knuckle section 5150, for this embodiment and for other embodiments, may be, for example, it may be a mechanical, electrical, hydraulic, pneumatic, or combinations and variations of these, which has activation and control devices, and has e.g., a piston push a wedge and slider into a pivoted linkage, or any other type of steering and directing devices know to those of skill in the downhole tool arts. It being understood that the arrangement and spacing of these components in the tool may be changed, and that additional and different components may be used or substituted in, for example, such as a MWD/LWD section.

Referring to FIG. 52 there is shown an embodiment of a laser tool having a laser drill and cutting head section 5200, having a drilling laser beam path 5290 and a cutting laser beam path 5291. The tool has two anchor sections, a lower anchor section 5210 and an upper anchor section 5211. The anchors in the anchor sections are rotated 90 degrees with respect to each other. Anchor 5211 has four anchors, two of which 5212, 5213, can be seen in the view of the figure. Anchor section 5210 has four anchors 5214, 5215, 5216, 5217. In addition to each section being rotated, the anchors in section 5211 and 5210 are staggered with respect to each other, as is seen in section 5210. The tool has a termination end 5230 that receives a high power laser conveyance structure 5240. The tool has a knuckle section 5250 that provides the ability for the tool to bend at a predetermined angle at this section. In the view of FIG. 52, the knuckle section 5250 is shown in a bent configuration. Knuckle section 5250 has a lower section 5251 and an upper section 5252 that are connected by a knuckle or joint 5254. Upper section 5252 has a device for providing rotation, such as an electric motor, and provides for rotation as shown by arrow 5253. The knuckle section 5250 provides for bends in the tool as defined by angle 5255. Having the rotational device located above the knuckle provides the ability to find and drill holes at all angles or locations within the angle 5255. The tool also has a linear motion section 5270 that provides for motion of the tool as shown by arrow 5271. By fixing either the upper anchor 5211, the lower anchor 5210, or both, the laser drill and cutting head 5200 can be advanced or retracted with respect to the rest of the tool, or the entire tool can be moved. Further, the tool may be moved independent of, e.g., without, force being exerted from the conveyance structure. It being understood that the arrangement and spacing of these components in the tool may be changed, and that additional and different components may be used or substituted in, for example, such as a MWD/LWD section.

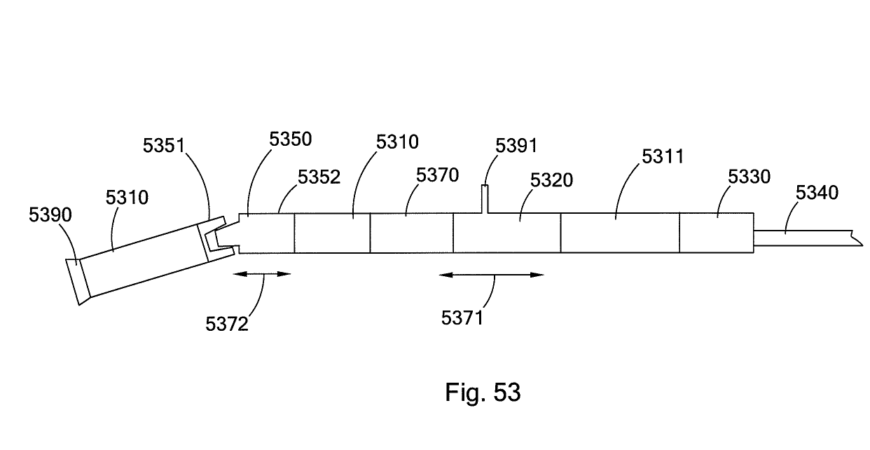

Referring to FIG. 53 there is shown an embodiment of a laser tool having a laser drill and cutting head section 5300, having a drilling laser beam path 5390. The tool has two anchor sections, a lower anchor section 5310 and an upper anchor section 5311. Although not shown in the figure, the anchors in the anchor sections are rotated 90 degrees with respect to each other. The tool has a laser head section 5320 that has a laser beam path 5391. The tool has a termination end 5330 that receives a high power laser conveyance structure 5340. The tool has a knuckle section 5350 that provides the ability for the tool to bend at a predetermined angle at this section. In the view of FIG. 53, the knuckle section 5350 is shown in a bent configuration. Knuckle section 5350 has a lower section 5351 and an upper section 5352 that are connected by a joint. Upper section 5352 has a device for providing rotation. The tool also has a linear motion section 5370 that provides for motion of the tool as shown by arrows 5371, 5372. By fixing either the upper anchor 5311, the lower anchor 5310, or both, the laser drill head 5300 can be advanced or retracted with respect to the rest of the tool, the laser cutting head 5320 can be moved forward (to the left in the view of the figure) or backward (to the right in the view of the figure) or the entire tool can be moved. The laser cutting section has a device for providing rotation of the beam path. Thus, the beam path can be moved through any laser beam delivery pattern that is desirable. It being understood that the arrangement and spacing of these components in the tool may be changed, and that additional and different components may be used or substituted in, for example, such as a MWD/LWD section.

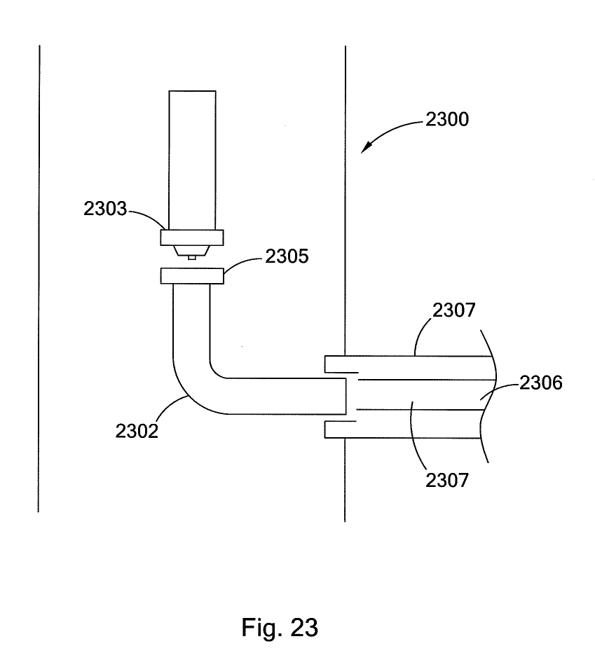

In FIG. 23 there provided a compound fluid laser jet tool 2300 that utilizes a fluid jet filled pipe 2302 that provides for the ability to bend and direct the jet while maintaining its waveguide properties. Thus, there is provided a laser optics 2303 that launches a laser beam into a first nozzle 2305, which forms a fluid jet containing the laser beam 2307. This fluid jet will become the core 2306 of the compound fluid jet 2307. The fluid jet and laser are directed into a pipe, tube, or member that is made from a material having a different index of refraction from the fluid of the fluid jet, thus causing the fluid jet to function as a waveguide for the laser beam. The fluid jet filled waveguide pipe that conveys the first jet and laser to a second annular nozzle that forms the composite fluid laser jet.

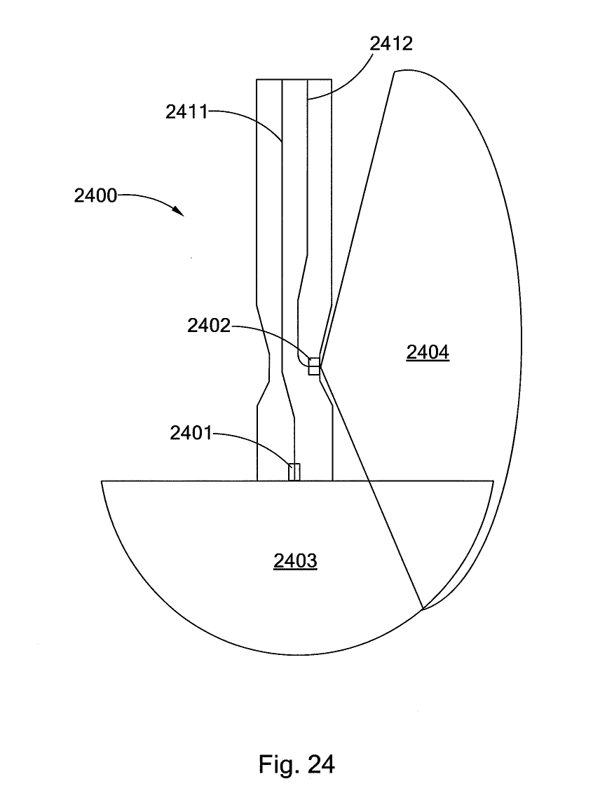

In FIG. 24 there is provided an example of a laser tool 2400 that has a first nozzles 2401 and a second nozzle 2402. Either or both of the nozzles may provide a fluid jet and laser beam path and laser beam, such as a gas jet, or a compound fluid jet and laser beam path and laser beam. In this embodiment, it is preferred that both nozzles can pivot or otherwise move, point, and thus, direct the axis of each of the fluid laser jet over an area. Thus, nozzle 2401 can direct the jet and its associated laser beam and beam path over area 2403; and nozzle 2402 can direct the jet and its associated laser beam and beam path over area 2404. Area 2403 partially overlaps with area 2404. A compete overlap and no overlap may also be utilized. Alternatively, only one of the nozzles can be movable, or none of the nozzles can be movable. Each nozzle 2401, 2402 has an optical path and fluid path, 2411, 2412 respectively, associated with it. The optical paths may have optical fibers, connectors, and optics of the type disclosed and taught herein optically associated therewith. The optical paths function to transmit the laser beam to the respective nozzles and launch those beams into the jets that are formed by the nozzles. The fluid paths provide the necessary fluid(s) for the formation of the jet.

Mechanical devices may be used to isolate the area where the laser operation is to be performed and the fluid removed from this area of isolation, by way of example, through the insertion of an inert gas, or an optically transmissive fluid, such as an oil, kerosene, or diesel fuel and thus have an isolated laser beam. The use of a fluid in this configuration has the added advantage that it is essentially incompressible. A mechanical snorkel like device, or tube, which is filled with an optically transmissive fluid (gas or liquid) may be extended between or otherwise placed in the area between the laser tool and the work surface or area. Similarly mechanical devices such as an extendable pivot arm may be used to shorten the laser beam path keeping the beam closer to the cutting surface as the cut is advanced or deepened.

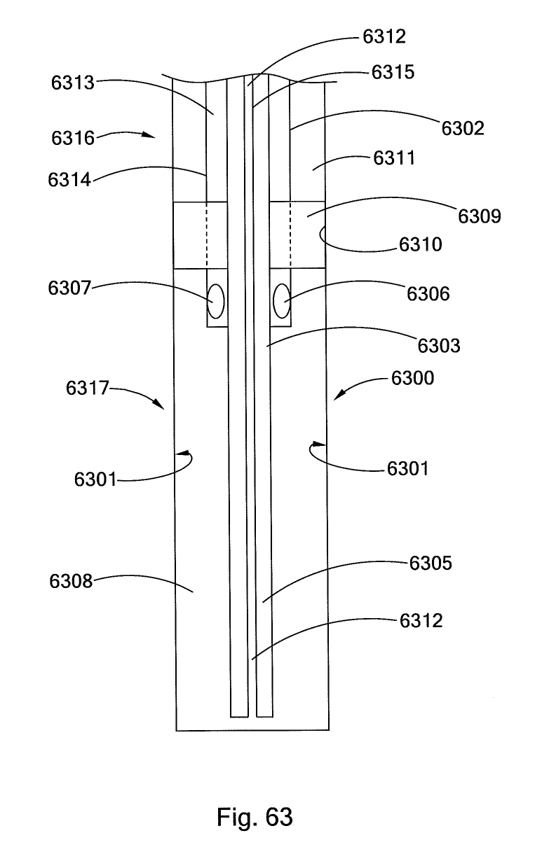

Examples of preferred mechanical devices and systems for creating a movable isolation zone and isolated laser beam are disclosed in U.S. patent application Ser. No. 13/211,729 the entire disclosure of which is incorporated herein by reference. Thus for example, turning to FIG. 63, there is shown a cross sectional view of one such embodiment of a laser tool assembly in a borehole 6300. The borehole 6300 has sidewalls 6301. A piston 6309 with a wiper seal 6310 forms a seal against borehole sidewall 6301.

The piston 6309 is lowered by coiled tubing 6302. The coiled tubing 6302 has an inner tubular 6315 forming a channel 6312 for transmitting a clearing gas to the bottom of the bore-hole or laser work area. This inner tubular 6315 and the outer wall 6314 of the coiled tubing 6302 form an annulus 6313. The annulus 6313 carries the cuttings, debris, e.g., returns out of the borehole. The cuttings enter annuls 6313 though openings 6306, 6307. The laser tool 6303 has a channel 6305 through it for flowing a clearing gas, this channel is in fluid communication with a channel 112 in the laser-bit 104. Thus, the clearing gas flows down inner channel 6312, to inner channel 6305, to inner channel 6312 and out the laser-bit 6304. The returns are then carried up the lower section, e.g., the section of borehole below the piston 6309 and enter openings 6306, 6307. An electric motor laser bottom hole assembly of U.S. provisional patent application Ser. No. 61/446,042 and a laser-mechanical bit of U.S. provisional patent application Ser. No. 61/446,043 may be utilized. The drilling assembly of U.S. patent application Ser. No. 12/986,021 may also be used. Drilling mud 6311, or other drilling fluid, is contained above the piston 6309 by the seal formed between wiper 6310 and the sidewall 6301. The clearing air flow through the channels 6312, 6305, 6312 exits the tool and carries cuttings and debris up and into the return openings 6306, 6307. In operation, as the laser tool preforms its operations in the borehole and, in particular, if those operations require the tool to advance in the borehole, or if the tool, for example, after cutting a window is advancing a borehole from the window, the piston and wiper may more down, i.e., slide, while maintaining the seal against the sidewall to prevent the drilling mud from moving around or below the piston. In this manner, this embodiment may be view as in slidable engagement with the sidewall. There is also created an advancing upper isolation zone 6316 and an advancing lower isolation zone 6317. The laser tools provided in this specification may be used in this embodiment. For example the laser tools of FIGS. 45, 45A and C (in which case circulation may not be necessary or beneficial), FIG. 45B, FIG. 46, and FIGS. 50-53 may be used in this embodiment.

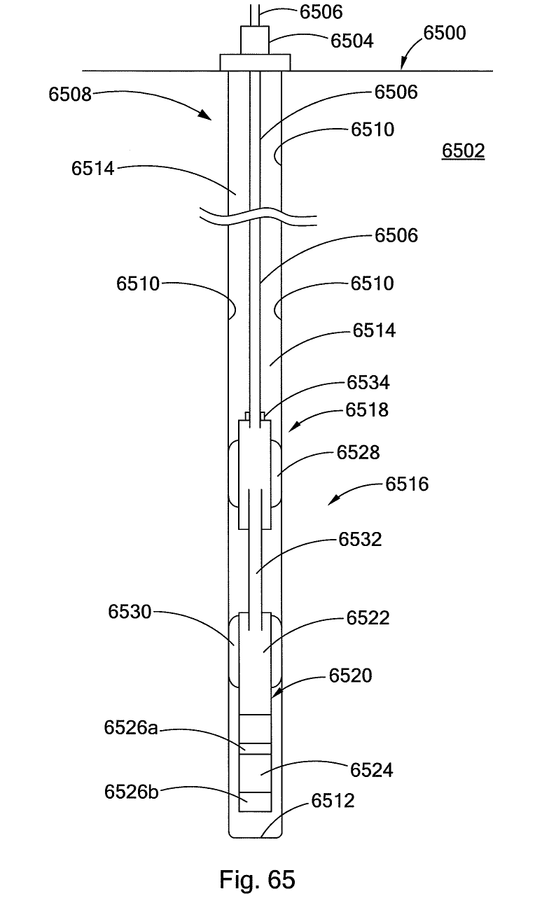

Turning now to FIG. 65, which illustrates an embodiment of a fluid-gas laser tool system in use in a borehole. Thus, there is provided in the earth 6502a borehole 6508. The borehole 6508 has a sidewall surface 6510 and a borehole bottom surface 6512. At the surface 6500 of the earth there is provided the top, or start of the borehole. At the surface 6500 of the earth, there is provided a surface assembly 6504, which may have a wellhead, a diverter, and a blowout preventer (BOP).

A conveyance device 6506 is extended through the surface assembly 6504 and into the borehole. For example, the conveyance devices can be coiled tubing, with tubes and lines contained therein, and thus a coiled tubing rig, as for example provided in the above incorporated by reference published patent applications, can be used with the conveyance device.

The conveyance device 6506 extends down the borehole 6508 and is attached to the packer laser cutter tool assembly 6516 by attachment device 6534. The attachment device can be any means suitable for the purpose; it can be permanent, temporary or releasable. It can be a weld, a threaded member and a nut, a quick disconnect, a collet, or other attachment devices that are known to the art.

The packer laser cutter tool assembly 6516 has a first section 6518 and a second section 6520. The second section 6520 of the assembly has a first part 6522 and a second part 6524. The assembly has a first laser head 6526a and a second laser head 6526b. There is further provided an inflatable packer 6528 on the first section 6518 of the LBHA 6516 and an inflatable packer 6530 on the second section 6520 of the assembly 6516.

As shown in FIG. 65 the packers are shown as inflated, thus they are shown as extending from the assembly to and engaging the surface of the sidewall of the borehole. In this way the inflatable packers engage the surface of the borehole wall and seal against the wall, or form a seal against the wall. Further by sealing against the borehole wall the packers isolate the upper section of the well, i.e., the section of the borehole wall from the packer to the start of the well, from the lower section of the well, i.e., the section of the well from the packer to the bottom of the borehole. As shown in FIG. 65 the packer 6518 is inflated against the wall and isolates and prevents the drilling fluid or drilling mud 6514 contained in the borehole from advancing toward the second section 6520 of the assembly; or the bottom of the borehole 6512; thus preventing the fluid from causing any potential interference with the laser beam or laser beam path.

The second or lower section 6520 of the assembly contains the laser optics that, for example, may form the beam profile and focus the beam, and the means for rotating the laser head(s). The rotation means can be for example an electric motor or an air driven mud motor. Each laser head may have its own optics and rotating means or they may be combined or one may not rotate. Further, if circulation is required or beneficial, the lower section of the assembly may have ports or openings for the air to return into the assembly and carry the cuttings up the conveyance device to the surface or a junk collection device may be used.

The first 6518 and second 6520 sections of the assembly 6516 are connected by a piston 6532. Thus, in use the packer 6528 is inflated and in addition to forming a seal, fixes and holds the first section 6518 in position in the borehole. The piston 6532 is then advance at a controlled rate or withdrawn at a control rate and advances and returns, e.g. moves the second section 6520 of the assembly. In this way, as the piston is extended, and a high level of control can be maintained over beam delivery pattern and cutting rate in generally longitudinal directions. Monitors and sensors can be located in the assembly and connected to control devices at the surface by way of cables and/or fibers associated with the conveyance device.

When the piston has reached the end of its stroke, i.e., it is extended to its greatest practical length, the packer 6530 is inflated, as shown in FIG. 65 and then the packer 6528 is deflated, sufficiently so that the piston can be retracted and the upper or first section 6518 is moved down toward the second section 6522. The packer 6528 is then inflated and the piston extend. This process is repeated, in an inch-worm like fashion advancing to different locations in the well bore. Alternatively, the upper packer 6328 can be a retractable cleat or other fixing apparatus that releasably attaches to or engages the borehole wall. In this case the lower packer remains inflated and is slid along the borehole wall surface, maintaining the seal and isolating the drilling mud above the lower section, which contains the gas flow.

The inflatable packers that are preferred in the present inventions have a tubular member and an inflatable bladder like structure that can be controllably inflated and deflated to fill the annulus between tubular member and the bore wall. Further, the pressure that the bladder exerts against the bore wall can be controlled and regulated. Control lines and lines for providing the media to inflate and deflate the bladders are associated, with or contained within, the conveyance device. Other configurations of packers or other types of isolation devices may be used with the laser cutting tools of the present invention.

Further, the use of oxygen, air, or the use of very high power laser beams, e.g., greater than about 1 kW, could create and maintain a plasma bubble, a vapor bubble, or a gas bubble in the laser illumination area, which could partially or completely displace the fluid in the path of the laser beam. If such a bubble is utilized, preferably the size of the bubble should be maintained as small as possible, which will avoid, or minimize the loss of power density.

The laser tools, laser heads, nozzles, isolated laser beams, and laser fluid jets provide the ability to deliver precise and predetermined laser beam patterns to a work surface of a work piece. In this way process considerations of overall speed, cutting rate, cutting efficiency, process efficacy, cut quality, cut reliability, surface smoothness of the cuts, cut depth, work piece material(s), laser power, spot size, spot shape, spot power density, and other factors may be evaluated, balanced and utilized in selecting and determining a particular laser beam pattern for a particular laser processing task. Additionally, the ability to have precise and predetermined laser beam patterns provides the ability to cut less, preferably substantially less, and more preferably far less, material than the total volume of material that is to be removed.

For example, and by way of illustration, presume that an 8″×120″ rectangle of casing, having a ¼″ wall thickness, is to be removed downhole to form an opening. Using conventional downhole mechanical methodologies the entire volume of casing material (e.g., about the 240 cubic inches) must be removed, i.e., cut/milled to obtain the opening. On the other hand, using a laser pattern that only cuts the periphery of the window with a ¼-inch width kerf, a relatively small volume of material (e.g., about 16 cubic inches) needs to be removed by the laser tool to form the opening. Thus, in this illustration, the laser tool has the ability to provide the same downhole opening area in the casing as a conventional mechanical milling tool; but the laser tool only has to remove about 7% of the material in the opening. Viewed another way, in this illustration a laser tool removes 93% less material than conventional mechanical milling tool to obtain the same size (area) opening.

Accordingly, in making an opening in a work piece, and in particular in making an opening in a work piece in a borehole, e.g., a tubular within a borehole, the present laser systems, tools and devices, and the predetermined laser beam patterns that may be provided by them have the ability to make a window opening by removing less than about 25%, preferably less than about 50%, more preferably less than about 75%, and still more preferably less than about 95%, of the total volume of material of the work piece occupying the opening before it is made.

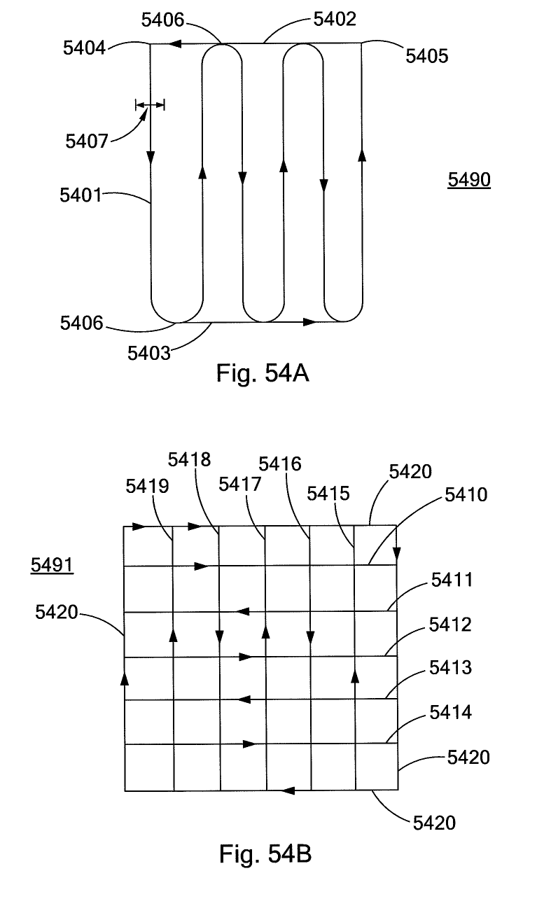

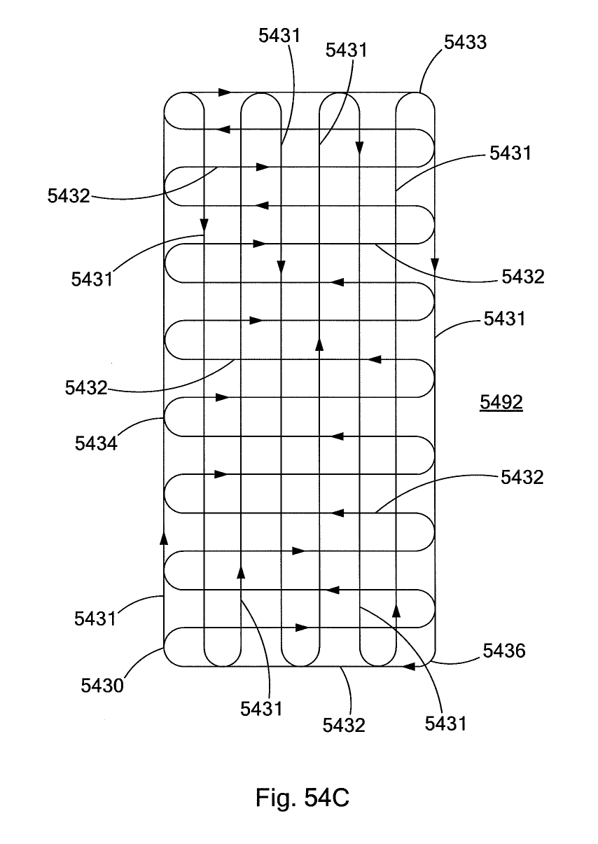

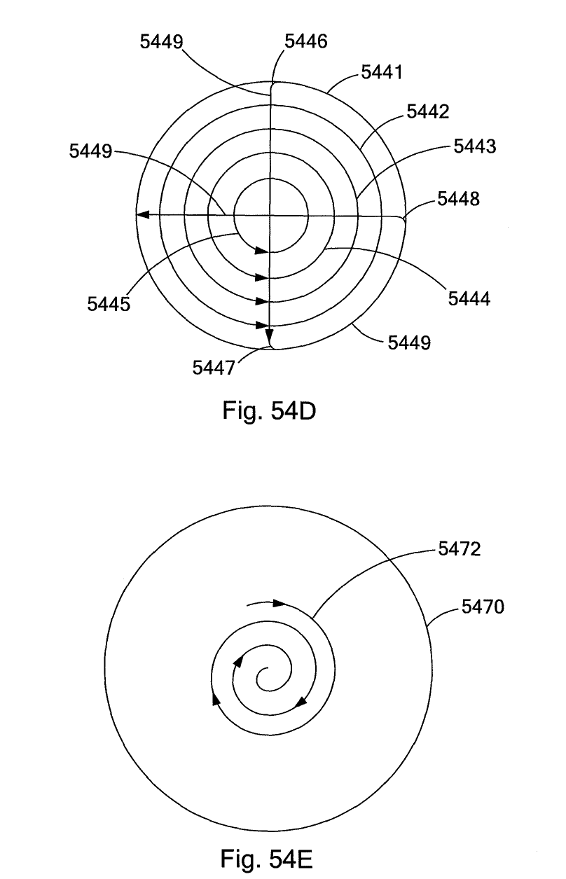

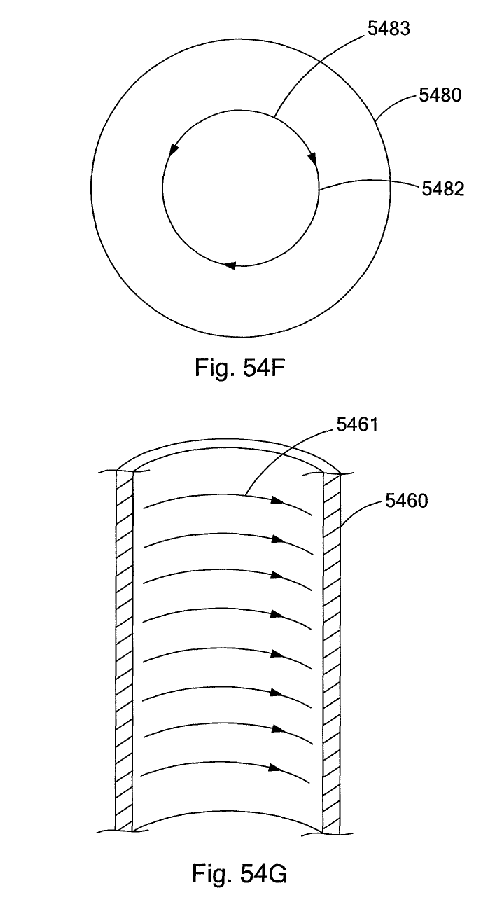

Turning to FIG. 54A there is shown a diagram representing an embodiment of a laser beam delivery pattern. In this pattern the laser beam, when delivering the pattern, forms a spot at the surface of the work piece 5490. The shape of the spot may be circular, essentially circular, elliptical, linear, or other spot shapes, and have various spot sizes (areas) to meet particular cutting and performance requirements. The beam would from a kerf, or cut, that may extend through the work piece and through material behind the work piece. The work piece could be for example a casing located in a borehole, having cement behind it.

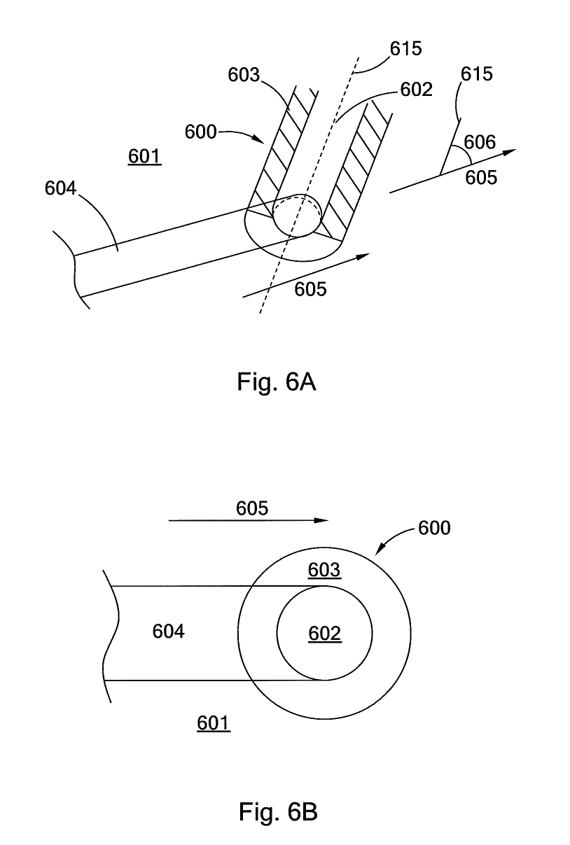

The laser beam pattern in FIG. 54A has three passes that would follow lines 5401, 5402, 5403. The laser beam spot, preferably the center of the spot, would follow the lines of the pattern. Thus, the actual kerf, or cut, made in the work piece, typically, would be winder than the line as drawn in the figure. (see, e.g., FIGS. 6A and 6B).

As used herein the width of the kerf, or the cut, would be the dimension of the cut that is transverse to the movement of the laser beam. The distance of the kerf, or cut that follows the movement of the laser beam through the pattern would constitute the length of the cut. Thus, for example, the length of the kerf for pass 5401, would be the entire length of line 5401 from point 5404 to point 5405; and the width of the kerf for this pass would be shown by double arrow 5407 (not drawn to scale).

The first pass has a start point 5404; and proceeds along line 5401 in the direction of the arrows. If the top of the page is viewed as up, or toward the top (surface opening) of a borehole, this pass may be referred to as an essentially vertical type scan pattern, and more specifically a “spaced” essentially vertical type scan pattern, because the vertical lines of the pass do not overlap, i.e., the kerfs that they created will be separated by solid material of the work piece. The first pass 5401 ends at point 5405, where the second pass begins. The second pass has a start point 5405; and proceeds along line 5402 in the direction of the arrow. This pass could be referred to as a linear scan pattern, because it is essentially a single straight line. Continuing with the same orientation convention, this pass may be referred to as a horizontal line scan. This orientation convention will be used for all of the FIG. 54 drawings, unless specified otherwise.

The second pass 5402 overlaps with sections of the first pass 5401 at various locations along the out edge of the pattern, e.g., 5406. Although shown in the figure as having complete overlap, which may be preferred for some patterns or processes, the amount of overlap may be less than complete. As used herein, “overlap” is present, even when the pattern lines do not overlap at all, provided that the pattern as delivered (i.e., when the kerfs are formed by the laser beam) does not have any work piece material left between the kerfs in the area of the intended overlap in the pattern.

Provided that the spacing between the vertical lines of the pattern and the spacing between the horizontal lines of the patter are substantially greater than the spot diameter, or the resultant kerf width (e.g., about 3 times greater, about 4 times greater, and preferably about 5 or more times greater), then the delivery of a laser beam along the predetermined laser beam pattern shown in FIG. 54A will make a window in the work piece by cutting substantially less material than the total volume of material occupying the window before it is made.

Turning to FIG. 54B there is shown a diagram representing an embodiment of a laser beam delivery pattern. In this pattern the laser beam, when delivering the pattern, forms a spot at the surface of the work piece 5491. The shape of the spot may be circular, essentially circular, elliptical, linear, or other spot shapes, and have various spot sizes (areas) to meet particular cutting and performance requirements. The beam would from a kerf, or cut, that may extend through the work piece and through material behind the work piece. The work piece could be for example a tubular associated with a borehole.

The laser beam pattern in FIG. 54B has a series of horizontal passes, a series of vertical passes, and a boundary pass, which traces the edge of the opening to be made. The laser beam spot, preferably the center of the spot, would follow the lines of the pattern. Thus, the actual kerf, or cut, made in the work piece, typically, would be wider than the lines as drawn in the figure.

The horizontal passes proceed along lines 5410, 5411, 5412, 5413, and 5414 in the direction of the arrows. The vertical passes proceed along lines 5415, 5416, 5417, 5418, and 5419 in the direction of the arrows. The boundary pass would follow line 5420 in the direction of the arrows. The passes of the pattern would overlap at the points of intersection of the lines as shown in the figure.

Provided that the spacing between the vertical lines of the pattern and the spacing between the horizontal lines of the pattern is substantially greater than the spot diameter, or the resultant kerf width (e.g., about 4 time greater, and preferably about 5 or more times greater), and the kerf width for the boundary pass is essential the same as the other kerf widths, then the delivery of a laser beam along the predetermined laser beam pattern shown in FIG. 54B will make a window in the work piece by cutting substantially less material than the total volume of material occupying the window before it is made.

Turning to FIG. 54C there is shown a diagram representing an embodiment of a laser beam delivery pattern. In this pattern the laser beam, when delivering the pattern, forms a spot at the surface of the work piece 5492. The shape of the spot may be circular, essentially circular, elliptical, linear, or other spot shapes, and have various spot sizes (areas) to meet particular cutting and performance requirements. The beam would form a kerf, or cut, that may extend through the work piece and through material behind the work piece. The work piece could be for example a deck plate.

The laser beam pattern in FIG. 54C has two spaced patterns that are overlaid and rotated 90 degrees, which respect to each other. The laser beam spot, preferably the center of the spot, would follow the lines of the pattern when the pattern is being delivered. Thus, the actual kerf or cut, made in the work piece, typically, would be winder than the lines as drawn in the figure.

The first spaced pattern would have a single pass that proceeds along line 5431, starting at point 5430 moving in the direction of the arrows and ending at transition section 5436. Because this pass provides the ability for the laser beam to be delivered along the entire length of the pass, without interruption or cessation of beam delivery to the work piece, it may be referred to as a continuous line trace scan pattern. The second spaced pattern would have a single pass that proceeds along line 5432, starting at transition section 5436 and moving in the direction of the arrows and ending at point 5433. In this manner by overlaying the passes of the patterns, a boundary kerf, or cut, is created without the need for a separate boundary pass. The passes and their patterns would overlap at the points of intersection of the lines as shown in the figure.

Provided that the spacing between the lines of the passes is substantially greater than the spot diameter, or the resultant kerf width, (e.g., about 4 time greater, and preferably about 5 or more times greater), then the delivery of a laser beam along the predetermined laser beam pattern shown in FIG. 54C will make a window in the work piece by cutting substantially less material than the total volume of material occupying the window before it is made.

Turning to FIG. 54D there is shown a diagram representing an embodiment of a laser beam delivery pattern. The pattern has a series of circular passes 5445, 5444, 5443, 5442, and 5441, which may preferably be delivered in the order of smallest to largest. There is a transition 5446 from circular line 5441 to line 5449, which has a linear or straight section that goes to transition zone 5447, a circular section, which is coincident with line 5441, which goes to transition zone 5448 and then a final straight section. The delivery of the passes along the lines is in the direction of the arrows.

Turning to FIG. 54E there is shown a pattern that for example may be used to remove a stuck tool that could not be fished out of a borehole 5470. The laser pattern 5472 is a spiral pattern starting from the outside and spirally in as shown by the arrows. This pattern may also be delivered starting from the center and spirally outwardly. A laser head or laser tool may be used with, or as a part of, a fishing tool, to assist the tool in removing a stuck object, such as a BHA.

Turning to FIG. 54F there is shown a pattern that for example may be used to remove a stuck tool that could not be fished out of a borehole 5480. The laser pattern 5483 has a start point 5482 and is a circle delivered as shown by the arrows. Multiple concentric circles may be used, or multiple non-concentric and overlapping, adjacent or non-overlapping may also be used. Other patterns for removing stuck objects may also be used.

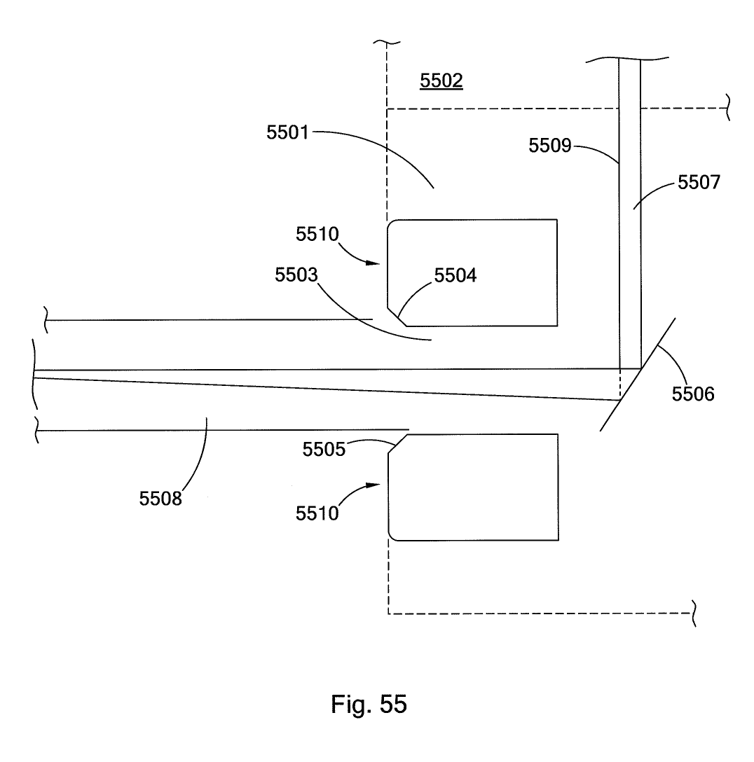

Turning to FIG. 55G there is shown a pattern for applying a laser beam to the interior of a tubular 5460, for example a cased borehole, production pipe in a borehole, or pipeline. The laser pattern 5461 is delivered as a spiral pattern moving along the length of the tubular as shown by the arrows.

The laser beam patterns, and passes may be delivered with any laser beam from any laser system that is capable, or made capable, of delivering the laser beam to the intended work piece under the environmental conditions present and in a manner sufficient to laser process (e.g., melt, vaporize, anneal, cut, ablate, decompose, remove, etch, spall, laser induced break down, soften, etc.) the work piece. The sequencing of the delivery of the various patterns and passes may be varied and repeated.

Preferably, the sequencing of the delivery of the pattern will provide the most efficient beam delivery for the pattern, e.g., the least amount of time when the tool, or its components, are moving but the laser beam is not being delivered to the target. Further, in considering the sequencing of the delivery, the capability of the tool, e.g., rotating devices and linear movement devices, should be taken into consideration. Similarly, start, stop and transition points may be utilized in the delivery of a beam pattern or patterns. Thus, there may be one, two, a multiplicity, or none, of such points in the delivery of a beam pattern.

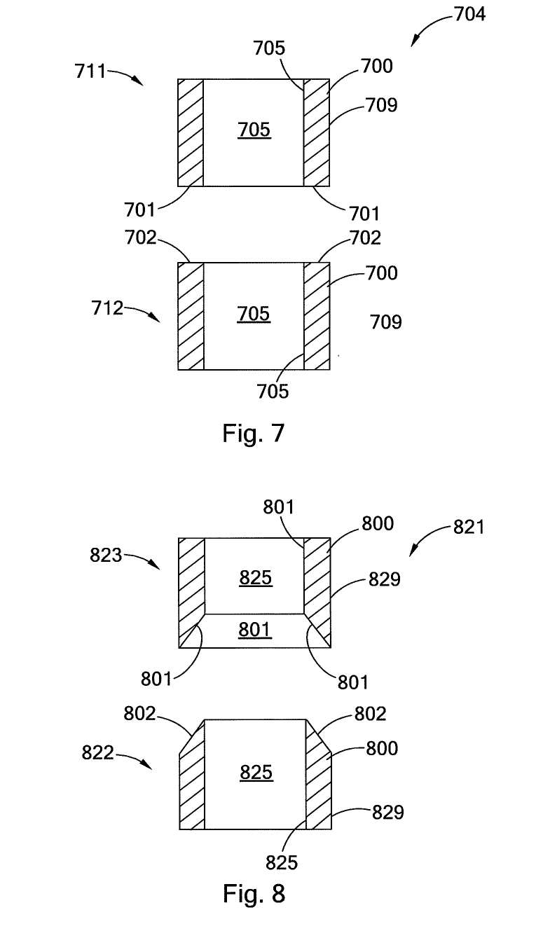

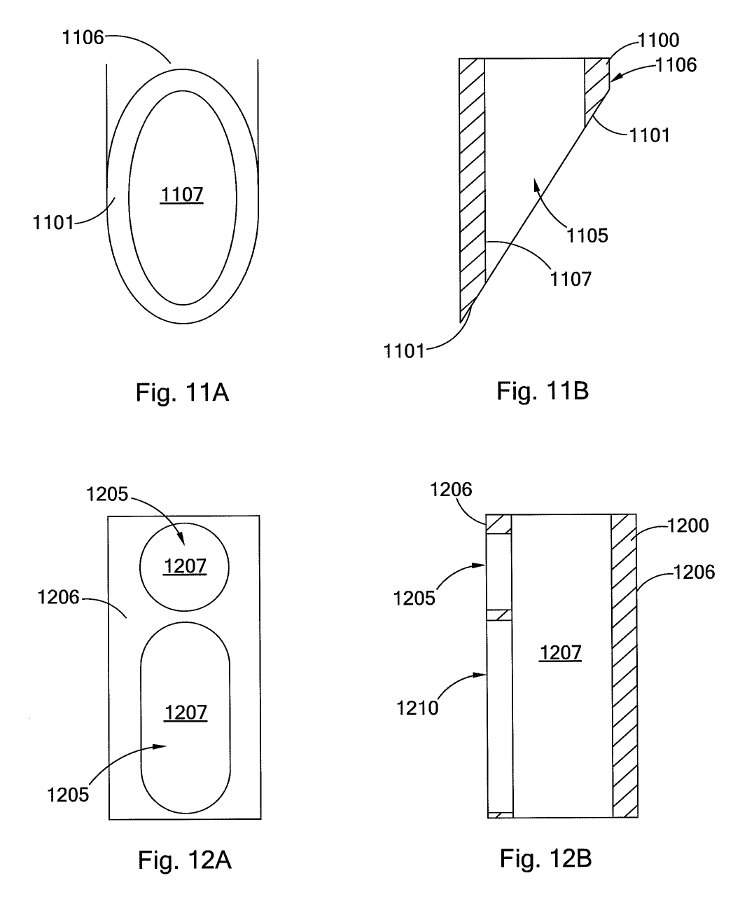

Although, generally rectangular openings are showing in the FIGS. 54 A to C, patterns, and other shape are contemplated, including circles, arches, ellipses, slots, meshes, spirals, custom shapes, the openings of FIGS. 11 and 12, as well as, combinations and variations of these and other shapes. In addition to openings, flaps, tabs, hinged members, and similar structures may be made into a work piece by the delivery of a beam pattern. (For example, three adjoining sides of a square pattern may be cut completely through, and the fourth side may only be lightly scored, creating a hinged flat in the work piece.) The patterns may also be, for example, those used to create the cuts shown in the embodiments of FIGS. 7 to 10.

In additional to pattern lines having the essentially vertical and horizontal straight line shapes, as shown in FIG. 54, spiral lines, circular lines, elliptical lines, annular lines, diagonal lines, line shapes based upon work environmental conditions, such as downhole data, formation properties, or downhole conditions, and combinations and variations of these may be utilized.

The patterns, the passes in a pattern, or the lines of the pattern may be arranged such that they: (i) all overlap, in which case the laser will remove all of the material occupying the area of the window, i.e., the volume of laser removed material and the volume of material in the opening before it is made will be the same; (ii) overlap at only a single point; (ii) substantially overlap; (iii) only overlap at locations along the periphery of the pattern, or edge of the opening; (iv) overlap to create uncut areas of the work piece that are less than about 3 sq. ft., less than about 2 sq. ft., less than about 1 sq. ft., less than about 36 sq. inches, less than about 9 sq. inches, less than about 4 sq. inches, or less than about 1 sq. inch; (v) do not overlap at locations along the periphery of the pattern, or edge of the opening; (vi) other types of overlaps; (vii) and combinations and variations of these.

The angle of the laser beam with respect to the surface of the work piece and the direction of the movement of the spot as the beam pattern is delivered may be perpendicular, or any other angle. Further, this angle may be changed during the delivery of the pattern(s), e.g., from pattern-to-pattern, pass-to-pass, or line-to-line. In this manner, volumetric shapes may be removed, such as rods, rectangles, squares, cones, wedges, pie-slices, other shapes and combinations and variations of these. For shapes having a narrower and wider side, the narrow side or wide side of such shape may be located closer to the surface of the work piece that is initially closest to the laser tool, or neither of these sides may be so located. Additionally, the angles of the sides of the opening, flap, or cut may be varied. Thus, for example the angles of the cuts in the delivery of the pattern of FIG. 54C, may be such that the sides of the uncut materials are tapered to facilitate their removal. This may prove especially beneficial in cutting openings in thick materials. (The tapered sides may be obtained for example, by using a diverging laser beam, or by delivering the same patterns twice with different angles being used.)

If monitoring devices are not employed, or even if they are, the patterns may be delivered twice, or more, to make certain that the intended cuts are complete. For example, in a pattern such as shown in FIG. 54C, after the pattern has been delivered, a subsequent boundary pass may be delivered. If the cut was complete, essentially no back reflections or emissions should be observed during delivery of the subsequent boundary pass.

A continuous or a pulsed laser may deliver the patterns. In the case of pulsed lasers, or a laser that is pulsed, the individual pulses, or a collection of plusses, may be delivered to one point and then the next adjacent point along a scan line or they may staggered or stepped, e.g., skipping an adjacent spot and then returning to the skipped spot later in the delivery of the pattern. Similarly, if for example the spot shape was essentially a linear, a series of linear horizontal spaced cuts could be made, each having essentially the same cut profile as the spot shape, and of then a series of linear vertical spaced cuts could be made, each having essentially the same cut profile as the spot shape, in this manner the object will be cut along the same lines as when the pattern of FIG. 53C is delivered.

In situations where it may be desirable to perform a radially limited complete cut, for example removal of an inner string of casing, while not cutting an outer string of cases, which outer string is cemented to the formation. If the casing is filled with brine or water a wavelength for the laser may be selected such that the brine or water present has heavy absorption characteristics. In this manner the laser brine and water would attenuate the laser. The jet pressure may then be selected, in view of the attenuation, and other cutting conditions, e.g., pressure, to limit, or predetermine, the length of the jets travel into the casings to be cut, e.g., the reach of the jet from the tool is controlled and predetermined. The laser beam would then be dispersed at this predetermine location by the water or brine, in such a manner where the inner casing is completely severed and the outer casing is not cut or otherwise adversely effected by the laser beam. In this embodiment, it is preferable to have a centralizing device, or other apparatus to know the location of the tool within the casing and thus, have a reference point for determining the reach of the jet.

The forgoing patterns and considerations are illustrative and are not limiting of the types of beam delivery patterns that may be provided by the laser systems, tools and devices of the present inventions. These systems, tools and devices provide the ability to deliver custom and predetermined beam patterns to a work piece; to create custom and predetermined laser processed areas, e.g., openings, on a case-by-case basis.

In general, the use of fluid jets in high power laser applications finds greater applicability and benefits for laser applications that are being conducted in, or through, a liquid or debris filled environment, such as in a borehole or subsea. Thus, these fluid laser jets can provide substantial benefits for example in performing, e.g., an outside-to-inside cut where sea water is present, or an inside-to-outside cut where drilling mud is present. The fluid jets may use any type of fluid, such as a liquid, a gas, a supercritical fluid, or a foam. The fluid jets may be a single jet or multiple jets, in which case the multiple jets may be parallel (discrete, substantially adjacent, or adjacent) annular, coaxial, intersecting, converging but not indented to intersect, diverging and combinations of these. In the case of multiple jets, the jets may be the same or different fluids, for example, in an annular jet the inner annular jet may be a gas and the outer annular jet may be a liquid, the inner annular jet bay be a liquid and the outer annular jet may be a gas, or the inner annular jet and outer annular jets are liquids having predetermined and preferably different indices of refraction. The surface effects, flows, jet integrity, ability to function as a waveguide, and other factors regarding these various combinations should be taken into consideration when selecting the combination and configuring a nozzle(s) so that flow and jet requirements are established to meet the conditions of an intended use or uses.

The laser beam path, and the laser beam when propagated in the jet, may be coaxial with the jet, it may be off axis, or the jet may function as a waveguide, in which case, provided the jet is long enough, the laser beam will fill the jet and the laser beam path and laser beam will be coincident with the jet. The fluid jet, or jets, may be cross sectional areas that are circular, essentially circular, essentially linear, i.e., as would be obtained by an air curtain, air knife or air blade, and other shapes. The use of a substantially linear jet may, for example, be utilized in a laser mechanical bit, of the type shown in U.S. provisional patent application Ser. No. 61/446,043. In such bits the laser beam guide could be configured to provide for an substantially linear air jet that exists the bottom of the beam and functions as a laser beam path while keeping the beam path clear of borehole fluids and cutting debris.

In general there is provided an embodiment of a fluid laser jet that has a compound fluid jet. The compound fluid jet has an inner core jet that is surrounded by annular outer jets. A single annular jet can surround the core, or a plurality of nested annular jets can be employed. As such, the compound fluid jet has a core jet. This core jet is surrounded by a first annular jet. This first annular jet can also be surrounded by a second annular jet; and, the second annular jet can be surrounded by a third annular jet, which can be surrounded by additional annular jets.

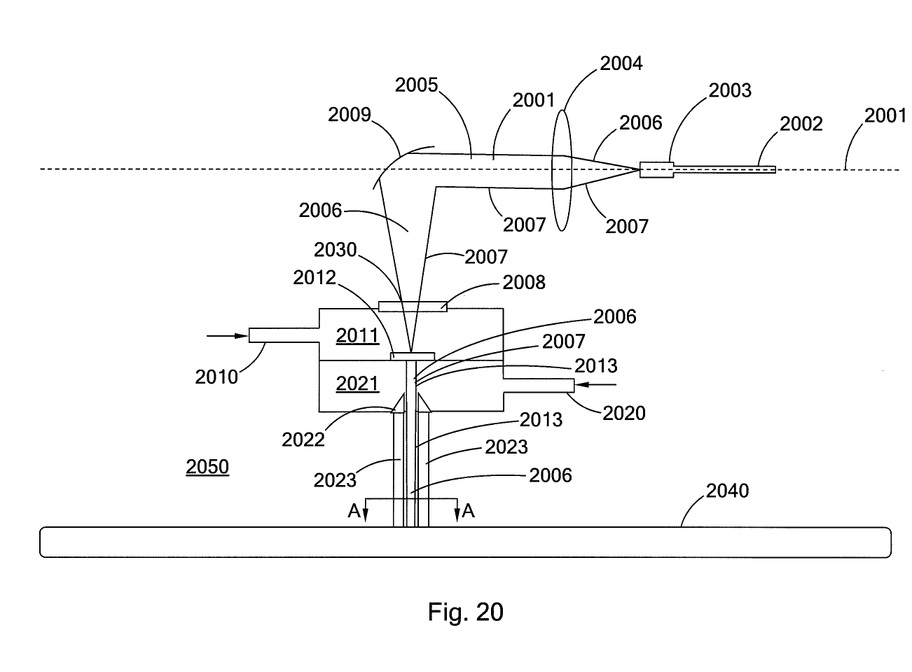

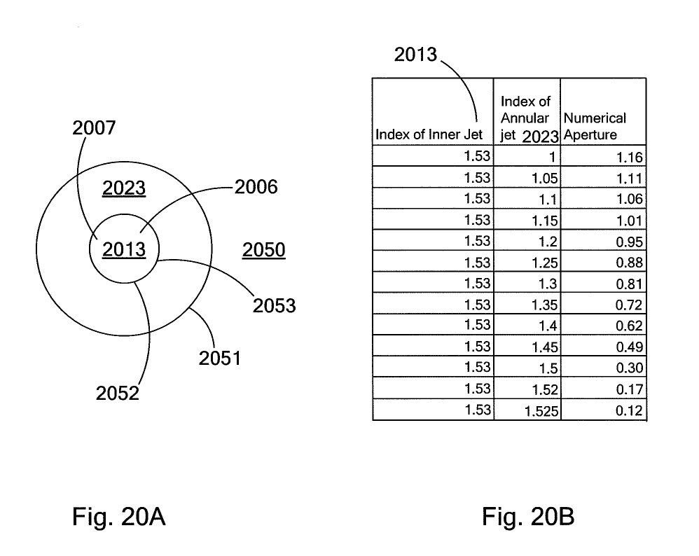

Turning to FIGS. 20, 20A, and 20B there is provided a general schematic overview of an embodiment of a compound fluid jet tool, delivering a compound laser fluid jet to a work surface. In this embodiment the high power laser beam is transmitted from a high power laser (not shown) by optical fiber 2002 to a connector 2003. The laser beam 2007, is launched from the connector 2003, and travels along laser beam path 2006. There is also shown a centerline 2001 of a borehole, in which the tool is located.

The laser beam 2007 and beam path 2006 enter collimating lens 2004, and upon leaving collimating lens 2004, travel in collimated space 2005, to focusing mirror 2009. Focusing mirror 2009 directs and focuses the laser beam 2007, along the beam path 2006 to and through window 2008. Window 2008 is adjacent, or may form a part of a first chamber 2011. The first chamber 2011 has an inlet 2010 for providing first fluid to the first chamber 2011. The first chamber 2011 has a nozzle 2012 for forming an inner fluid jet 2013 from the first fluid.

A second chamber 2021 is operationally associated with the first chamber 2011. The second chamber 2021 has an inlet 2020 for providing a second fluid to the second chamber 2021. The second chamber 2021 has a nozzle 2022 that forms an outer annular fluid jet 2023 from the second fluid.

The focused laser beam has a focal point 2030 and a depth of field. As seen in other embodiments, and as discussed further in this specification, having the focus point at or near the window, in some configurations may not be preferred. Such a configuration may result in an excessive energy density at or near the window, which in turn could result in damage to the window, thermal issues, thermal deposition of material on the back side of the window, and thermal lensing issues within the first fluid, among other things.

The laser beam 2007 and beam path 2006 is coupled (launched) into the inner jet 2013. The inner jet 2013, having the laser beam 2007 and beam path 2006, coincident with it, has annular outer jet 2023 formed around it; forming a compound fluid laser jet. The compound fluid laser jet travels through an environmental medium 2050, e.g., an aqueous liquid, to work surface 2040. The outer boundary 2052 of the inner fluid jet 2013 is adjacent the inner boundary 2053 the outer fluid jet 2023. The outer boundary 2051 of the outer fluid jet 2023 is adjacent the environmental medium 2050. The Table of FIG. 20B provides the index of refraction for various combinations of fluids and the numerical apertures for the compound fluid jet that they would provide. In this manner the laser beam, and the laser beam path are coincident with the inner fluid jet and are isolated from the outer annular jet and the environmental medium. Further, in this manner the laser beam, and the laser beam path, do not travel through or in the annular jet or the environmental medium.

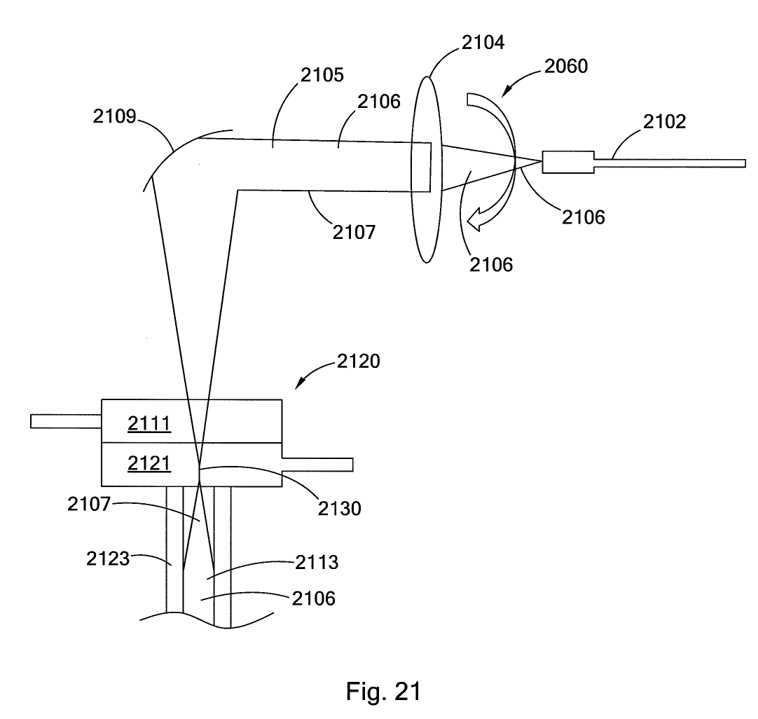

Turning to FIG. 21 there is provided a general schematic overview of an embodiment of a compound fluid jet tool, delivering a compound laser fluid jet in a rotating and movable manner, which movement may be used to deliver the laser beam, within the compound fluid jet, to a work surface in a beam delivery pattern. There is provided a high power laser fiber 2101 that launches a laser beam 2107 along a beam path 2106. The beam path travels through a zone of rotational tool movement, indicated by arrow 2060, to a first optic 2104, and to a second optic 2109. In this embodiment the first optic 2104 may be a collimating lens and the second optic may be a focusing optic, in which case the space 2105 of the beam path would be collimated space. The tool would have a first chamber 2111 that is in fluid communication with the inner core fluid jet 2113, and a second chamber 2121 that is in fluid communication with the outer annular fluid jet 2123. A nozzle for forming the fluid jets is also in fluid associated with these chambers, thus making up a nozzle assembly 2120. The focusing optic 2109 provides a focal point 2130 along the beam path 2106. In this manner the laser head, e.g., the optics 2104, 2109 and nozzle assembly 2120 may be rotated a full 360 degrees, which the optical fiber remains stationary. Vertical or longitudinal movement along the length of a borehole may be achieved by moving the conveyance structure, e.g., a wireline or coiled tube associated with the fiber, in and out, or up and down. A sliding assembly may be located in the area of the collimated space 2015 to provide for finer movements or adjustments that may be difficult to achieve with for example, a coiled tubing rig. A camera system may also be integrated with, or associated with, this tool, and in particular the laser head.

In general, the outer annular jets may function to protect the inner core jet from the medium that is present in the work environment. Thus, for example, in a work environment, such as for example the downhole environment of a borehole, or under the water off shore, fluid will likely be present. For example, such borehole fluids could include, by way of example, water, seawater, salt water, brine, drilling mud, air, nitrogen, inert gas, diesel, mist, foam, hydrocarbons, or drilling fluid. There can also be present in the borehole cuttings, e.g., debris, which are being removed from, or created by, the advancement of the borehole or other downhole operation. There can be present in the borehole two-phase fluids and three-phase fluids, which would constitute mixtures of two or three different types of material. As used herein, the term “mixture(s)” is to be given its broadest possible definition unless expressly stated otherwise, and would include, without limitation, combinations, solutions, suspensions, colloidal suspensions, emulsions and reverse emulsions.

Such work environment fluids can interfere with the ability of the laser beam to cut, or perform the desired operation, on the target, e.g., a work piece, a section of a work piece, a tubular, other downhole structures, or the earth formation. These work environment fluids can be non-transmissive or partially-transmissive to the laser beam, and thus interfere with, or reduce the power of, the laser beam when the laser beam is passed through such medium, i.e., the work environment fluid. The non-transmissiveness and partial-transmissiveness of the media can result from several phenomena, including without limitation, absorption, refraction and scattering. Further, the non-transmissiveness and partial-transmissiveness can be, and likely will be, dependent upon the wavelength of the laser beam. However, the actual phenomena or mechanism by which the medium reduces the laser beam power or otherwise interferes with the laser beam, as well as the wavelength of the laser, is of little import, because the annular jet removes this medium from the laser beam path and protects, by eliminating, reducing or significantly reducing the laser beam interaction with the medium. Thus, allowing the core jet to deliver the laser beam to the target unaffected, or substantially unaffected, by the work environment medium.

The core jet and the first annular jet should be made from fluids that have different indices of refraction. In the situation where the compound jet has only a core and an annular jet surrounding the core the index of refraction of the fluid making up the core should be greater than the index of refraction of the fluid making up the annular jet. In this way, the difference in indices of refraction enable the core of the compound fluid jet to function as a waveguide, keeping the laser beam contained within the core jet and transmitting the laser beam in the core jet. Further, in this configuration the laser beam does not appreciably, if at all, leave the core jet and enter the annular jet.

In the situation where multiple annular jets are employed, the criticality of the difference in indices of refraction between the core jet and the first (inner most, i.e., closes to the core jet) annular jet is reduced, as this difference can be obtained between the annular jets themselves. However, in the multi-annular ring compound jet configuration the indices of refraction should nevertheless be selected to prevent the laser beam from entering, or otherwise being transmitted by the outermost (furthest from the core jet and adjacent the work environment medium) annular ring. Thus, for example, in a compound jet, having an inner jet with an index of refraction of N₁, a first annular jet adjacent the inner jet, the first annular jet having an index of refraction of N₂, a second annular jet adjacent to the first annular jet and forming the outer most jet of the composite jet, the second annular jet having an index of refraction of N₃. A waveguide is obtained when for example: (i) N₁>N₂; (ii) N₁>N₃; (iii) N₁<N₂ and N₂>N₃; and, (iv) N₁<N₂ and N₁>N₃ and N₂>N₃.

The pressure and the speed of the various jets that make up the compound fluid jet can vary depending upon the applications, use environment or work environment medium. Thus, by way of example the pressure can range from about 3,000 psi, to about 4,000 psi to about 30,000 psi, to preferably about 70,000 psi, to greater pressures. The core jet and the annular jet(s) may be the same pressure, or different pressures, the core jet may be higher pressure or the annular jets may be higher pressure. Preferably the core jet is higher pressure than the annular jet. By way of example, in a multi-jet configuration the core jet could be 70,000 psi, the second annular jet (which is positioned adjacent the core and the third annular jet) could be 60,000 psi and the third (outer, which is positioned adjacent the second annular jet and is in contact with the work environment medium) annular jet could be 50,000 psi. The speed of the jets can be the same or different. Thus, the speed of the core can be greater than the speed of the annular jet, the speed of the annular jet can be greater than the speed of the core jet and the speeds of multiple annular jets can be different or the same. The speeds of the core jet and the annular jet can be selected, such that the core jet does contact the work environment medium, or such contact is minimized. The speeds of the jet can range from relatively slow to very fast and preferably range from about 1 m/s (meters/second), to about 50 m/s (meters/second), to about 200 m/s, to about 300 m/s and greater. The order in which the jets are first formed can be the core jet first, followed by the annular rings, the annular ring jet first followed by the core, or the core jet and the annular ring being formed simultaneously. To minimize, or eliminate, the interaction of the core with the work environment medium, the annular jet is created first followed by the core jet.

In selecting the fluids for forming the jets and in determining the amount of the difference in the indices of refraction for the fluids the wavelength of the laser beam and the power of the laser beam are factors that should be considered. Thus, for example, for a high power laser beam having a wavelength in the 1070 nm (nanometer) range the core jet can be made from an oil having an index of refraction of about 1.53 and the annular jet can be made from water having an index of refraction from about 1.33 or another fluid having an index less than 1.53. Thus, the core jet for this configuration would have an NA (numerical aperture) from about 0.95 to about 0.12, respectively.

Fluids of known and predetermined indices of refraction and transmittance for various wavelengths are readily available and known. For example, a fluid of mixed phthalate esters, that is colorless, having a pour point of >−45° C., a boiling point of >300° C. (760 nm Hg), a flash point >199° C. (COC), a density of 1.115 g/cc (25° C.), a density temperature coefficient of −00008 g/cc/C, thermal conductivity of 0.00032 cal/sec/cm²/° C.-1 cm thickness, a viscosity of 41 cSt (25° C.) and a surface tension of 39 dynes/cm (25° C.) has an index of refraction of about 1.522 at 1070 nm and 25° C. Further, such fluids can be acquired commercially, for example, from Cargill Laboratories, having a place of business in Cedar Grove, N.J.

Other fluids that may be useful, are silicon oil, diesel, kerosene, baby oil, and mineral oil. Further, for example, the outer annular jet(s) may be a liquid, e.g., one of the above mentioned liquids, and the inner jet may be a gas, e.g., air, oxygen, or nitrogen, or the inner jet may be a liquid.

Such fluids having predetermined indices of refraction can be costly and the volumes of fluid needed, relative to cost, can be large. For example, in some configurations about 20 to 30 gallons per hour of such fluids may be used. Thus, processes and systems for recovering, cleaning and reusing or otherwise recycling such fluids are desirable.

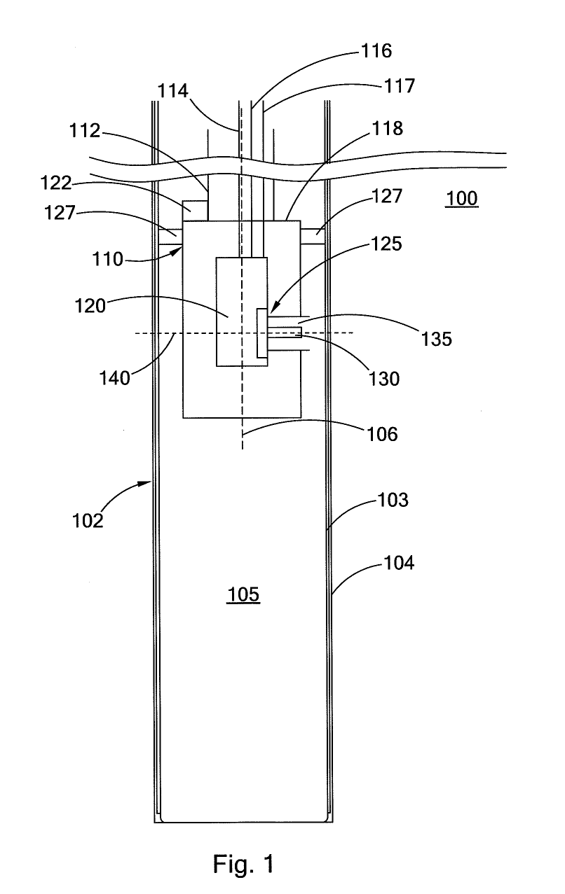

Turning to FIG. 1 there is provided an illustration of an example of a system for providing a laser compound fluid jet. Thus, there is shown a formation 100 in which there is a borehole 102, having a casing 103 and cement 104. The borehole 102 contains a borehole fluid 105, such as a drilling fluid, that is substantially non-transmissive to the laser beam, that is generated by a laser as discussed above but which is not shown in the figure. There is provided in FIG. 1 a laser tool 110 that is connected to a conveyance means 112, which in this illustration is coiled tubing, but could also be a composite tube, wireline, slick line, or conventional drill pipe. The conveyance means 112 has associated with it an optical fiber 114, which preferably can be an optical fiber of the type discussed above. The conveyance means 112 has associated with it a first fluid line 116, a second fluid line 117. The conveyance means 112 is connected to a laser tool housing 118. The optical fiber 112 is in optical communication and optically associated with the laser tool 110, the laser tool housing 118, and in particular the optical components in those structures. The first and second fluid lines 116 and 117 are in fluid communication with and are fluidly associated with the laser tool 110, the laser tool housing 118 and in particular the components used to create the fluid jets. The laser tool 110 also has positioning and holding devices 127 to maintain the position of the laser tool, determine the position of the laser tool, controllably advance or mover the position of the laser tool or all of the forgoing. This device is addressed further and in greater detail below in this specification. This device may be connected to a surface control unit, power unit by cables, such as optical, data, electrical, hydraulic, or the like.

There is provided in FIG. 1 an assembly 120 that has the optical components for focusing and delivering the laser beam to a target, the nozzle assemblies for creating the core and annular jet or jets, as well as, the components of these assemblies that launch or place the laser beam within the core jet. These components can be associated in a separate assembly, a housing, or can be positioned within the laser tool housing, or the laser tool, with or without the use of a separate housing, or additional structures, or housings. There is provided a nozzle 125 having an inner nozzle 130 for forming the core jet having the laser beam and an outer nozzle 135 for forming an annular jet that surrounds the core jet. There is further shown in FIG. 1 the centerline 106 of the borehole 102 and the jet axis 140 of the composite laser jet that will be formed by the nozzle and optics. The laser beam, the core jet and the annular jet will be coaxial with this jet axis 140.

There is further provided in the embodiment shown in the FIG. 1 a box 122, which is a schematic representation for logging, measuring, or analyzing equipment or tools that may be associated with the laser tool 110. Such tools 122 may be operationally associated with the positioning and holding device 127, either directly downhole hole, or through a control systems on the surface. Although shown as a box for the simplicity and clarity of the figure, these tools 122 are more complex, can be much larger, and may be located above, below or both with respect to laser tool.

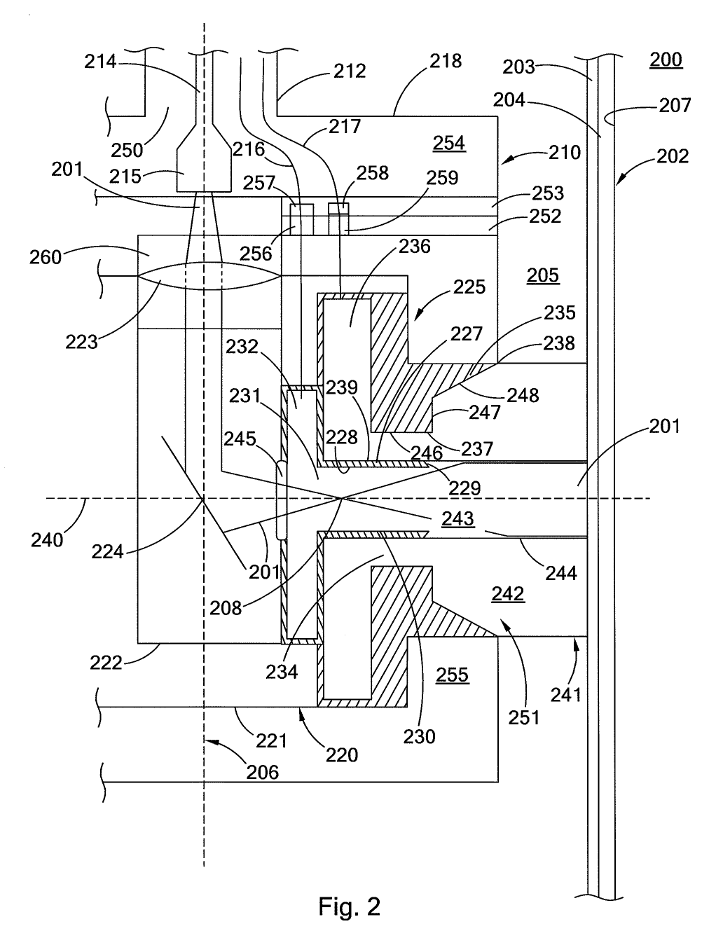

FIG. 2 is a more detailed illustration of an embodiment of a system for providing a laser beam for window cutting, milling, and perforating, downhole in a borehole work environment. There is provided a borehole 202 in a formation 200 that is located below the surface, not shown, of the earth. The borehole 202 has casing 203 and cement 204. The cement 204 fills the annular space between the borehole wall 207 and the casing 203. The borehole has a borehole centerline 206. The borehole is filled with a borehole fluid 205. There is provided a laser tool 210 that is connected to a conveyance means 212. The conveyance means 212 has associated with it an optical fiber 214, an optical connector 215, a first fluid line 216, and a second fluid line 217. This assembly is connected to the laser tool 210. The laser tool 210 has a laser tool housing 218, which has an inlet 250 for permitting the optical fiber 214, the first fluid line 216 and the second fluid line 217 to enter the laser tool 210. Thus, the inlet 250 provides an opening for the laser beam 201 and the fluids for the formation of the fluid jets 243, 242 to enter the laser tool 210 and the laser tool housing 218. If multiple annular jets are to be created additional fluid lines may be necessary or means to divide the fluids into multiple annular nozzles may be employed. The laser tool 210 has associated therewith, an assembly 220, which assembly includes a housing 221, an optics housing 222, collimating optics 223, focusing optics 224 and nozzle 225. There is further provided an inner nozzle 230, which forms the core jet 243, which functions as a waveguide for and transmits laser beam 201 to the casing 203 to be cut. The inner nozzle 230 has a stem 227, and an orifice 231. The stem 227 of the inner nozzle 230 has an inner surface 228 and an end 229. The shape of the end 229 can be sharp, blunt, rounded, angular or made up of several different surfaces. The shape of the end 229, along with other factors, such as for example, viscosity of the fluids, speed of the fluids, and pressure of the fluids, can be determined to provide a core jet and a core jet/annular jet boundary 244 or interaction that is desired. The inner nozzle 230 has a chamber 232 associated therewith for providing the first fluid to the orifice 231 of the inner nozzle 230. The first fluid chamber 232 has associated with it a window 245 for permitting the laser beam 201 to pass through the window 245 and enter into the orifice 231.

There is further provided in the embodiment shown in FIG. 2 an outer nozzle 235 for forming an annular jet 242. The annular jet 242 and the core jet 243 form a compound fluid jet, and the annular jet 242, the core jet 243, and the laser beam 201 form a compound fluid laser jet 241. The nozzle 235 is in fluid communication with chamber 236, which provides or holds the second fluid for use in the nozzle 235 to form the annular jet 242. The outer nozzle 235 has an annulus 234, a first inner surface 237, a second inner surface 239 and an end 238. The end 238 has a first end surface 246 (which in this embodiment is the same as inner surface 237), a second surface 247 and a third surface 248. These surfaces, their number, shape and angular relationship can be varied and changed to obtain the desired flow properties of the annular jet. The nozzle 225 forms a compound fluid laser jet 241 having a jet axis 240.

The laser optics provide a laser focal point 208. In the exemplary embodiment shown in FIG. 2 the laser focal point 208 is located in the core jet 243, at a point about ⅓ of the length of the inner surface 228 of the inner nozzle 230. The focal point 208, however, may be located at any point in the core jet along the length of the inner surface 228, in the chamber 232, the orifice 231, or in the core jet downstream from the end 229.

In addition to the inlet 250, there is provided an inlet 260 into housing assembly housing 221, and there is provided an outlet 251 for the first and second fluids and the laser beam to leave the laser tool 210 as it is directed along jet axis 240 to the target, which in the example of FIG. 2 is the casing 203, and subsequently, although not shown in the figure, in the case of perforating can be the cement 204 and the formation 200. The inlet 260 may be an open path, have one or more windows, have optics or combinations thereof, for transmitting, shaping or directing the laser beam 201 or permitting the fiber 214 or the connector 215 to be located within housing 221.

There is also provided in the exemplary embodiment shown in FIG. 2 a rotating component 252 and a telescoping component 253, which are associated with non-rotating section 254 and rotating section 255 of the laser tool 210. These components should preferably be configured to be associated with collimated space in the laser beam path, so that the transition from rotating to non-rotating structures, or the lengthening of a section will be in collimated space. In this manner the rotation of the jet, and thus the jet axis around the interior of the borehole can be accomplished. Further, the movement of the jet along the length of the borehole, or tubular to be cut, can be accomplished. Thus, the tool has the ability to cut windows in the casing, as well as any other predetermined shapes, such as circles, lines, vertical lines, horizontal lines, lines angled with respect to the length of the borehole, ellipses, squares, rectangles, triangles, other polygonal shapes. To accommodate the fluid lines, and permit this motion, rotating unions 256, 259 and telescoping unions 257, 258 can be employed. Instead of these unions, other means for accommodating the rotating and telescoping movements may also be utilized including the provisions of additional length of lines.

FIG. 3 is an illustration of another embodiment of a system for providing a laser beam for window cutting, milling, and perforating, downhole in a borehole work environment using a dual annular jet. This system of FIG. 3 is similar to the exemplary embodiment shown in FIG. 2, however in FIG. 3 the shape of the nozzles and in particular the end of the nozzles are changed. Thus, in FIG. 3 there is provided a borehole 302 in a formation 300 that is located below the surface, not shown, of the earth. The borehole 302 has casing 303 and cement 304. The cement 304 fills the annular space between the borehole wall 307 and the casing 303. The borehole centerline 306 is illustrated. The borehole is filled with borehole fluid 305. There is provided a laser tool 310 that is connected to a conveyance means 312. The conveyance means 312 has associated with it an optical fiber 314, an optical connector 315, a first fluid line 316, and a second fluid line 317. This assembly is operably associated with the laser tool 310. The laser tool 310 has associated therewith, an assembly 320, which assembly includes collimating optics 323, focusing optics 324 and nozzle 325. There is further provided an inner nozzle 330, which forms the core jet 343, which functions as a waveguide for and transmits laser beam 301 to the material or structure, i.e., the target, to be cut. The inner nozzle 330 has a stem 327, and an orifice 331. The stem 327 of the inner nozzle 330 has an inner surface 328 and an end 329. The shape of the end 329 can be sharp, blunt, rounded, angular or made up of several different surfaces. The shape of the end 329, along with other factors, such as for example, viscosity of the fluids, speed of the fluids, and pressure of the fluids, can be determined to provide a core jet and a core jet/annular jet boundary 344 or interaction that is desired. The inner nozzle 330 has a chamber 332 associated within for providing the first fluid to the orifice 331 of the inner nozzle 330. The first fluid chamber 332 has associated with it a window 345 for permitting the laser beam 301 to pass through the window 345 and enter into the orifice 331.

There is further provided in the exemplary embodiment shown in FIG. 3 an outer nozzle 335 for forming an annular jet 342. The annular jet 342 and the core jet 343 form a compound fluid jet, and the annular jet 342, the core jet 343, and the laser beam 301 form a compound fluid laser jet 341. The outer nozzle 335 has an annulus 334, a first inner surface 337, a second inner surface 339 and an end 338. The nozzle 335 is in fluid communication with chamber 336, which conveys the second fluid. The end 338 has a shape, which may be rounded, arcuate, smooth, sharp or other configurations, preferably the shape should be rounded or smoothed in a manner that reduces or minimizes the formation of eddies or ventures or other flows in the medium, e.g., the mud 305, that may tend to disrupt the jets. The nozzle 325 forms a compound fluid laser jet 341 having a jet axis 340.

The laser optics provides a laser focal point 308. In the example of FIG. 3 the laser focal point 308 is located in the core jet 343.

In the exemplary embodiment shown in FIG. 3 there is shown the core jet and laser cutting through and otherwise penetrating and removing the casing 303, the cement 304, the borehole wall 307 and portions of the formation 300. As shown in this figure, it is believed that as the laser beam penetrates into these structures, the outer annular jet will separate from the core jet, will not flow, or appreciably flow into the hole created by the laser beam; but will continue to protect the laser beam from the borehole fluid. In this way the core jet and the laser beam are isolated, or substantially isolated, from and protected, or substantially protected by the annular jet from the borehole fluid.

There is also provided in the embodiment shown in FIG. 3 a rotating component 352 and a telescoping component 353, which are associated with non-rotating section 354 and rotating section 355 of the laser tool 310. These components should preferably be configured to be associated with collimated space in the laser beam path, so that the transition from rotating to non-rotating structures, or the lengthening of a section will be in collimated space. In this manner the rotation of the jet, and thus the jet axis around the interior of the borehole can be accomplished. Further, the movement of the jet along the length of the borehole, or tubular to be cut, can be accomplished. Thus, the tool has the ability to cut windows in the casing, as well as, any other predetermined shapes, such as circles, lines, vertical lines, horizontal lines, lines angled with respect to the length of the borehole, ellipses, squares, rectangles, triangles, other polygonal shapes. It should further be noted that the conveyance means, such as, e.g., means 312, may also be used to move the laser tool longitudinally, rotationally, or both to direct, in whole or in part, the placement of the laser beam, or to deliver a predetermined beam pattern, to a target area on a work piece, such as a down hole tubular. To accommodate the fluid lines, and permit various types of motion, rotating unions 356, 359 and telescoping unions 357, 358 can be employed. Instead of these unions, other means for accommodating the rotating and telescoping movements may also be utilized including the provisions of additional length of lines.

The systems and laser tools can also have measuring and logging apparatus operably associated with them. In this manner the exact location, the location within the borehole, and the conditions of the formation at the location of the laser tool can be known and potentially known in real-time. Further, optical viewing apparatus can also be operably associated with the laser tool for downhole viewing. Thus, by way of example logging and measuring apparatus 380 are provided.

Further, the laser tools may also preferably have a device or devices to stabilize, centralize and determine and fix the location of the tool relative to the casing or borehole wall can also be operably associated with the laser tool. One, some, or all of these operations may be accomplished by a single assembly, or multiple components. The systems and apparatus provided in U.S. provisional application Ser. No. 61/374,594 and U.S. patent application Ser. No. 13/211,729 can be used in such applications, the entire disclosures of each of which are incorporated herein by reference. Further, a stabilizing tool such as a caliper system can be used to determine and set the distance between the object to be cut and the tool and the nozzle. In this way the precise distance that the tool, and thus the nozzle, are from the material to be cut, e.g., casing is known and can be determined. Moreover, a caliper system, which is capable of stabilize measure and adjust functions can position the tool in a non-concentric location, i.e., the centerline of the tool may be different than the centerline of the borehole. In this way distance determination and position can be adjusted and optimized. Further such caliper systems are capable of moving along the length of the borehole, proving stabilizing while moving along the length of the borehole, and thus providing even greater control and flexibility in the predetermine shapes and cuts that are obtained from such laser tools. Thus, such a system would have the addition of caliper style “arms”, likely a three point (may be more) mechanism, to the laser tool, this would stabilize the assembly and provide a predetermined distance from the wall, item or object to be cut. The use of conductors in association with a laser tool system could be implemented much like a wireline (“WL”) caliper tool and could measure the distance and allow vertical travel of the tool while maintaining the appropriate distance to the target, e.g., the area of a tubular to be cut. The system could also then be used to move the laser forward to and away from the target for the optimum position.

Thus, by way of example a centralizer 381, is provided in the example shown in FIG. 3, which also has the ability to fix the tool in a position in the borehole by applying a force against the casing. It should be noted and is readily seen from the drawing that only slightly more than half of the borehole is shown in FIGS. 2 and 3. As such it should be understood that other centralizers, not shown, would also be positioned against the borehole or casing wall, not shown, and located opposite to, or at an appropriate force balancing location and in an appropriate force balancing number, to the centralized 381. Further, annular and multiple apparatus can be utilized, and the force, or forces exerted by these apparatus balanced.

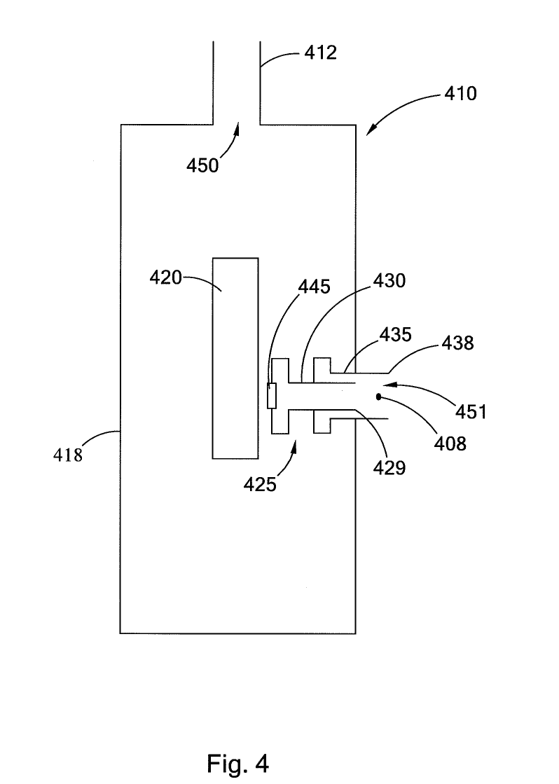

FIG. 4 provides an illustration of a further example of a laser tool system. In this example there is provided a laser tool 410, a laser focal point 408, a composite tube 412, a housing 418, an optics assembly 420, a first nozzle 430 having an end 429, a second nozzle 435 having an end 438 and a window 445. The laser tool also has an inlet 450 and an outlet 451. The first nozzle 430 is used to form a core fluid jet that contains and the laser beam. The second nozzle 435 is used to form an annular fluid jet that surrounds the core fluid jet. This example provides a showing of one of many varied relative positionings of the first and second nozzles.

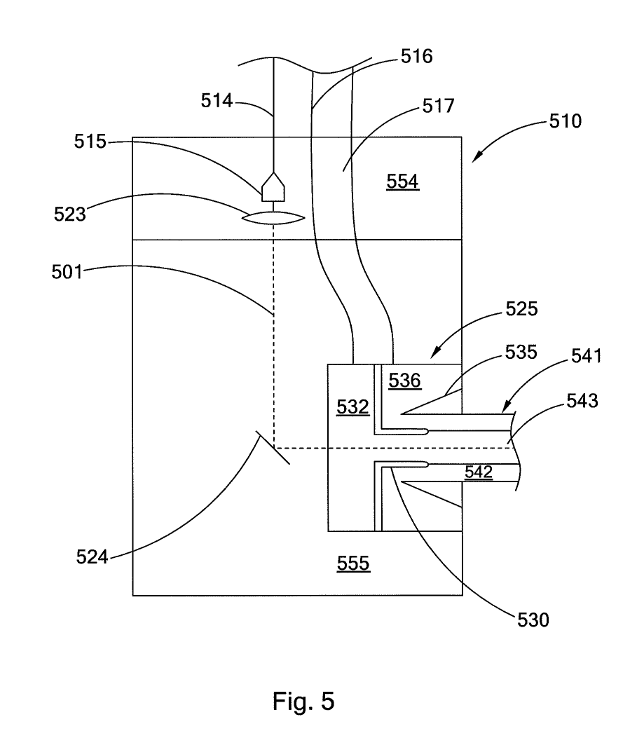

In FIG. 5 there is provided an illustration of an example of a laser tool system. Thus, there is provided a laser tool 510, a non-rotating section 554 of the laser tool 510 and a rotating section 555 of the laser tool 510. Associated with the non-rotating section 554 is the collimating optics 523, the optical fiber 514 and an optical connector 515. Thus, the laser beam 501 can be transmitted downhole to the laser tool 510 by optical fiber 514, which may also be a plurality of fibers, to optical connector 515 and launched, or otherwise delivered to the collimating optics 523. The collimated beam then leaves the collimating optics 523 and travels to the focusing mirror 524, which is associated with the rotating section 555 of the laser tool 510. In this way the laser beam can be transferred from the non-rotating components of the laser tool to the rotating components of that tool. Further, a separate optical slip ring type assembly may be used to transition the laser beam for non-rotating to rotating components. The transfer as shown in FIG. 5 however, is the presently preferred way to accomplish such a transfer. The fluids for the jet are supplied by feed lines 516, 517. These lines have sufficient slack in them to provide for the nozzle to make slightly more than one complete rotation. In this way any beam pattern that is delivered will be able to be delivered to the entire interior of a borehole.

In FIGS. 6A and 6B there is provided a perspective cut away view (FIG. 6A) and a plan view (FIG. 6B) of a compound fluid laser jet 600 cutting a material 601, e.g., a piece of metal, concrete, or a section of a tubular. The compound fluid laser jet 600 has a laser beam in an inner core jet 602, which jet is surrounded by an annular jet 603. (In FIG. 6A a portion of the annular jet 603 is cut away to show the inner jet 602.) The movement of the jet 600 relative to the material 601 is shown by arrow 605. The kerf 604 or cut of removed material is also shown. The angle at which the beam and the jet impact the material is shown by angle 606, which is the angle formed between the axis 615 of the jet 600 and the surface of the material 601 in the direction of travel 605 (when the jet and laser are coaxial, otherwise this angel would be the angle of the laser beam and the direction of movement). This angle can be greater than 90°, less than 90°, 90° and can range from about 0° to about 180° depending upon the particular jet, laser, material and if present, borehole or other optically interfering material, such as a borehole fluid. The same or similar determination would be used for determining the angle at which a single fluid jet, liquid or gas strikes the work surface.

The diameter of the core fluid jet can be any diameter that optically corresponds with the beam size that is provided to the laser tool. Preferably, the core fluid jet is from about 200 to 600 microns, less than or equal to about 1000 microns, and most preferably about 400 microns.

In addition to the waveguide features of the compound fluid jet methodology, this approach further provides the ability to maintain the power of the laser beam energy as it first strikes the object, such as the casing. Because the core functions as a wave guide and the core, and thus beam are prevented from expanding as the beam travels from the tool to the object, the power, e.g., energy/unit area, of the beam is maintained. Thus, one of the purposes of the annular fluid jet(s) is to maintain the core jet and thus, the laser beam, in as tight a formation as possible, so that the power density will remain sufficient to perform the intended operation on the material, e.g., cut the casing. The fluid may also be used to help push molten material from the cut, as well as, uses depending upon the force, flow rate, pressure, configuration and environment factors.

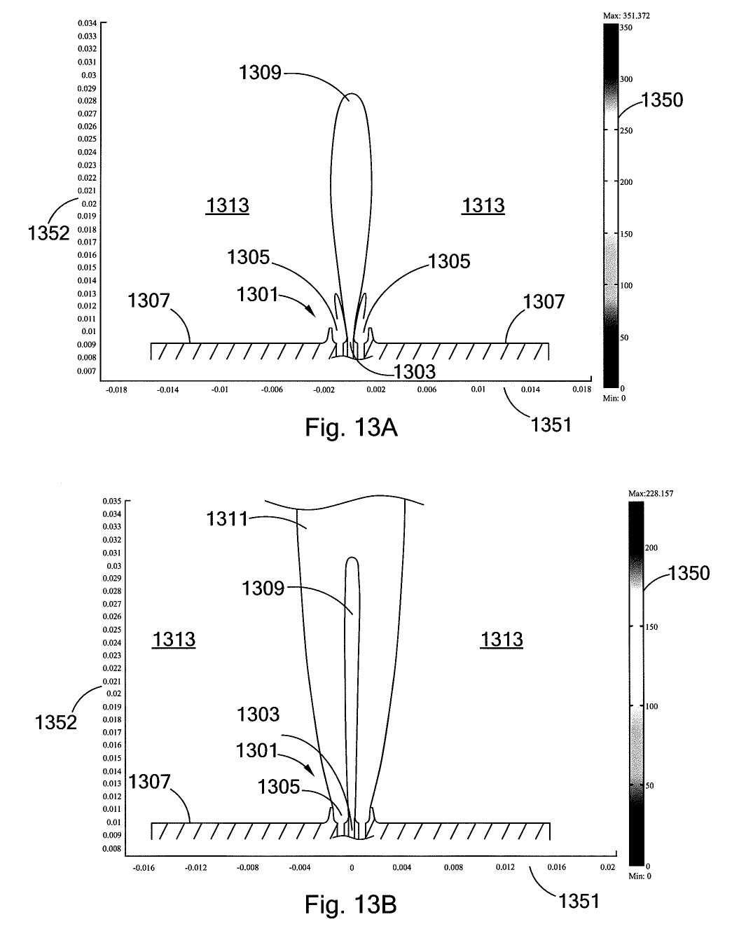

The ability and effects of an outer annular jet to control the size of the core jet, and assist in the advancement of the core jet through an environmental medium are shown, in general, in FIGS. 13 to 16. These figures are computer models, or simulations, using COMSOL Multiphysics. In general they show surface velocity using a streamline analysis and particle trace analysis of the core jet, with and without the annular jet in an aqueous environmental medium. The streamline analysis models the speeds at which the fluids are moving and the particle trace analysis models the path that a particle in the fluid would take. Further, the particles travel is used to understand the momentum of the fluid jet. Thus, in general a particle, which is a means for measuring flow, should behave according to the simulations.

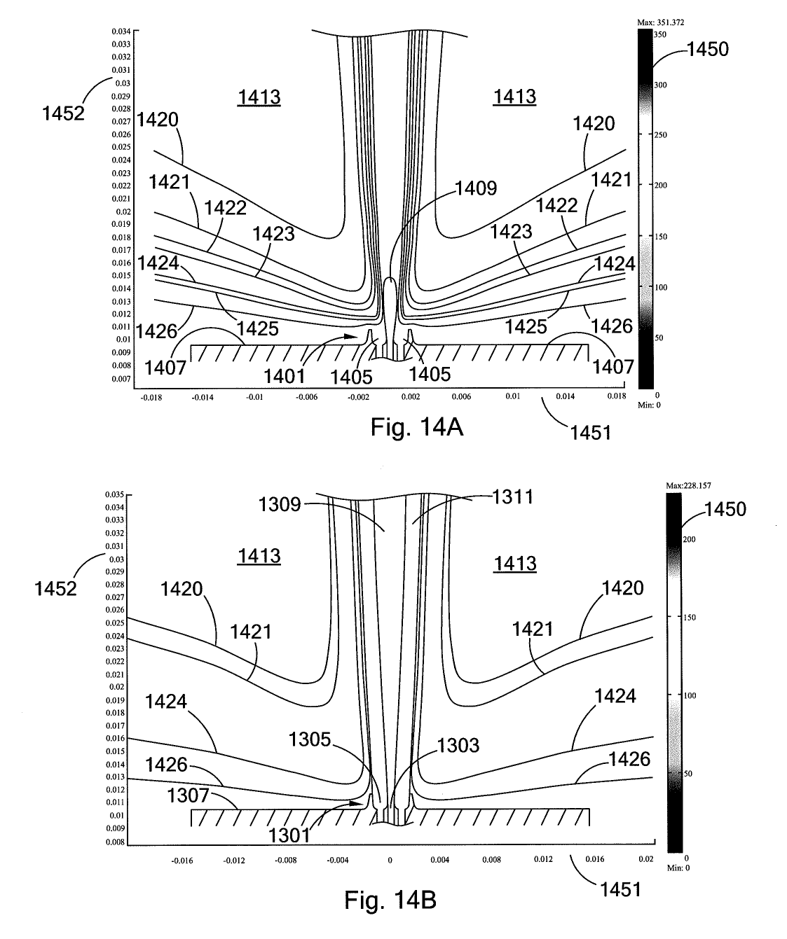

Turning to FIG. 13A there is shown a particle tracing velocity model and in FIG. 14A there is shown a streamline velocity model for an inner core jet 1309, made up of oil, in static drilling mud 1313 at 14 psi. In these models the laser tool 1307 has a nozzle assembly 1301, having an inner nozzle 1303 for forming the inner core jet and an outer annular nozzle 1305, for forming an outer annular jet (not formed, or shown in FIGS. 13A, 14A). The inner jet 1309 is at 3000 psi in the aperture of the inner nozzle 1303. The nozzle 1303 aperture diameter is about 400 microns.

The two models viewed together show that the effective depth of penetration for jet 1309 is about 2 cm (although the particle trace FIG. 13A shows the jet extending to 3 cm, the streamline model FIG. 14A, shows that by about 2 cm the jet has essentially lost all of its velocity). The models further show that the jet spreads from 600 microns upon leaving the nozzle 1303, to over 2 mm in diameter. Further, and in particular in the stream line analysis model, the various streamlines 1420, 1421, 1422, 1423, 1424, 1425, 1426, show that there is a rapid deterioration of the jet 1309 as the drag induced on the jet 1309 by the mud 1313 causes the jet 1309 to break down. These streamlines represent entrainment flow streamlines as a result of the drag on borehole fluid by the jet.

In FIGS. 13B and 14B there is shown the same nozzle and core jet configurations as in 13A and 14A (thus, like numbers correspond to like items), except that the outer annular jet 1311 has been added. The outer annular jet 1311 is water, at about 3,000 psi in the aperture of the annular nozzle 1305. The outer annular jet upon exiting the nozzle has an outer diameter of about 1 mm, and as the outer jet progress through the mud 1313 its outer diameter increase to almost about 4 mm. Significantly, in the presence of the outer jet, the diameter of the inner jet no longer increase to over 2 mm, instead the forces from the outer jet enables the inner jet to remain tightly formed, expanding to only about 800 microns. In particular, the streamline analysis FIG. 14B, shows that there is a rapid deterioration of the outer jet 1311 as the drag induced on the jet 1311 by the mud 1313 causes the jet 1311 to break down. This analysis further shows that the inner jet 1309 is to a substantial extent shielded from any of this induced drag by the outer jet 1311. The streamline analysis, FIG. 14B also shows that the inner jet 1309 essentially maintains it velocity well beyond 2 cm.

The scales 1350/1450 are the fluid velocity legend in m/sec., the scales 1351/1451 are legends that provide the distance from the center of the nozzle in meters, e.g., the diameter of each jet, and the scales 1352/1452 provide the depth of penetration of each jet in meters.

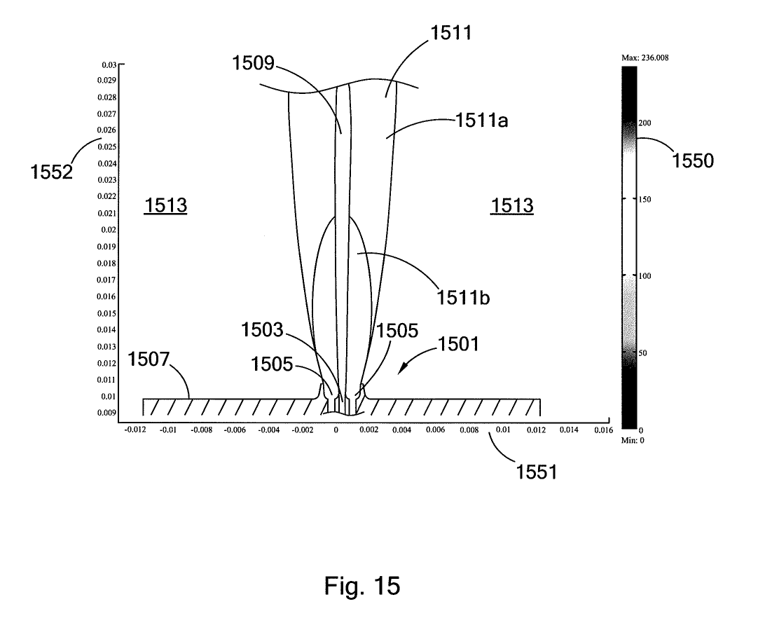

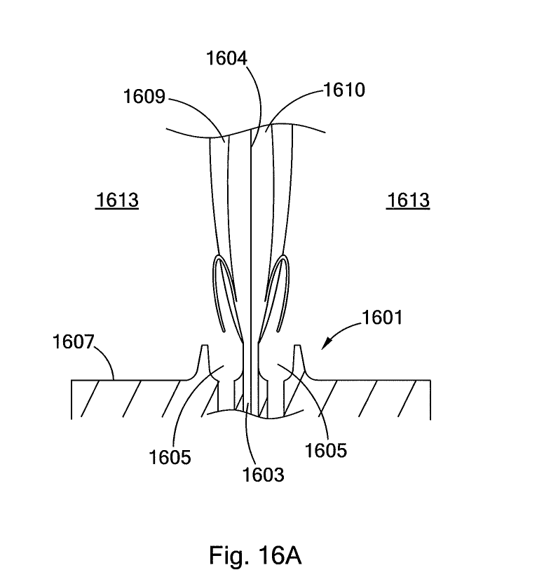

Referring now to FIG. 15 there is shown a model of a particle trace velocity analysis for a dual fluid jet. In this model the laser tool 1507 has a nozzle assembly 1501, having an inner nozzle 1503 for forming the inner core jet 1509 of oil; and an outer annular nozzle 1505, for forming an outer annular jet 1511 of water. The environmental medium 1513, is a drilling mud at 14 psi. The inner jet 1509 is at 4,000 psi, in the aperture the inner nozzle 1503; and the outer jet 1511 is at 6,000 psi in the aperture of the annular nozzle 1505. The inner nozzle 1503 aperture diameter is about 400 microns. The higher-pressure annular jet 1511, as compared to the annular jet 1311 of FIGS. 13B and 14B, provides greater confinement of and protection for the inner jet 1509. Thus, in this model, FIG. 15, the inner annular jets diameter expands to only about 630 microns. In this model there is further seen two separate zones of the annular jet, and inner zone 1511b and outer zone have greater deterioration 1511a.

The scales 1550 is the fluid velocity legend in m/sec, the scale 1551 provides the distance from the center of the nozzle in meters, e.g., the diameter of the jets, and the scale 1552 provides the depth of penetration of the jets in meters.

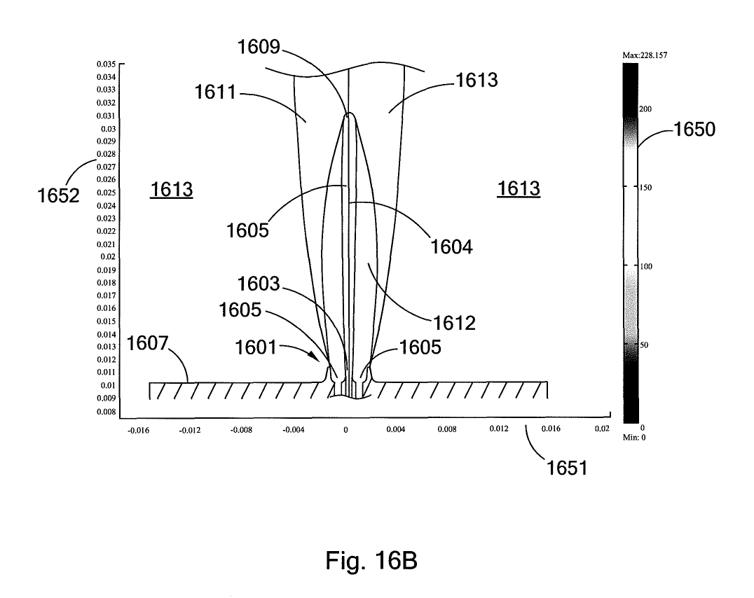

Turning now to FIGS. 16A and 16B, there are provided particle trace velocity models of a nozzle showing the laser beam path and laser beam. In this model the laser tool 1607 has a nozzle assembly 1601, having an inner nozzle 1603 for forming the inner core jet 1609 of oil; and an outer annular nozzle 1605, for forming an outer annular jet 1611 of water. The environmental medium 1613, is a drilling mud at 14 psi. In FIG. 16A there is shown a close up of the inner jet 1609, without the outer jet. It can be seen from this model that there is substantial drag and deterioration of the inner jet as seen in zone 1610 of inner jet 1609. A laser beam path 1604 is shown, but the laser beam is not being propagated in this model. In FIG. 16B, the outer annular jet 1611 is utilized. This jet 1611 has an inner zone 1611 and an outer zone 1613, which outer zone 1613. A laser beam 1605 is propagated along beam path 1604, and extend to and slightly beyond the end of the inner jet 1609.

The scales 1650 is the fluid velocity legend in m/sec., the scale 1651 provides the distance from the center of the nozzle in meters, e.g., the diameter of the jets, and the scale 1652 provides the depth of penetration of the jets in meters.

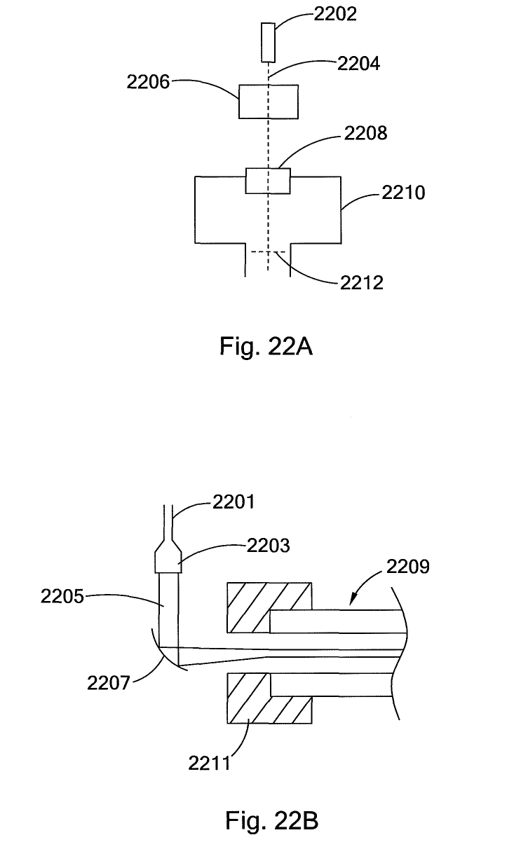

A single imaging (or reimaging) optic may be used to launch the beam or transfer from the rotating to non-rotating sections of the laser tool with the imaging place being located in the area of the nozzle. Thus, as shown in FIGS. 22A and 22B there is provided general schematic overviews of embodiments of tools using such optics. In the embodiment of FIG. 22A there is an optical fiber 2202, a laser beam path 2204, a reimaging optic 2206, a window 2208, a nozzle assembly 2210. An image plane 2212 is located along the beam path 2204, preferably in the area of the nozzle and more preferably after the core or inner fluid jet has formed. In the embodiment of FIG. 22B the is provided an optical fiber 2201, having a connector 2203. The laser beam 2205 is launched from the connector 2203 to an imaging optic 2207, which redirects and images the laser beam 2207 into a dual fluid jet 2209 formed by a dual nozzle 2211. The imaging (or reimaging) optics may include, for example, a finite conjugate lens, which is optimized for imaging a pair of infinite conjugate lenses, which collimate and refocuses the object to the image plane. The optic can be any combination of plano-convex, bi-convex-meniscus and aspheric. They may also be for example, refractive optics, shaped mirrors, lens arrays, diffractive optics, Fresnel lenses, or any combination thereof,

A high-pressure laser liquid jet, having a single liquid stream, may be used with the laser beam. The liquid used for the jet should be transmissive, or at least substantially transmissive, to the laser beam. In this type of jet laser beam combination the laser beam may be coaxial with the jet. This configuration, however, has the disadvantage that the fluid jet, in typical uses, will not act as a wave-guide. A further disadvantage with this single jet configuration is that the jet must provide both the force to keep the drilling fluid away from the laser beam and be the medium for transmitting the beam. The laser heads or nozzles for forming a single liquid jet may be used with, or incorporated into an annular nozzle to form a compound fluid jet.

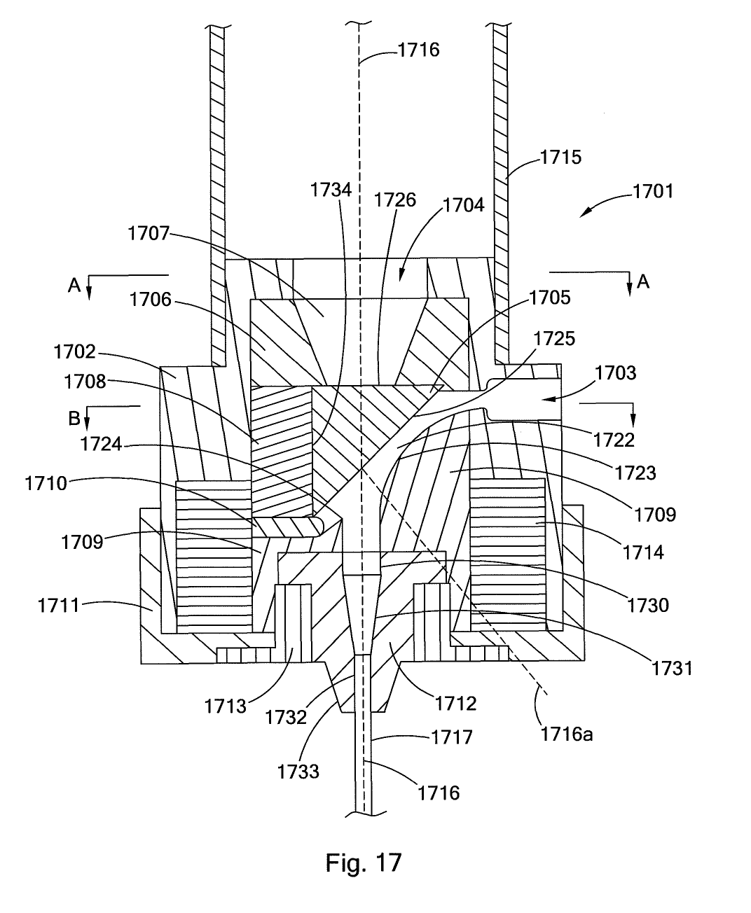

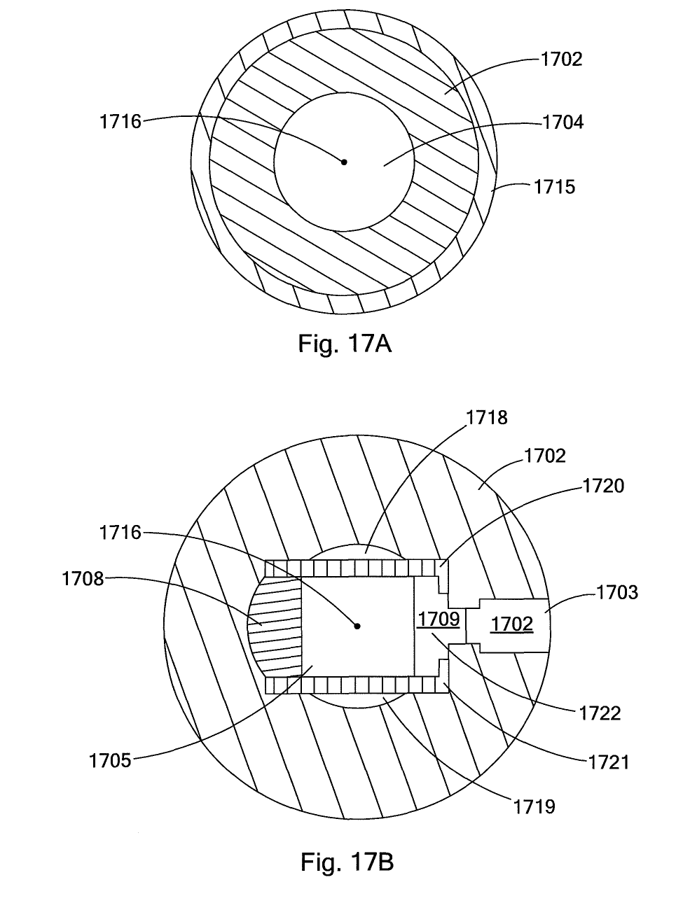

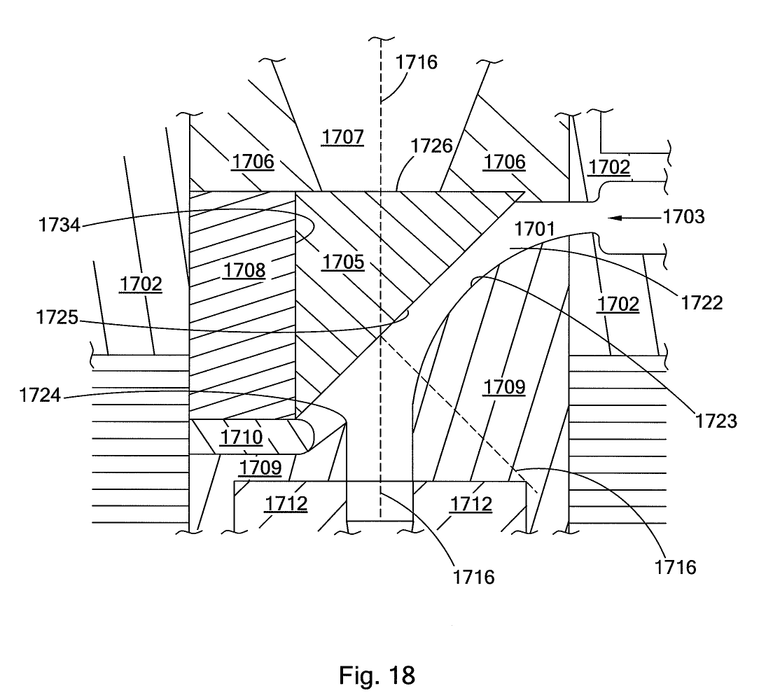

An example of a nozzle configuration for providing a single liquid jet is provided in FIGS. 17, 17A, 17B, 18 and 19. FIGS. 17A and 17B are transverse cross sections of the embodiment of FIG. 17 taken along lines A-A and B-B respectively. FIG. 18 is an enlarged view of the prism and flow passage area of the laser head assembly of FIG. 17.

Turning to FIG. 17 there is shown a laser head assembly 1701 having a housing 1702. The housing 1702 has a fluid port 1703 for receiving a liquid to form the liquid jet 1717 and a laser beam path opening 1704 for receiving a laser beam. The laser beam path 1716 is shown through the laser head assembly 1701. Along the beam path 1716, within the housing 1702, there is a prism engagement member 1706, having a laser beam path opening 1707. The prism engagement member 1706 is located between the prism 1705 and an inner surface of the housing 1702. The prism 1705 is located within the laser beam path 1716 and has a beam entry face 1726 and a beam exit face 1725. A prism supporting and positioning member 1708 is located between the inner surface of the housing 1702 and the face 1734 of the prism, which face is not in the laser beam path 1716.

There is a flow path creating member 1709 that has a first curved surface 1723 and a second curved surface 1724. The exit face 1725 of the prism 1705 and the first curved surface 1723 and the second curved surface 1724 form a liquid flow chamber 1722. There is also a flow plug 1710 in the liquid flow chamber 1722. The flow plug 1710 may be removed providing for the recirculation of the liquid through recirculation ports 1718, 1719.

The laser head assembly 1701 at its bottom end has a bottom cap 1711 and a locking ring 1713. The locking ring 1713 engages the bottom cap 1711 and a nozzle 1712. The nozzle has an inner flow path having three sections, a first section 1730, a second tapered section 1713, and a third section 1732. The inner diameter of the first section 1730 may be, for example, two, three or more times larger than the inner diameter of the third section 1732. The length of the second section may be, for example from about the same as the diameter of the first section to about twice as long as the diameter of the first section, or longer. The size and shape of these sections depends upon factors such as the viscosity of the liquid and the intended pressures and flow volumes of the jet. Additionally the profile of the laser beam is a consideration, as the beam should not contact the nozzle components or surfaces. Preferably the inner diameter third section 1732, which forms the aperture for the nozzle, is from about 400 microns to about 2000 microns, and preferably about 600 microns to about 1500 microns. The nozzle 1712 has a tip 1733 that extends beyond the bottom of the locking ring 1713.

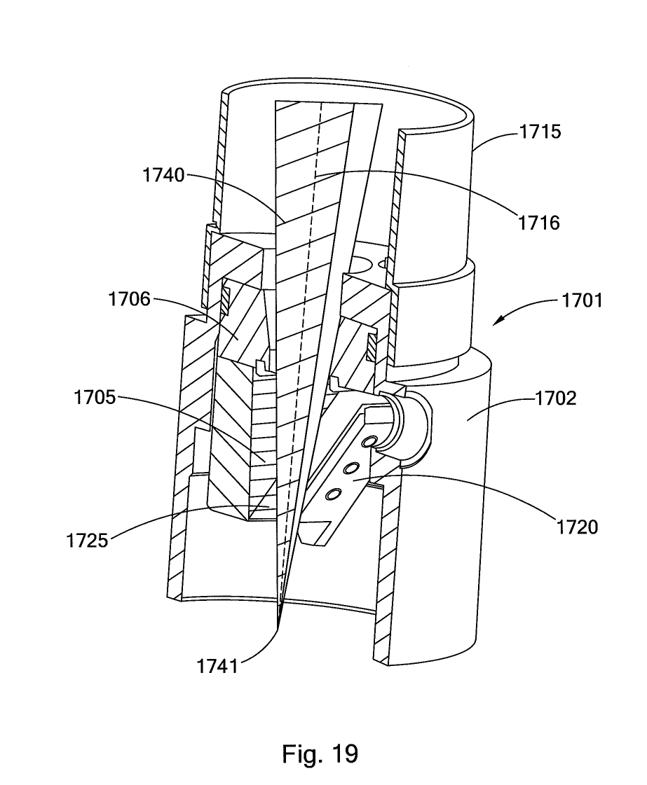

Referring to FIG. 19 there is provided a cross sectional perspective view of the laser head 1701, with its lower components (e.g., nozzle 1712, flow path creating member 1719, locking ring 1713 and cap 1711) removed and the laser beam 1740 traveling along beam path 1716 being shown.

In operation a liquid is pumped under pressure into flow port 1703. The liquid flows into flow chamber 1722 and from flow chamber 1722 into nozzle 1712. The liquid exits nozzle 1712 as a fluid jet. The laser beam is focused by optics not shown in the figures, and travels along beam path 1716 through opening 1704, opening 1706 and enters into prism 1705 through prism face 1726. The laser beam travels through prism 1705 and, if a liquid is not present, exits prism face 1725 along beam path 1716a. Beam path 1716a travels into and through the lower components of the laser head and if a high power laser beam traveled along that path 1716a it would damage those components. If a liquid having a predetermined index of refraction is present in the chamber 1722, the laser beam will stay on and follow beam path 1716 and enter into the liquid at face 1722 and travel into the nozzle 1712 and exit the nozzle 1712 within the liquid jet 1717.

In order for the laser beam to travel along the entirety of laser beam path 1716, and thus enter the nozzle, the indices of refraction of the liquid and of the prism must be matched. By matched it is meant that the indices are identical, essential the same, or within about + or −5% different and within about + or −10% different. Further, this difference should generally should be small enough as to permit the laser beam to enter into the fluid without substantial reflections. To the extent that the indices are not identical the angle and position of the prism 1705 and in particular the angle of face 1725 can be adjusted, such that any shifting of the beam path resulting from the index change as the beam travels from the prism to the fluid, will be compensated for; and thus, the beam path and beam will be directed into the nozzle and not contact any of the components of the laser head.

The configuration of face 1725, and surfaces 1723 and 1724 affect the flow characteristics of the liquid as it moves through the chamber 1722. Thus, it is preferable to have surfaces 1723 and 1724 curved and configured to avoid, or minimize, the formation of any vortices and stagnation zones that would be contacted by, or interact with, the laser beam as it travels through the liquid into the nozzle. Preferably, sharper corners on surfaces 1724, 1723 should be avoided. It is also preferable to configure face 1725 and surfaces 1723 and 1724 to provide the higher flow rates, and avoid stagnation zones, at the face 1725 of the prism 1705. This enables the laser beam to be at a higher power density at face 1725, without overheating, or damaging the liquid or the face 1725.

To the extent that thermal lensing issues may arise (thermal lensing in general is a phenomena where the index of refraction of a fluid, in this case the liquid, changes as its temperature changes, and thus changes the laser beam) they may be dealt with by making the internal surfaces of the chamber 1722 and the nozzle 1712 from highly reflective materials. In some instances these thermal lensing effects are desirable in that they enable the nozzle to more readily combine the laser beam and the fluid jet.

The laser beam 1740 is focused by optics not shown. The laser beam has a focal point 1741 along the beam path 1716. Preferably the focal point 1741 may be located within the second section of the nozzle 1731, or within the third section of the nozzle 1732.

The focal point, laser beam properties, laser beam power density at locations along the beam path, the configuration of the chamber 1722, the characteristics of the liquid, the flow rates and pressures of the liquid in operation, and other facts, such as the operating environmental conditions, should be considered and balanced in configuring this laser head. Thus, by way of example, for a 20 kW laser beam, being delivered to the laser tool from an optical fiber having a core diameter of about 400 to 1000 microns, for use in a borehole contain drilling mud at a pressure of 10,000 psi, the prism may be made from fused silica, Infrasil, Suprasil, sapphire, ZnS (Zinc Sulfide) and have an index of refraction of 1.45 for Suprasil, the angle of face 1725 with respect to face 1726 may be 45 degrees, the liquid may be a silicon oil having for example the properties as follows: viscosity at 25 C, cSt. from about 10 to 500; viscosity at 99 C, cSt. from about <5 to about 35; viscosity temperature coeff. from about 0.78 to 0.88; index of refraction from about 1.490 to 1.588; and molecular weights from about 350-2700. Commercially available silicon oils may be obtained from, for example Gelest, Inc., and would include PDM-1992, -5021, -0011, -0021, -0025, -5053, -7040, -7050.

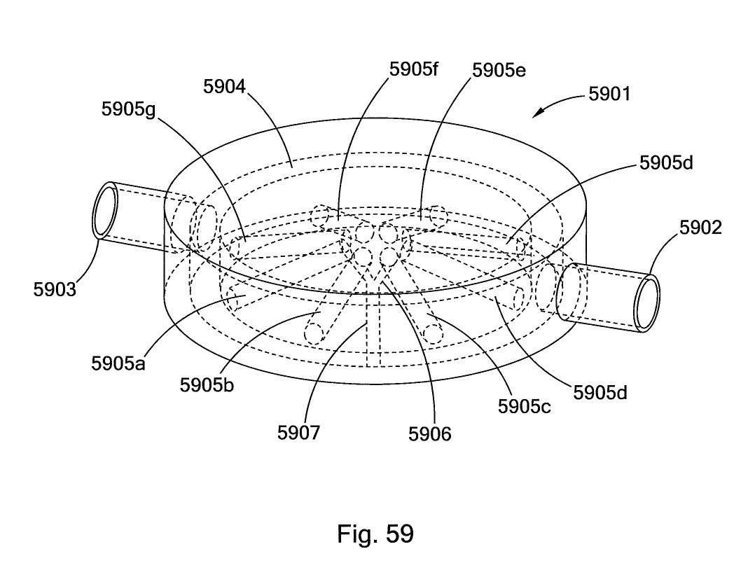

Turning to FIG. 59 there is shown a perspective view of a nozzle assembly 5901. The nozzle assembly has a first fluid inlet 5902, a second fluid inlet 5903, which are in fluid communication with an annular chamber 5904. The annular chamber 5904 is in fluid communication with nozzle feed passages 5905a, 5905b, 5905c, 5905d, 5905e, 5950f, 5905g. These feed passages are in fluid communication with a nozzle cone 5906 having a nozzle tube 5907.

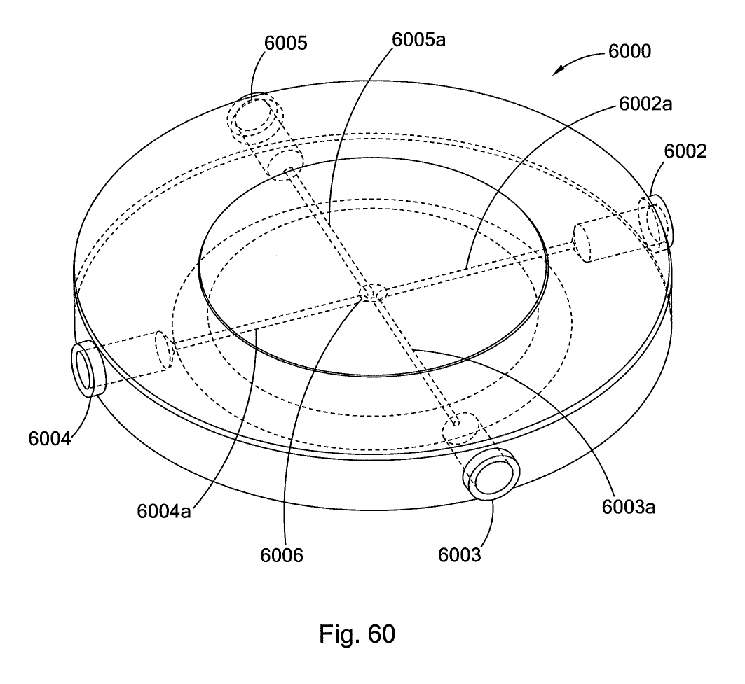

Turning to FIG. 60 there is shown a perspective view of a nozzle assembly 6001. The nozzle assembly has a four fluid intakes 6002, 6003, 6004, 6005, which each feed fluid intake passages 6002a, 6003a, 6004a, 6005a. These fluid intake passage feed nozzle 6006.

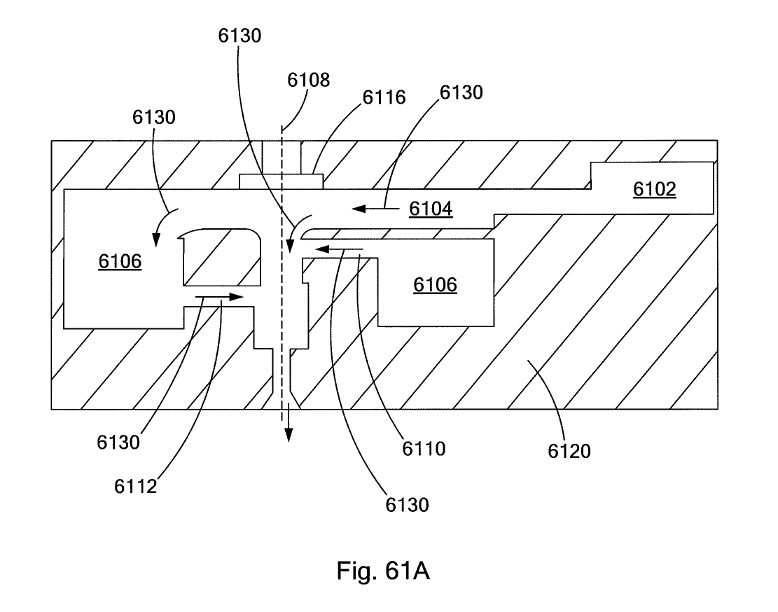

FIG. 61A is a cross-sectional view of a nozzle assembly have several ancillary chambers and FIG. 61B is a perspective cross-section cutaway of some of the components of this nozzle assembly. The nozzle assembly has a body 6120 that has a fluid inlet 6102, which feeds a window flow chamber 6104 (fluid flow is shown by arrows 6130). The fluid flows past window 6116 that has a laser beam path 6108. The fluid flows into the nozzle chamber that is parallel and coincident with the beam path 6108. The fluid may also flow into annular flow access chamber 6106, which flows in passages 6112, 6110 back to the laser beam path 6108. The laser beam 6114 following beam path 6108 is shown in FIG. 61B.

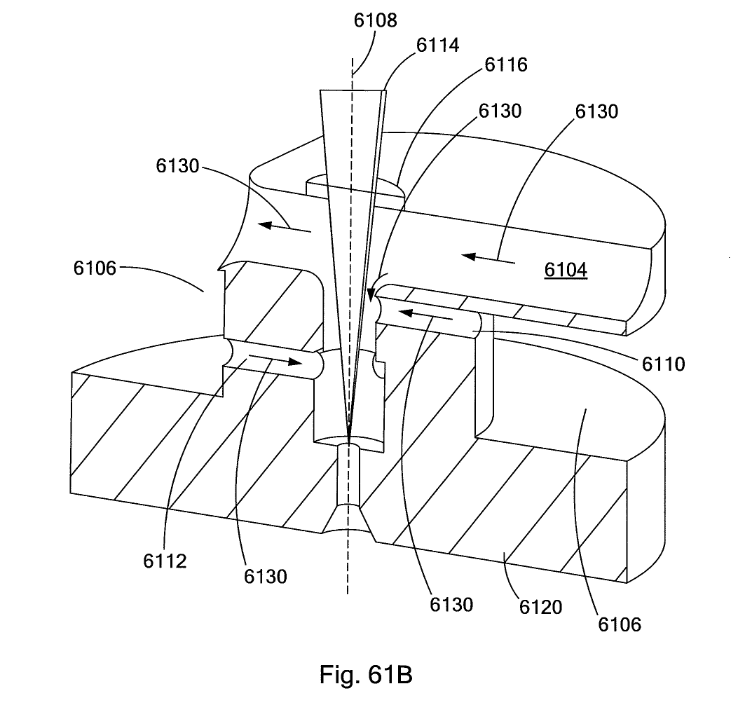

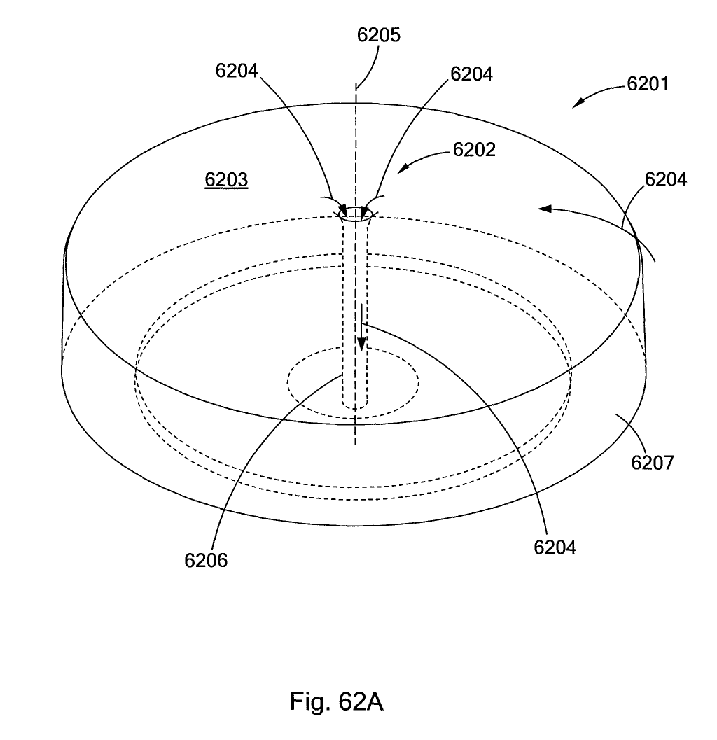

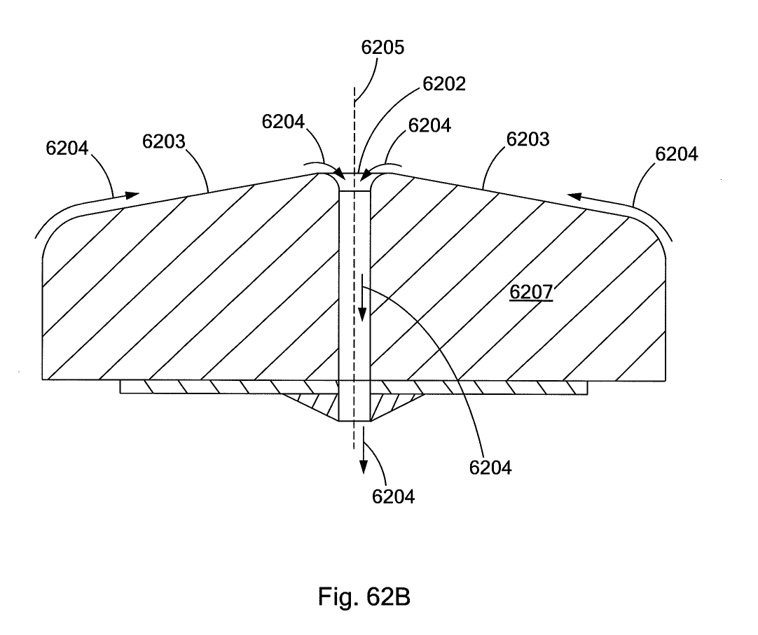

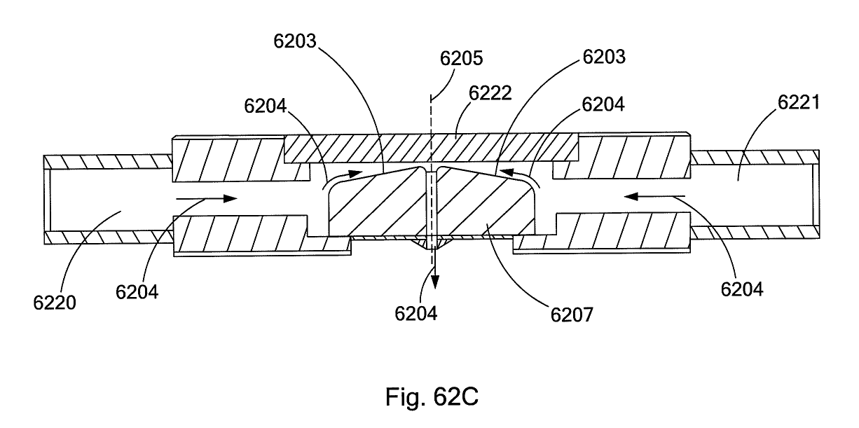

FIGS. 62A to 62C show a nozzle 6201 that has a body 6207 and a flow intake surface 6203. The fluid flow is shown by arrows 6204. The fluid flows along flow surface 6203 and into opening 6202 and tube 6206. The laser beam path 6205 travels through the opening 6202 and tube 6206. The nozzle 6201 is configured in a nozzle assembly having inlets 6220, 6221 and a window 6222.

A way to manage the change in refractive index with temperature is to design the nozzle as a non-imaging concentrator. The nozzle material would either be a highly reflective metal, Al An, etc. or a glass with a lower index of refraction than the fluid in the jet. If the fluid has an index of 1.5, than fused silica with an index of 1.45 would be suitable. The non-imaging concentrator would accept a wide range of beam angles, collecting the light and transferring it to the fluid jet. The non-imaging concentrator should not increase the NA to beyond the NA of the jet or the compound jet.

The laser tool may have a laser head that uses a gas jet with the laser beam. Preferably the jet is a high-pressure jet, which may be used to clear a path, or partial path for the laser beam. The gas may be inert, or it may be air, nitrogen, oxygen, or other type of gas that accelerates, enhances, or controls the laser cutting. The gas jet may be used alone, as a single jet, or it may form the inner or core jet for a compound fluid jet.

Turning to FIG. 55 there is provided a general schematic of an embodiment of a high power laser cutting head using a gas jet, a long focal length and having a large depth of field. Thus, the laser cutting head 5501 (shown in phantom lines) is associated with an optics assembly 5502 (partially shown and in phantom lines), which assembly takes the laser beam from a conveyance structure, focuses the laser beam (the optics assembly may also perform additional or other functions to effect beam properties) and provides the laser beam 5509 along a laser beam path 5507. The laser beam 5509 traveling along beam path 5507 is reflected by mirror 5506 (at for example a right angle as shown). The beam and beam path enter into nozzle 5503 that forms a gas jet 5508. The gas jet 5508 may be, for example, air, oxygen, nitrogen, an inert gas, a cutting gas, or a super critical fluid. The face 5510 of the nozzle 5503 may be tapered outwardly, as provided by surfaces 5504, 5505.

Focal lengths may vary from about 40 mm (millimeters) to about 2,000 mm, and more preferably from about 150 mm to about 1,500 mm, depending upon the application, material type, material thickness, and other conditions that are present during the cutting. The jet velocity may be about 100 to about 10,000 f/s and from about 100 to about 5,000 cf/m, depending upon the application, material type, material thickness, and other conditions that are present during the cutting.

The mirror may be any high power laser optic that is highly reflective of the laser beam wavelength, can withstand the operational pressures, and can withstand the power densities that it will be subjected to during operation. For example, the mirror may be made from various materials. For example, metal mirrors are commonly made of copper, polished and coated with polished gold or silver and sometime may have dielectric enhancement. Mirrors with glass substrates may often be made with fused silica because of its very low thermal expansion. The glass in such mirrors may be coated with a dielectric HR (highly reflective) coating. The HR stack as it is known, consists of layers of high/low index layers made of SiO₂, Ta₂O₅, ZrO₂, MgF, Al₂O₃, HfO₂, Nb₂O₅, TiO₂, Ti₂O₃, WO₃, SiON, Si₃N₄, Si, or Y₂O₃ (All these materials would work for may wave lengths, including 1064 nm to 1550 nm). For higher powers, such as 50 kW actively cooled copper mirrors with gold enhancements may be used. It further may be water cooled, or cooled by the flow of the gas. Preferably, the mirror may also be transmissive to wavelengths other than the laser beam wave length. In this manner an optical observation device, e.g., a photo diode, a camera, or other optical monitoring and detection device, may be placed behind it.

In the embodiment of FIG. 55, the face 5510 of the nozzle is flush with the body of the laser head 5501. The nozzle face, with respect to the body of the laser head may be recessed, slightly recessed, extend beyond, have an extension tube that extends beyond and combinations and variations of these.

Although not shown in the figure, the mirror and nozzle, or the entire head may be movable or steerable to provide a laser tool along the lines of the embodiment of FIG. 24.

During operations, and in particular when the laser tool is being operated in a fluid filled or dirty environment, the air flow should be maintained into the laser head and out the nozzle with sufficient pressure and flow rate to prevent environmental contaminants or fluid from entering into the nozzle, or contaminating the mirror or optics. A shutter, or door that may be opened and closed may also be used to protect or seal the nozzle opening, for example, during tripping into and out of a borehole. A disposable cover may also be placed over the nozzle opening, which is readily destroyed either by the force of the gas jet, the laser beam or both. In this manner the nozzle, mirror and optics can be protecting during for example a long tripping in to a borehole, but readily removed upon the commencement of downhole laser cutting operations, without the need of mechanical opening devices to remove the cover.

For performing downhole laser cutting operations, and in particular the laser cutting of tubulars within a borehole the following cutting rates may be obtained using a laser gas jet tool with an air pressure of about 125 psi above the environmental of use pressure, e.g., borehole pressure, at the nozzle (as borehole pressures increase high gas pressures may be used), an air flow volume of 10-300 cfm (depending upon the nozzle diameter), the focal point being about 6 inches from the nozzle face, and the surface of the tubular being about 5 inches from the nozzle face.

| laser power | spot size diameter | tubular wall | |
|---|---|---|---|
| at surface | at surface of | thickness | cutting rate |
| of tubular | tubular | (inches) | (inches/min.) |
| 15 kW | 5 mm | ¼ | 30+ |
| 15 kW | 5 mm | ⅜ | 25+ |
| 15 kW | 5 mm | ½ | 10+ |
| 20 kW | 5 mm | ½ | 35+ |
| 20 kW | 600 μm | ¼ | 200 |
| 20 kW | 600 μm | ½ | 100+ |
| 20 kW | 600 μm | ¾ | 75+ |

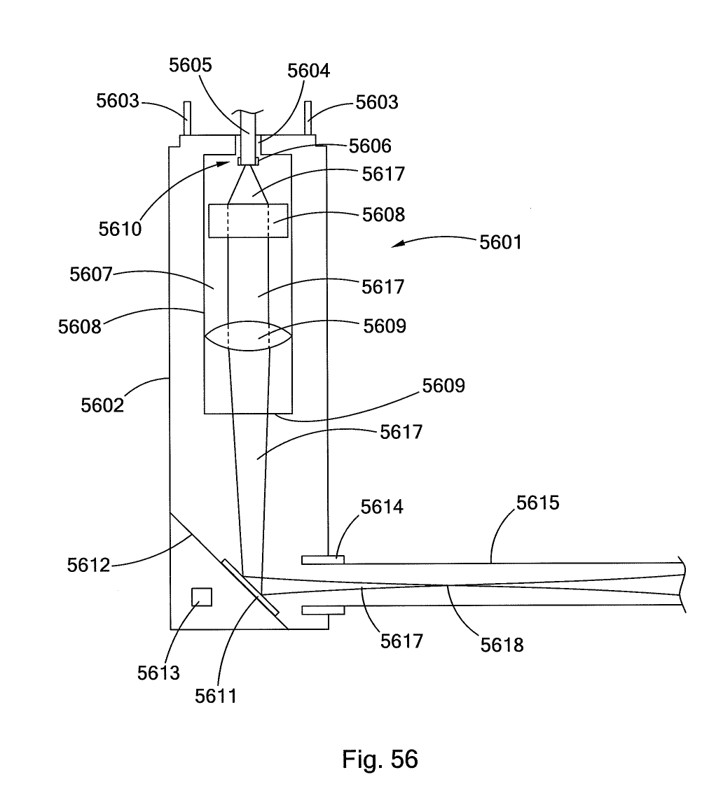

Turning to FIG. 56 there is shown a general schematic of an embodiment of a gas jet laser tool. Thus, the laser tool 5601 having a housing 5602. The housing 5602 has an attachment structure 5603 for attaching to a conveyance structure (not shown) and an attachment structure 5604 for receiving a high power connect 5605 (or other structure for providing the high power laser beam). The connector has a back reflection protection annular cap 5606. Within the housing 5602 of the laser tool 5601 there is an optics assembly 5607. The optics assembly 5607 has a collimating lens 5608 and a focusing lens 5609. The components of the optics assembly, 5608, 5609 may be mounted to the housing 5602, by way of a mountings (not shown) that have openings or ports for permitting the gas flow to pass. The optics assembly 5607 may be contained within a housing 5608, which protects the optics and has a window 5609 and an opening 5610 for receiving the high power laser beam or the connector 5605.

The laser tool 5601 has a mirror 5611 that has a mount 5612. The mirror is reflective to the wavelength of the laser and transmissive to other wavelengths. Preferably the mount 5612 does not have ports or openings to permit gas flow. A photoreceptor 5613 is located behind the mirror 5611 and in the line of sight through the mirror 5611 to the nozzle 5614. In this embodiment the nozzle 5614 that extends beyond the body of the laser tool 5601.

The photoreceptor receives light that enters the nozzle 5614 and travels through the mirror 5611. The photoreceptor may transmit data, information or the received light to the surface or other location for the purpose of monitoring, observing, controlling, or analyzing the cutting process or the tool. The photoreceptor may be place on the housing 5602, so that it may receive light without it having to pass through the nozzle and the mirror. In this way the photoreceptor may monitor back reflections, or the absence of such reflections, from the work piece. Back reflections from the work piece may also be monitored through the mirror, provided that the mirror is sufficiently reflective of the wavelength to reflect the vast majority of the laser beam, and that the photoreceptor is able to detect the small amount of light at the laser beam wavelength that passed through the mirror.

In operation gas is flowed through the housing 5602 and out the nozzle 5614 to form a gas jet 5615. The laser beam 5617 is launched, e.g., propagated, from the connector 5606 into the components of the optics assembly 5607. The laser beam 5617 has a focal point 5618 that is removed from the tool, and may be several inches for the nozzle.

If the laser beam had a wavelength of 1070 nm and the optical fiber (not shown) in the connector 5605 has a core size of 600 μm the collimating lens 5608 may be a 150 mm lens and the focusing lens 5609 may be a 250 mm to a 1500 mm lens. The focal length may be adjustable (including downhole during cutting operations), fixed, fixedly adjustable (e.g., it can be changed and set in the field, but cannot be changed during cutting operations) and combinations and variations of these. In using the tool, preferably the tool is positioned a distance from the work surface (or vice versa) so that the focal point and the depth of field are located behind the surface of the work piece. For a complex work piece, such as for example, a cased borehole having cement behind the casing, the focal point and depth of field may preferably be located completely behind the casing, i.e., in the cement.

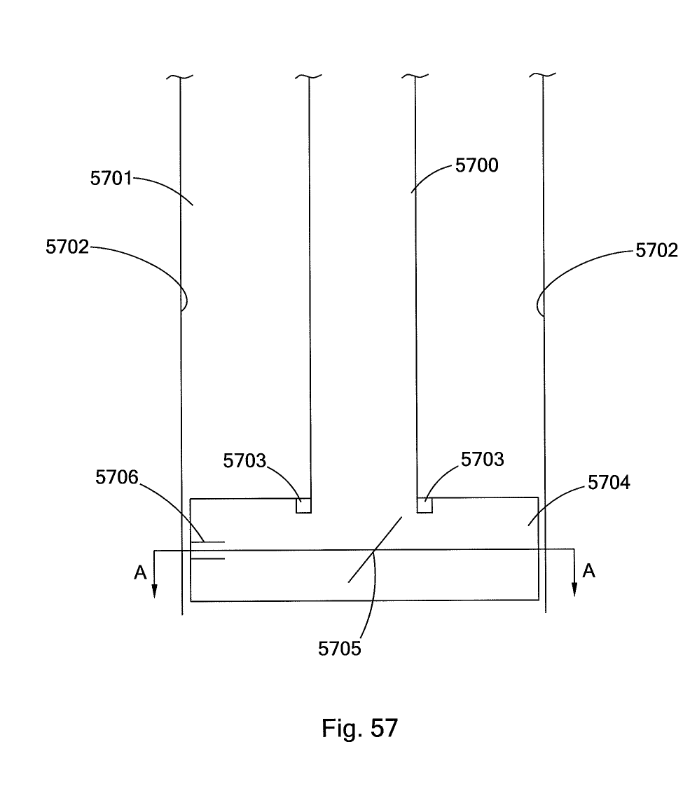

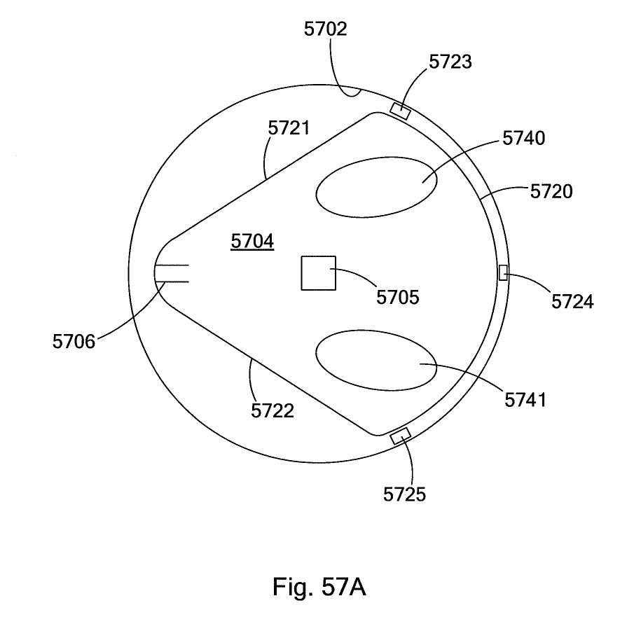

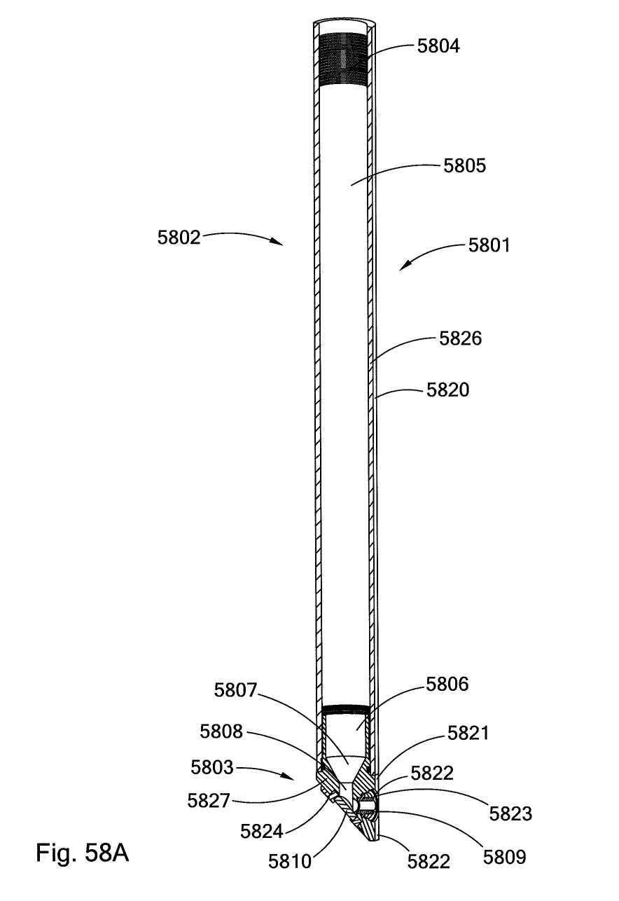

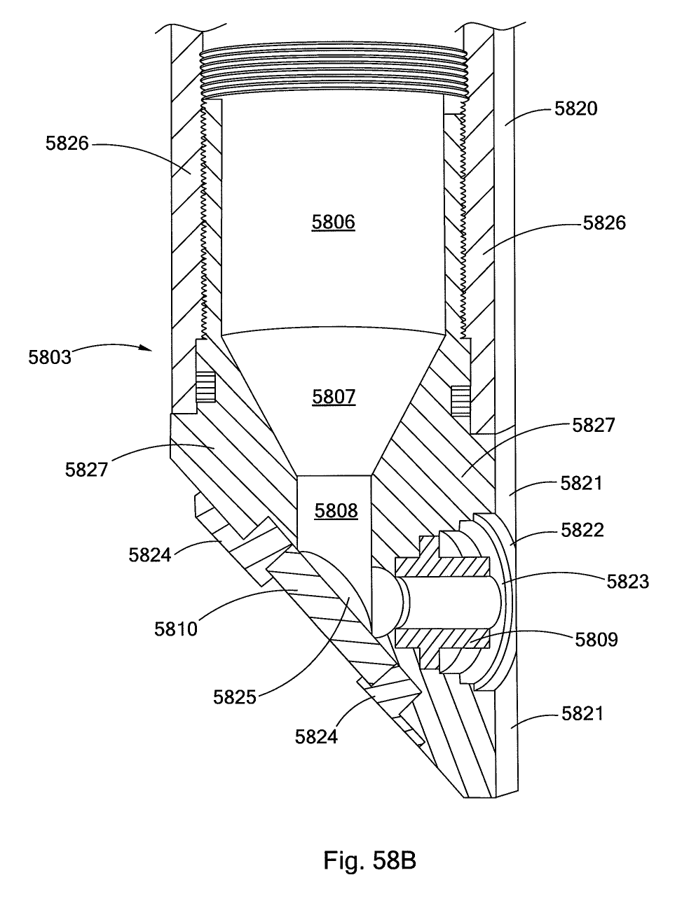

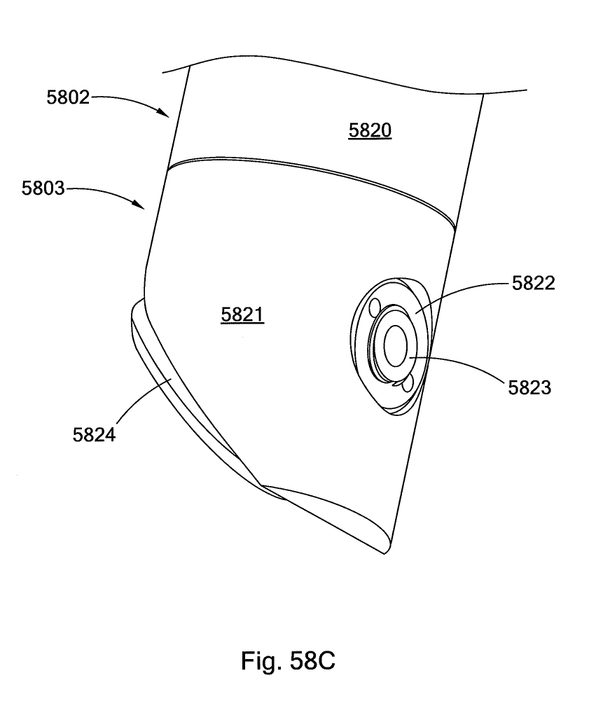

Referring now to FIGS. 57 and 57A there is provided a general schematic for an embodiment of a laser cutting head, which may be used with a laser fluid jet tool. The figures the embodiment is configured for use with a gas jet. Thus, there is a laser tool 5700 in a cased borehole 5701, having a sidewall 5702. The tool has a connection device 5703 for connecting the tool 5700 to a laser cutting head 5704. The laser cutting head has a mirror 5705, which may also be a focusing optic, and a nozzle 5706. The laser head 5704 is sized to fill substantially all of the boreholes diameter; and thus, position and maintain the nozzle in close relationship to the borehole sidewall 5702.

Turning to FIG. 57A, which is transverse cross sectional view along line A-A, the shape and position of laser head 5704 is seen with respect to the borehole sidewall 5702. The laser head is essentially triangular, with its base 5720 being arcuate, and its sides 5721, 5722 narrowing to the location of the nozzle 5706. The base 5720 has pads 5723, 5724, 5725 for engagement with the borehole sidewall 5702. In operation when the gas jet is shot from the nozzle, the reactive force will push the laser head 5704 back, such that pads 5723, 5724, and 5725 engage the borehole sidewall 5702. The laser beam would them be fired and the tool and the laser head rotated, or otherwise moved, to deliver a laser beam pattern to the sidewall. Openings 5740, 5741 are provided in the laser head 5704, If circulation was desired during the laser cutting operations.

The various embodiments of systems, tools, laser heads, nozzles, fluid jets and devices set forth in this specification may be used with various high power laser systems and conveyance structures, in addition to those embodiments in the Figures in this specification. The various embodiments of systems, tools, laser heads, nozzles, fluid jets and devices set forth in this specification may be used with other high power laser systems that may be developed in the future, or with existing non-high power laser systems, which may be modified, in-part, based on the teachings of this specification, to create a laser system. Further the various embodiments of systems, tools, laser heads, nozzles, fluid jets and devices set forth in the present specification may be used with each other in different and various combinations. Thus, for example, the laser heads, nozzles and tool configurations provided in the various embodiments of this specification may be used with each other; and the scope of protection afforded the present inventions should not be limited to a particular embodiment, configuration or arrangement that is set forth in a particular embodiment, or in an embodiment in a particular Figure.

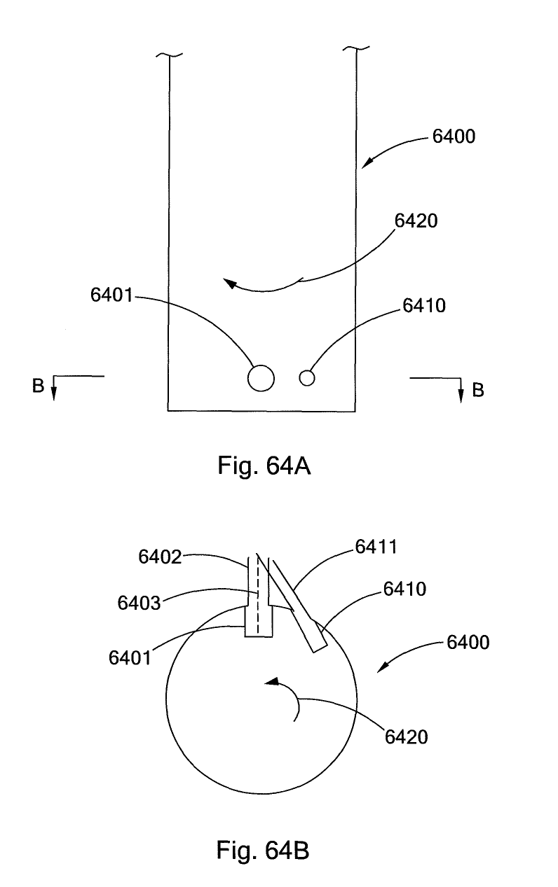

Thus, for example, an annular gas jet, using air, oxygen, nitrogen or another cutting gases, may have a high power laser beam path within the jet. As this jet is used to perform a linear cut or kerf, a second jet, which trails just behind the gas jet having the laser beam, is used. The paths of these jets may be essentially parallel, or they may slightly converge or diverge depending upon their pressures, laser power, the nature of the material to be cut, the standoff distance for the cut, and other factors. The presence of the second trailing jet may be used to remove molten material from the kerf, assist in maintaining the cutting area free from environmental fluids, such as drilling mud, or shape and maintain the laser-molten-solid interface to manage the formation of any surface that could create detrimental back reflections. An embodiment of this configuration is shown in FIGS. 64A and 64B. FIG. 64A is a plan view of a laser tool 6400 having a fluid jet nozzle 6401 having a laser beam path 6403 for providing fluid jet 6402. The tool has a second angled nozzle 6410 that has an angle jet 6411. The angle of rotation of the tool is shown by arrow 6420. FIG. 64B is a cross section of the tool taken along line B-B and shows the jets 6402, 6411 being launched and intersecting.

The high power laser fluid jets of the present inventions have many and varied applications and uses, some of which will realized after the publication of the present application and may be based thereupon. For example, laser jets can be used to cut tubulars in a downhole environment, they can perform window-cutting operations, and they can create perforations in a cased borehole or an open borehole and they may be used for flow control applications, as well as decommissioning plugging and abandonment activities.

Laser fluid jets, and their laser tools and systems may provide for the creation of perforations in the borehole that can further be part of, or used in conjunction with, recovery activities such as geothermal wells, EGS (enhanced geothermal system, or engineered geothermal system), hydraulic fracturing, micro-fracturing, recovery of hydrocarbons from shale formations, oriented perforation, oriented fracturing and predetermined perforation patterns. Moreover, the present inventions provide the ability to have precise, varied and predetermined shapes for perforations, and to do so volumetrically, in all dimensions, i.e. length, width, depth and angle with respect to the borehole.

Thus, the present inventions provide for greater flexibility in determining the shape and location of perforations, than the conical perforation shapes that are typically formed by explosives. For example, perforations in the geometric shape of slots, squares, rectangles, ellipse, and polygons that do not diminish in area as the perforation extend into the formation, that expand in area as the perforation extends into the formation, or that decrease in area, e.g., taper, as the perforation extends into the formation are envisioned with the present inventions. Further, the locations of the perforation along the borehole can be adjusted and varied while the laser tool is downhole; and, as logging, formation, flow, pressure and measuring data is received. Thus, the present inventions provide for the ability to precisely position additional perforations without the need to remove the perforation tool from the borehole.

Accordingly, there is provided a procedure where a downhole tool having associated with it a logging and/or measuring tool and a fluid laser jet tool is inserting into a borehole. The laser tool is located in a desired position in the borehole (based upon real-time data, based upon data previously obtained, or a combination of both types of data) and a first predetermined pattern of perforations is created in that location. After the creation of this first set of perforations additional data from the borehole is obtained, without the removal of the laser tool, and based upon such additional data, a second pattern for additional perforations is determined (different shapes or particular shapes may also be determined) and those perforations are made, again without removal of the laser tool from the well. This process can be repeated until the desired flow, or other characteristics of the borehole are achieved.

Thus, by way of example and generally, in an illustrative hydro-fracturing operation water, proppants, e.g., sand, and additives are pumped at very high pressures down the borehole. These liquids flow through perforated sections of the borehole, and into the surrounding formation, fracturing the rock and injecting the proppants into the cracks, to keep the crack from collapsing and thus, the proppants, as their name implies, hold the cracks open. During this process operators monitor and gauge pressures, fluids and proppants, studying how they react with and within the borehole and surrounding formations. Based upon this data the typically the density of sand to water is increased as the frac progresses. This process may be repeated multiple times, in cycles or stages, to reach maximum areas of the wellbore. When this is done, the wellbore is temporarily plugged between each cycle to maintain the highest water pressure possible and get maximum fracturing results in the rock. These so called frac-plugs are drilled or removed from the wellbore and the well is tested for results. When the desired results have been obtained the water pressure is reduced and fluids are returned up the wellbore for disposal or treatment and re-use, leaving the sand in place to prop open the cracks and allow the hydrocarbons to flow. Further, such hydraulic fracturing can be used to increase, or provide the required, flow of hot fluids for use in geothermal wells, and by way of example, specifically for the creation of enhanced (or engineered) geothermal systems (“EGS”).

The present invention provides the ability to greatly improve upon the typical fracing process, described above. Thus, with the present invention, preferably before the pumping of the fracing components begins, a very precise and predetermined perforating pattern can be placed in the borehole. For example, the shape, size, location and direction of each individual perforation can be predetermined and optimized for a particular formation and borehole. The direction of the individual perforation can be predetermined to coincide with, complement, or maximize existing fractures in the formation. Thus, although is it is preferred that the perforations are made prior the introduction of the fracing components, these steps may be done at the same time, partially overlapping, or in any other sequence that the present inventions make possible. Moreover, this optimization can take place in real-time, without having to remove the laser tool of the present invention form the borehole. Additionally, at any cycle in the fracturing process the laser tool can be used to further maximize the location and shape of any additional perforations that may be desirable. The laser tool may also be utilized to remove the frac-plugs, if present.

Additionally, the laser fluid jet can be used to advance a borehole, to ream a borehole, to clean a borehole, to remove wax from a borehole or for another actions that are needed or useful for boring, workover, or completion of a well. The laser fluid jets for example can be combined with a mechanical bit, a laser mechanical bit, or incorporated into a laser bottom hole assembly. Thus, the laser fluid jet can be used with, or incorporated into the structures and process disclosed in: (1) U.S. provisional patent application Ser. No. 61/247,796; (2) US patent application publication number 2010/0044106; (3) US patent application publication number 2010/0044104; (4) US patent application publication number 2010/0044105; (5) US patent application publication number 2010/0044102; (6) US patent application publication number 2010/0044103; and (7) U.S. provisional patent application Ser. No. 61/374,594, titled Two-Phase Isolation Methods and Systems for Controlled Drilling, filed Aug. 17, 2010, the entire disclosures of each of which is incorporated herein by reference.

In particular, and by way of example, the present laser jets could be used to enhance, or perform, gage cutting of the borehole, and thus reduce the stress on mechanical gauge cutters, enhance the life and performance of mechanical gauge cutters, and replace or element the need for gauge cutters entirely. Further, by way of example, the laser jets could be used to cut kerfs in the borehole, used in a kerfing operation, and used in a laser-mechanical kerfing operation. In such activities kerfs or groves are cut into the formation that is sought to be removed, e.g., the bottom of the borehole. The laser in the laser jet removes the material in a small line creating a kerf, e.g., a groove in the surface to be removed. Mechanical means or other laser means can be employed to remove the material left between the kerfs. This process can be continued to advance the borehole or otherwise remove the material intended to be removed. Further, the shape of the bottom of the grove can be predetermined by the power distribution of the laser beam.

The laser fluid jets can also be used for thermal processing of materials and in particular the thermal processing materials in a downhole environment, such as heat-treating, annealing, stress relieving, and welding.

The laser tool, systems and apparatus provided herein enable the performance of precise, predetermined and preselected cut types and shapes and in particular provides the ability to perform and obtain such cut types and shape in downhole environments, and in downhole environments with the present of borehole fluids.

Referring to FIG. 7 there is shown a cross-sectional view of a tubular 704, e.g., a drill pipe, that has been cut into two sections 711, 712. The tubular 701 has an inner surface 705 and an outer surface 709. The tubular has a wall 700. (Typically tubulars, for example casing, can have wall thickness ranging from about 6 mm to about 8 mm for 5½ inch casing; to about 8 mm to about 13 mm for 13⅜ inch cases, although thinner and thicker wall thickness may be employed; and drilling pipe for example can have a wall thickness ranging from about 7 mm for 2⅜ inch pipe to about 12 mm for 6⅝ inch pipe.) In the exemplary cut of FIG. 7 the cut is made normal (perpendicular) to the longitudinal dimension (axis) of the tubular 704. Thus, the laser cut provides planar end surface 701, on section 711, which surface is a ring that is formed from wall 700, and planar end surface 702, which surface is a ring formed from wall 700. These planar end surfaces 701, 702 are normal to the longitudinal dimensions of the tubular 700. This cut would provide a uniform, clean end of the pipe, and thus would provide a flat clean finishing neck.

Referring now to FIG. 8 there is shown a cross-sectional view of a tubular 821, e.g., a drill pipe, that has been cut into two sections 823, 822. The tubular 821 has an inner surface 825 and an outer surface 829. The tubular has a wall 800. In the exemplary cut of FIG. 8 the cut is made at an angle to the longitudinal dimension (axis) of the tubular 800. Thus, the laser cut provides an inwardly tapering lower end surface 802, which surface is a section of a conical shape that is formed from wall 800; and an outwardly tapering upper end surface 801, which surface is a section of a conical shape that is formed from wall 800. Further, as seen in the figure, the ends of the pipe as cut would nevertheless be in planes that are normal to the longitudinal dimension of the pipe. This cut could be referred to as a bevel down to the outside diameter cut, if section 823 is viewed as being above, closer to the surface than, section 822. This cut could be utilized to facilitate, or enhance the effectiveness of, an overshot or external grapple fishing tool when fishing for the lower pipe section 822. This cut provides a smooth receptacle for sealing the fishing tool against the outer surface 829 of the lower section 822. Further, if the upper section 823 of the pipe 821 is left in place in the borehole after the cut has been made, and the cut is made at the bottom of the pipe, the bevel or tapered surface 801 provides an entry surface that serves as a guide for tools that are run below the tubing tail, i.e., the lower end of section 801. In this usage little if any of the lower pipe 822 would be present in the borehole as the cut would be made as close to the tubing tail as possible, or the lower section would otherwise be moved out of the operative area of the borehole.

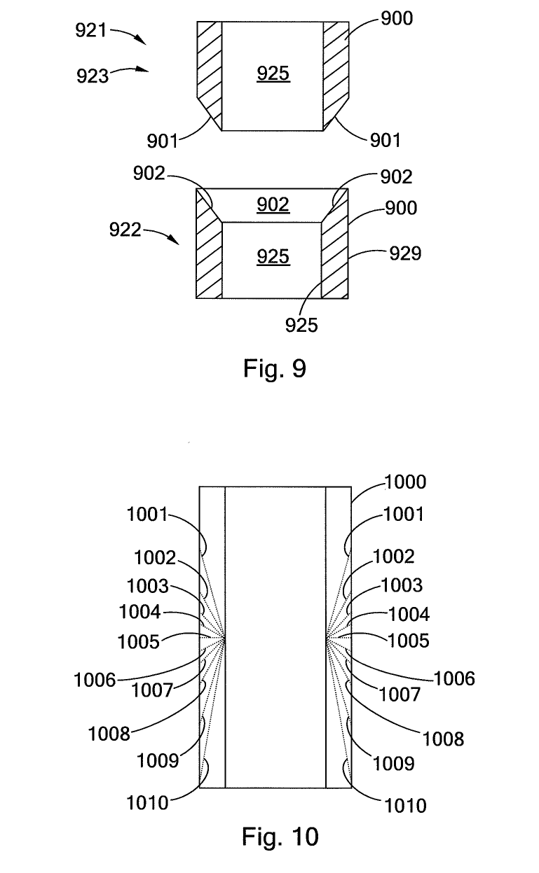

Referring now to FIG. 9 there is shown a cross-sectional view of a tubular 921, e.g., a drill pipe, that has been cut into two sections 923, 922. The tubular 921 has an inner surface 925 and an outer surface 929. The tubular has a wall 900. In the exemplary cut of FIG. 9 the cut is made at an angle to the longitudinal dimension (axis) of the tubular 921. Thus, the laser cut provides an inwardly tapering upper end surface 901, which surface is a section of a conical shape that is formed from wall 900; and an outwardly tapering lower end surface 902, which surface is a section of a conical shape that is formed from wall 800. Further, as seen in the figure, the ends of the pipe as cut would nevertheless be in planes that are normal to the longitudinal dimension of the pipe. This cut could be referred to as a bevel down to the inside diameter cut. This cut could be utilized to facilitate, or enhance the effectiveness of, a spear or internal grapple fishing tool when fishing for the lower pipe section 922. The tapered surface 902 having the effect of guiding the fishing tool onto the lower section 922. Further, if the upper section 923 of the tubular 921 is removed from the borehole, the tapered surface 902 provides a guide for tools that are run into the borehole if the lower section 722 is left in the borehole.

Turning to FIG. 10 there is shown examples of the different laser cuts that may be made in a pipe to sever the pipe and provide predetermined and custom angled end surfaces. Thus, there is provided a wide range of possible laser cuts, 1001, 1002, 1003, 1004, 1005, 1006, 1007, 1008, 1009, 1010, to sever the pipe wall 1000.

These exemplary laser beams patterns have a center point, that forms a center ring around the interior surface of the tubular. In this manner the amount, or degree of the taper of a particular cut can be predetermined by selecting a particular angle for a laser beam cut and then delivering that pattern to the tubular. This producer will provide an end of the cut that is in a plane that is normal to the length of the tubular. Further the ring will be in this plane. These illustrative potential cuts, such as shown in FIGS. 7, 8 and 9 may generally be referred to herein as a horizontal cut. These can be contrasted against the type of cut as shown in FIGS. 11A and B, wherein the end of the tubular after the cut is made is within a plane that is on an angle to the longitudinal direction of the tubular, which angle is greater than, less then, but not, 90 degrees. Cuts such as shown in FIGS. 11A and B would be referred to herein as diagonal cut.

Turning to FIGS. 11A and 11B there are provided a plan view and a cross sectional view, respectively, of a pipe that has been cut with a laser cutter into a diagonal cut or “mule shoe” configuration. Thus, the pipe has a sidewall 1100, which has an outer surface 1106 and an inner surface 1107. The laser cut creates an end face 1101, which makes or frames opening 1105 into the pipe. Preferably the end face is clean and uniform. This type of cut may be employed to remove a section of a tailpipe, which provides an entry guide for further borehole, e.g., well, access below the tailpipe. Such access could be carried out by the use of, for example, coiled tubing or wireline.

Turning to FIGS. 12A and 12B there are provided a plan view and a cross section view, respectively, of examples of the different types of windows, openings or slots that may be made in a pipe or tubular by a laser cutter. slide providing descriptions and illustrations of several examples of the types of downhole cuts that can be obtained.

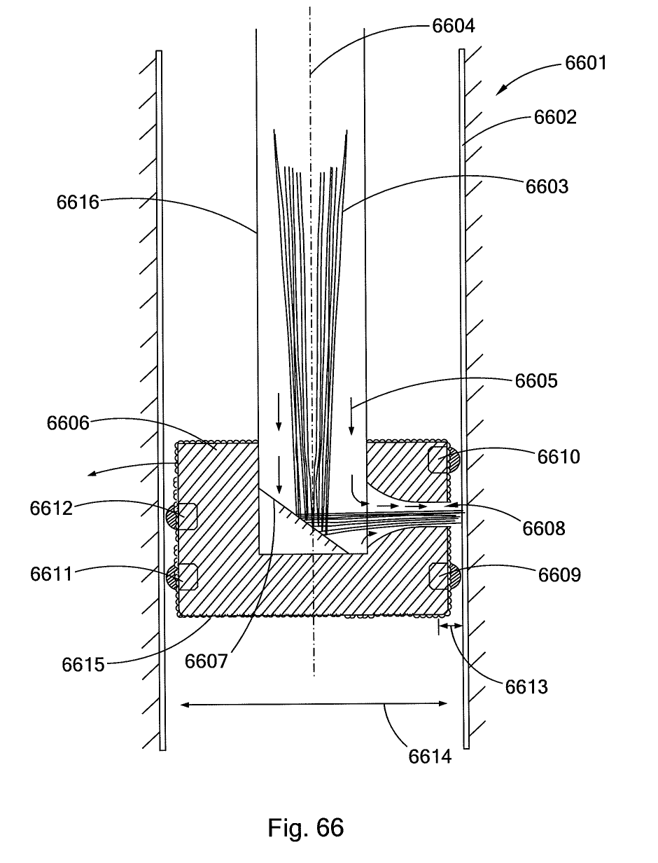

Referring to FIG. 66 there is shown an embodiment of a laser tool having a tool body 6616 in a borehole 6601 that has a tubular, such as pipe or case 6602. The laser tool has a laser head 6606 that has a mirror 6607. The laser beam path 6604 and laser beam 6603 travel down the tool body 6616 to the mirror 6607 and into the nozzle aperture 6608, where it is combined with the fluid jet (fluid flow is shown by arrows 6605). The laser head 6606 has inserts 6609, 6610, 6611, 6612, which may be tungsten carbide inserts or rollers to prevent any sticking on the pipe. The laser head 6606 may be coated with a protective coating 6615, which may be for example a corrosion resistant coating, a wear resistant coating (e.g., HVOF, high velocity oxyfuels) or a tungsten carbide layer. The tubular has an internal pipe diameter id 6614 and the laser tool head 6606 is shown as having a standoff distance 6613.

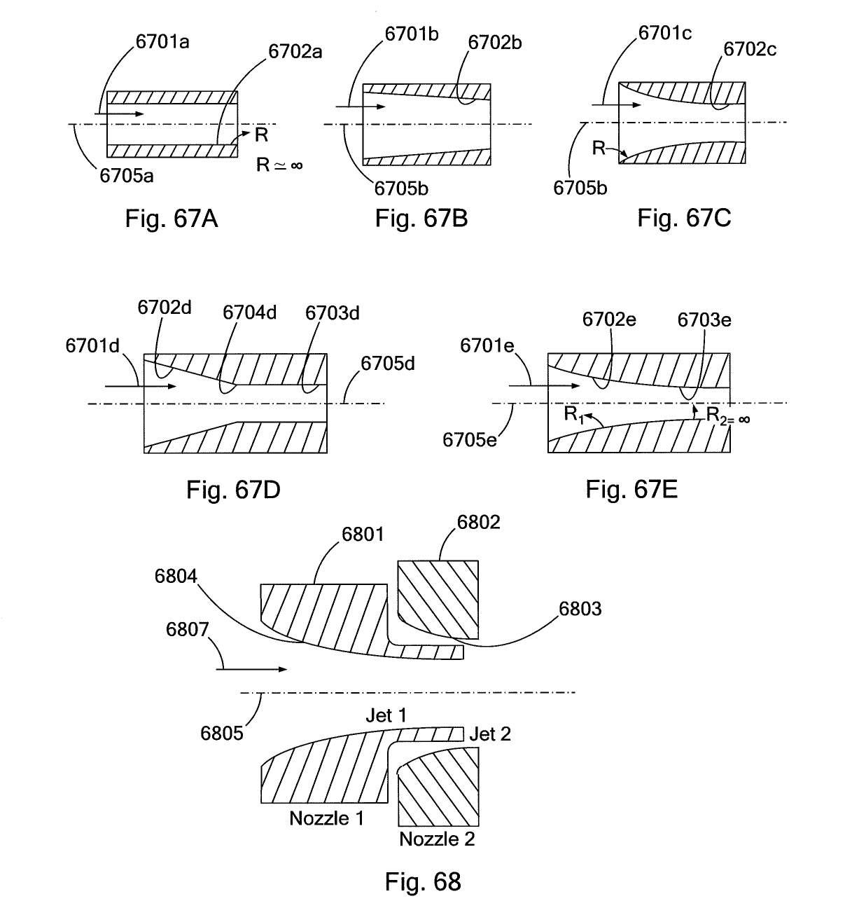

Various examples of nozzle configurations are shown in FIGS. 67A to 67E. In FIG. 67A there is shown a cross section of a nozzle having straight flow surfaces 6702a, an axis 6705a and a flow direction shown by arrow 6701a. In FIG. 67B there is shown a cross section of a nozzle having tapered flow surfaces 6702b, an axis 6705b and a flow direction shown by arrow 6701b. In FIG. 67C there is shown a cross section of a nozzle having a converging nozzle radius that has curved flow surfaces 6702c, an axis 6705c and a flow direction shown by arrow 6701c. In FIG. 67D there is shown a cross section of a nozzle having tapered 6702d and straight 6703d flow surfaces that are joined at point 6704d; and has an axis 6705d and a flow direction shown by arrow 6701d. In FIG. 67E there is shown a cross section of a nozzle having curved 6702e and straight 6703e flow surfaces, an axis 6705e and a flow direction shown by arrow 6701e.

An example of an embodiment of a compound annular fluid jet nozzle is shown in FIG. 68. The nozzle has an inner jet nozzle section 6801, having a curved flow surface 6804 (along the lines of the embodiment of FIG. 67C) and an outer jet nozzle section 6802, having a flow surface 6803 (along the lines of the embodiment of FIG. 67C). The nozzle has an axis 6805 and the flow direction of fluids is shown by arrow 6807.

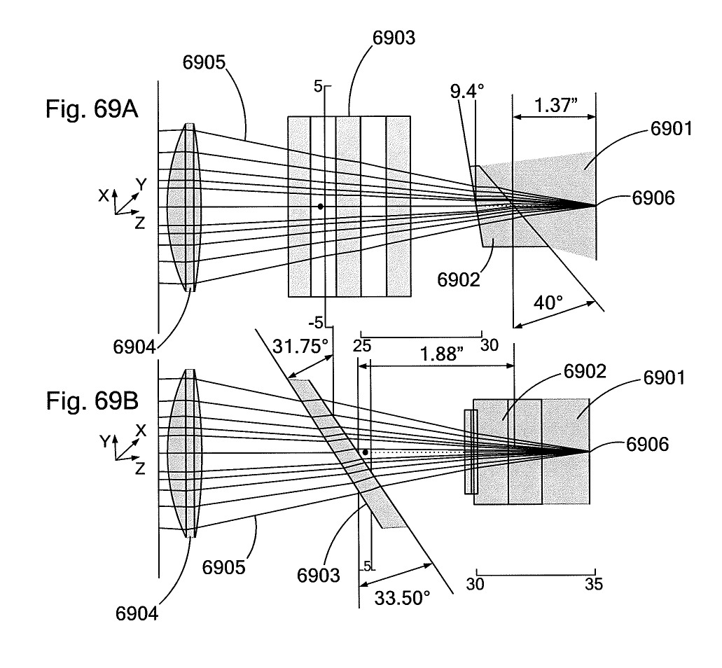

Turning to FIGS. 69A and 69B there is shown an embodiment of a two prism configuration for launching a laser beam into a liquid, where the index of refraction of the prisms and the fluid are essentially the same. FIG. 69A is viewed along the Y axis and FIG. 69B is viewed along the x axis. The fluid 6901 would have an index of refraction of 1.398, the prisms 6902, 6903 would be made from fused silica having an index of refraction of 1.44956. The ray paths 6905 of a laser beam as it travels from a lens 6904, to the prism 6903, to the prism 6902 (which has a surface that interfaces with the fluid 6901), into the fluid 6901, and to a focus point 6906 are shown. The angles and spatial relationship of the components are shown in the figure.

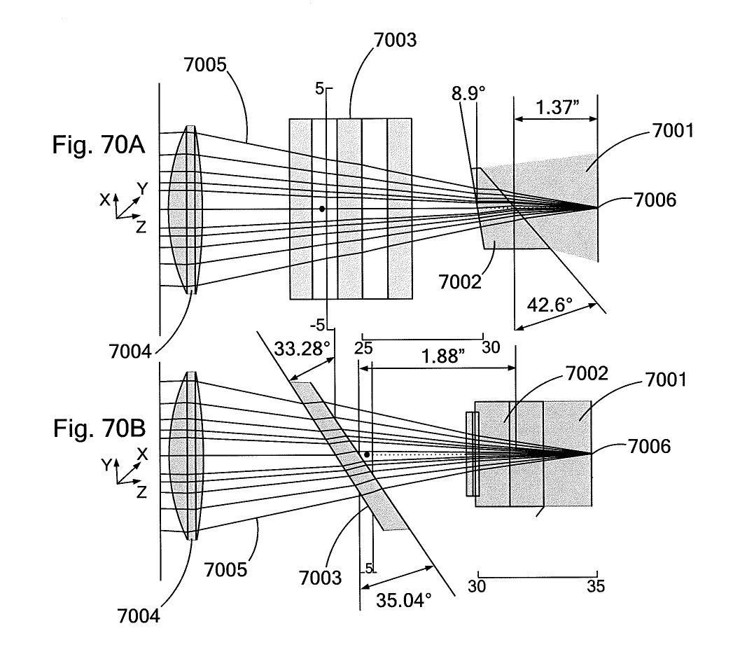

Turning to FIGS. 70A and 70B there is shown an embodiment of a two prism configuration for launching a laser beam into a liquid, where the index of refraction of the prisms and the fluid are essentially the same. FIG. 70A is viewed along the Y axis and FIG. 70B is viewed along the x axis. The fluid 7001 would have an index of refraction of 1.345, the prisms 7002, 7003 would be made from fused silica having an index of refraction of 1.44956. The ray paths 7005 of a laser beam as it travels from a lens 7004, to the prism 7003, to the prism 7002 (which has a surface that interfaces with the fluid 7001), into the fluid 7001, and to a focus point 7006 are shown. The angles and spatial relationship of the components are shown in the figure.

The present laser tools, systems, methods and devices may have many uses and applications, the following examples of which are illustrative and are in no way limiting of the various applications and uses to which the present inventions may be put. The advantages and benefits mentioned in these examples as potentially being attained with the present laser tools, systems, methods and devices over existing non-lasers methods, are illustrative and not limiting. Many other and different benefits and advantages (as well as new and different capabilities and applications) are possible with the present laser tools, systems, methods and devices depending upon the specific laser process and application, environment of use, and other factors.

### Example 1

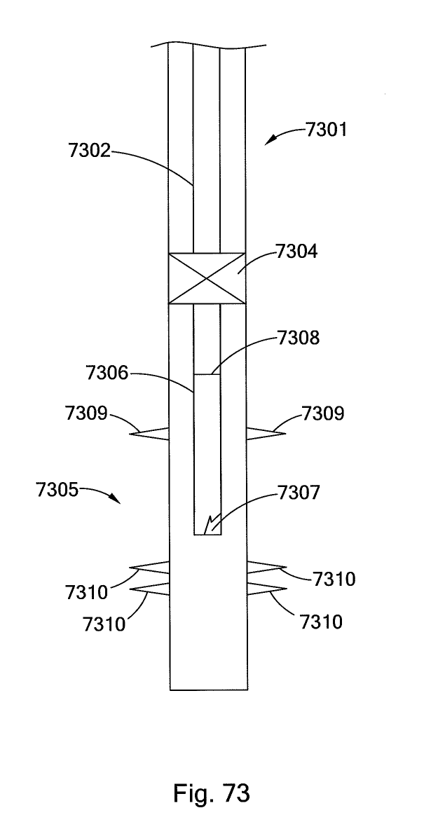

An application for tailpipe cutting is shown in FIG. 73. Within a completed well 7301, there are many times when a length of production tubing 7302 extends beyond a lower packer 7304 into the perforated section 7305 of the well casing (having existing perforations 7310), commonly called a tailpipe 7306. Elimination or shortening of the tailpipe may be needed to: a) perforate an upper section behind the tailpipe, b) to remove a restrictive inside diameter, c) remove a damaged section e.g., 7307 that disallows workover procedure.

Using the present laser tools, systems, methods and devices many if not all of the disadvantages of the prior non-laser procedures may be reduced, substantially reduced or eliminated. Thus, the present laser tools, systems, methods and devices may allow the well to remain live, with no loss of production. The laser cutting head is run into the well to the point of desired cut 7308, and the tool is anchored to the tubing above where the cut is to be made. The laser is then activated to sever the pipe, leaving a clean cut for re-entry with subsequent workover methods. The laser also forms new perforations 7309. The cut can be tapered or “mule shoe cut” to provide an entry guide for tools run below cut section.

### Example 2

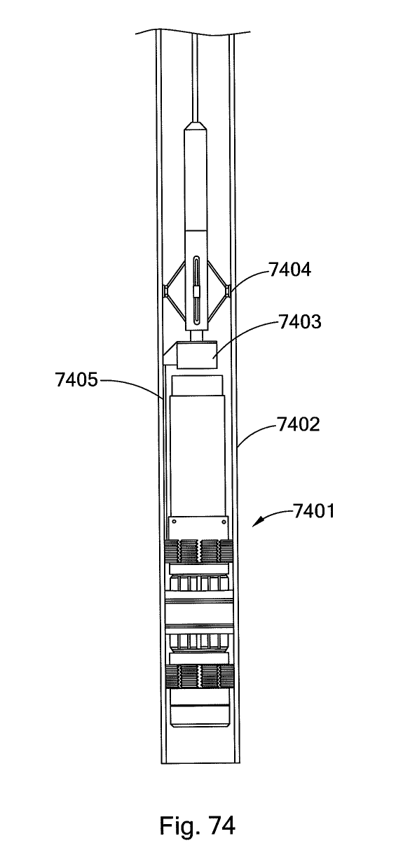

An application for packer release and retrieval with the present laser tools, systems, methods and devices (the laser system) is shown in FIG. 74. The laser system allows the removal of the packer 7401 by retrieval or movement to bottom of the well 7402. In the event that tubing/pipe is still attached to the packer and unable to be removed by backing off of the threaded joint, the laser system will be used to run into the tubing and cut the pipe above the packer. The tubing will then be removed with the same assembly as used to cut, leaving an internal catch capability with a fishing tool. Another run will provide a laser cutting head 7403, with a stabilizer sub 7404 in the assembly, which will direct the laser beam 7405 to cut around the perimeter of the packer assembly, eliminating or weakening the contact area of the packer to the casing, releasing it. The assembly may include a fishing latch component, allowing the packer to be retrieved at that time, or a second run can be made to retrieve the packer once it has fallen from position. Inflatable packers can be deflated by entering the internal diameter of the packer or along the upper perimeter of the packer/casing interface, using the laser to penetrate the bladder, releasing the packer. A fishing latch may be incorporated into the same assembly to then retrieve the packer from the well.

### Example 3

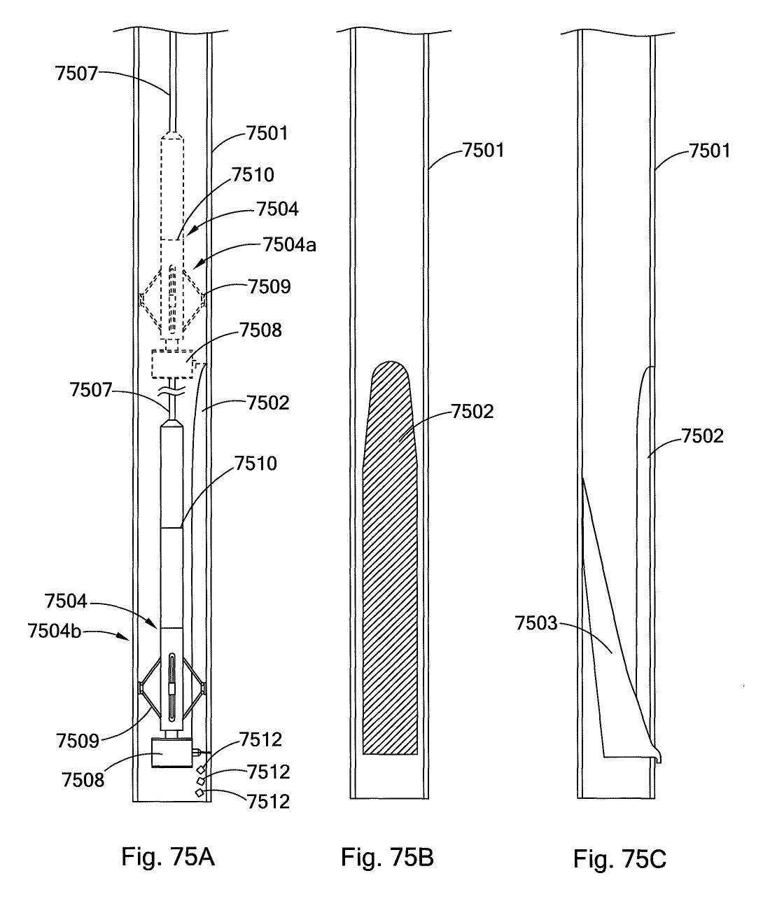

An application for casing exits with the present laser tools, systems, methods and devices (the laser system) is shown in FIGS. 75A-C. Casing exit procedures are often required to provide a means of continuing drilling operations in the event that a lower section of the well has been mechanically compromised and or when a production target outside of the existing well path is desired. The procedure includes cutting a “window” in the existing casing string to allow the passage of a drilling assembly for further drilling beyond the exit point. This procedure is typically done with the use of a whipstock assembly, conveyed and set-in-casing assembly which creates a ramp, which remains in place while a milling string is run in the hole and rotated to mill the casing away for access to formation (which activity may also be done with the laser system, although not shown in this example).

Using the laser system many, if not all, of the disadvantages of the existing non-laser procedures may be reduced, substantially reduced or eliminated. Casing exit using the present laser system is done with use of the laser cutting head assembly 7504 being deployed with wireline or coiled tubing 7507. The system will include the laser cutting head 7508, a mechanical anchoring device 7509 and a direction/inclination/orientation measurement component 7510. Once at the desired depth for the window 7502, the tool will be anchored in position and the orientation measurement system used to cut the casing 7501 into sections 7512 of size that can be dropped below the point of cut, or magnetically removed from the wellbore using a magnet system included in the assembly. As seen in FIG. 75A the assembly 7504 is shown in a first position (in phantom lines) 7504a, where the start of the window cut begins, and in a second and final position 7504b where the window has been completed. The size of the needed window, dependent on the casing size and the assemblies that are to be passed through the window, will dictate the number of anchored setting positions for the tool to complete the window. The laser, making relatively quick cuts through the casing, will be capable of sizing the pieces being remove to a) ensure dropping to well bottom without creating possible blockage or hold up in the well bore, or b) sizing the pieces to ensure accumulation around the downhole magnet to ensure retrieval through the upper wellbore without sticking or loss of material. In FIG. 75B, a cross-sectional plan view of the completed window 7502 is shown with the laser assembly being removed. (In FIGS. 75A and C, the window is shown in a side cross-sectional view.) Upon completion of the window, a ramp 7503, either permanent or retrievable, can be deployed to the window and locked, potentially with a specific cut generated by the laser at the lowest portion of the window, in place to provide problem free pass through with subsequent bottom hole assemblies and completions.

### Example 4

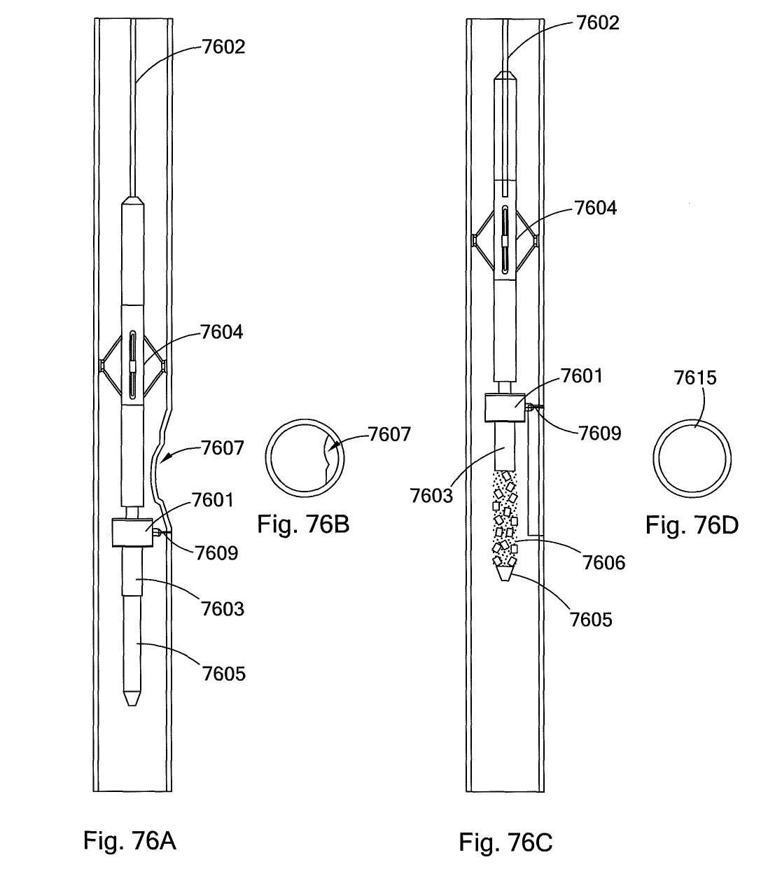

An application for removal or repair of damaged/deformed downhole casing sections with the present laser tools, systems, methods and devices (the laser system) is shown in FIG. 76. Sections of casing that have been placed in the wellbore may become damaged due to human error, tectonic movement or defective materials. When occurring in a string that has been cemented in to place, the method of correcting is typically done by milling through the deformed or damaged area, or using a swage or casing roller to attempt to reshape the casing to usable dimension. If milled, or when a breach of the casing has occurred, a casing patch system is then used to restore isolation between the wellbore and the formation. Other methods are deployment of a straddle assembly, with packers above and below the damaged area with a smaller diameter tubular between the two packers. This will re-establish wellbore integrity; however, greatly reduces the completion options for the well. This method may still require milling or the swage/roller procedure to be done prior to deployment to ensure passage of the packers.

Using the laser system many, if not all, of the disadvantages of the existing non-laser procedures may be reduced, substantially reduced or eliminated. The laser system utilizes a laser cutting head 7601, conveyed by wireline or coiled tubing 7602. Included in the assembly package will be a downhole imaging device 7603, capable of determining exact dimensions of the wellbore, a direction/inclination/orientation measurement device, an anchoring system 7604 and a magnet tool 7605 to retrieve cut pieces 7606 of metal during the procedure. The system will be lowered in to the well to a point above the known area of damage 7607, with a pass through the area to image the section. The assembly will then be pulled above the damage for correct position and the anchor mechanism set to stabilize the tool. With direction from the imaging pass, the laser beam 7609 will make precision cuts, removing the deformed area in pieces sized to allow capture on the magnet, which is positioned below the area of cut. There may be need to reset and re-anchor the tool multiple times, depending on the length of damage done and requiring removal. Another version may include an anchor and tractor combination component that will allow the stabilization of the tool, as well as precise bi-directional movement of the assembly for operations. The laser assembly will cut and remove only the deformed sections, leaving the geometrically sound pipe in place. Once all is removed, and additional pass is made to re-image the area to ensure thorough removal, and the tool removed from the well with the cut pieces attached to the magnet. The area will then require a casing patch 7615 procedure to establish wellbore integrity. Should the casing failure disallow the passage of the tool for imaging, the tool will be deployed without the magnet below and the area imaged from above. The cuts will then be made downward at the damage, reducing blockage to allow the magnet to be attached and passed through the damaged area.

### Example 5

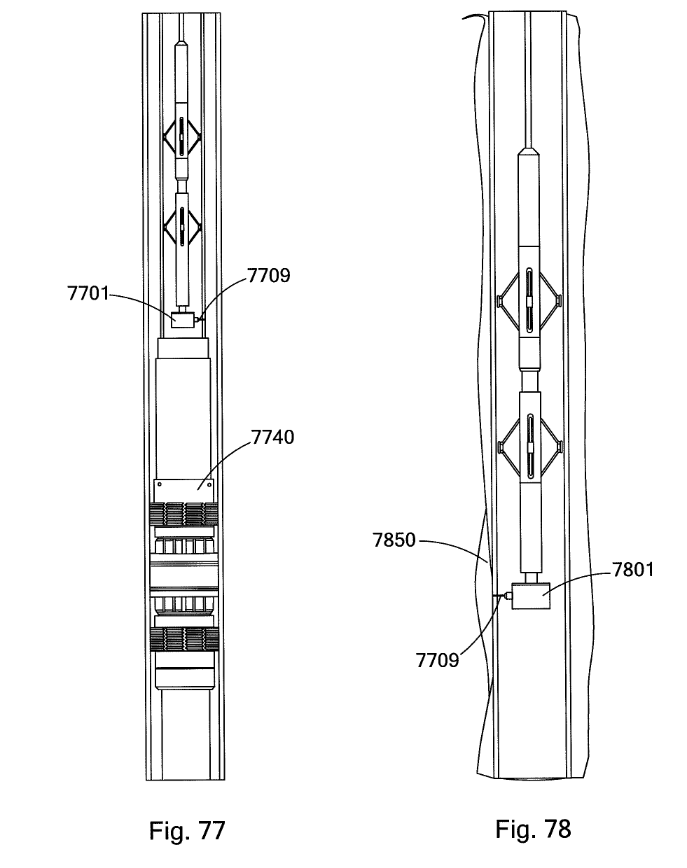

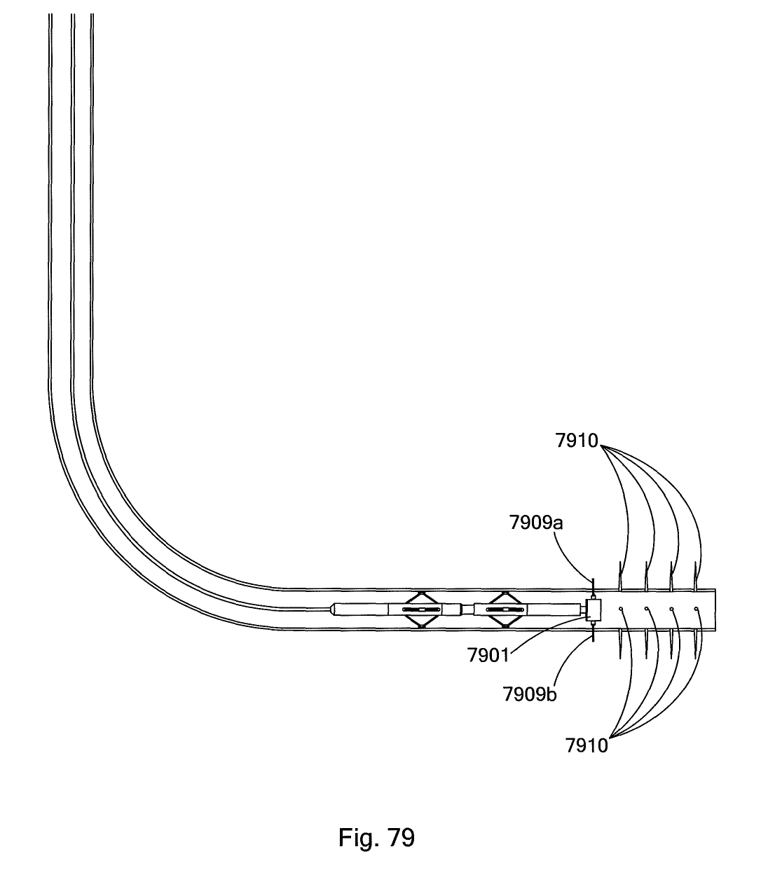

Applications for perforating of tubing and casing with the present laser tools, systems, methods and devices (the laser system) are shown in FIGS. 77, 78 and 79. The perforating of casing and tubing is done as a means of establishing communication between two areas previously isolated. The most common type of perforating done is for well production, the exposure of the producing zone to the drilled wellbore to allow product to enter the wellbore and be transported to surface facilities. Similar perforations are done for injection wells, providing communication to allow fluids and or gases to be injected at surface and placed into formation. Workover operations often require perforating to allow the precise placement of cement behind casing to ensure adequate bond/seal or the establishing of circulation between two areas previously sealed due to mechanical failure within the system.

These perforations are typically done with explosive charges and projectiles, deployed by either electric line/wireline or by tubing, either coiled or jointed.

The charges can be set fired by electric signal or by pressure activated mechanical means.

Using the laser system many, if not all, of the disadvantages of the existing non-laser procedures may be reduced, substantially reduced or eliminated. The laser system for perforating includes a laser cutting head 7701, 7801, 7901, which propagates a laser beam(s) 7709, 7809, 7909a and 7909b, an anchoring or an anchoring/tractor device, 7704, 7804, 7904 an imaging tool and a direction/inclination/orientation measurement tool. The assembly is conveyed with a wireline style unit and a hybrid electric line. The assembly is capable of running in to a well and perforating multiple times through the wellbore in a single trip, with the perforations 7910 specifically placed in distance, size, frequency, depth, and orientation. The tool is also capable of cutting slots in the pipe to maximize exposure while minimizing solids production from a less-than-consolidated formation. In a horizontal wellbore, the tractor 7904 is engaged to move the assembly while perforating. The tool is capable of perforating while underbalanced, even while the well is producing, allowing evaluation of specific zones to be done as the perforating is conducted. The tool is relatively short, allowing deployment method significantly easier than traditional underbalanced perforating systems. In FIG. 77 the tool is positioned above a packer 7740 to establish an area to be perforated that has an established circulation, in FIG. 78 the tool is being used to cut access to an area of poor cement bond 7850.

For single shot applications, there is no need for explosive permitting and the associated safety measures required on a job location, with the system having the ability to run in the well and precisely place a hole of desired dimension, without risk of damage to other components within the wellbore safely and quickly.

### Example 6

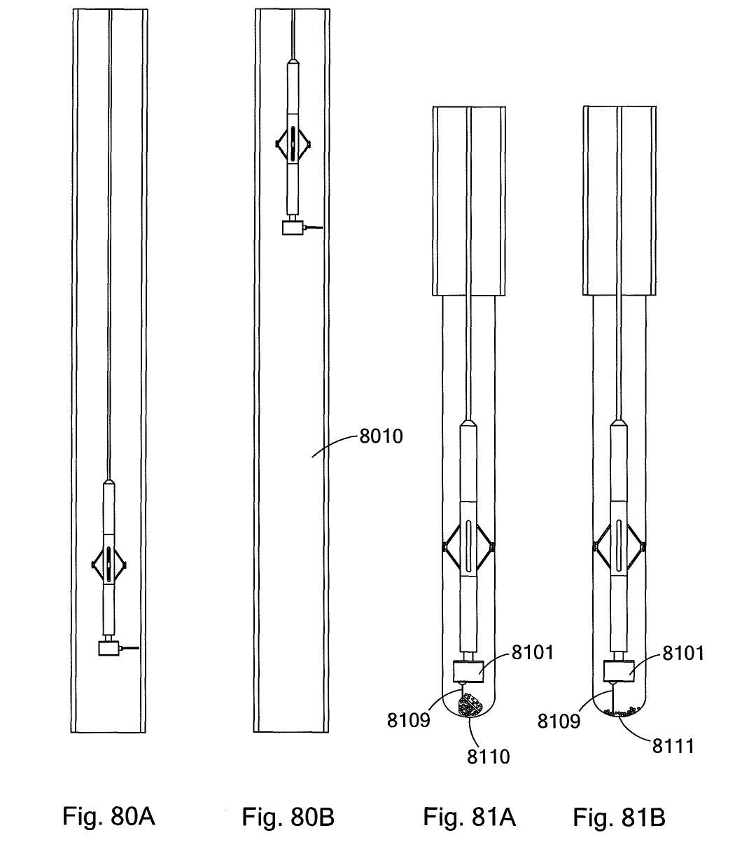

An applications for full length longitudinal cuts of a downhole tubular to compromise strength for fishing with the present laser tools, systems, methods and devices (the laser system) are shown in FIGS. 80A and 80B. Attempting to fish a tubular component that has been stuck in the hole is difficult in part due to the cohesion and friction created from the full outside diameter of the stuck component. A lessening of the friction can be seen if the component is cut along a longitudinal line, allowing a degree of collapse of the tubular. The effect in the circumstance of a tubular, such as a pipe, that has been intentionally or inadvertently cemented in a hole could be significant in retrieving the pipe from the well. A similar method of relaxing components can be done contingent on the ability to pass the laser cutting head through the component. Components such as a packer may be passed through, and then the laser head assembly pulled back through the packer while cutting the inner mandrel, allowing all parts supported by the mandrel to relax and lessening the bond of the packer to the casing. Using the laser system a laser cutting head 8001 providing a laser beam 8009, an imaging device, a direction/inclination/orientation device and a centralizing device. The tool has the capability to be pulled through a tubular (starting at the position shown in FIG. 80A and ending at the position shown in FIG. 80B) while remaining stabilized and the line for cut 8010 remain straight along the component, with the orientation device providing control of the laser direction.

### Example 7

An application for removal of junk in wellbore or rat hole with the present laser tools, systems, methods and devices (the laser system) are shown in FIGS. 81A and 81B. Often in the drilling of a well, or when workover operations are being conducted, components are broken or dropped, leaving debris in the wellbore or rat hole that disallows a desired function. Items can be very difficult and expensive to fish from a well, especially items dropped to the bottom of the well, or rat hole. Milling of dropped components can be difficult, having no anchor and simply spinning below the mill and not progressing. In a drilling scenario, the use of tri cone or insert bits have resulted in lost cones in the well, with the cone normally falling to the bottom of the hole. The hardness and shape of the cones make fishing the item difficult and often requires kicking off from the existing well trajectory, an expensive and time consuming function. Using the laser system can avoid and minimize many of the problems associated with dropped or lost items in the well. The laser system has a laser cutting head 8101, propagating a laser beam 8109, and has a downhole imaging device, and a stabilization device, conveyed with either an electric line hybrid or coiled tubing, can be run in to the well to the point of obstruction and the imaging tool utilized to determine position. The laser cutting head is then employed to make multiple precise cuts across the object 8110, lessening the size of the component(s) 8111 to allow junk-basket retrieval, a later circulating of the items from the bottom of the well, or diminished to the point of not being a factor for forward operations.

### Example 8

An example of another application for the present laser tools, systems, methods and devices is a to provide a new subsurface method of geothermal heat recovery from existing wells situated in permeable sedimentary formations. This laser based method minimizes water consumption and may also eliminate or reduces the need for hydraulic fracturing by deploying the present laser tools to cut long slots extending along the length (top to bottom) of the well and thus providing greatly increased and essentially maximum contact with the heat resource in preferably a single down hole operation.

The existing well infrastructure system in the United States includes millions of abandoned wells in sedimentary formations, many at temperatures high enough to support geothermal production. These existing wells were originally completed to either minimize water flow or bypass water-bearing zones, and would need to be converted (i.e. re-completed) to support geothermal heat recovery. Such wells may be re-completed and thus converted into a geothermal well using the present laser cutting tools. The slots that these laser tools can cut increases geothermal fluid flow by increasing wellbore-to-formation surface area. The present laser tools may rapidly create long vertical slots (hundreds to thousands of feet long) in the casing, cement and formation in existing wells in a single downhole operation (by contrast, perforation requires many trips due to the consumptive use of explosives). These long laser created slots can cover the entire water-bearing zone of the well, and thus, maximize water flow rates and heat recovery. In turn, the need for acidizing and hydraulic fracturing may also be reduced or eliminated, further decreasing costs. The long laser cut slots provide several benefits, including: higher flow rates; increases in the wellbore/formation surface area; reduction in the risk of missing high-permeability sections of the formation due to perforation spacing; and, eliminating or reducing the crushed zone effect that is present with explosive perforations.

The inventions may be embodied in other forms than those specifically disclosed herein without departing from its spirit or essential characteristics. The described embodiments are to be considered in all respects only as illustrative and not restrictive.

What is claimed:

1. A method for removing material from an object using a high power laser beam, the method comprising:
a. directing a laser beam into an orifice of a first nozzle;
b. directing a first fluid into the orifice of the first nozzle;
c. the first nozzle forming a first fluid jet, the first fluid jet comprising the laser beam and the first fluid;
d. directing the first fluid jet and the laser beam into an orifice of a second nozzle;
e. directing a second fluid into an annulus of the second nozzle, the annulus surrounding the orifice of the second nozzle;
f. the second nozzle forming a second fluid jet, the second fluid jet comprising an annular fluid jet of the second fluid surrounding the first fluid jet, whereby a laser compound annular fluid jet is formed; and,
g. directing the laser compound annular fluid jet toward an object, whereby the laser beam assists in the removal of at least a portion of the object.

2. The method of claim 1, wherein the first fluid is a liquid and has an index of refraction, the second fluid is a liquid and has an index of refraction, and the index of refraction for the first fluid is greater than the index of refraction for the second fluid, wherein the second fluid jet functions as a cladding medium.

3. The method of claim 2, wherein the index of refraction of the first fluid is greater than or equal to about 1.53.

4. The method of claim 1, wherein the jet comprising the annular fluid jet of the second fluid surrounding the first fluid jet has a numerical aperture of from about 0.12 to about 1.16.

5. The method of claim 1, wherein the numerical aperture is about 0.5 to about 0.9.

6. The method of claim 1, wherein the object is a tubular in a borehole.

7. The method of claim 1, wherein the object is a tubular associated with an offshore drilling rig.

8. The method of claim 1, comprising a step for managing back reflections.

9. The method of claim 4, wherein the second nozzle defines area and the laser beam has a focal point in an area of the second nozzle.

10. The method of claim 4, wherein the first nozzle defines an area and laser beam has a focal point in an area of the first nozzle.

11. The method of claim 9, wherein the first nozzle defines an area and the laser beam has a focal point in an area of the first nozzle.

12. The method of claim 1, wherein the laser beam has a power of at least about 10 kW when it enters the orifice of the first nozzle.

13. The method of claim 2, wherein the laser beam has a power of at least about 10 kW at the object.

14. The method of claim 3, wherein the laser beam has a power of at least about 10 kW at the object.

15. The method of claim 12, wherein the laser beam loses less than 20% of its power as it moves from a location near the orifice of the first nozzle to the object.

16. The method of claim 1, wherein the second fluid comprises a mixture of the first fluid and a third fluid.

17. The method of claim 1, wherein the second fluid comprises a mixture of the first fluid and a third fluid.

18. The method of claim 1, wherein the first fluid is an oil having a refractive index of greater than about 1.53.

19. The method of claim 1, wherein the first fluid is an oil having a refractive index of greater than about 1.53.

20. The method of claim 1, wherein the first fluid comprises an oil and the second fluid comprises a mixture of an oil and an oil.

21. The method of claim 1, wherein a speed of the first fluid in the second fluid jet is substantially the same as a speed of the second fluid in the second fluid jet.

22. The method of claim 1, wherein a speed of the second fluid in the second fluid jet is greater than a speed of the first fluid in the second fluid jet.

23. The method of claim 1, wherein a speed of the first fluid jet in the second fluid jet is greater than a speed of the second fluid in the second fluid jet.

24. A method for removing material from an object using a high power laser beam, the method comprising:
a. directing a laser beam having at least about 5 kW of power into an orifice of a first nozzle;
b. directing a first fluid having a pressure of at least about 3,000 psi into the orifice of the first nozzle;
c. the first nozzle forming a first fluid jet, the first fluid jet comprising the laser beam and the first fluid;
d. directing the first fluid jet and the laser beam into an orifice associated with a second nozzle;
e. directing a second fluid having a pressure of at least about 3,000 psi into an annulus defined by the second nozzle, the annulus surrounding the orifice associated with the second nozzle;
f. the second nozzle forming a second fluid jet, the second fluid jet comprising an annular fluid jet of the second fluid surrounding the first fluid jet, whereby a laser compound annular fluid jet is formed; and,
g. directing the laser compound annular fluid jet toward an object, whereby the laser beam removals material from the object.

25. The method of claim 24, wherein the object is a tubular.

26. The method of claim 25, wherein at least a portion of the tubular is within a borehole.

27. The method of claim 26, wherein the first fluid is a liquid, the second fluid is a liquid, and an index of refraction for the first fluid is greater than an index of refraction for the second fluid.

28. The method of claim 27, wherein the pressure of the first fluid jet is at least about 20,000 psi.

29. The method of claim 28, wherein the second fluid jet has a numerical aperture of from about 0.12 to about 1.16.

30. The method of claim 29, wherein the numerical aperture is about 0.5 to about 0.9.

31. The method of claim 30, comprising managing back reflections.

32. The method of claim 1, wherein the directing the laser compound annular fluid jet comprises directing the laser beam in a predetermined delivery pattern.

33. The method of claim 32, wherein the predetermined delivery pattern comprises a first pass and a second pass.

34. The method of claim 33, wherein the first and second passes have an area of overlap.

35. The method of claim 34, wherein the first and second passes have a plurality of areas of overlap.

36. The method of claim 33, comprising a periphery pass.

37. The method of claim 34, wherein a total volume of material removed from the object by delivery of the predetermined delivery pattern is substantially greater than a volume of material removed by the laser beam.

38. The method of claim 32, wherein a total volume of material removed from the object by delivery of the predetermined delivery pattern is at least 80% greater than a volume of material removed by the laser beam.

39. The method of claim 32, wherein a total volume of material removed from the object by delivery of the predetermined delivery pattern is at least 50% greater than a volume of material removed by the laser beam.

40. The method of claim 32, comprising managing back reflections, and wherein the laser beam has a power of at least about 10 kW at the object, and wherein a total volume of material removed from the object by delivery of the predetermined delivery pattern is at least 80% greater than a volume of material removed by the laser beam.

41. The method of claim 32, comprising managing back reflections, and the laser beam having a power of at least about 10 kW at the object, and wherein a total volume of material removed from the object by delivery of the predetermined delivery pattern is at least 50% greater than a volume of material removed by the laser beam.

42. The method of claim 24, wherein the directing the laser compound annular fluid jet comprises directing the laser beam in a predetermined delivery pattern.

43. The method of claim 42, wherein the predetermined delivery pattern comprises a first pass and a second pass.

44. The method of claim 43, wherein the first and second passes have an area of overlap.

45. The method of claim 44, wherein the first and second passes have a plurality of areas of overlap.

46. The method of claim 43, comprising a periphery pass.

47. The method of claim 44, wherein a total volume of material removed from the object by delivery of the predetermined delivery pattern is substantially greater than a volume of material removed by the laser beam.

48. The method of claim 42, wherein a total volume of material removed from the object by delivery of the predetermined delivery pattern is at least 80% greater than a volume of material removed by the laser beam.

49. The method of claim 42, wherein a total volume of material removed from the object by delivery of the predetermined delivery pattern is at least 50% greater than a volume of material removed by the laser beam.

50. The method of claim 42, comprising managing back reflections, and wherein the laser beam has a power of at least about 10 kW at the object, and wherein a total volume of material removed from the object by delivery of the predetermined delivery pattern is at least 80% greater than a volume of material removed by the laser beam.

51. The method of claim 42, comprising managing back reflections, and the laser beam having a power of at least about 10 kW at the object, and wherein a total volume of material removed from the object by delivery of the predetermined delivery pattern is at least 50% greater than a volume of material removed by the laser beam.

52. A method of cutting tubulars associated with a borehole, the method comprising:
a. providing a laser tool near the tubular to be cut;
b. forming a compound fluid laser jet and shooting the compound fluid laser jet through a medium in a direction toward the tubular, the compound fluid jet having a first axis corresponding to the direction, the compound fluid jet formed such that the jet comprises an inner core having a second axis corresponding to the first axis, and an outer liquid sheath having a third axis corresponding to the first axis;
c. directing a laser beam within the inner core of the compound fluid laser jet along the first axis of the compound fluid laser jet, whereby the outer liquid in the jet substantially prevents a medium in a borehole from interfering with the laser beam;
d. wherein the laser beam contacts a tubular without substantial power loss from the medium; and
e. wherein the laser beam cuts at least a portion of the tubular.

53. The method of claim 52, wherein the tubular comprises a sub-sea riser and the medium is seawater.

54. The method of claim 52, wherein the tubular comprises a sub-sea riser.

55. The method of claim 52, wherein the tubular comprises a casing.

56. The method of claim 52, wherein the tubular comprises a drill pipe.

57. The method of claim 52, wherein the medium is selected from the group consisting of water, brine, drilling mud, cuttings, and combinations thereof.

58. The method of claim 52, wherein the medium is selected from the group consisting of water, seawater, salt water, brine, drilling mud, air, nitrogen, inert gas, diesel, drilling fluid, non-transmissive liquid, non-transmissive mixture, two-phase fluid, three-phase fluid, mist, foam, cuttings, and combinations thereof.

59. The method of claim 52, wherein the tubular comprises a casing and the medium is selected from the group consisting of water, seawater, salt water, brine, drilling mud, air, nitrogen, inert gas, diesel, drilling fluid, non-transmissive liquid, two-phase fluid, three-phase fluid, mist, foam, cuttings, and combinations thereof.

60. The method of claim 52, wherein the tubular comprises a drill pipe and the medium is selected from the group consisting of water, seawater, salt water, brine, drilling mud, air, nitrogen, inert gas, diesel, drilling fluid, non-transmissive liquid, two-phase fluid, three-phase fluid, mist, foam, cuttings, and combinations thereof.

61. The method of claim 52, wherein the tubular comprises a sub-sea riser and the medium is selected from the group consisting of water, seawater, salt water, brine, drilling mud, air, nitrogen, inert gases, diesel, drilling fluid, non-transmissive liquid, two-phase fluid, three-phase fluid, mist, foam, cuttings, and combinations thereof.

62. The method of claim 52, wherein the laser tool is positioned inside of the tubular.

63. The method of claim 52, wherein the laser tool is positioned outside of the tubular.

64. The method of claim 52, wherein the inner fluid is a liquid having an index of refraction, the outer liquid has an index of refraction, and the index of refraction for the inner liquid is greater than the index of refraction for the outer liquid, wherein the jet functions as a cladding medium.

65. The method of claim 52, wherein the tubular is selected from the group consisting of sub-sea riser, drill pipe, and casing and the medium is selected from the group consisting of water, seawater, salt water, drilling mud, air, nitrogen, an inert gas, diesel, drilling fluid, and a non-transmissive liquid, two-phase fluid, three-phase fluid, mist, foam, cuttings, and combinations thereof.

66. The method of claim 52, wherein the laser beam has a power of at least about 5 kW when it enters the inner core.

67. The method of claim 52, wherein the laser beam has a power of at least about 10 kW at the tubular.

68. The method of claim 52, wherein a speed of the inner fluid in the jet is substantially the same as a speed of the outer liquid in the jet.

69. The method of claim 52, wherein a speed of the outer liquid in the jet is greater than a speed of the inner liquid in the jet.

70. A method of cutting an object associated with a borehole, the method comprising:
a. providing a laser tool within the borehole near the object to be cut;
b. forming a compound laser jet and shooting the compound laser jet through a medium in a direction toward the object to be cut, the compound jet having an axis corresponding to the direction, the compound jet formed such that the jet comprises an inner fluid core having an axis corresponding to the axis, and an outer fluid sheath having an axis corresponding to the axis;
c. directing a laser beam within the inner core of the compound laser jet along the axis of the compound laser jet;
d. the medium being substantially non-transmissive to the laser beam;
e. the outer fluid in the jet preventing the medium from blocking the transmission of the laser beam;
f. wherein the laser beam contacts the object and cuts at least a portion of the object.

71. A method of delivering a high power laser beam through an at least partially obstructing medium, the method comprising:
a. optically associating a high power laser tool with a source of a high power laser beam, the high power laser tool having a beam launch face;
b. positioning the high power laser tool in an environment containing a partially obstructing medium;
c. providing the high power laser beam to the laser tool, wherein the high power laser beam travels along a beam path defined by the high power laser tool, wherein the beam path extends from within the laser tool, through the beam launch face, away from the laser tool and into the medium;
d. focusing the high power laser beam along the beam path, thereby providing a focal length of at least about a first distance and providing a focal point along the beam path;
e. the focal point being in the medium and at least about a second distance away from the launch face; and,
f. providing a high pressure gas jet along a portion of beam path extending away from the beam launch face;
g. wherein, the high power laser beam is capable of traveling at least the second distance through the medium along the beam path without substantial power loss and without substantial formation of back reflections along the beam path.

72. The method of claim 71, wherein the laser source is capable of generating a laser beam having at least about 5 kW of power.

73. The method of claim 71, wherein the laser source is capable of generating a laser beam having at least about 10 kW of power.

74. The method of claim 71, wherein the laser source is capable of generating a laser beam having at least about 20 kW of power.

75. The method of claim 71, wherein the laser source is capable of generating a laser beam having at least about 5 kW of power.

76. The method of claim 71, wherein the laser beam has a power of at least about 5 kW at a point along the beam path within the laser tool.

77. The method of claim 71, wherein the laser beam has a power of at least about 10 kW at a point along the beam path within the laser tool.

78. The method of claim 71, wherein the laser beam has a power of at least about 15 kW at a point along the beam path within the laser tool.

79. The method of claim 71, comprising providing a plurality of laser beams to the laser tool.

80. The method of claim 71, wherein the first distance is greater than about 1 foot and the second distance is greater than about 2 inches.

81. The method of claim 71, wherein the first distance is greater from about 1 to about 3 feet and the second distance is from about 1 inch to about 8 inches

82. The method of claim 71, wherein the laser beam is capable of traveling at least 1.5 times as long as the second distance through the medium along the beam path without substantial power loss.

83. The method of claim 71, wherein the laser beam is capable of traveling at least twice as long as the second distance through the medium along the beam path without substantial power loss.

84. The method of claim 73, wherein the laser beam is capable of traveling at least 1.5 times as long as the second distance through the medium along the beam path without substantial power loss.

85. The method of claim 73, wherein the laser beam is capable of traveling at least twice as long as the second distance through the medium along the beam path without substantial power loss.

86. The method of claim 76, wherein the laser beam is capable of traveling at least 1.5 times as long as the second distance through the medium along the beam path without substantial power loss.

87. The method of claim 76, wherein the laser beam is capable of traveling at least twice as long as the second distance through the medium along the beam path without substantial power loss.

88. The method of claim 78, wherein the laser beam is capable of traveling at least 1.5 times as long as the second distance through the medium along the beam path without substantial power loss.

89. The method of claim 78, wherein the laser beam is capable of traveling at least twice as long as the second distance through the medium along the beam path without substantial power loss.

90. The method of claim 81, wherein the laser beam is capable of traveling at least 1.5 times as long as the second distance through the medium along the beam path without substantial power loss.

91. The method of claim 81, wherein the laser beam is capable of traveling at least twice as long as the second distance through the medium along the beam path without substantial power loss.

92. The method of claim 71, wherein the medium is selected from the group consisting of water, seawater, salt water, brine, drilling mud, drilling fluid, hydrocarbons, non-transmissive liquid, non-transmissive mixture, two-phase fluid, three-phase fluid, mist, foam, cuttings, and combinations thereof.

93. The method of claim 73, wherein the medium is selected from the group consisting of water, seawater, salt water, brine, drilling mud, hydrocarbons, non-transmissive liquid, non-transmissive mixture, two-phase fluid, three-phase fluid, mist, foam, cuttings, and combinations thereof.

94. The method of claim 76, wherein the medium is selected from the group consisting of water, seawater, salt water, brine, drilling mud, hydrocarbons, drilling fluid, non-transmissive liquid, non-transmissive mixture, two-phase fluid, three-phase fluid, mist, foam, cuttings, and combinations thereof.

95. The method of claim 78, wherein the medium is selected from the group consisting of water, seawater, salt water, brine, drilling mud, air, nitrogen, inert gas, diesel, drilling fluid, non-transmissive liquid, hydrocarbons, non-transmissive mixture, two-phase fluid, three-phase fluid, mist, foam, cuttings, and combinations thereof.

96. The method of claim 81, wherein the medium is selected from the group consisting of water, seawater, salt water, brine, drilling mud, air, nitrogen, inert gas, diesel, drilling fluid, non-transmissive liquid, hydrocarbons, non-transmissive mixture, two-phase fluid, three-phase fluid, mist, foam, cuttings, and combinations thereof.

97. The method of claim 71, comprising directing the laser beam along the beam path in a predetermined delivery pattern.

98. The method of claim 97, wherein the predetermined delivery pattern comprises a first pass and a second pass.

99. The method of claim 98, wherein the first and second passes have an area of overlap.

100. The method of claim 98, wherein the first and second passes have a plurality of areas of overlap.

101. The method of claim 97, comprising a periphery pass.

102. The method of claim 97, wherein the predetermined delivery pattern provides for a total volume of material to be removed from an object by delivery of the predetermined delivery pattern to be substantially greater than a volume of material to be removed by the laser beam.

103. The method of claim 97, wherein the predetermined delivery pattern provides for a total volume of material to be removed from an object by delivery of the predetermined delivery pattern to be at least 80% greater than a volume of material to be removed by the laser beam.

104. The method of claim 97, wherein the predetermined delivery pattern provides for a total volume of material to be removed from an object by delivery of the predetermined delivery pattern to be at least 80% greater than a volume of material to be removed by the laser beam.

105. A method of delivering a high power laser beam through a medium to an object, the method comprising:
a. optically associating a high power laser tool with a source for a high power laser beam, the high power laser tool having a beam launch face;
b. positioning the high power laser tool in an environment containing a medium, the high power laser tool defining a beam path, wherein the beam path extends from within the laser tool, through the beam launch face, away from the laser tool and into the medium;
c. providing the high power laser beam to the laser tool, whereby the high power laser beam travels along the beam path;
d. focusing the high power laser beam along the beam path, thereby providing a focal length of at least about a first distance and providing a focal point along the beam path at least about a second distance away from the launch face; and,
e. providing a high pressure gas jet along a portion of beam path extending away from the beam launch face;
f. wherein, the high power laser beam is delivered along the beam path to an object in a predetermined beam delivery pattern without substantial power loss and without substantial formation of back reflections along the beam path.

106. The method of claim 105, wherein the beam launch face is a locking ring.

107. The method of claim 105, wherein the beam launch face comprises the face of a high pressure gas jet nozzle.

108. The method of claim 105, wherein the beam launch face comprises an outer surface of the laser tool.

109. The method of claim 105, wherein the gas jet comprises nitrogen having a pressure of at least 5,000 psi.

110. The method of claim 105, wherein the gas jet comprises nitrogen having a pressure of at least 20,000 psi.

111. The method of claim 105, wherein the gas jet has a pressure greater than a pressure of the medium in the environment.

112. The method of claim 105, wherein the first distance is greater than about 2 feet.

113. The method of claim 105, wherein the first distance is greater than about 3 feet.

114. A method of delivering a high power laser beam through a medium to an object, the method comprising:
a. optically associating a high power laser tool with a source for a high power laser beam having at least 10 kW of power, the high power laser tool having a nozzle and a beam launch opening;
b. positioning the high power laser tool a first distance from an object in an environment containing a medium, the high power laser tool defining a beam path, wherein the beam path extends from within the laser tool, through the nozzle, through the beam launch opening, away from the laser tool and into the medium and to the object;
c. providing the high power laser beam to the laser tool, whereby the high power laser beam travels along the beam path to the object;
d. focusing the high power laser beam along the beam path, thereby providing a focal length of at least about a second distance and providing a focal point along the beam path at least about a third distance away from the launch opening; and,
e. providing a jet from the nozzle at least along the portion of beam path extending away from the beam launch opening;
f. wherein, the high power laser beam is delivered along the beam path to the object in a predetermined pattern;
g. wherein the second distance is greater than the first distance and the third distance, and the third distance is greater than the first distance.

115. The method of claim 114, wherein the jet comprises a supercritical fluid.

116. The method of claim 114, wherein the jet comprises air.

117. The method of claim 114, wherein the jet comprises an oil.

118. The method of claim 114, wherein the jet has a pressure greater than a pressure of the medium in the environment.

119. The method of claim 114, wherein the jet has a pressure greater than about 5,000 psi.

120. The method of claim 114, wherein the first distance is less than about 1 inch.

121. The method of claim 114, wherein the first distance is less than about 2 inches.

122. The method of claim 114, wherein the first distance is less than about 6 inches.

123. The method of claim 114, wherein the first distance is from about 1 to about 6 inches.

124. The method of claim 114, wherein the first distance is greater than about 1 inch.

125. The method of claim 114, wherein the first distance is greater than about 3 inches.

126. The method of claim 114, wherein the second distance is greater than about 12 inches.

127. The method of claim 114, wherein the second distance is greater than about 18 inches.

128. The method of claim 114, wherein the second distance is greater than about 24 inches.

129. The method of claim 114, wherein the second distance is greater than about 30 inches.

130. The method of claim 114, wherein the second distance is greater than about 36 inches.

131. The method of claim 114, wherein the third distance is greater than about 3 inches.

132. The method of claim 114, wherein the third distance is greater than about 6 inches.

133. The method of claim 114, wherein the first distance is about 1 inch, the second distance is about 3 feet and the third distance is about 6 inches.

134. A method of delivering a high power laser beam through a medium to an object, the method comprising:
a. optically associating a high power laser tool with a source for a high power laser beam having at least 5 kW of power, the high power laser tool having a face from which the laser beam is launched;
b. positioning the high power laser tool face a first distance from an object in an environment containing a medium, the high power laser tool defining a beam path, wherein the beam path extends from within the laser tool, through the face, into the medium and to the object;
c. providing the high power laser beam to the laser tool, whereby the high power laser beam travels along the beam path to the object;
d. focusing the high power laser beam along the beam path, thereby providing a focal length of at least about a second distance and providing a focal point along the beam path at least about a third distance away from the face; and,
e. providing a jet from a nozzle, the jet directed at the object;
f. wherein the high power laser beam is delivered along the beam path to the object in a first predetermined pattern;
g. wherein the jet is delivered to the object in a second predetermined pattern;
h. wherein the second distance is greater than about 2 feet.

135. The methods of claim 105, 114 or 134, wherein the laser beam forms a spot at a surface of the object having an area of at least about 0.065 inches.

136. The methods of claim 105, 114 or 134, wherein the laser beam forms a spot at a surface of the object having an area of at least about 0.01 inches.

137. The methods of claim 105, 114 or 134, wherein the medium is selected from the group consisting of water, seawater, salt water, brine, nitrogen, diesel, air, drilling mud, air, nitrogen, inert gas, diesel, drilling fluid, non-transmissive liquid, two-phase fluid, three-phase fluid, mist, foam, cuttings, and combinations thereof.

138. The method of claim 105, 114 or 134, wherein the laser beam predetermined pattern comprises directing the laser beam in a predetermined delivery pattern.

139. The method of claim 105, 114 or 134, wherein the laser beam predetermined pattern comprises a first pass and a second pass.

140. The method of claim 105, 114 or 134, wherein the laser beam predetermined pattern comprises a first pass and a second pass and the first and second passes have an area of overlap.

141. The method of claim 105, 114 or 134, wherein the laser beam predetermined pattern comprises a first pass and a second pass and the first and second passes have plurality of areas of overlap.

142. The method of claim 105, 114 or 134, wherein the laser beam predetermined pattern comprises a periphery pass.

143. The method of claim 105, 114 or 134, wherein a total volume of material removed from the object by delivery of the pattern is substantially greater than a volume of material removed by the laser beam.

144. The method of claim 105, 114 or 134, wherein a total volume of material removed from the object by delivery of the pattern is at least 80% greater than a volume of material removed by the laser beam.

145. The method of claim 105, 114 or 134, wherein a total volume of material removed from the object by delivery of the pattern is at least 50% greater than a volume of material removed by the laser beam.

146. The method of claim 105, 114 or 134, comprising managing back reflections, and wherein the laser beam has a power of at least about 10 kW at the object, and wherein a total volume of material removed from the object by delivery of the pattern is at least 80% greater than a volume of material removed by the laser beam.

147. The method of claim 105, 114 or 134, comprising managing back reflections, and the laser beam having a power of at least about 10 kW at the object, and wherein a total volume of material removed from the object by delivery of the pattern is at least 50% greater than a volume of material removed by the laser beam.

148. A method for launching a high power laser beam into a flowing liquid, the method comprising:
a. directing a high power laser beam having at least 5 kW of power into a prism having a first index of refraction, wherein the prism comprises a first face and a second face, the laser beam entering the first face and the laser beam exiting the second face;
b. flowing a liquid across the second face of the prism, the liquid having a second index of refraction, wherein the second index of refraction is essentially the same as the first index of refraction;
c. wherein the laser beam travels into the fluid.

149. The method of claim 148, wherein first index of refraction is from about 10% greater to about 10% smaller than the second index of refraction.

150. The method of claim 149, wherein first index of refraction is from about 5% greater to about 5% smaller than the second index of refraction.

151. The method of claim 150, wherein first index of refraction is from about 1% greater to about 1% smaller than the second index of refraction.

152. The method of claim 149, wherein the fluid and the laser beam travel into a nozzle and exit the nozzle as a laser fluid jet.

153. The method of claim 152, wherein the laser fluid jet is directed toward a surface in a borehole.

154. The method of claim 152, wherein the nozzle comprises a non-imaging concentrator.

155. A method of removing material from a casing within a borehole to form a window, by cutting the casing, the method comprising:
a. cutting a kerf into a casing in a borehole in a predetermined pattern;
b. the kerf having a plurality of kerf overlap areas, wherein the kerf and overlap areas define a plurality of sections of uncut casing; and,
c. removing the sections of uncut casing, thereby forming a window in the casing;
d. wherein a total volume of material removed to form the window is substantially greater than a volume of material removed by cutting the kerf.

156. The method of claim 155, wherein the total volume of material removed to form the window is at least 80% greater than the volume of material removed by cutting the kerf.

157. The method of claim 155, wherein the total volume of material removed to form the window is at least 50% greater than the volume of material removed by cutting the kerf.

158. The method of claim 155, wherein the kerf is cut using a high power laser beam.

159. The method of claim 158, wherein the kerf is cut using a laser beam having a power of at least about 5 kW at the casing.

160. The method of claim 155, wherein a plurality of kerfs are cut into the casing.

161. An apparatus for cutting tubulars in a borehole, the apparatus comprising:
a. a housing configured for insertion into a borehole, the housing having an inlet for receiving a laser beam and an outlet for delivering a laser compound fluid jet;
b. a means for conveying the housing to a predetermined position with respect to a tubular in a borehole, said conveying means comprising a means for transmitting a laser beam to the housing, the transmitting means associated with the housing by way of the inlet for receiving the laser beam;
c. the housing comprising a means for controlling the laser beam, a first nozzle assembly, a second nozzle assembly, a first fluid path for providing a first fluid to the first nozzle assembly, a second fluid path for providing a second fluid to the second nozzle assembly;
d. the first fluid path containing the first fluid, the first fluid having a first index of refraction;
e. the second fluid path containing the second fluid, the second fluid having a second index of refraction;
f. the first nozzle assembly, the second nozzle assembly, and the means for controlling the laser beam configured within the housing to provide a laser fluid jet that exits the housing by way of the housing jet outlet, wherein the laser fluid jet comprises an inner core of the first fluid, the laser beam contained within the inner core, and an outer annular jet of the second fluid; and,
g. the index of refraction of the first fluid is greater than the index of refraction of the second fluid, whereby the first fluid jet functions as a waveguide.

162. The apparatus of claim 161, wherein the laser beam has at least about 3 kW of power at the housing laser inlet.

163. The apparatus of claim 161, wherein the laser beam has at least about 5 kW of power at the housing laser inlet.

164. The apparatus of claim 161, wherein the laser beam has at least about 10 kW of power at the housing laser inlet.

165. The apparatus of claim 161, wherein the means for transmitting is a single optical fiber.

166. The apparatus of claim 161, wherein the means for transmitting is a single optical fiber.

167. The apparatus of claim 161, wherein the means for controlling comprises a means for focusing the laser.

168. The apparatus of claim 161, wherein the means for controlling comprises a means for collimating the laser.

169. The apparatus of claim 161, wherein the means for controlling comprises a means for directing the laser.

170. The apparatus of claim 161, wherein the first fluid is an oil having an index of refraction greater than about 1.53.

171. The apparatus of claim 161 wherein the second fluid has an index of refraction less than about 1.53.

172. An apparatus for cutting an object associated with a borehole, the apparatus comprising:
a. a housing, the housing having an inlet for receiving a laser beam and an outlet for delivering a laser compound fluid jet;
b. a means for conveying the housing to a predetermined position in relation to an object associated with a borehole, said conveying means comprising a means for transmitting a laser beam to the housing, the transmitting means associated with the housing by way of the inlet for receiving the laser beam;
c. the housing comprising a means for controlling the laser beam, a first nozzle assembly, a second nozzle assembly, a first fluid path for providing a first fluid to the first nozzle assembly, a second fluid path for providing a second fluid to the second nozzle assembly;
d. a means for providing the fluids to the housing;
e. the first fluid path containing the first fluid, the first fluid having a first index of refraction;
f. the second fluid path containing the second fluid, the second fluid having a second index of refraction;
g. the first nozzle assembly, the second nozzle assembly, and the means for controlling the laser beam configured within the housing to provide a laser fluid jet that exits the housing by way of the housing jet outlet, wherein the laser fluid jet comprises an inner core of the first fluid, the laser beam contained within the inner core, and an outer annular jet of the second fluid; and,
h. the index of refraction of the first fluid is greater than the index of refraction of the second fluid.

173. The apparatus of claim 172, wherein the laser beam has at least about 1 kW of power at the housing laser inlet.

174. The apparatus of claim 172, wherein the laser beam has at least about 3 kW of power at the housing laser inlet.

175. The apparatus of claim 172, wherein the laser beam has at least about 5 kW of power at the housing laser inlet.

176. The apparatus of claim 172, wherein the laser beam has at least about 10 kW of power at the housing laser inlet.

177. The apparatus of claim 172, wherein the means for transmitting is a single optical fiber.

178. The apparatus of claim 172, wherein the means for transmitting is a single optical fiber.

179. The apparatus of claim 172, wherein the means for controlling comprises a means for focusing the laser.

180. The apparatus of claim 172, wherein the means for controlling comprises a means for collimating the laser.

181. The apparatus of claim 172, wherein the means for controlling comprises a means for directing the laser.

182. The apparatus of claim 172, wherein the first fluid is an oil having an index of refraction greater than about 1.53.

183. The apparatus of claim 172, wherein the second fluid is has an index of refraction less than about 1.53.

184. An apparatus for providing a laser waveguide compound fluid jet, the apparatus comprising:
a. an inlet for receiving a laser beam and an outlet for delivering a laser compound fluid jet;
b. a laser source in optical communication with the inlet for receiving the laser beam;
c. an optic in optical communication with the inlet;
d. a nozzle in optical communication with the optic;
e. a first passage in fluid communication with the nozzle;
f. a second fluid passage in fluid communication with the nozzle;
g. the first passage comprising a first fluid and the second passage comprising a second fluid, the first fluid having an index of refraction that is greater than the second fluid; and,
h. the nozzle in fluid and optical communication with the outlet.

185. An apparatus of delivering a high power laser beam through an optically obstructive medium the apparatus comprising:
a. a housing, the housing having an outer surface;
b. the housing having a fluid channel for directing a fluid to a nozzle for forming a fluid jet;
c. a mirror capable of reflecting a high power laser beam;
d. the mirror located within the housing;
e. an optics assembly having a focusing element and a directing element;
f. the focusing element having a focal length of greater than 1 foot;
g. the directing element configured to direct the laser beam along a laser beam path, wherein the laser beam path extends between the mirror and an orifice in the nozzle; and,
h. wherein a focal point is located outside of the housing and at least about 3 inches away from the housing surface.

186. The apparatus of claim 187, comprising a means for managing back reflections.

187. An apparatus of delivering a high power laser beam, the apparatus comprising:
a. a laser tool comprising a housing and a laser cutting head, the housing having an outer surface and the laser cutting head having an outer surface;
b. a nozzle having an opening, the opening of the nozzle associated with the outer surface of the laser cutting head, the nozzle having a passage in fluid communication with the opening of the nozzle for forming and directing a fluid jet;
c. a means for providing a laser beam path having a focal point along the laser beam path; and
d. wherein the laser beam path is through the passage of the nozzle and opening of the nozzle and a focal point is on the laser beam path and the focal point is outside of the outer surface of the laser cutting head.

188. A laser beam delivery system, comprising:
a. a means for providing a high power laser beam;
b. a high power laser tool;
c. a means for conveying the high power laser beam and a first fluid to the high power laser tool;
d. a means for forming a laser jet; and,
e. a means for managing back reflections.

189. The system of claim 188, wherein the means for forming the fluid jet is a means for forming a compound annular fluid jet.

190. A high power laser tool, comprising:
a. a body;
b. an optics assembly comprising a focusing element and a prism;
c. the optics assembly defining a first laser beam path and a second laser beam path,
d. the body comprising a nozzle for forming a fluid jet;
e. the first laser beam path extending from a face of the prism into the body; and,
f. the second laser beam path extending from the face of the prism into the nozzle;
g. wherein a laser beam will travel along the second beam path when a fluid having a preselected index of refraction is adjacent the face of the prism and contained within the nozzle.
